(19) United States
(12) Patent Application Publication
(10) Pub. No.: US 2010/0004957 A1
(43) Pub. Date: Jan. 7, 2010

(54) Interactive system and methods for insurance-related activities

(76) Inventor: Robert Ball, Atlanta, GA (US)

Correspondence Address: WINSTON & STRAWN LLP;PATENT DEPARTMENT, 1700 K STREET, N.W., WASHINGTON, DC, 20006, US

(21) Appl. No.: 12/380,564

(22) Filed: Feb. 27, 2009

Related U.S. Application Data
(63) Continuation-in-part of application No. 12/113,087, filed on Apr. 30, 2008.
Application No. 12/113,087 is a continuation-in-part of application No. 11/891,616, filed on Aug. 10, 2007.
Application No. 11/891,616 is a continuation-in-part of application No. 11/510,537, filed on Aug. 25, 2006.
(60) Provisional application No. 60/763,200, filed on Jan. 27, 2006.

(51) Int. Cl. G06Q 40/00

(52) U.S. Cl. 705/4; 705/35

(57) ABSTRACT

Systems and methods for performing insurance related activities are provided. Software can be implemented to provide a (optionally networked) application that includes an interactive interface for use by insurance professionals in managing clients. Personal data can be received for computing a client's financial condition. Business data of the client can be received for computing a business financial condition of the business at the death of the client. An assumption of the business financial condition, including levels of business owned life insurance can be modified. A selection mechanism can also be provided, which when selected displays a representation of a death benefits to the client and to the business, based on the modified assumption. The personal financial and business financial condition can change in relation to a change in the personal death and business death benefit as the assumptions are interactively modified, thereby showing the benefit of business owned life insurance.

### RELATED PATENT APPLICATION

This application is a continuation-in-part of U.S. patent application Ser. No. 12/113,087 filed Apr. 30, 2008, which is a continuation-in-part of U.S. patent application Ser. No. 11/891,616 filed Aug. 10, 2007, which is a continuation-in-part of U.S. patent application Ser. No. 11/510,537 filed Aug. 25, 2006, which claims the benefit of U.S. Provisional Patent Application No. 60/763,200 filed Jan. 27, 2006, which are hereby incorporated herein by reference in their entirety.

### COPYRIGHT NOTICE

The present application includes material that is subject to copyright protection. The copyright owner does not object to the facsimile reproduction of the application by any person as the application appears in the records of the U.S. Patent and Trademark Office, but otherwise reserves all rights in the copyright.

### BACKGROUND OF THE INVENTION

The present invention relates to interactive tools for assisting insurance professionals in performing activities such as marketing services to new or existing clients, managing client relationships, and prospecting for new clients.

Historically, insurance professionals have relied on traditional paper and notebook type techniques for tasks such as client management, organization, sales, and marketing. Transitioning to computer-based solutions can be complex and confusing to such professionals who may not already have familiarity with using personal computers and the Internet. In addition, many who are presently practicing in the insurance field commenced their careers well before the prevalence of personal computers and the Internet. The insurance field is also one in which professionals practicing in that field tend to adopt and maintain the traditional ways of conducting business. However, many of those who are entering the insurance field as professionals are typically individuals who are accustomed and more comfortable interacting with an electronic world of personal computer and the Internet then traditional techniques. As such, electronic solutions and features for insurance professionals that can meet the variable needs of interested parties are needed in the insurance field.

Moreover, known software applications for insurance professionals do not provide adequate support for a broad range of activities or services that are needed by the insurance professionals. For example, such known software applications are inadequate in meeting the needs of insurance professionals in areas such as interactive insurance reports, client organizers, interactive insurance calculators, client data gathering tools, automatic configuration based on client data, etc.

As such, a need exists for improved software and system solutions in the insurance field.

### SUMMARY OF THE INVENTION

In accordance with the principles of the present invention, methods, apparatuses, media, and systems for providing interactive insurance related tools and applications are provided.

For example, a method or system for providing an interactive retirement tool on a platform is provided. The method or system can include receiving personal data of a client for computing a personal financial condition for the client's family at a death of the client. The method or system can include receiving business data of a business for computing a business financial condition of the business at the death of the client. The method or system can include modifying an assumption of the business financial condition. The method or system can include providing a selection mechanism, which when selected displays a representation of a personal death benefit to the client and a representation of a business death benefit to the business, based on the modified assumption. The personal financial condition and the business financial condition can change in relation to a change in the personal death benefit and the business death benefit (e.g., as the assumption is interactively changed). Modifying the assumption of the business financial condition can include selecting a business owned life insurance policy for a key person of the business.

The system or method can include maintaining a business cash flow of the business at the death of the client within a threshold of a desired percentage of another business cash flow of the business prior to the death of the client, based on the modified assumption; and maintaining a personal cash flow of the family at the death of the client within a threshold of another desired percentage of another personal cash flow of the family prior to the death of the client, based on the modified assumption. The modified assumption can include an addition of business owned life insurance.

The system or method can include displaying an impact on the liability of the business based on the business death benefit. The liability can include funding a purchase of an ownership in the business, paying a mortgage or loan of the business, or replacing lost profits due to the death of a key person of the business.

The system or method can include displaying an impact on an asset of the family as a debt in an amount of a value of the business less at least a portion of the business death benefit.

The system or method can include computing a personal cash flow of the personal financial condition based on at least two of a savings rate of the family, a spending rate of the family, an income of the family, and an income replacement comprising disability insurance payments, retirement income, or savings; and computing a net worth of the family based on an asset of the family, a liability of the family, and the change in the personal death benefit.

The system or method can include determining if an option is selected to sell an ownership of the business by the family at the death of the client. If so, the method or system can perform computing an owner's equity of the business financial condition based on a mortgage or loan liability of the business, a contractual requirement to purchase the ownership by the business for a value of the business, and the change in the business death benefit; computing a business cash flow of the business financial condition based on the mortgage or loan liability of the business and the change in the business death benefit; computing a liability of the personal financial condition based on a debt owed by the business for at least a portion of a value of the business that is unfunded by the change in the business death benefit; and computing a cash flow of the personal financial condition based on any assets paid by the business for the ownership.

The system or method can include determining if an option is selected to keep an ownership of the business by the family at the death of the client. If so, the method or system can perform computing an owner's equity of the business financial condition based on a mortgage or loan liability of the business and the change in the business death benefit; and computing a business cash flow of the business financial condition based on the mortgage or loan liability of the business and the change in the business death benefit.

The system or method can include varying a display of the personal financial condition for a client's family and a display of the business financial condition of the business based on a combination of at least two of a scenario for keeping an ownership of the business with the family, a scenario for selling the ownership, a scenario for changing a business owned life insurance policy, and a scenario for changing a personal life insurance policy.

In another example, an apparatus for providing an interactive retirement tool can be provided. The apparatus can include a first computing component configured to generate a personal financial condition for a client's family at a death of the client, based on personal data of the client. The apparatus can include a second computing component configured to generate a business financial condition of the business at the death of the client, based on business data of a business of the client. At least a portion of the personal financial condition or business financial condition can be configured to be modified in a layer in a user interface. The apparatus can include a third computing component configured to receive an assumption about the business financial condition and the personal financial condition. The assumption can include a personal life insurance policy for the client, and a business owned life insurance policy for a key person of the business. The apparatus can include a fourth computing component configured to change the personal financial condition and the business financial condition based on a change in a level of insurance protection provided by the received assumption.

The fourth computing component can be further configured to display, based on the change in the level of insurance protection, a positive cash flow within the displayed layer. The cash flow can be a business cash flow of the business or a client cash flow of the client. The fourth computing component can be further configured to maintain a cash flow of the business at the death of the client within a threshold of a desired percentage of another cash flow of the business prior to the death of the client.

The apparatus can include a fifth component for displaying an impact on a liability of the business based on the business death benefit. The liability can include funding a purchase of an interest in the business, paying a mortgage or loan of the business, or replacing lost profits due to the death of the key person.

The apparatus can include a fifth component for providing an interface mechanism for establishing a business sponsored retirement program or executive benefit plan based on a decision tree data structure. The decision tree data structure can include rules based on a type of the business, the business financial condition, and an employee characteristic.

In another example, a system for providing an interactive retirement tool over a network can be provided. The system can include a consumer interface for providing over the network, personal data about a client and business data about a business of the client. The system can include a web host configured for calculating personal financial condition based on the personal data and to generate business financial condition based on the business data.

The system can include an insurance carrier for marketing to the client over the network, the personal life insurance policy and the business owned life insurance policy.

The system can include an agent that is configured to perform actions. The actions can include providing a selection mechanism configured to receive a selection of a personal life insurance policy for the client and a business owned life insurance policy for a key person employed by the business; and providing another selection mechanism, which when selected displays an aggregation of a representation of a personal death benefit to the client and a representation of a business death benefit to the business based on a combination of the life insurance policies. The personal financial condition and the business financial condition can change in relation to changes in the death benefit.

The agent's actions can further include displaying an interactive comparison for displaying at death and the current business financial condition and personal financial condition.

The agent's actions can further include displaying an interactive tool for varying an application or parameter of the life insurances; and sending a message over the network to the web host to recalculate the personal financial condition and the business financial condition based on the varied application or parameter. The business financial condition can include an owner's equity comprising a business liability and a portion of the business death benefit that is due to a change in the business owned life insurance.

The agent's actions can further include providing an interactive cash flow planning tool for predicting a cash flow of the business based on a mortgage or loan information and an insurance protection for an asset of the business. The asset can include a key person of the business. The business financial condition can include the business cash flow of the business.

In another example, a user interface for providing an interactive retirement tool comprising computer displayed components can be provided. The user interface can include a personal interactive snapshot summary configured to provide personal information about a plurality of personal financial domains of the client. A plurality of layers of the personal summary can display each of the different plurality of personal financial domains. The user interface can include a business interactive snapshot summary configured to provide business information about a plurality of business financial domains of the business. A plurality of layers of the business summary can display each of the different plurality of business financial domains.

The user interface can include a selection mechanism configured to modify an assumption about the personal financial domains and the business financial domains. A modification of the assumption changes a display of the personal information and the business information. A change in the personal information can be a function of a change in the business information and whether the assumption can include sufficient levels of an additional insurance protection to fund a liability of the client and the business. The user interface can include a navigation mechanism configured to modify the information displayed in the personal and business information based on a sequence of displays of information within the personal financial domains and the business financial domains.

The user interface can further include a personal data entry interface configured to receive information about at least a portion of the plurality of personal financial domains. The user interface can further include a personal cash flow interface configured to determine a cash flow of the family at the death or disability of the client. The user interface can further include a business cash flow design interface configured to compute a cash flow of the business based on a business valuation and at least a portion of the business financial domains. The user interface can further include a business protection interface configured to determine a degree of protection for at least a portion of the business financial domains. The user interface can further include a retirement plan interface configured to suggest a business paid retirement plan for a plurality of covered persons of the business based on received answers to decision trees. The user interface can further include a reporting interface configured to generate an observation reports about the personal financial domains and the business financial domains based on a received level of selected insurance for a key person, a received information about a mortgage and loan of the business.

In another example, a processor readable medium for providing an interactive retirement tool can be provided. The processor readable medium can include instructions that when executed by a processor causes the processor to perform actions. The actions can include receiving personal data of a client for computing a personal financial condition for a client's family at a death of the client; receiving business data of a business for computing a business financial condition of the business at the death of the client; selecting a personal life insurance policy for the client; selecting a business owned life insurance policy for a key person employed by the business; and providing a selection mechanism, which when selected displays an aggregation of a representation of a personal death benefit to the client and a representation of a business death benefit to the business based on a combination of the life insurance policies. The personal financial condition and the business financial condition can change in relation to a change in the personal death benefit and a change in the business death benefit.

### BRIEF DESCRIPTION OF THE DRAWINGS

Further features of the invention, its nature and various advantages will be more apparent from the following detailed description, taken in conjunction with the accompanying drawings in which like reference characters refer to like parts throughout, and in which:

FIG. 1 is a functional block diagram of illustrative systems for providing software-implemented insurance related services in accordance with one embodiment of the invention;

FIG. 2 is a flow chart for providing interactive insurance related services to insurance professionals in accordance with one embodiment of the invention;

FIG. 3 is a flow chart for providing a network application to insurance professionals in accordance with one embodiment of the invention;

FIG. 4 is a flow chart for providing a software application for insurance professionals in accordance with one embodiment of the invention;

FIG. 5 is a flow chart for implementing a multi-layered software and tool in accordance with one embodiment of the invention;

FIG. 6 is a flow chart for providing client and insurance category focused display pages in accordance with one embodiment of the invention;

FIG. 7 is a flow chart of a software tool in accordance with one embodiment of the invention;

FIG. 8 is a flow chart directed to a life value tool in accordance with one embodiment of the invention;

FIG. 9 is a flow chart directed to a disability value tool in accordance with one embodiment of the invention;

FIG. 10 shows a block diagram for one or more apparatuses for providing insurance related services to insurance professionals in accordance with one embodiment of the present invention;

FIGS. 11-142 are diagrams of illustrative display pages for implementing interactive methods and systems for insurance related activities in accordance with embodiments of the present invention;

FIGS. 143-152 are flow charts directed to managing insurance needs of a client and a business of a client in accordance with embodiments of the present invention; and

FIGS. 153-159 are decision trees directed to managing insurance needs of a client and a business of a client in accordance with embodiments of the present invention.

### DETAILED DESCRIPTION OF PREFERRED EMBODIMENTS

Software applications, tools, or features are provided for insurance professionals that are intuitive, easy to comprehend, and easy to install. Software, for example, is implemented that can aid those with little software or Internet experience to collect client information, manage clients, track progress with respect to clients, generate reports, and evaluate insurance weaknesses. A networked solution can be provided to alleviate data storage needs of insurance professionals and to increase marketing opportunities by way of sharing client information. Aggregation services can be combined with software features to increase the usefulness of the software overtime in analyzing the insurance needs of clients. Software can also be implemented with color coordination and navigation tools to ease a user's comprehension and interaction with the software. Another aspect can involve detailed data collection and automatic use of collected data and the automatic configuration of the software (e.g., options, pages) based on the collected data. These and other features that show a general step forward in the insurance field are also described herein.

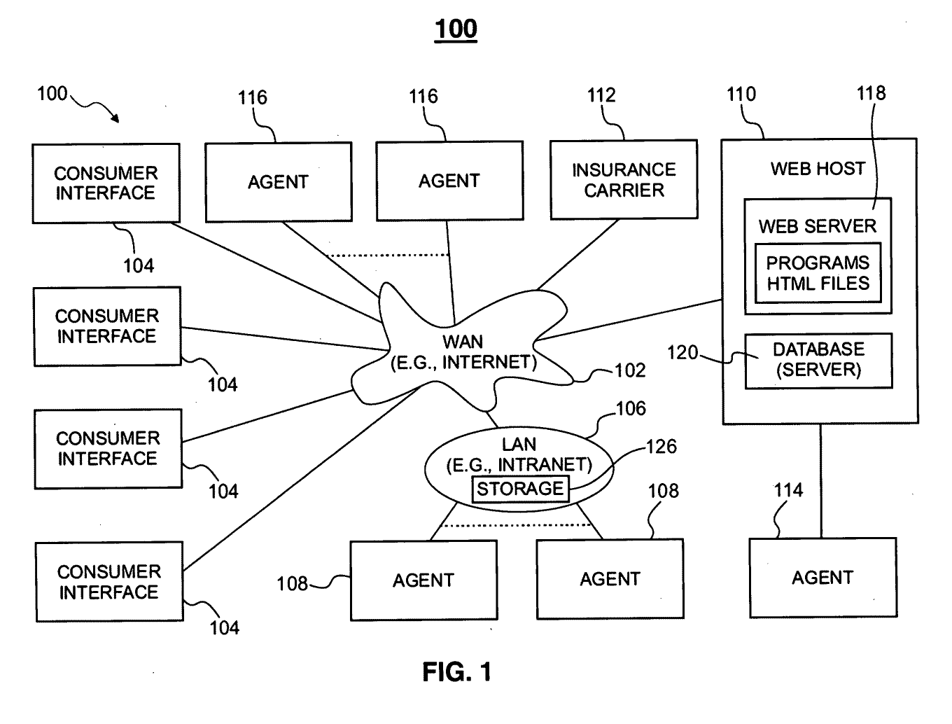

With reference now to FIG. 1, an environment such as environment 100 may be used by insurance agents for receiving insurance related services to, for example, assist the insurance agent in managing, marketing, and providing insurance services. Environment 100 may include wide area network (“WAN”) 102 (e.g., the Internet), WAN consumer interfaces 104, insurance carrier equipment 112, web host equipment 110, and agent equipment 116. If desired, a configuration may be implemented in which insurance carrier equipment 112 and web host equipment 110 are combined (e.g., to provide the insurance carrier as also the web host). If desired, environment 100 may be configured to include local area network (“LAN”) 106 (e.g., an intranet) and LAN agent interface equipment 108. If desired, environment 100 may be configured to include agent equipment 114 that is directly connected to web host equipment 110 and/or to include a direct connection from insurance carrier equipment 112 to web host equipment 110. If desired, environment 100 may also be configured in other ways. For example, there may be fewer or greater number of components (e.g., equipment or consumer interfaces) in environment 100. Environment 100 may include software applications implemented in environment 100 to support interactive tools for insurance professionals and to provide an interface for consumers.

Web host equipment 110 may be central to providing insurance tools. If desired, however, a distributed architecture may be used. Web host equipment 110 may include equipment such as web server 118 and database 120. Database 120 can be part of web server 118, a separate database server, multiple servers, or other such host equipment. One or more applications for providing interactive insurance tools may be implemented on web server 118 to provide insurance related services. Database 120 may store information related to consumers, agents, or insurance carriers that use the tools and services that are available in environment 100.

Web host equipment 110 may have been implemented by an insurance carrier to assist the agents and representatives of the insurance carrier by providing interactive tools available through agent equipment 116 that can drive and manage business for the agents.

Agents preferably interact with insurance related services, available via WAN 102, such as insurance services tools using agent interface equipment 116. Agent interface equipment 116 preferably includes personal computers such as laptops, workstations, or other type of computer equipment that includes a suitable interface for implementing one or more of the insurance tools available via environment 100. For example, for tools related to data collection and compilation, a computer that provides a convenient interface for data entry such as a full keyboard would be preferred. However, the use of other features may not require such functionality for each instance of their use. LAN 106 may be an enterprise platform implementation in which some or all of the functionality and services available from web host 110 is implemented in LAN 106 to supplement or replace web host equipment 110. Agent interface equipment 108 may comprise equipment such as that mentioned above in connection with agent interface equipment 116. As mentioned above, web host equipment 110 may be configured to include a direct connection with agent interface equipment 114. Agent interface equipment 114 may comprise equipment such as that mentioned above in connection with agent interface equipment 116.

Consumers may preferably interact with insurance related services available via WAN 102 using consumer interfaces 104. Consumer interfaces 104 may include personal computers, personal digital assistants, minicomputers, or other computer equipment that has a suitable communications connection with WAN 102.

Insurance carrier equipment 112 can include an interface for an insurance carrier to interact with web host equipment 110. If desired, insurance carrier equipment 112 may allow an insurance carrier to interact with agents via WAN 102. If desired, insurance carrier equipment 112 may be configured to have a direct connection or a private network connection to web host equipment 110 that is in addition or an alternative to a WAN connection. Insurance carrier equipment 112 may comprise computer equipment such as a personal computer (e.g., a PC on a LAN of the insurance carrier) or other computer equipment suitable for communicating with web host equipment 110.

One or more insurance carriers may participate in environments 100 such as through a plurality of insurance carrier equipment 112. However, preferably, environment 100 is configured to include a private communications network that is sponsored by one particular company, an insurance carrier, to provide tools and assistance to their agents through networked applications and databases. The private communications network can be implemented at least partially through a public packet data network such as the Internet. The applications and services may be branded with the carrier's logo and details.

Communications links within environment 100 may be wireless links, wired links, or combinations thereof. Suitable links may be used for the communications links in environment 100 to allow sufficient data throughput and interaction between end-users (e.g., agents, consumers, insurance carriers, web host provider, etc.). Techniques for implementing such communications links are known to those of ordinary skilled in the art.

Environment 100 may provide a variety of insurance related services to insurance agents. For example, environment 100 may be used to provide insurance services tools to insurance agents to assist them in marketing insurance products, managing information, educating clients, generating presentations, managing clients or developing prospects, managing insurance options for a client with business interests, or other tools or services illustratively described herein.

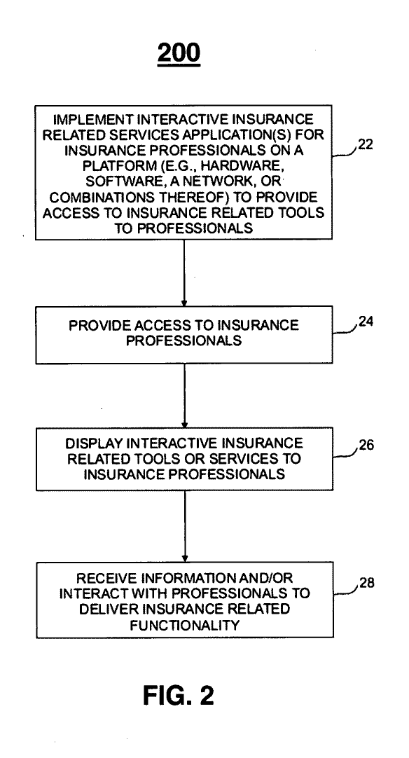

An interactive application for providing insurance related tools and functionality for insurance professionals can be provided at least based in part on the process illustratively shown in FIG. 2.

With reference now to FIG. 2, at step 22, an interactive insurance related services application specifically configured for insurance professionals or one or more such applications is implemented on a platform to provide access to insurance related tools or services to insurance professionals such as to assist and support the professionals. The platform can comprise hardware, software, a network, or combinations thereof. For example, the combination of the application and the platform can be considered agent-interface equipment (e.g., agent interface equipment 116 of FIG. 1). At step 24, insurance professionals can be provided access to the application. In providing access, authentication techniques are preferably implemented to provide access only to intended types of users and in addition only to those users who are registered to use the application. As such, the general public would not be provided access to the application. At step 26, interactive tools or services are displayed to insurance professionals. For example, after a user is authenticated, an application that implements insurance-related interactive tools or services displays the tools or services to the user. At step 28, the application receives information and/or interacts with one or more insurance professionals to deliver insurance related functionality to the professional. Accordingly, through interaction with the application, functionality, such as client tracking, data organization, data collection, or preparation of presentations, an insurance agent can benefit from insurance related services that are designed to enhance and improve the professionals business operations including its efficiency and speed of service.

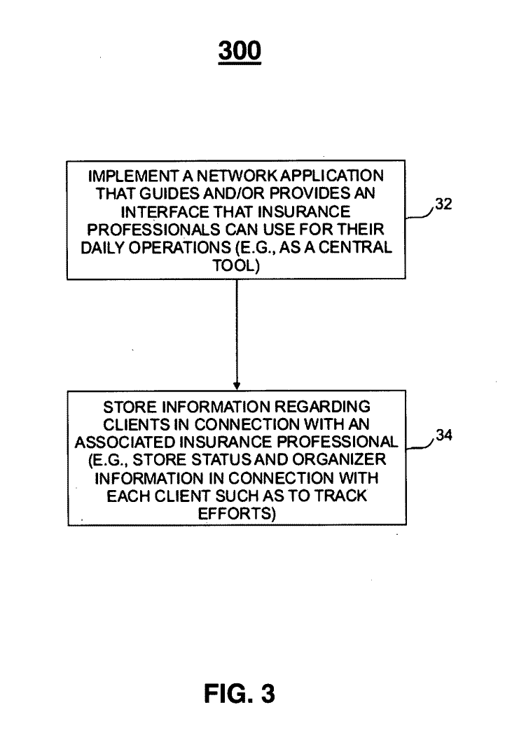

Illustrative steps involved in, for example, providing network-based insurance related software tools or services to insurance professionals are shown in FIG. 3. With reference now to FIG. 3, at step 32, a network-based application is implemented that is configured to guide and/or provide a user interface for insurance professionals that can, for example, be used for the daily operations of insurance professionals. The network-based application is, for example, a web application that is configured using HTTP communications in a client-server arrangement. The application is preferably configured to be a central interface for insurance professionals in conducting their daily business operations. As such, insurance professionals would interact with the application to use its various features to achieve their business needs. At step 34, in response to interaction with insurance professionals, information is stored regarding clients or potential clients in connection with an associated insurance professional. For convenience, “clients” as used herein refers to clients and potential clients if the combined meaning is applicable in the given context. The status information that is stored is, for example, regarding a particular client or status information regarding the extent of progress with respect to a particular client.

Further, by way of example, an organizer tool can be provided that stores information for organizing an insurance professional's client information, tasks, reminders, alerts, etc. (e.g., with respect to an individual client). This implementation allows an insurance professional to be able to review information on the state of discussions with a particular client and to, for example, pick up on discussions from where the professional left off without having to recall from personal memory or by maintaining notes on such activity. For example, the application preferably provides a record of activity completed with respect to a particular client and would preferably provide a record of desired activity that remains to be completed (e.g., using a to do list feature).

If desired, calendar information that is specific to a client or potential client can also be stored. For example, the calendar can be used to generate automatic alerts for the insurance professional in connection with each client. The information is preferably stored on a server that is remote from the insurance professional. This implementation provides the advantages of improved data security and portability. For example, an insurance agent would be able to access the data and application from any network-connected computer without having to be tied to the storage on his personal computer or the enterprise server of the professional's company. Improved data security is provided in such a system because the customer data can, for example, be encrypted in communications, and the server for the network-based application can be implemented with a higher level of physical and electronic security (including back-up services) than would likely be available by the system of the insurance professional. In addition, network-based implementations reduce the cost and complication that is imposed on insurance professionals to provide such security and storage capabilities on their own. If desired, in some embodiments of the systems and methods illustratively described herein, other ways of providing such insurance applications and services can be implemented. For example, the application can be configured as a software resident application on an insurance professional's computer or can be implemented as a combination of a resident application and network-based application. Thus, the interface can be an application provided through a browser or an application interface that is displayable without the need to open a browser. Another variation may be to provide only local storage of client information or provide a combination of local and remote storage (e.g., to provide limited duplication of the data).

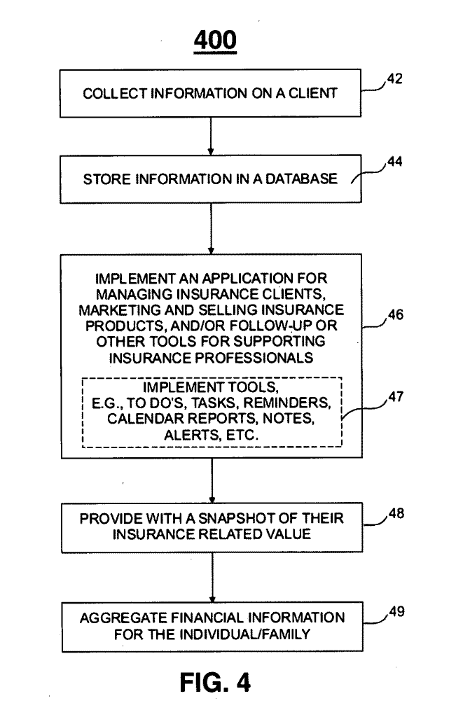

An application can be implemented to provide a combination of different tools and services to insurance professionals. The application can be a single application, combination of different applications (e.g., that are electronically connected, that are separately selectable for execution, etc.), or can comprise one or more modules, applets, applications, or other software that is executable for providing desired functionality. Illustrative steps in providing an application that provides various tools and services including a snapshot of a client's insurance related value are shown in FIG. 4. At step 42, user interface and input functionality is implemented to collect information with respect to a client. For example, an insurance professional interacts with the user interface to collect and input data regarding a particular client and can do so for multiple clients. At step 44, the information is stored in a database for later retrieval by the insurance agent or possibly the client. As illustratively described, the database is preferably stored on a server remote from the insurance profession, but other embodiments can also be implemented if desired. At step 46, insurance related tools and services are implemented and/or provided for performing activity such as managing insurance clients, marketing, and selling insurance products, providing follow-up, or other tools for supporting insurance professionals. Preferably, the application would be a central source or outlet for the insurance professional such that it would provide a comprehensive and sole resource or interface for the professional. This, for, example would provide the advantage of simplifying computer interactions for insurance professionals such that they only need to interact with this application (e.g., as a dedicated terminal) rather to navigate multiple applications and interact with the operating system which can often times be confusing for less experienced computer users.

Step 46 may, for example, include step 47. At step 47, various specific tools or services can be provided to insurance professionals. The tools or services can, for example, include a “to do” or tasks feature, reminders, calendar, reports, notes, alerts, etc. (e.g., that can be configured to be specific to each particular client).

At step 48, a snapshot feature is provided. The snapshot feature can provide a tool for both presenting information and illustrating the insurance related needs or value of an individual or a family in connection the information. For the sake of clarity and convenience, the term individual or client is used herein to refer to an individual client or an individual client's family (i.e., immediate family or dependents) where applicable in the given context. The snapshot can be interactive to allow variations of the information to illustratively present different scenario's (e.g., levels of insurance protection). The snapshot is preferably configured as a tool for illustrating, in connection with a particular category of insurance (e.g., life insurance, disability, etc.), the real life impact on the financial state (e.g., income difference) if an event that would typically trigger the insurance coverage occurred. Thus, the snapshot would be able to display insurance related values (e.g., related to that insurance category) for an individual or a family that would exist before and after the triggering event. In addition, the snapshot can be configured to provide insurance-related parameters. The insurance related parameters can, for example, be used for controlling how the insurance proceed(s) would be applied or managed, and to illustratively vary a snapshot view for analysis by the insurance professional to illustrate for the client.

The snapshot feature can be implemented as a module or a component of a network application. In one embodiment, the module can require communications from an insurance agent's computer to a remote processor that performs the calculations and transmits information, such as, the resultant data to the insurance agent for display. In another embodiment, or in combination with such an embodiment, processing and calculations can be performed locally such that a noticeable delay between selecting a “calculate button” and the display of the resulting information does not exist (e.g., in a network application, there may be a delay involved in sending and receiving information in connection with the calculation). A benefit of the network-based implementation is that a user would not need to install a resident application on their computer.

Enhanced functionality of the insurance snapshot feature can be realized by combining this feature with an aggregation feature (step 49). Aggregation provides a functionality in which current financial information about an individual can be aggregated, stored, and updated. For example, an individual would provide account or personal information to an insurance professional. The information is used to automatically access electronic information (e.g., nightly, in real time, periodically, etc.) to provide a resource for viewing the current financial state of an individual in various categories (e.g., bank accounts, investments, mortgage, credit card debts, investment property, etc.) and preferably in all categories. The aggregate feature in combination with the snapshot feature provides a tool by which an individual or insurance professional can periodically evaluate whether the individual's insurance coverage matches the individual's current financial state (e.g., should the individual now increase or decrease his or her insurance coverage). The aggregated information can also be provided to the insurance professional to conduct such an analysis.

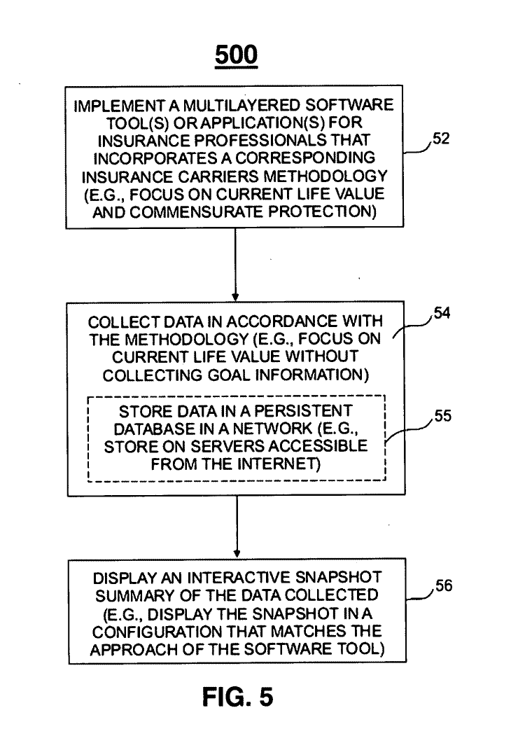

An application (e.g., a network application) can be specifically configured to match or present an insurance carrier's approach for marketing insurance. The application can, thus, integrate the insurance carrier's techniques, its insurance approach, and concepts from its instructions and teaching materials for its insurance professionals. Consequently, the application facilitates an integrated interface for the insurance professionals that provides a seamless connection in thought from instructions and teaching materials to the information displayed in the application, and the interactions and “look-and-feel” therein. Such an approach, for example, provides continuity with the insurance carrier's business approach and presents the application to be intuitive to the user, who may be well familiar with the insurance carrier's philosophy, but may not be as well versed in computers, the Internet, or software application. Illustrative steps involved for implementing such an approach are shown in FIG. 5.

With reference now to FIG. 5, at step 52, a multi-layered software tool(s) or application(s) for insurance professionals is implemented that incorporates a corresponding insurance carriers methodology. The methodology may in particular be that in which the focus is on the life value or current life value of an individual and providing commensurate insurance protection. For example, the evaluation of an individual's insurance protection would be based on whether the protection is commensurate with the individual's current financial value (e.g., what would be required, taking into consideration the future wages and year of retirement of an individual, to provide the same financial picture for the individual's family). Such an approach preferably does not take into consideration the individuals goals or objectives such as goals with respect to financial condition, savings, or investment goals, which are future term activity which may not be germane to better understanding the current financial picture of that individual. A benefit of providing a multi-layered software tool or application is that it provides a convenient interface for the insurance professional to implement the many different but related functions that an insurance carrier would need for business operations. Thus, for example, issues that often times arise with respect to interoperability of applications and inheritance of persistent data from one application to another can be automatically solved.

At step 54, the software tool(s) or application(s) is implemented to collect data in accordance with the methodology (e.g., focus on current life value without collecting financial or investment goal information). For example, the software tool may provide insurance professionals with a data entry section specifically configured to match the insurance carrier's methodology. The data collection can, for example, have a sequence that matches the methodology. The data collection can, for example, focus on the current life value of the individual without collecting or prompting for information on investment needs, educational funding for children, etc. A look and feel through colors can be implemented to match the methodology. Step 54 may include step 55. At step 55, the collected data is stored in a persistent database in a network that is accessible by the insurance professionals. For example, the information can be collected by way of computer input by an insurance agent at an agent's computer and stored on a server that is accessible from the Internet using the multilayered software tool or application.

At step 56, an interactive snapshot summary of the financial and insurance information of the individual collected at step 54 or aggregated is displayed. The snapshot display can be structured for example to display the snapshot in a configuration that matches the methodology of the software. For example, the information can be displayed in a single page in a hierarchy that matches the methodology. In addition, color schemes can be used to provide the display to be intuitive in connection with the methodology and the configuration of the software. The feature can be interactive in that items of information displayed in the snapshot can be selected to display underlying information with respect to the selected information.

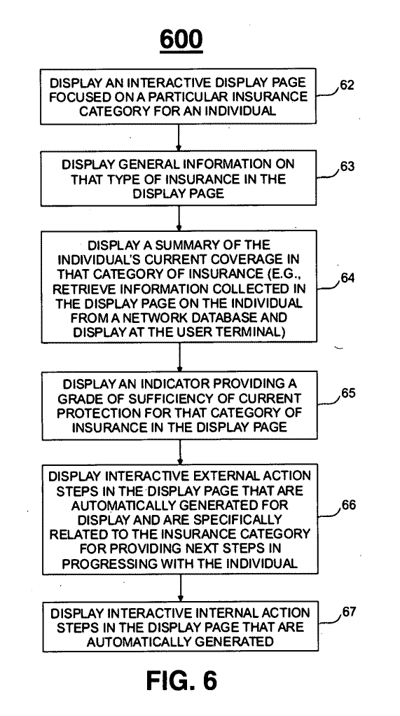

A component of the software application can be an interactive insurance information display page that is specific to an individual. Illustrative steps involved in providing such a software feature are shown in FIG. 6. At step 62, an interactive display page is displayed that is focused on a particular insurance category (e.g., life, disability, etc.) for an individual. At step 63, general information on that type of insurance is displayed in the display page (e.g., so as to occupy one section of the display page that is dedicated to such information). At step 64, a summary of the individual's current insurance coverage in that category is displayed in the display page (e.g., so as to occupy one section of the display page that is dedicated to such information). Step 64 can involve retrieving information that was previously collected on the individual from a network database and displaying the information at the user terminal. Alternatively, the information can be stored or cached locally.

At step 65, an indicator is displayed that provides a grade of sufficiency for the current insurance coverage of the individual for the insurance category (e.g., so as to occupy one section of the display page that is dedicated to such information). The indicator is displayed in the display page to provide a convenient sufficiency indicator to the viewer. The grade that is assigned can be subjective or objective. For example, the grade may be selected by the insurance agent after reviewing the individual's insurance information or, if desired, can be automatically selected based on an algorithm that compares the individual's information to a database of insurance information to perform an evaluation. The indicator can be set from the interactive insurance display page or from a different page as a precursor to generating the interactive insurance display page.

At step 66, interactive action steps that are related to external tasks are automatically generated and displayed (e.g., so as to occupy one section of the display page that is dedicated to such information). The action steps are specifically related to the insurance category of the current interactive display page. The action steps are preferably a list of steps suggested for interaction with the client in connection with current insurance category. For example, a database can be implemented that would store sets of action items in association with different insurance categories. Each set would be configured to cover the steps needed to, for example, gather, analyze, or consider relevant information in connection with a particular insurance category with respect to a client. This would provide a tool for an insurance agent such that an automatic list can be generated and tracked for each client. If implemented as a network application, the list can be automatically updated without the need for periodic upgrades such that new strategies or legal requirements can be compiled and addressed with the database of action steps. The external action steps can provide intuitive next steps but can also be implemented as a comprehensive list of actions for the insurance agents consideration. The external action steps relate to activities that the client needs to perform with an insurance agent, some other client representative or acquaintance, or individually. The action steps displayed in the display page can be displayed on the basis of some level of intelligence or filtering. For example, steps that were selected and marked as being completed are preferably not displayed again when an insurance agent returns to the same page. Thus, the action steps can reflect the state of interaction or progress with respect to a particular client. The information can be persistent. Therefore, an insurance professional would not need to personally track progress or what has been covered with each client. The software automatically provides such functionality and allows the insurance professional to pick up where he or she left off with each client. In addition, filtering based on the information collected on a client can be implemented such as to not display action items that are not applicable to the client (e.g., if the client does not have children, certain action steps may not be applicable and should not be displayed).

At step 67, interactive internal action steps are automatically generated and displayed (e.g., so as to occupy one section of the display page that is dedicated to such information). Internal action steps are actions that are suggested to the insurance professional to be performed in the software application. The internal action steps are specifically related to the insurance category of the current interactive display page. For example, a database can be implemented that would store sets of internal action items in association with different insurance categories. Each set would be configured to cover the steps needed to support the insurance agent to market the current insurance category (the displayed insurance category) or to market other products. This would provide a tool for an insurance agent such that an automatic list can be generated and tracked for each client. If implemented as a network application, the list can be automatically updated without the need for periodic upgrades of a resident application such that new strategies or legal requirements can be complied within the database of internal action steps. The internal action steps can provide intuitive next steps but can also be implemented as a comprehensive list of actions for the insurance agent's consideration. The internal action steps displayed in the display page can be displayed on the basis of some level of intelligence or filtering. For example, steps that were selected and marked as being completed are preferably not displayed again when an insurance agent returns to the same page. Thus, the action steps can reflect the state of interaction or progress with respect to a particular client. The information can be persistent. Therefore, an insurance professional would not need to personally track progress or what has been covered with each client. The software tool automatically provides such functionality and allows the insurance professional to pick up where he or she left off for each client. In addition, filtering based on the information collected on a client can be implemented such as to not display internal action items that are not applicable to the client (e.g., if the client does not have children, certain action steps may not be applicable and should not be displayed).

By implementing an interactive display page for a particular insurance category that includes a general information section, client summary section, grade indicator, external action steps, and internal action steps, a software tool can be provided that integrates information, organizational needs, client specific data, and a grade indicators together as a convenient tool for quickly viewing information and status with respect to a client for a particular insurance category and to generate a report on the basis of the information.

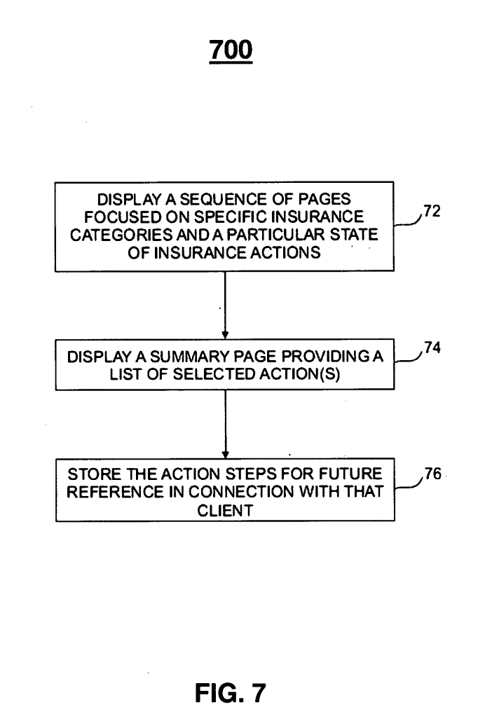

Interactive insurance display pages can be implemented to provide a particular software tool. For example, a sequential methodology can be implemented such that the pages for different insurance categories can be implemented to be displayed in sequence and automatically summarized at the end of the sequence. For example, with reference now to FIG. 7, a sequence of interactive insurance display pages that are each focused on a specific insurance category and include action steps that reflect the state of interactions with a corresponding or with the application with respect to a particular client (e.g., such as that illustratively described in connection with FIG. 6) can be displayed (step 72). At step 74, an interactive summary page is displayed that provides a list of selected action steps. Thus, the summary page can display a compilation of the actions selected in each interactive insurance display page as a summary of selected actions to be completed. At step 74, the action steps can be selectable so as to allow the user to reconsider a selected items to remove that step from the list. At step 76, information with respect to the action steps (e.g., which ones selected or not selected) are stored for future reference in connection with that client (e.g., to reflect the status of work with that client).

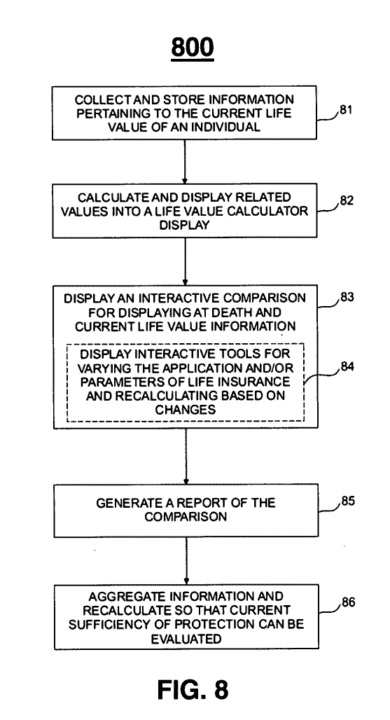

A current value snapshot feature can be specifically implemented for life insurance. For example, with reference now to FIG. 8, at step 81, information pertaining to the current life value of an individual can be collected and stored. At step 82, the software, calculates values relating to the current life value based on the collected information and displays the values in an interactive life value calculator display page. At step 83, an interactive comparison for illustrating the at-death and the current life value related information of a particular individual are displayed in the interactive life value calculator display page based in the information that was inputted and calculated. Step 83 may include step 84, which is implemented to allow for user variation of the displayed values to vary the snapshot. At step 84, interactive tools for varying the application and/or parameters of life insurance are displayed and recalculated based on the changes. At step 85, a report option can be included as part of the page for generating a report of the current comparison information. At step 86, an aggregation feature can be used to update and recalculate relevant values so that the current sufficiency of the client's life insurance protection can be periodically evaluated. In one particular embodiment, this feature is part of a network application in which recalculation would require communications to and from a server to redisplay the information. In other words, relevant signals and data are transmitted to a server that calculates and returns the relevant results.

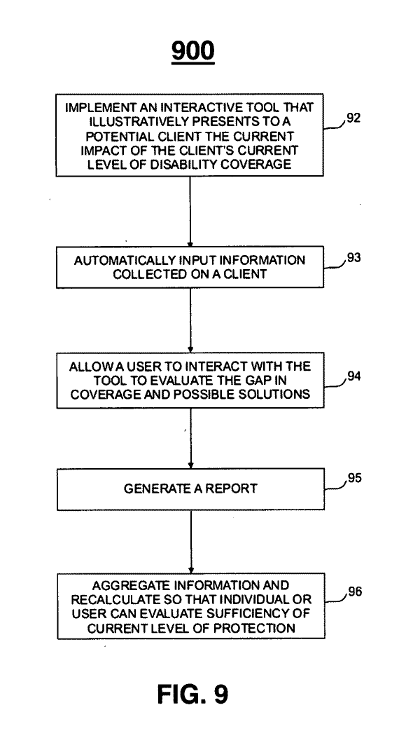

A similar feature can be provided for other insurance categories such as disability. Illustrative steps involved in implementing such a feature for disability insurance is shown in FIG. 9. At step 92, an interactive tool is implemented that illustratively presents to a potential client or a software user, the current impact of the client's current level of disability coverage. At step 93, information that was collected from the client are automatically collected and input for use in the insurance disability coverage evaluation. At step 94, a user (e.g., an insurance agent) is allowed to interact with the tool to evaluate whether a gap in the client's disability insurance coverage exists and to interact with the tool to suggest possible solutions (e.g., impact of different coverage). At step 95, a report may be generated that comprises the information displayed with respect to the client's disability coverage. At step 96, an aggregation feature can be implemented so that client information can be updated and the disability coverage and related financial data can be recalculated and displayed to allow for an evaluation of the sufficiency of the current level of protection.

The systems, apparatuses, processes, user interfaces, reports, and other mechanisms described herein can be used in conjunction with any or all or any combination of components, processes, etc., described in more detail in U.S. patent application Ser. Nos. 12/113,087, 11/891,616, 11/510,537, and/or 60/763,200.

Further Description of Illustrative System

Referring back to FIG. 1, system 100 can provide an account and data aggregation tool that electronically organizes and displays financial holdings identified by the client for the client and the client's business in a consolidated format and can provide part of a process for determining the client's insurance and, if applicable, investment needs. Such information can be entered, determined, or otherwise generated on any of the components of system 100, including web host 110. Processes for providing such information are described in further detail in conjunction with FIGS. 2-9, 143-151.

System 100 can be used by insurance professional to assist with recommendations that are suitable for the client's situation. In one embodiment, non-specific strategic advice or product recommendations can be provided, for example, between web host 110 and consumer interfaces 104, and references can be made to property and casualty insurance, estate planning, wills or other legal documents or reports prepared or produced with the insurance, plan, will, or legal documents. The system can provide indications or suggestions that the certain property or casualty insurance should be determined by a properly licensed property and casualty insurance agent, legal counsel, or tax advisor when and where appropriate. In one embodiment, web host 110 can receive available insurance options for providing to the consumer interfaces' 104 from, for example, insurance carriers 112.

System 100 can maintain the proper form and level of protection and assist a client to achieve optimum financial balance for a client and the client's business. The implementation of a sound protection program can be provided, for example, through storing client data on database server 120/storage 126, generating protection suggestions based on the client's current financial and insurance protection situation and/or desired situation, and/or providing such protection assistance over networks 102/106 to agents 116, insurance carrier 112 and/or consumer interfaces 104.

System 100 can be directed to educating the client of the primary role of insurance to fully indemnify against losses that, if left uninsured, would otherwise create financial hardship, and the general desirability to insure all or substantially all assets and/or all or substantially all future income in an amount equal or substantially equal to their full and complete replacement value against forms of hazards and peril.

System 100 can be directed to educating a client of maintenance of insurance equal to or substantially equal to existing liabilities such as short term debts, mortgages, and various taxes. This strategy can protect against the possibility of forced liquidation of assets or unnecessary cash flow expense following a particular loss. The suggested strategy can be selected, computed, and generated on web host 110, stored in database server 120/storage 126, and/or sent over networks 102/106 to other devices of system 100.

System 100 can assist in providing protection, decisions and the insurance protections coordinated with important legal documentation to insure that personal and business financial objectives can be realized. The effective use of legal documents can maximize the benefits of available insurance protection. The important documents or information about the important documents can be received by web host 110 over networks 102/106 from any device (e.g., agents 108, consumer interface 104). The document information can be associated with the client within, for example, database server 120/storage 126. In one embodiment, the documents can even be parsed to retrieve information about the documents (e.g., type of document, such as buy-sell agreements, business formation agreements, etc.). Suggestions for insurance protections can be provided based on the documents, as described herein, communicated over, for example, networks 102/106.

System 100 can display representations of current insurance or other protection coverage highlights, asset and liability values, cash flow scenarios, and other financial holdings on, for example, any interface, including consumer interfaces 104. The displayed data can be input from information provided by the client (e.g., through consumer interfaces 104), or obtained by electronic feeds, for example, over networks 102/106, from the client's financial institutions, third-party sources, or the like. Statistical data and/or historical data provided can be received from third-party source prior to the operations of the interfaces or even in real time, e.g., through electronic feeds.

The data that is input or received can indicate “current information,” which was provided by the client or his or her financial institutions or other third party sources as of the date and time noted. Current information, however, can reflect valuations obtained from an earlier date and time. Actual current valuations can be different, perhaps by a significant amount. Information, data and valuations obtained from either the client or electronically from his or her financial institutions or third party sources can be, but need not be, verified by the insurance professional or the system, thus simplifying the process for providing advice about insurance needs.

System 100 can periodically request the client to review and update the list of financial holdings appearing in the system materials and/or any valuations or input data that the client provided and was not obtained from electronic feeds (e.g., home, personal property, illiquid securities). The request to review can occur through email reminders, calendar reminders, or the like. The review request can be generated by web host 110 and/or sent over networks 102/106.

Consumer interfaces 104 can display figures, assumptions, and calculations, described herein. This information is hypothetical in nature and can be used for illustrative purposes. The charts and calculations described herein can ignore or take into account deductions for fees, expenses, sales charges or taxes on certain assets or products. Certain hypothetical calculations can also be based on assumptions provided by the client concerning income level, applicable tax rates, tax basis, or the like. The calculations can be performed by, for example, web host 110.

Calculations used in embodiments of the system can produce summaries and reports (for example, portfolio comparisons, Efficient Frontier, e.g., graphs displaying the best possible return against lowest possible risk, and Monte Carlo analysis). The calculations can be performed on, for example, consumer interfaces 104, agents 116, or web host 110. The summaries are hypothetical in nature and if different assumptions are used, the actual values, cash flows, summaries and results can differ, thereby displaying to the client a possible need for different life insurance or other insurance options for different scenarios. In addition, the client can provide certain data assumptions (e.g. his or her current protection coverage, asset and liability values, cash flow scenarios, after tax results, rate of return, reserve fund, debt and mortgage payoff through the interfaces described herein). If different data or assumptions are input, summaries and reports would be affected.

Calculations of hypothetical income producing asset values, described herein, have been adjusted to reflect embedded capital gains taxes or deferred ordinary income taxes. Tax information can be stored on database server 120/storage 126 and can be used to compute taxable values, described herein. The taxing information can be changed periodically or received over a computer network to reflect changes in law, or even changed/received in real-time on an on-demand basis when the taxing information is required by the tax based calculations described herein.

Illustrative Apparatus(es)

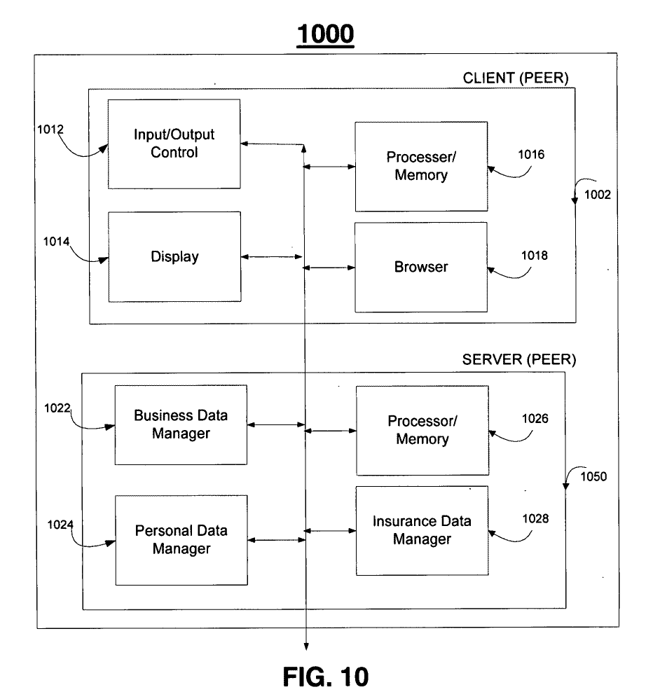

FIG. 10 shows a block diagram for one or more apparatuses for providing insurance related services to insurance professionals in accordance with one embodiment of the invention. As shown, system 1000 includes client device 1002 in communication with server 1050 over a communication channel. In one embodiment, client device 1002 and server 1050 can be separate devices in communication over a computer network. The network communications can be via network interfaces. In one embodiment, client device 1002 and server 1050 can be components of device 1000, wherein the client device 1002 and server 1050 are in communication over a communication interfaces, such as a bus. There can be more or fewer components without departing from the scope of the invention. For example, there can be other processors computing different aspects of the operations of the modules of server 1050. In other embodiments, the processor of the client and the server can be the same processor. Also, other communication configurations can also be used besides client-server, such as a peer-to-peer configuration with a plurality of interconnected peers, wherein any node in the peer-to-peer network can perform the actions of the client device 1002 or server 1050.

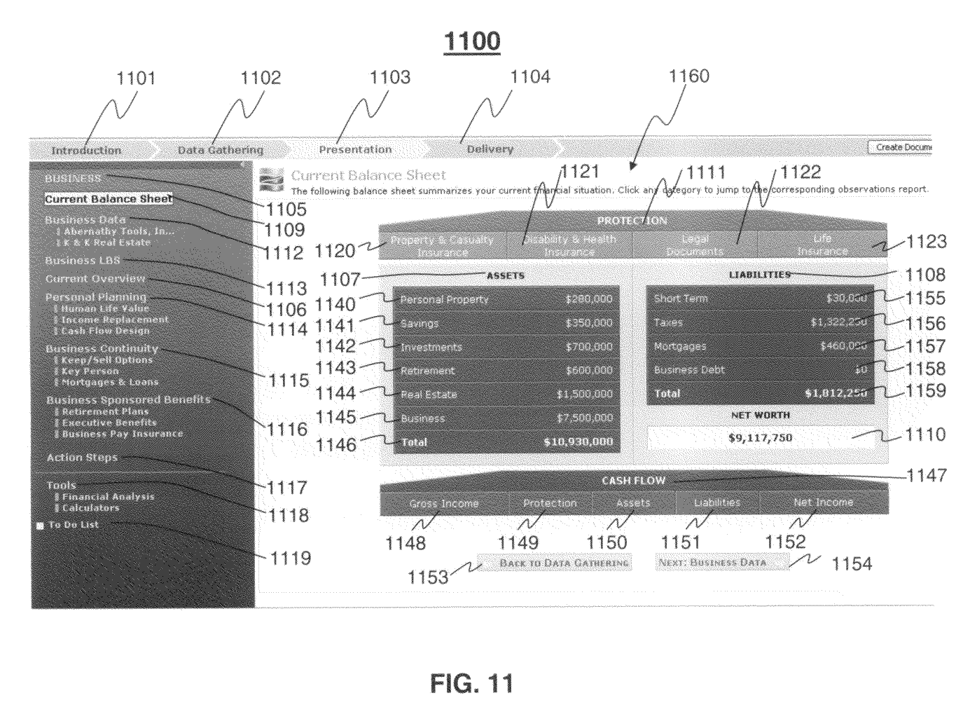

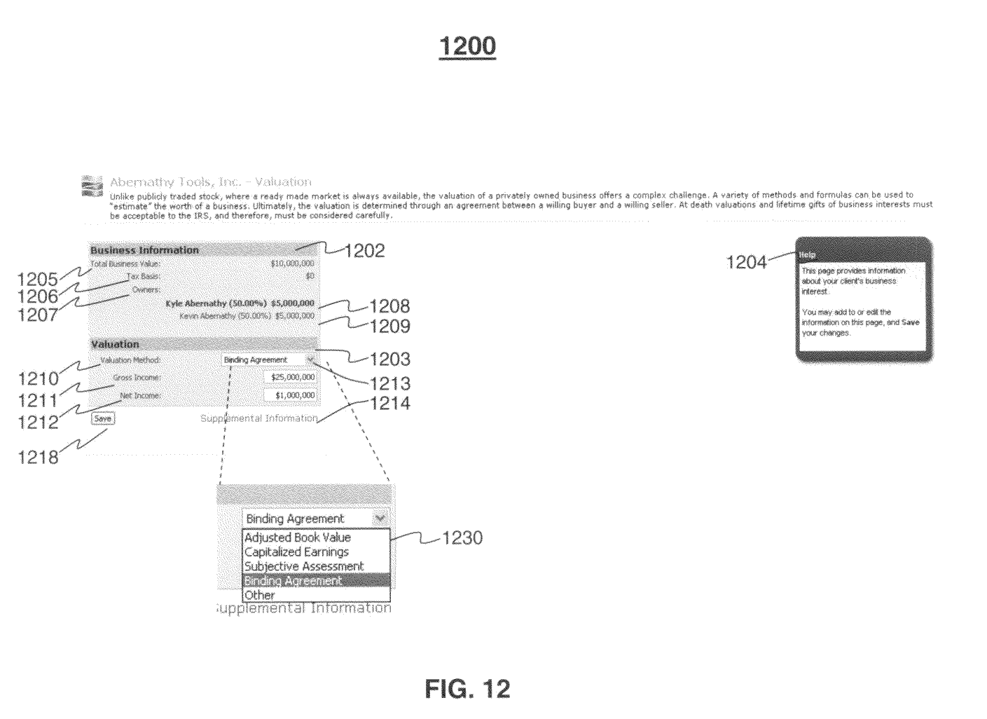

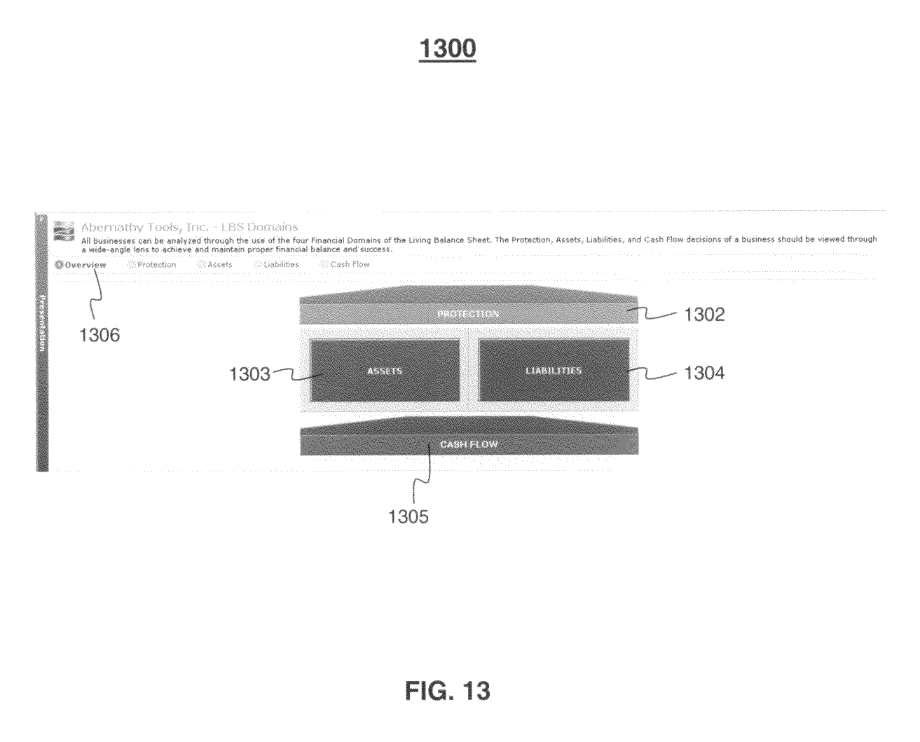

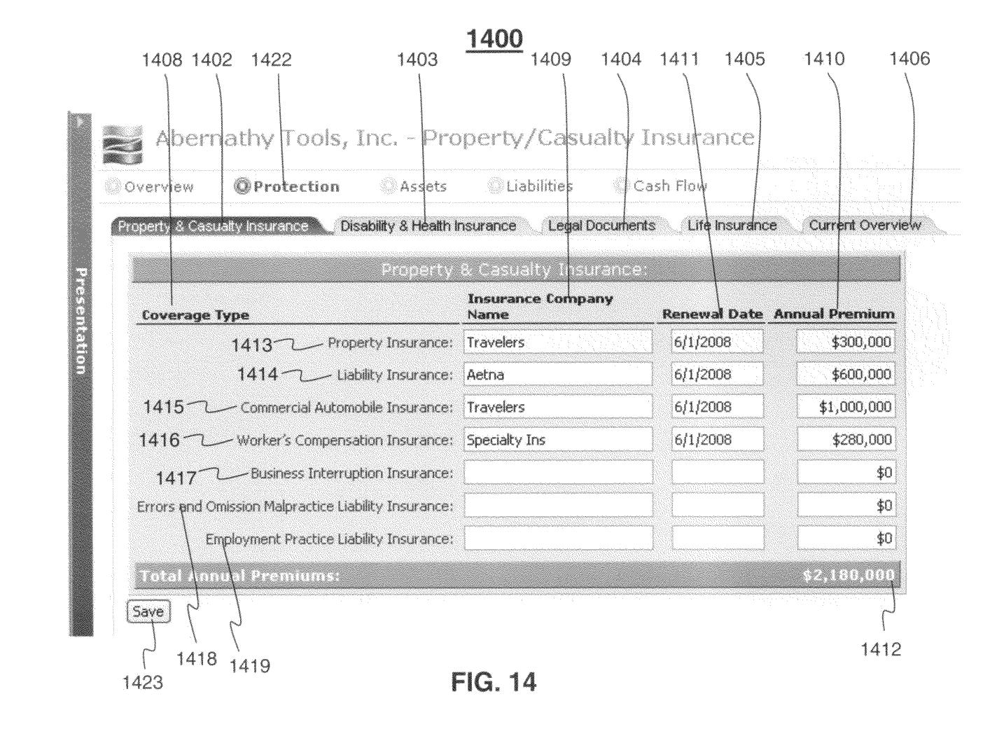

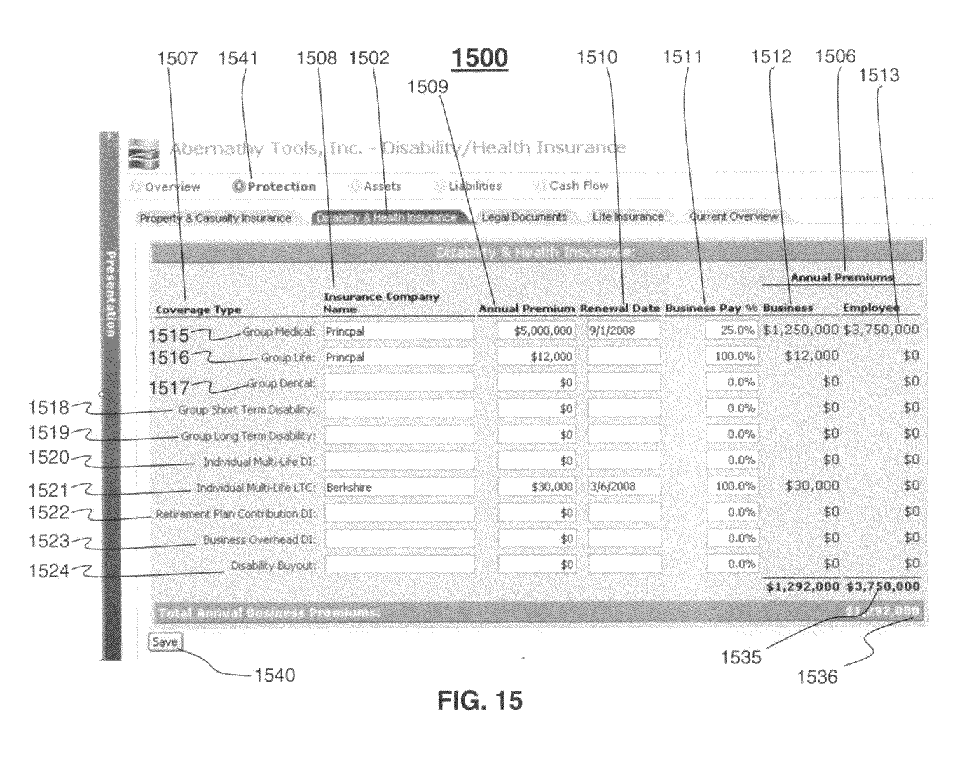

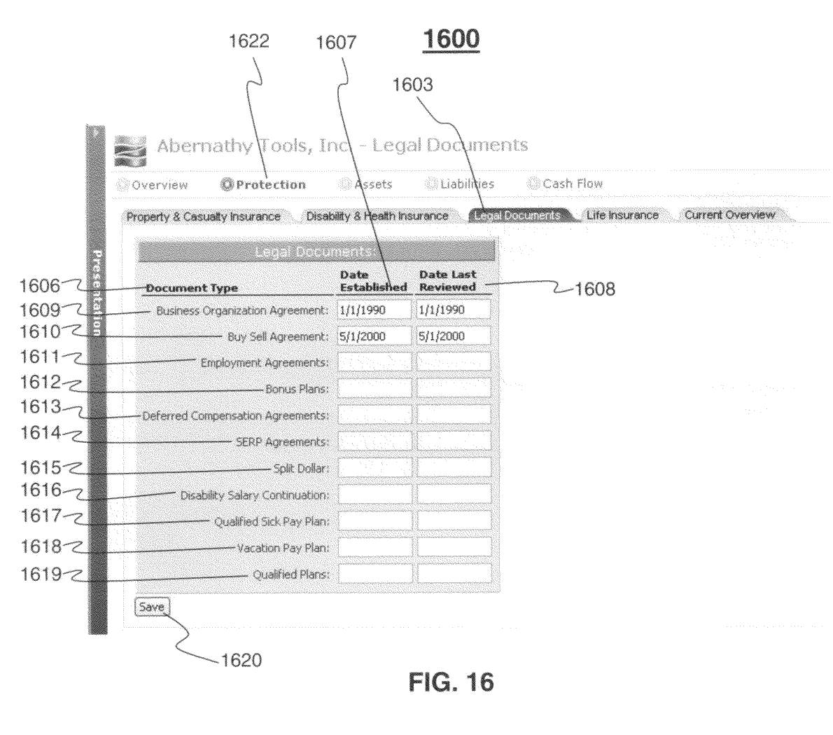

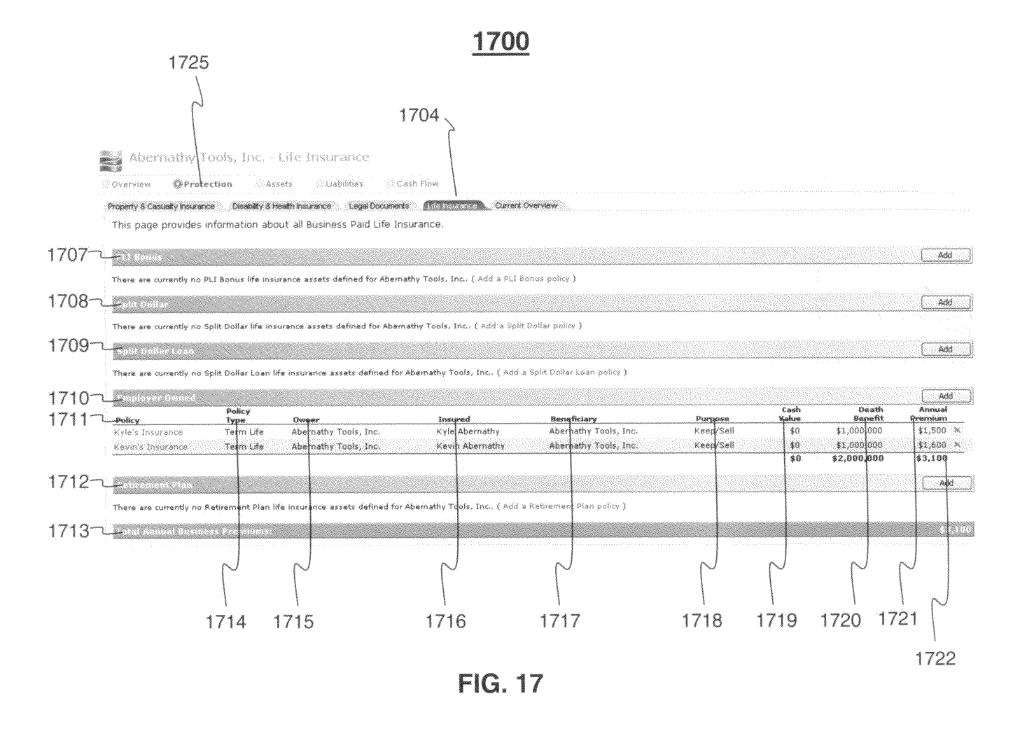

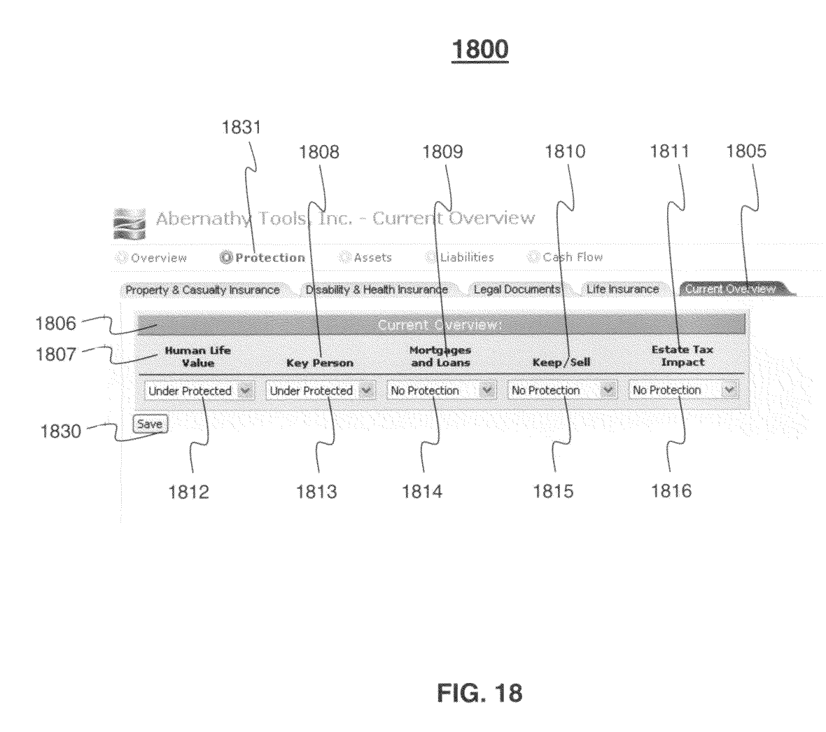

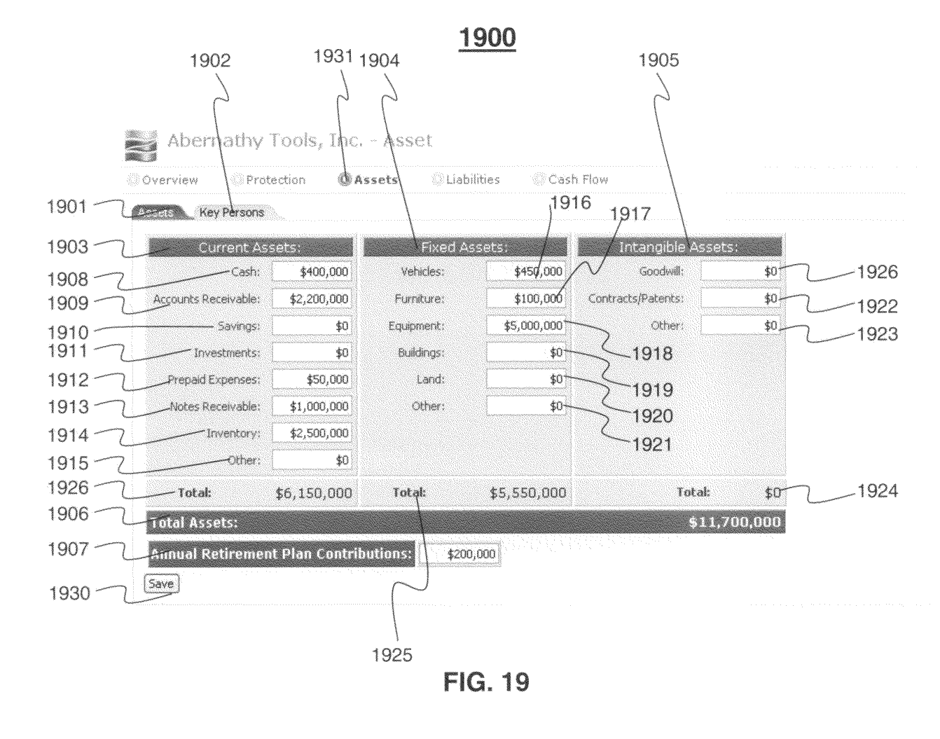

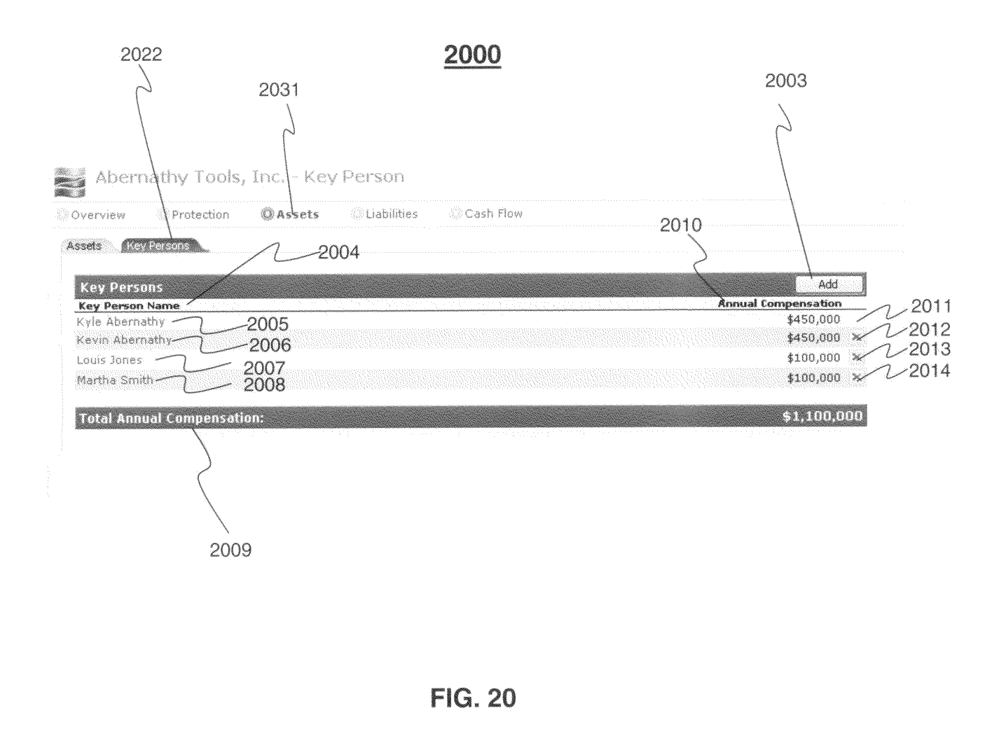

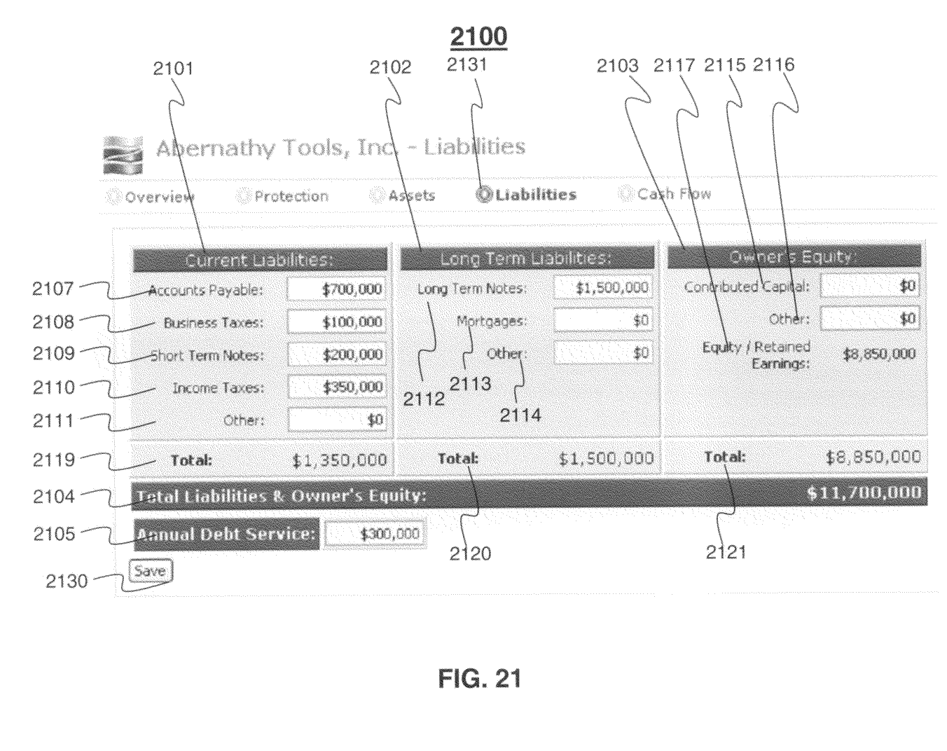

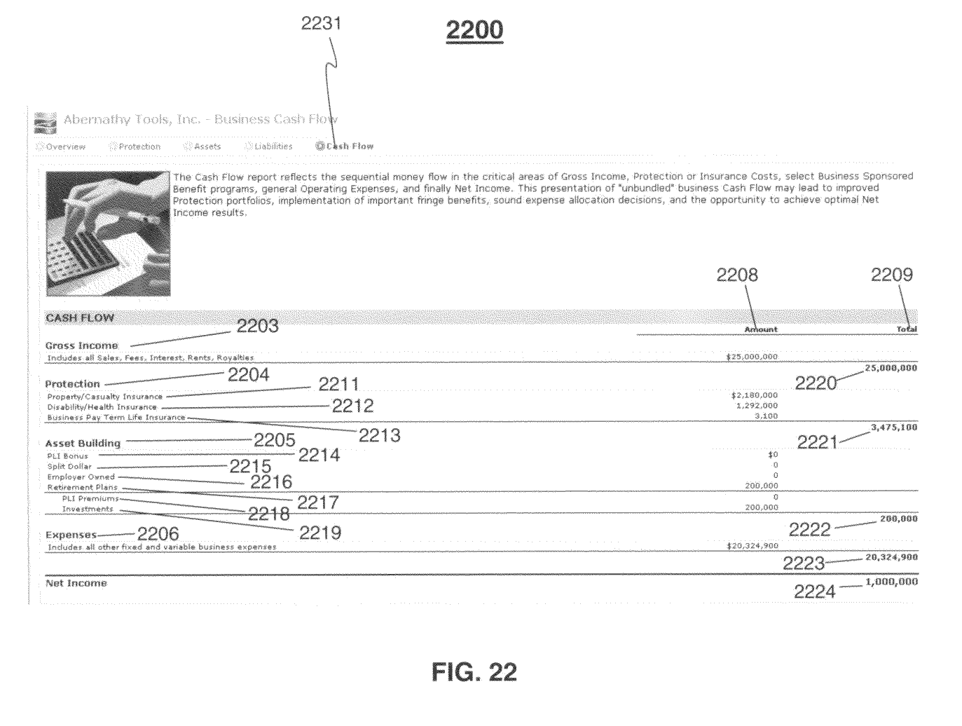

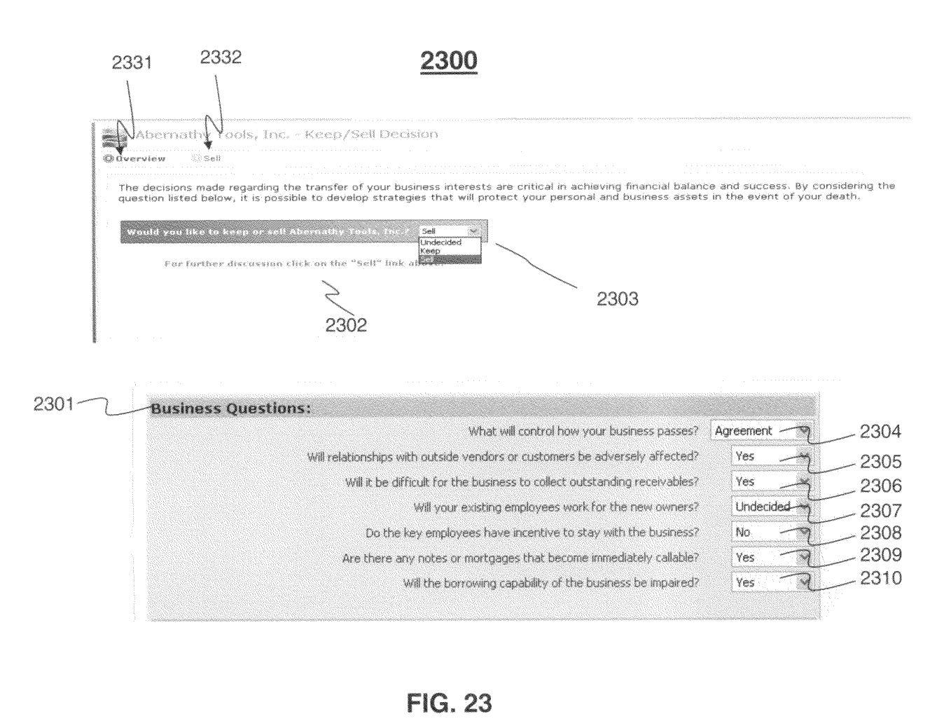

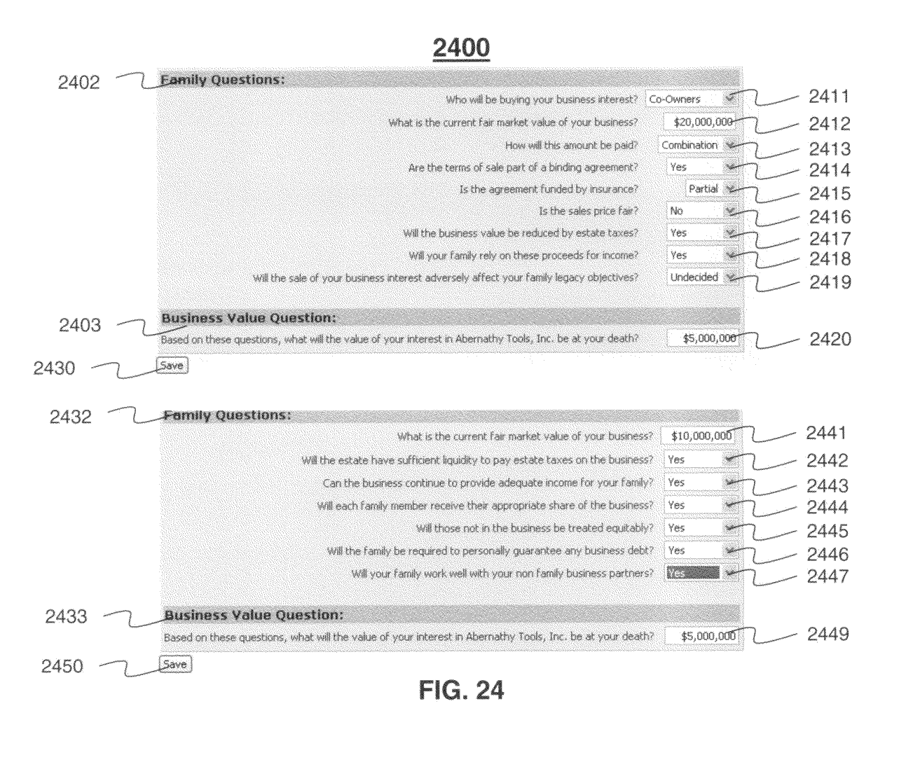

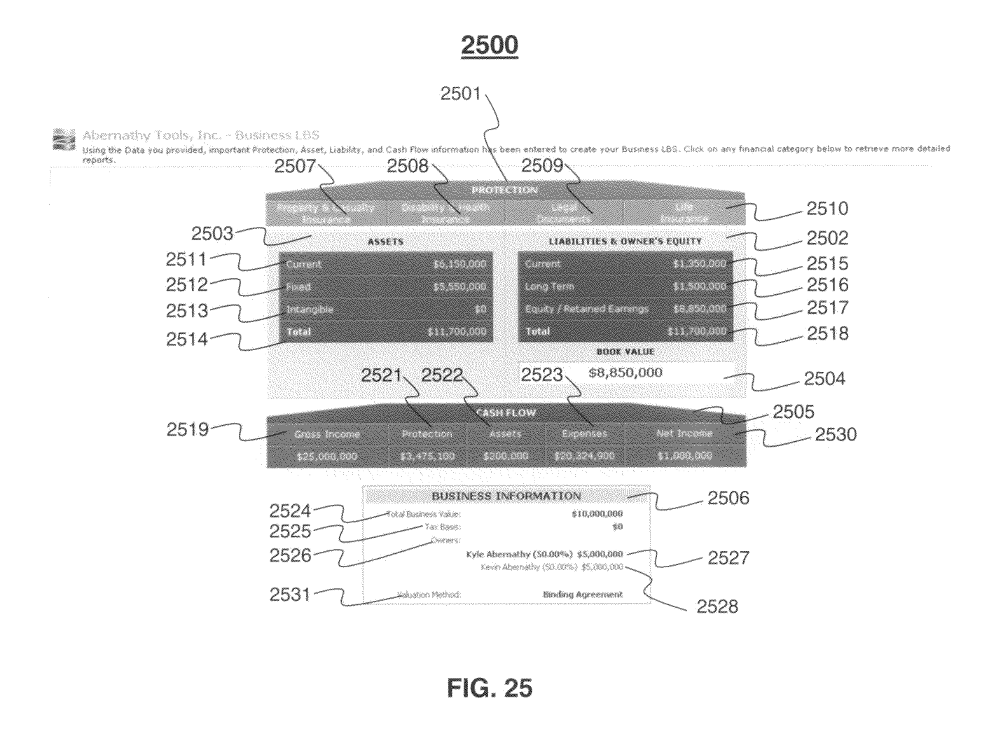

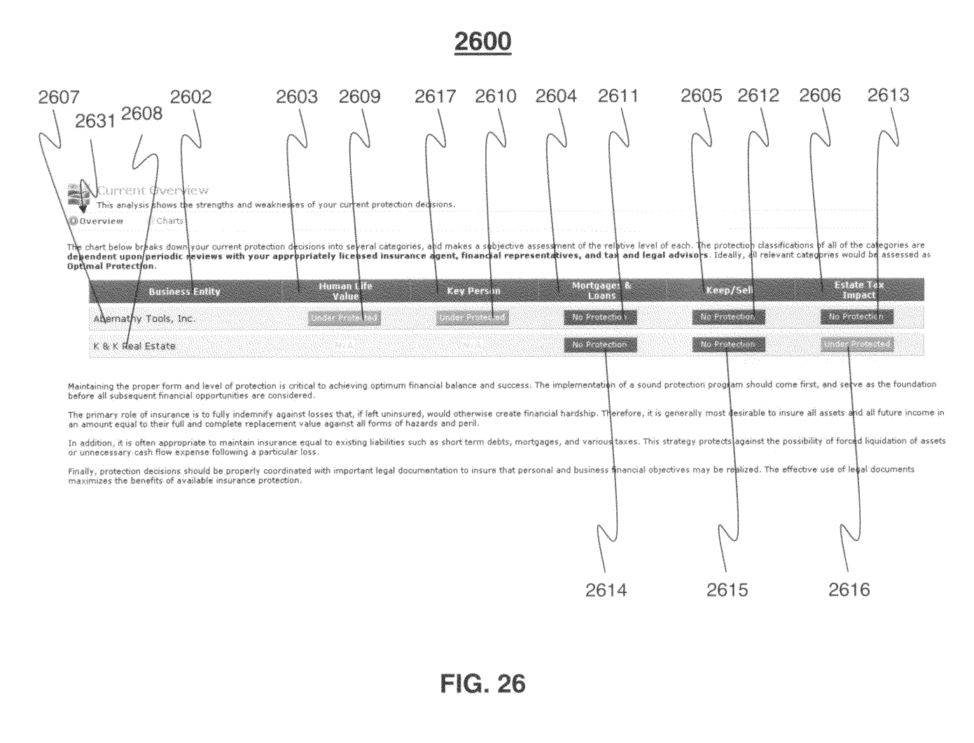

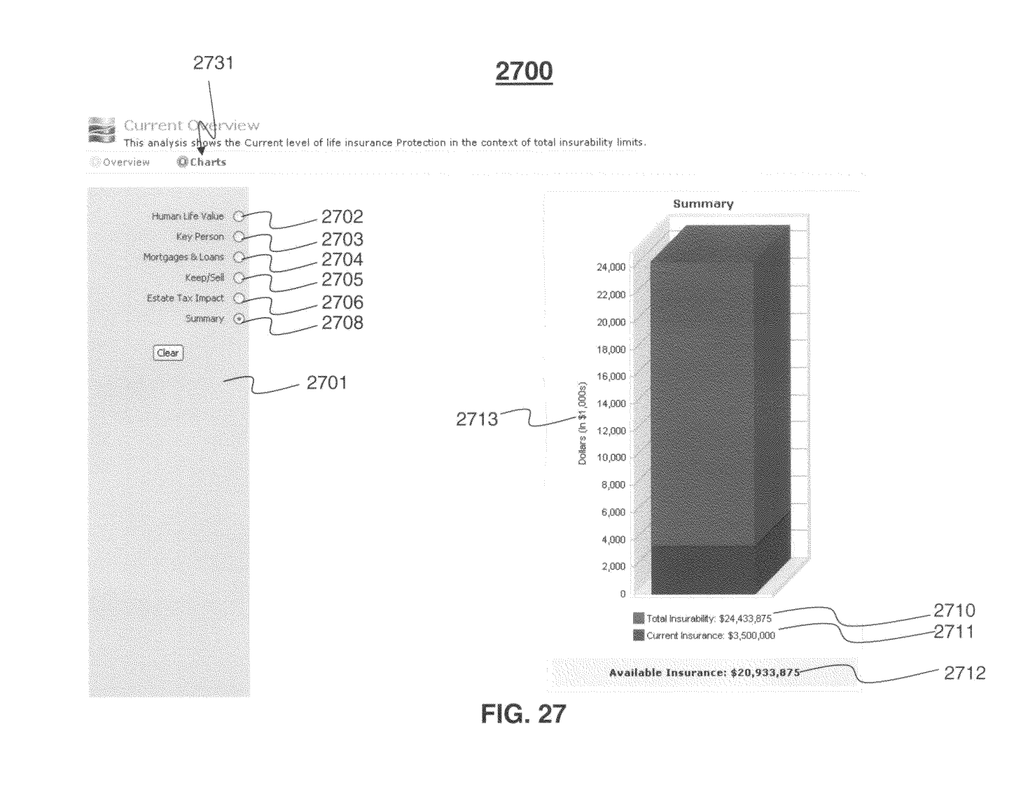

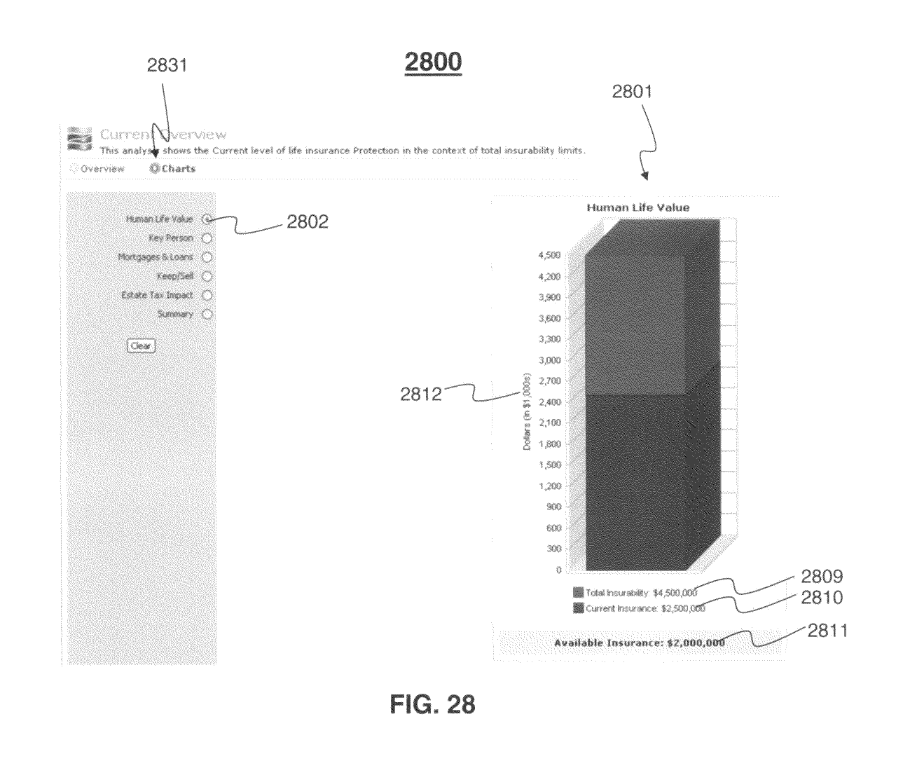

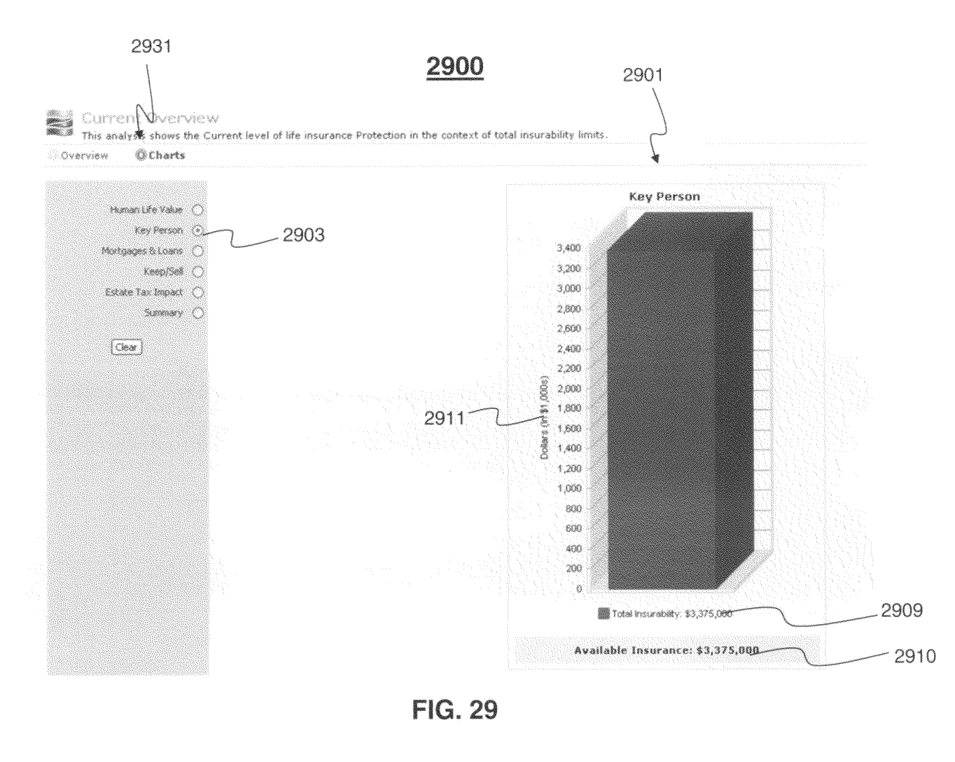

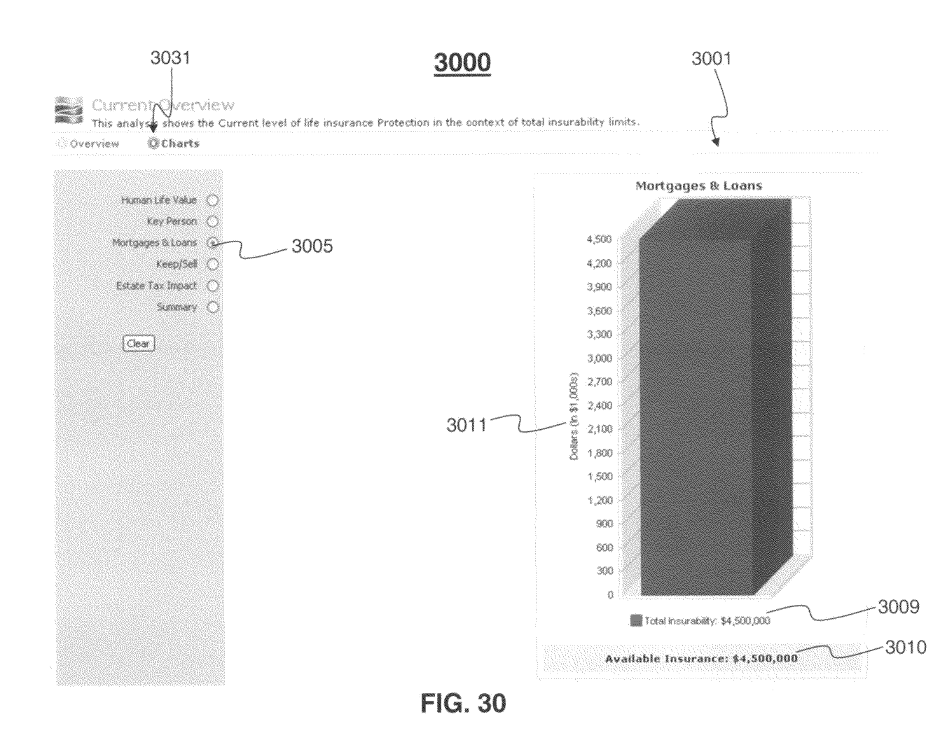

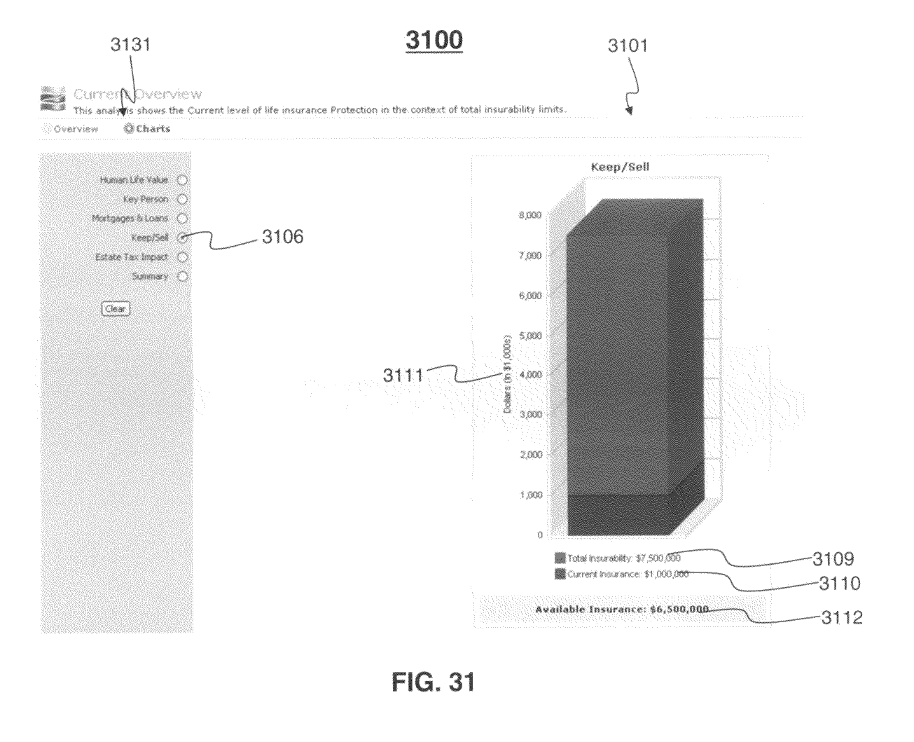

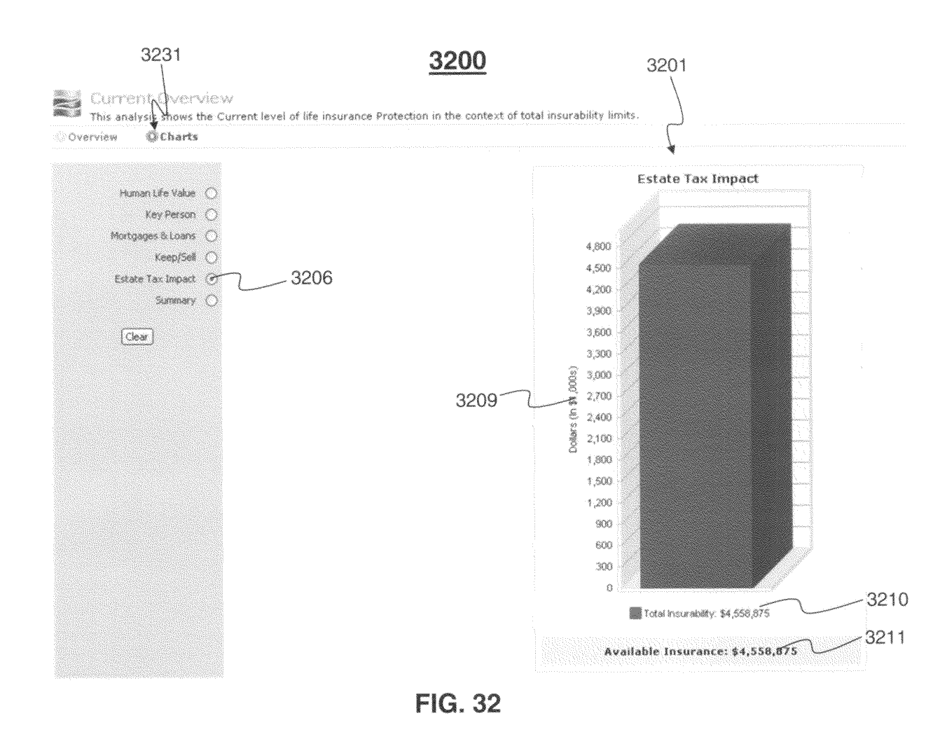

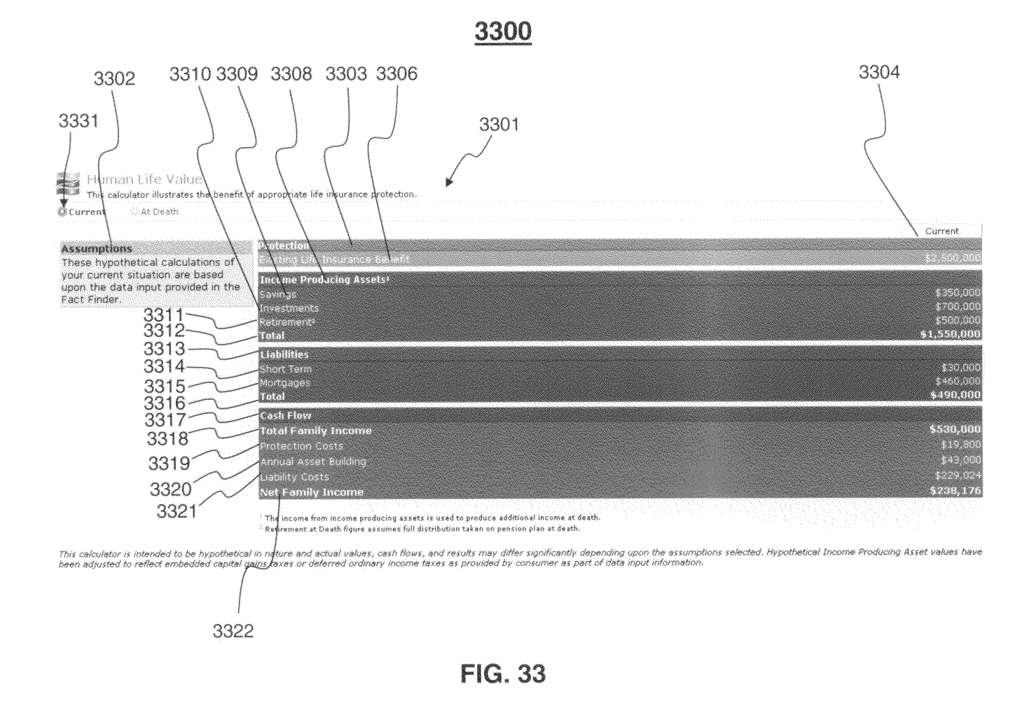

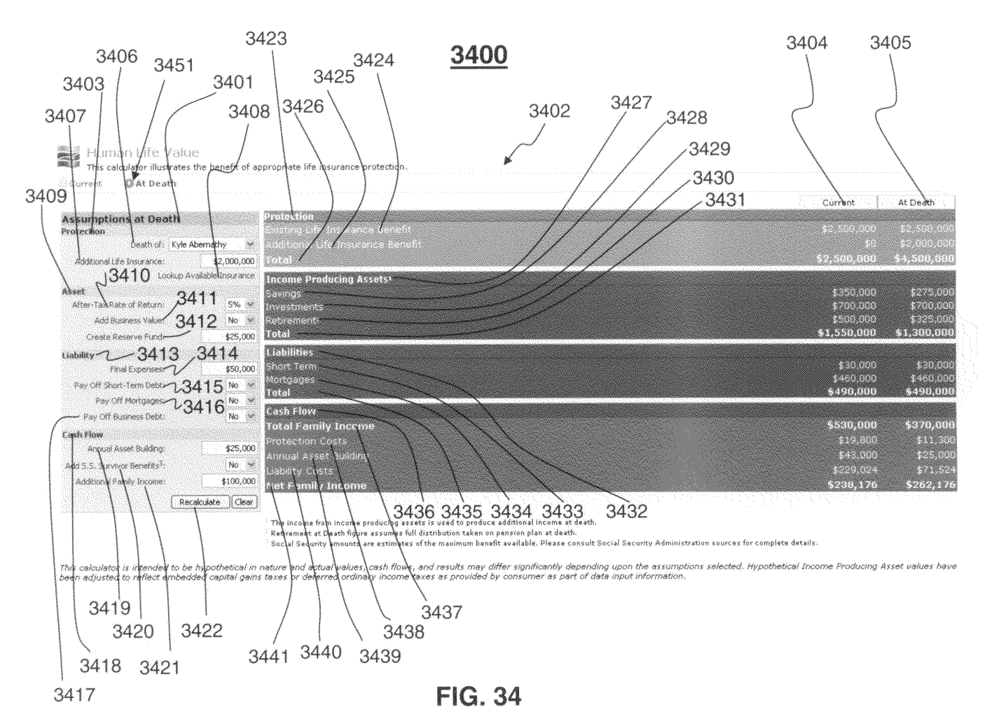

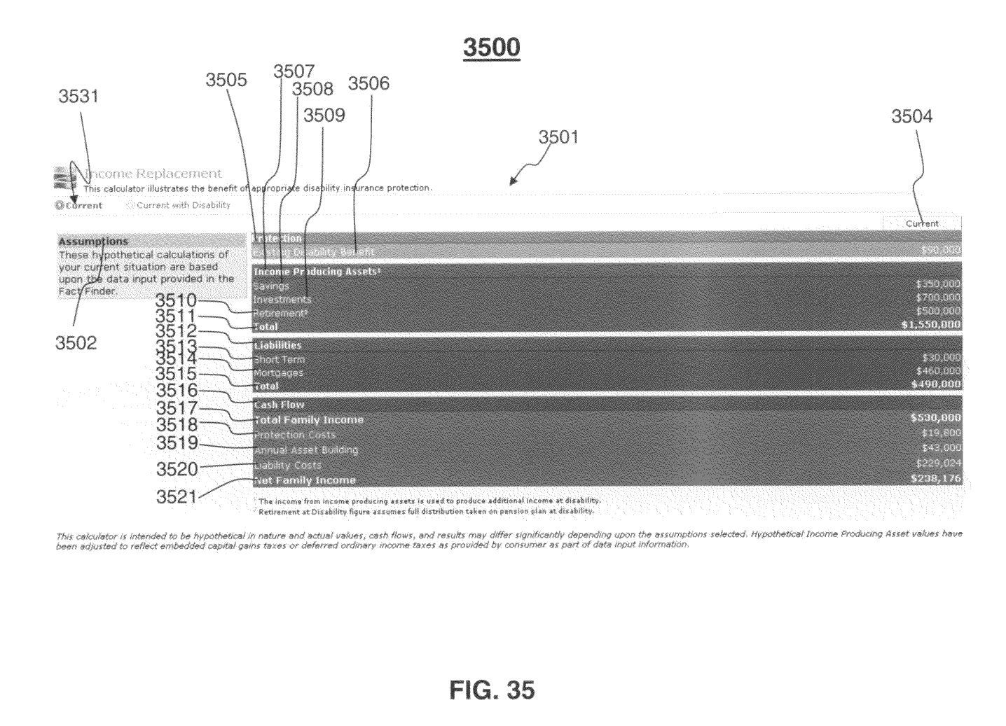

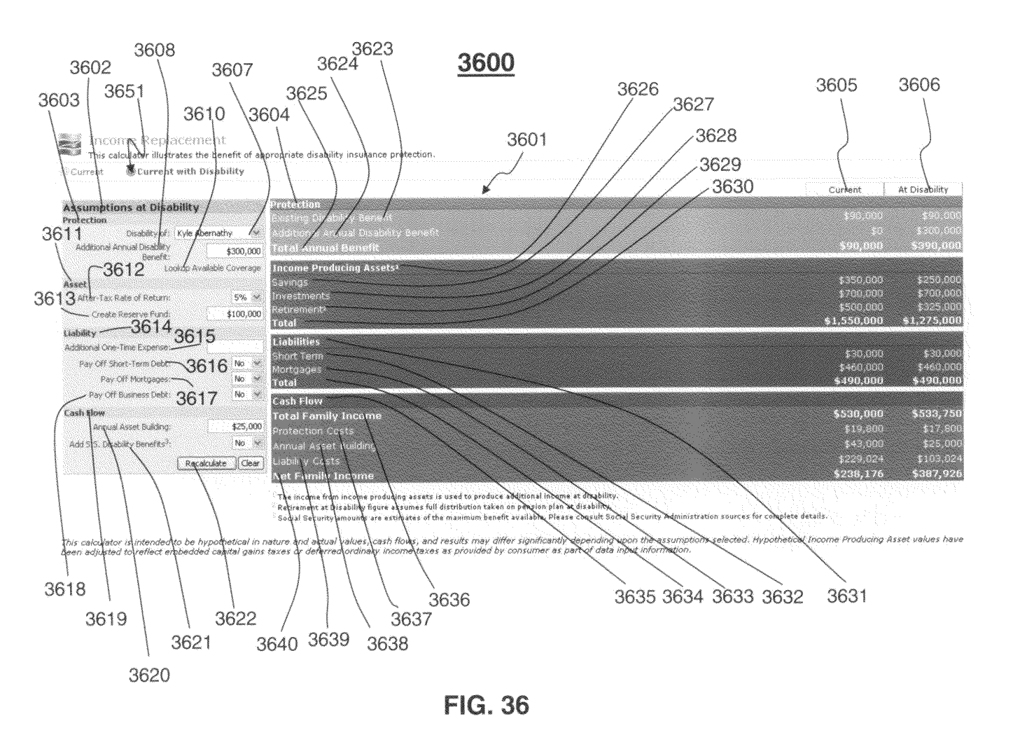

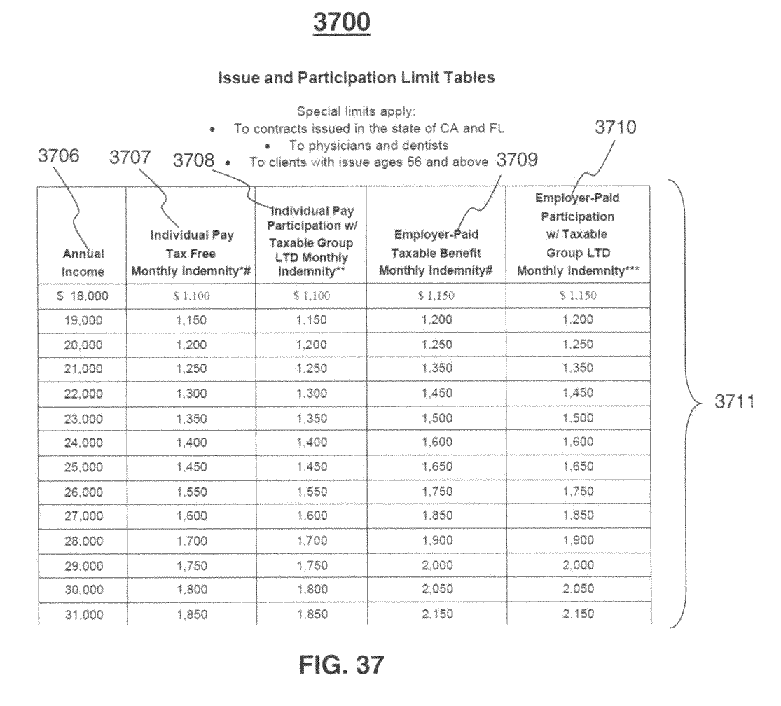

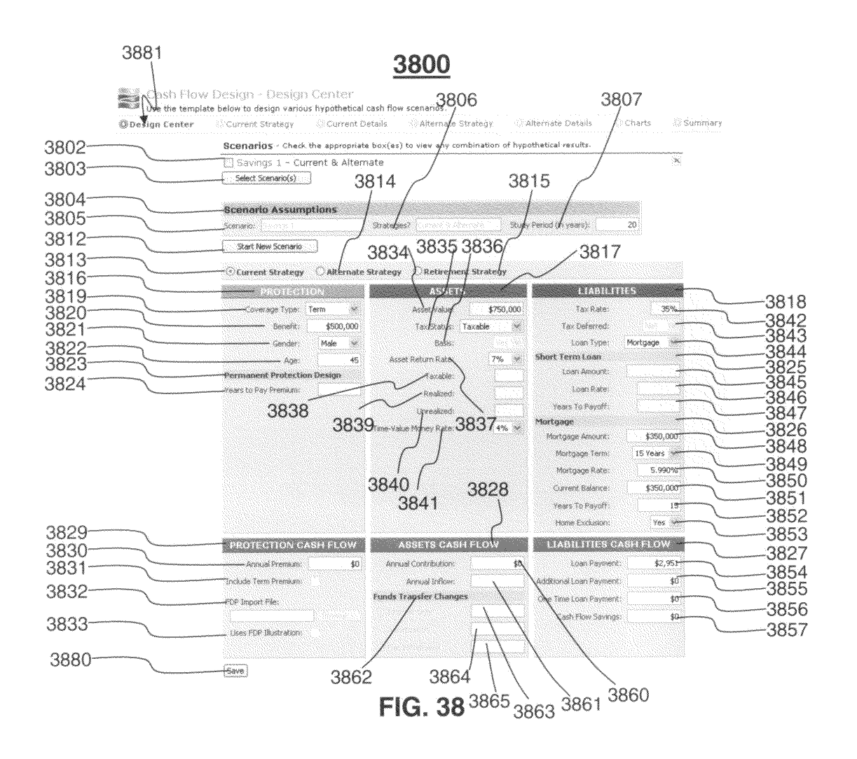

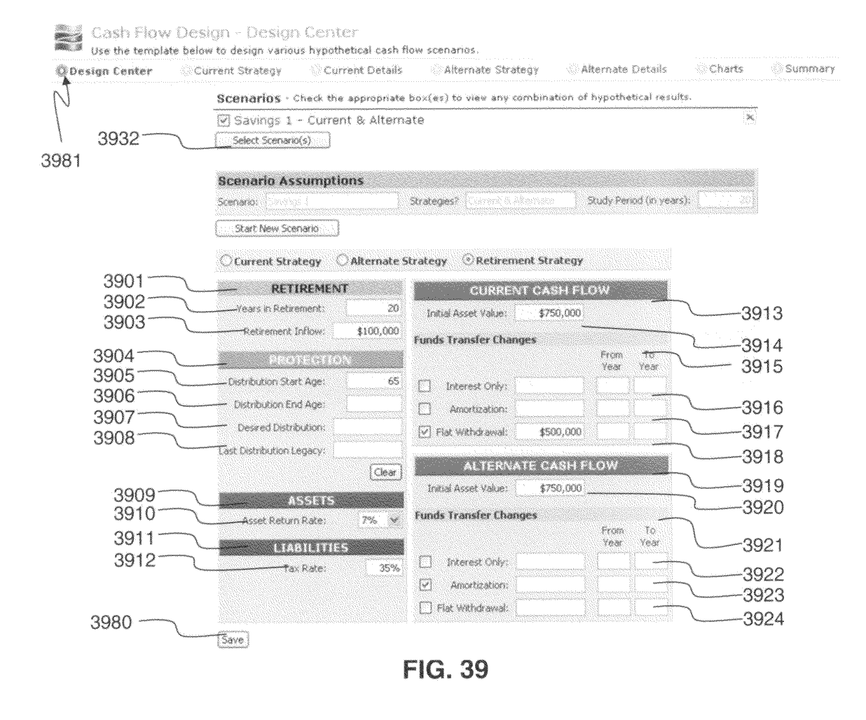

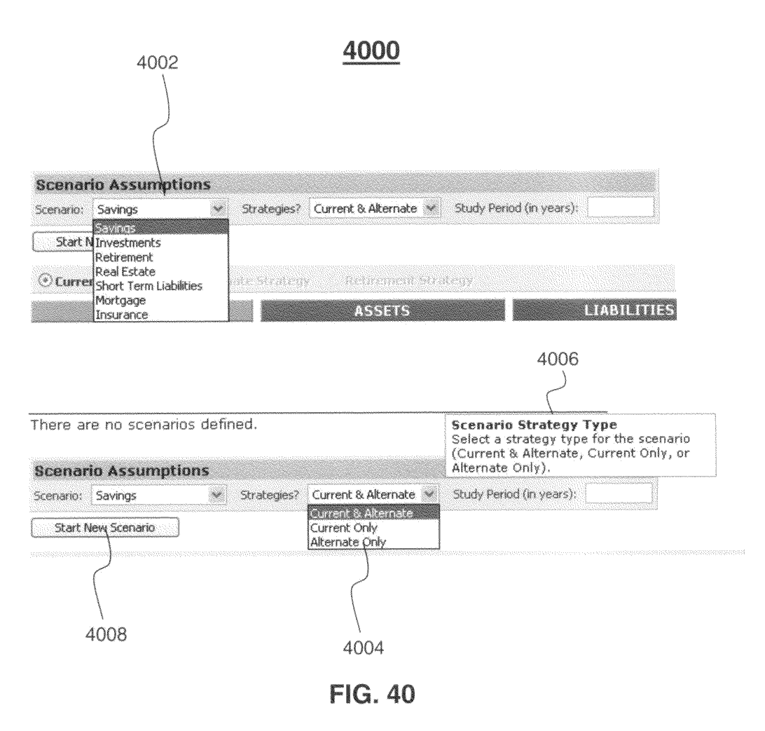

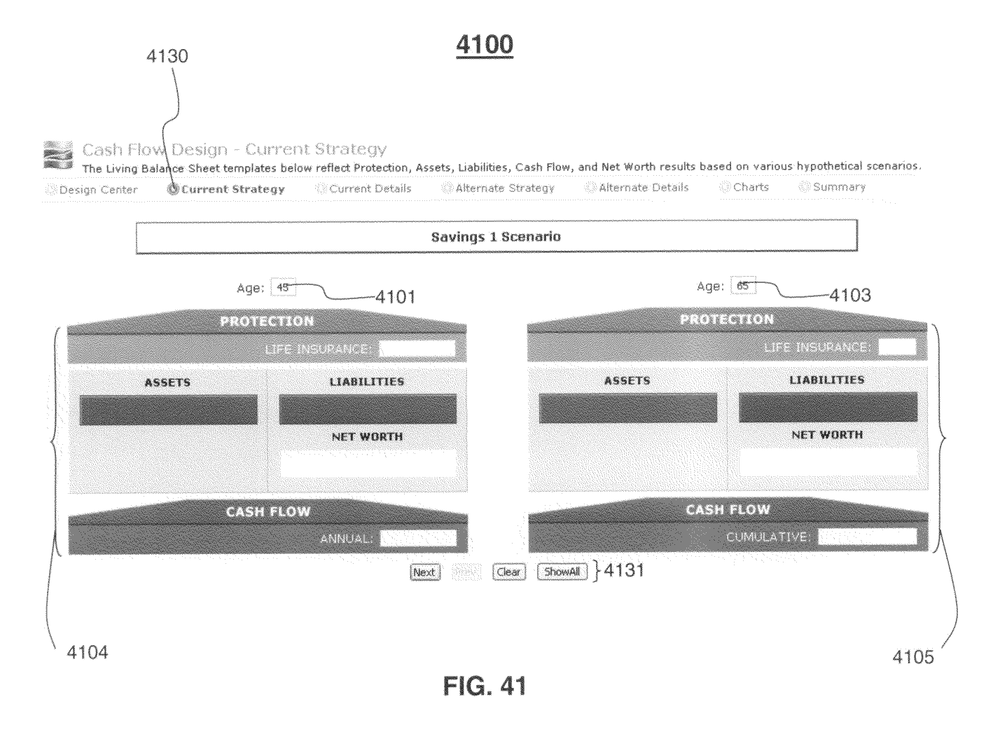

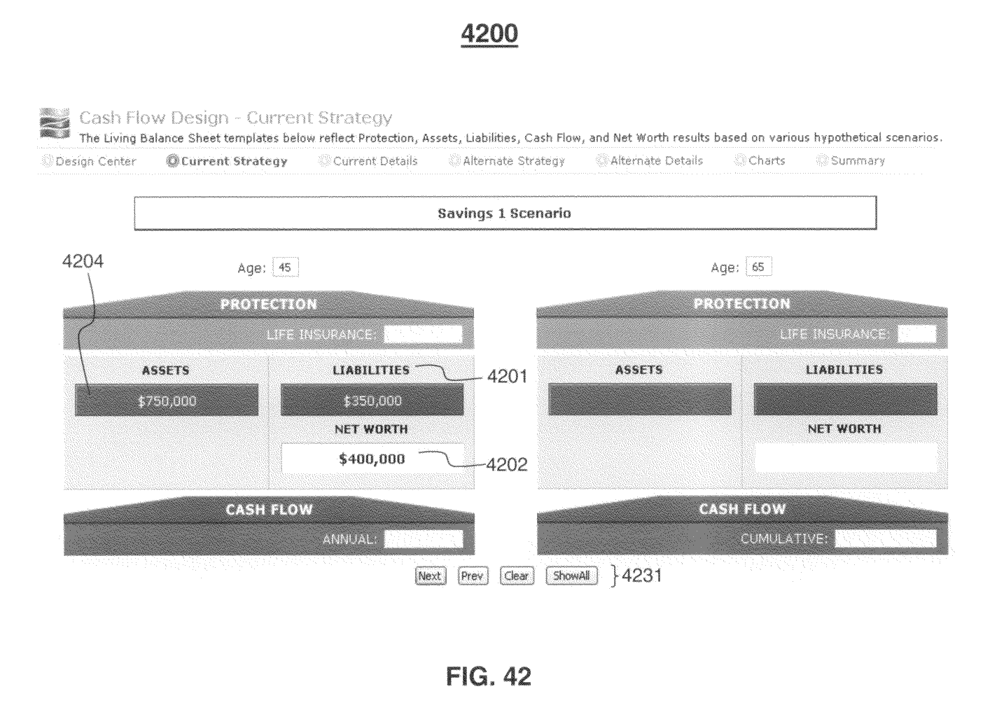

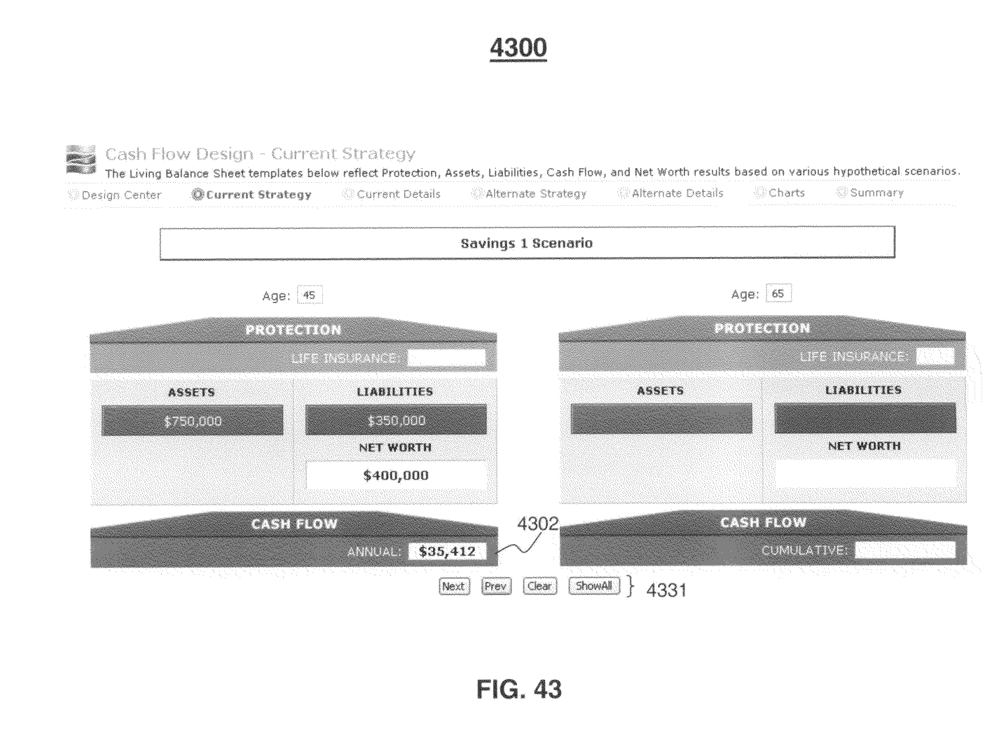

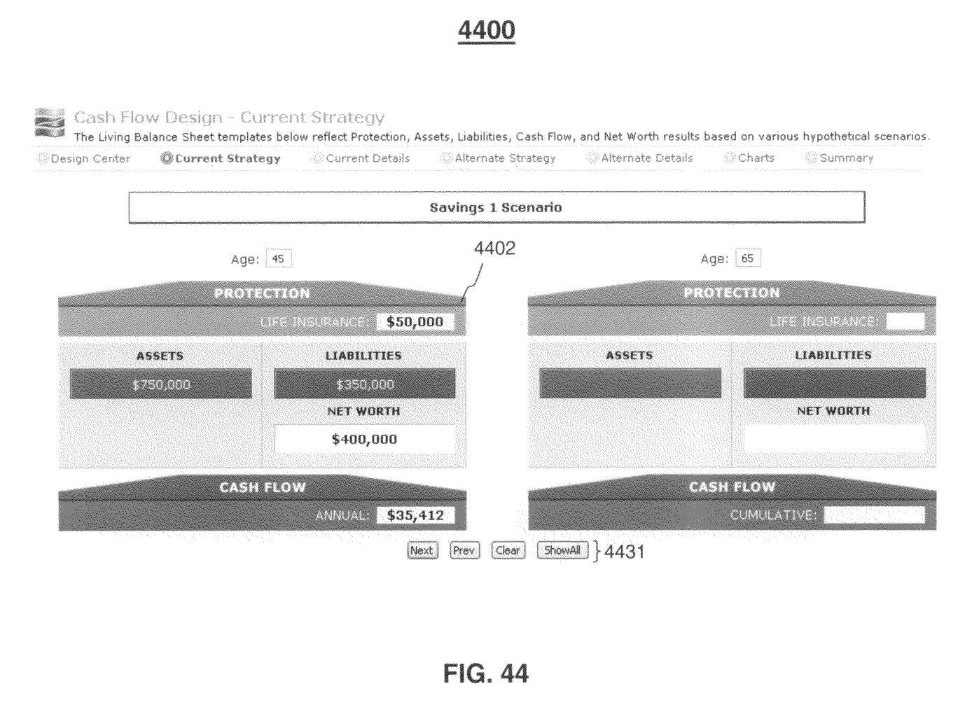

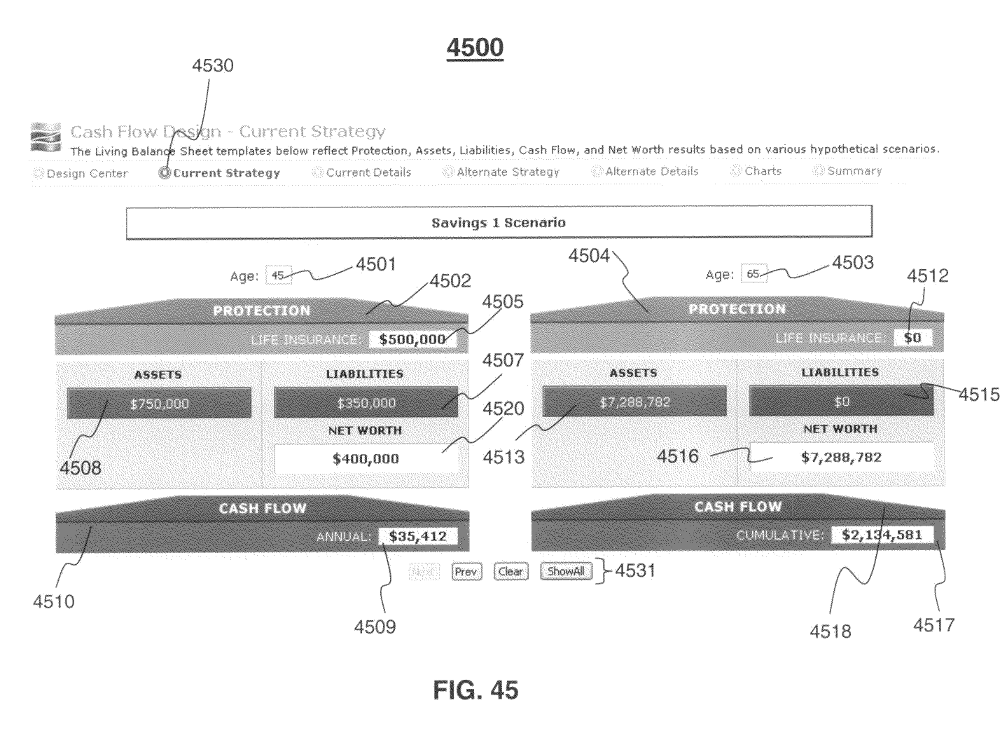

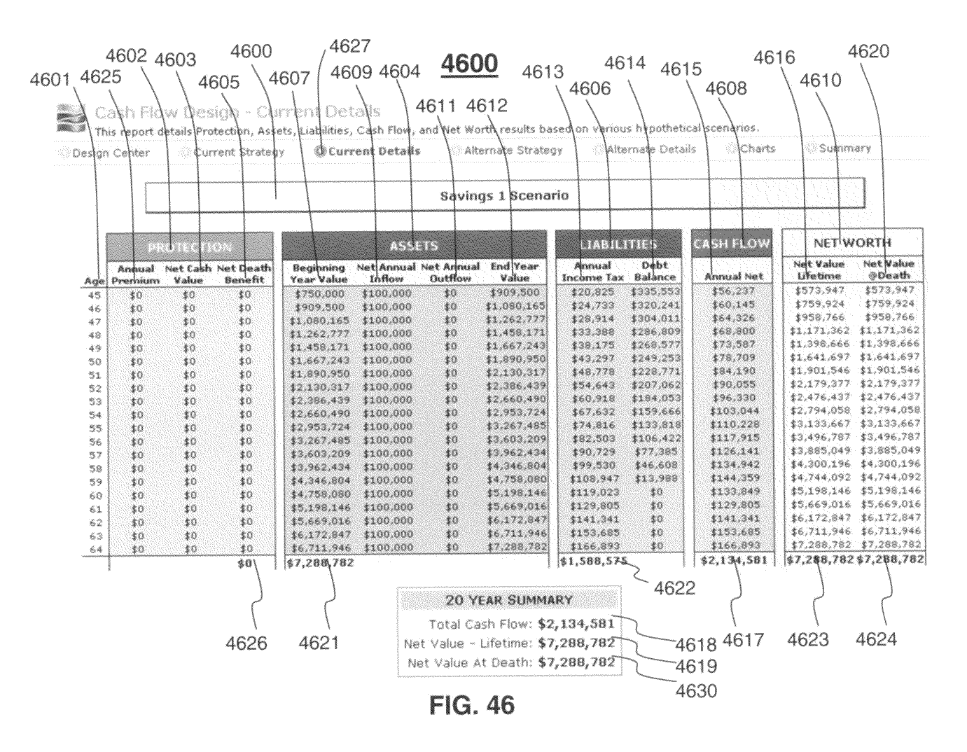

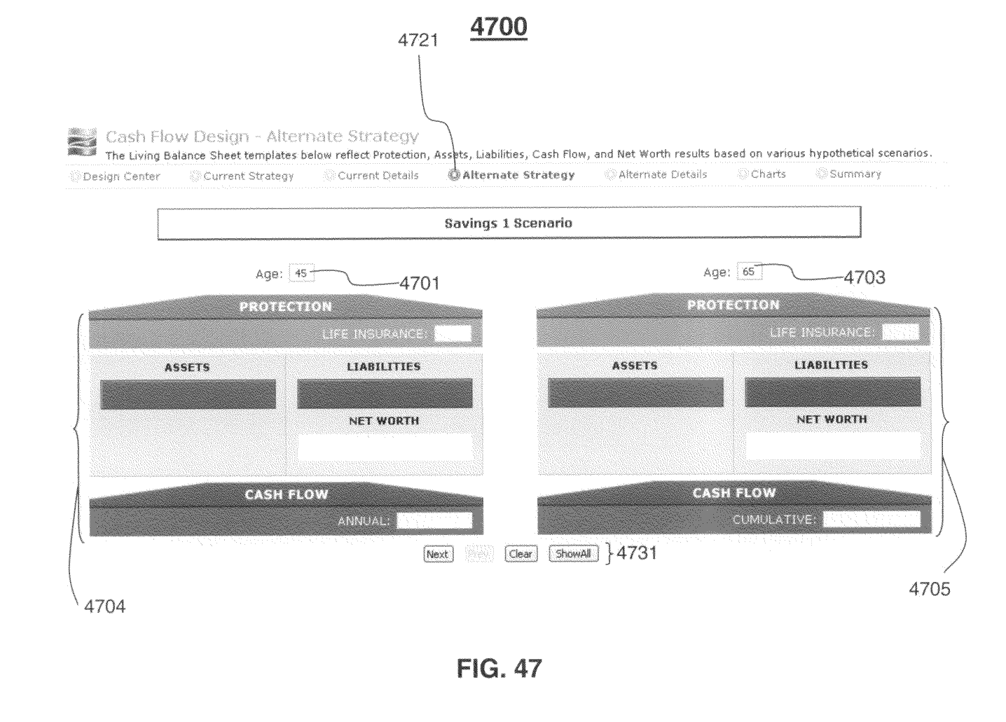

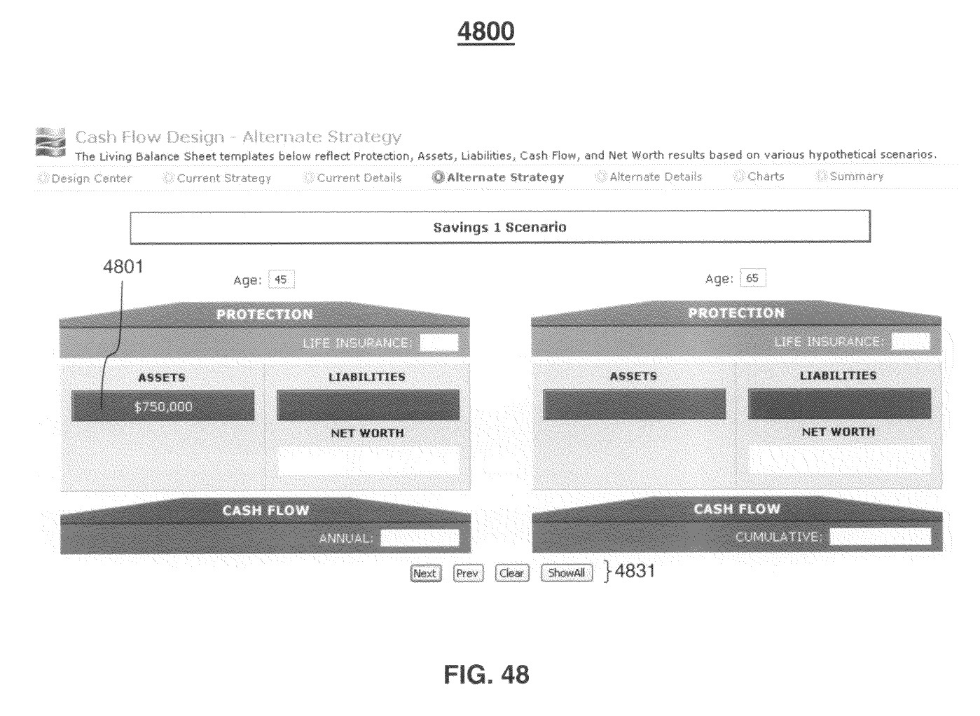

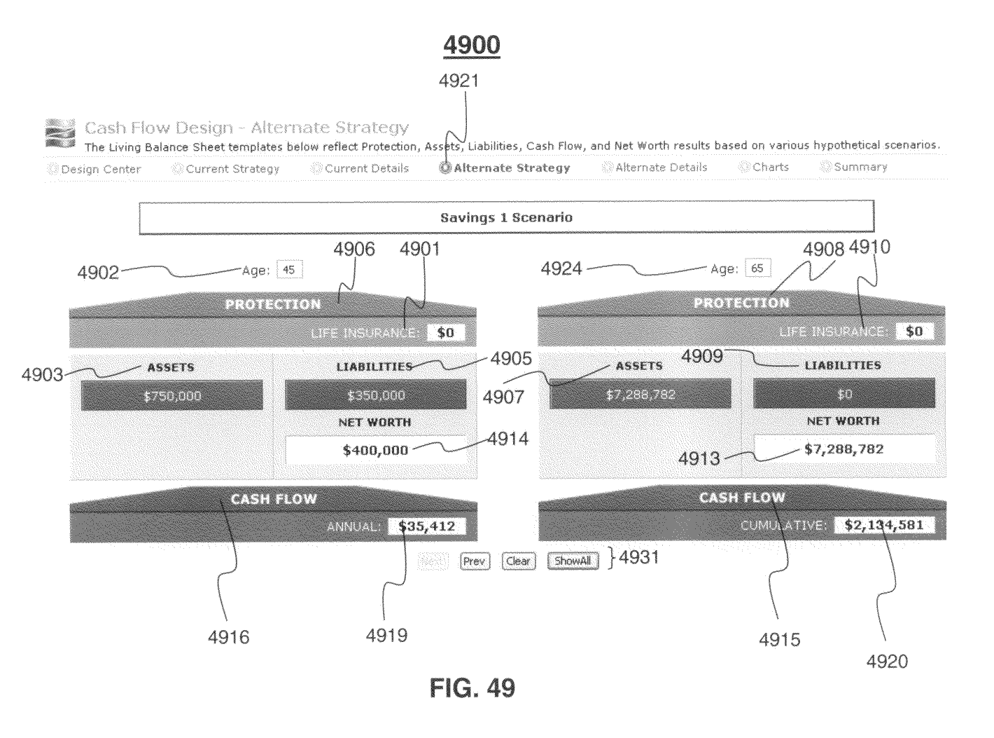

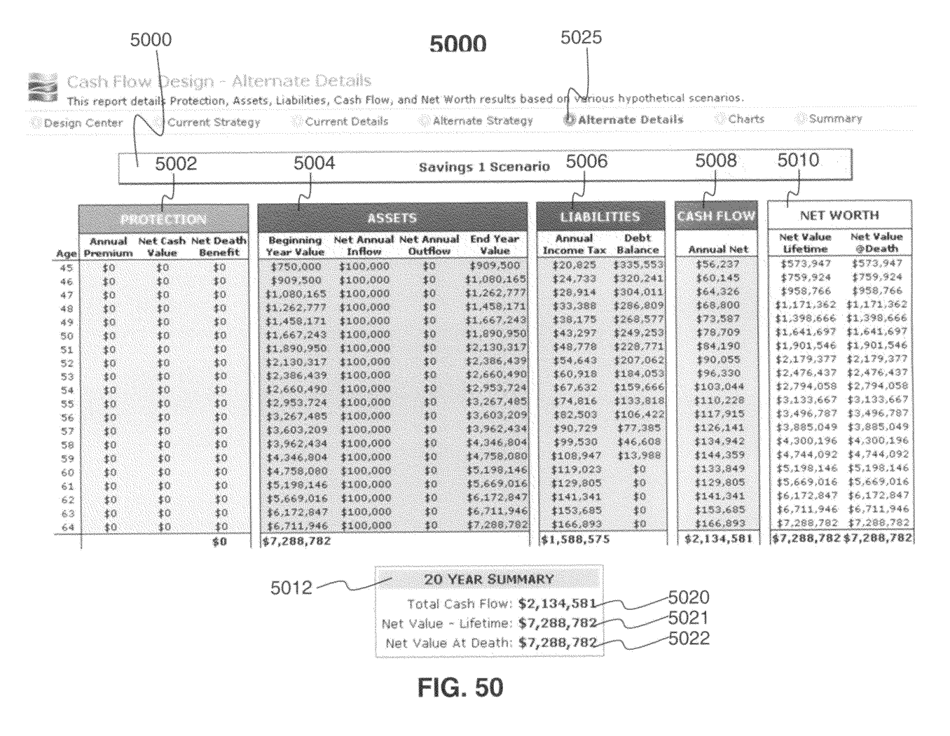

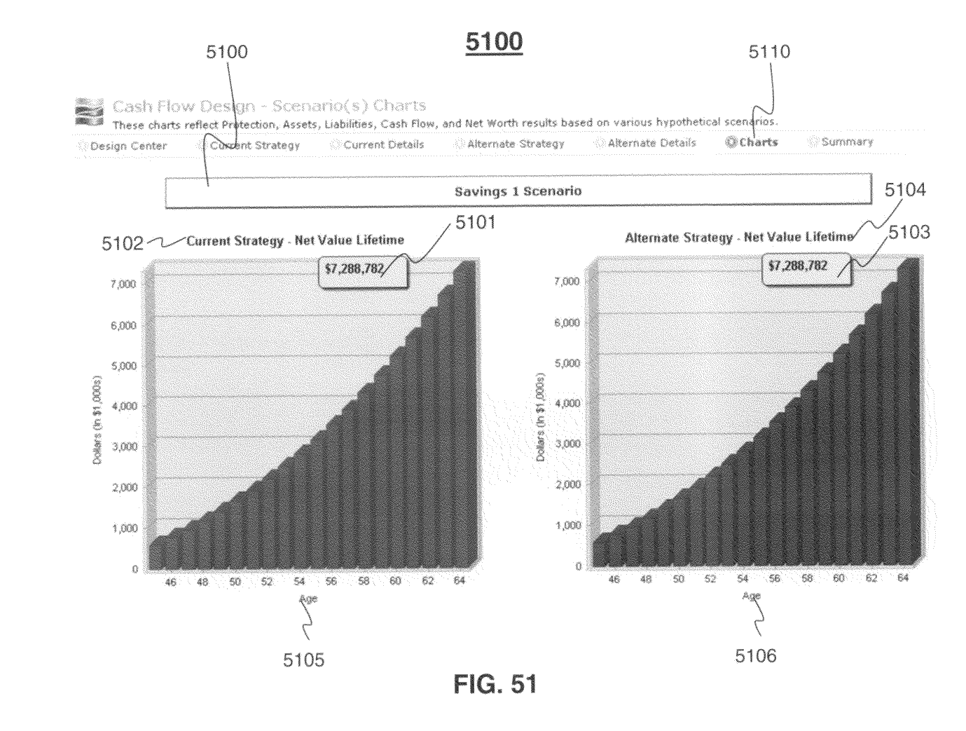

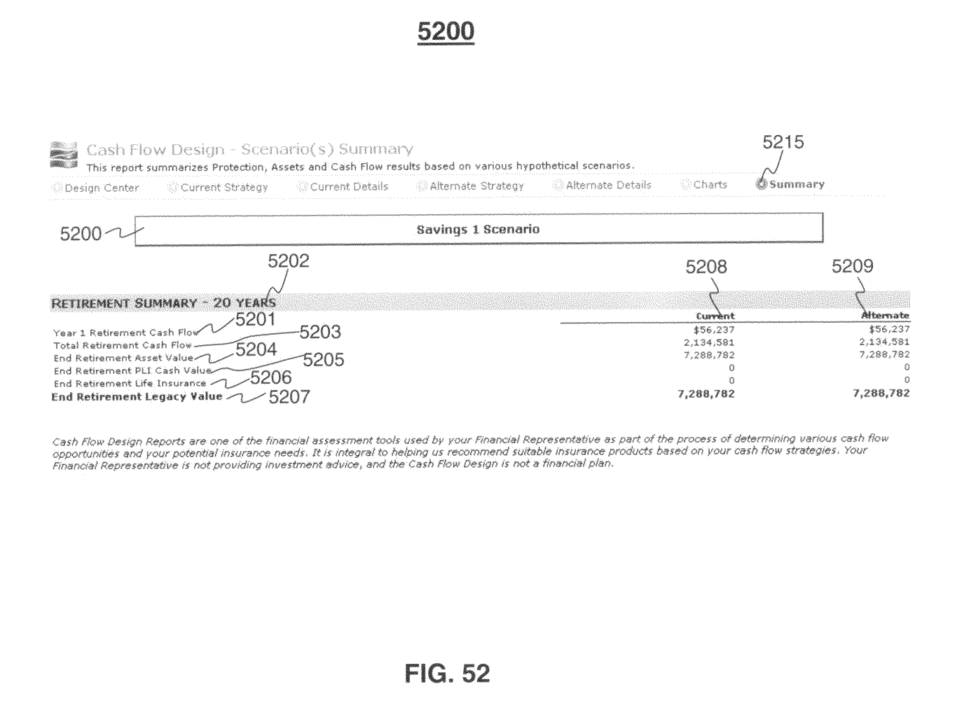

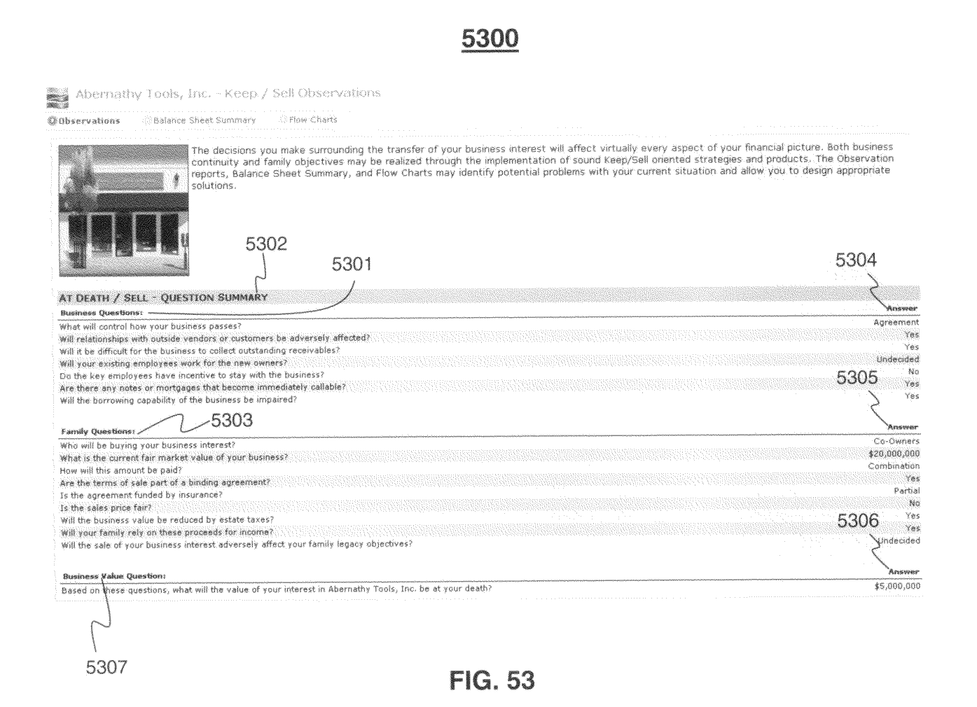

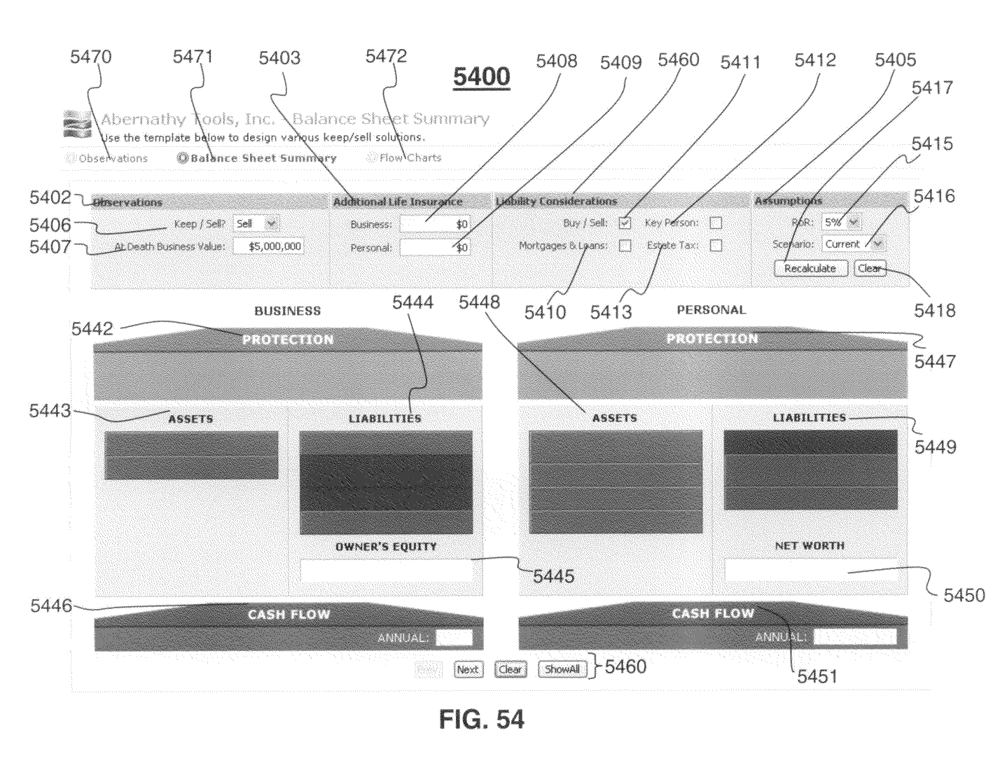

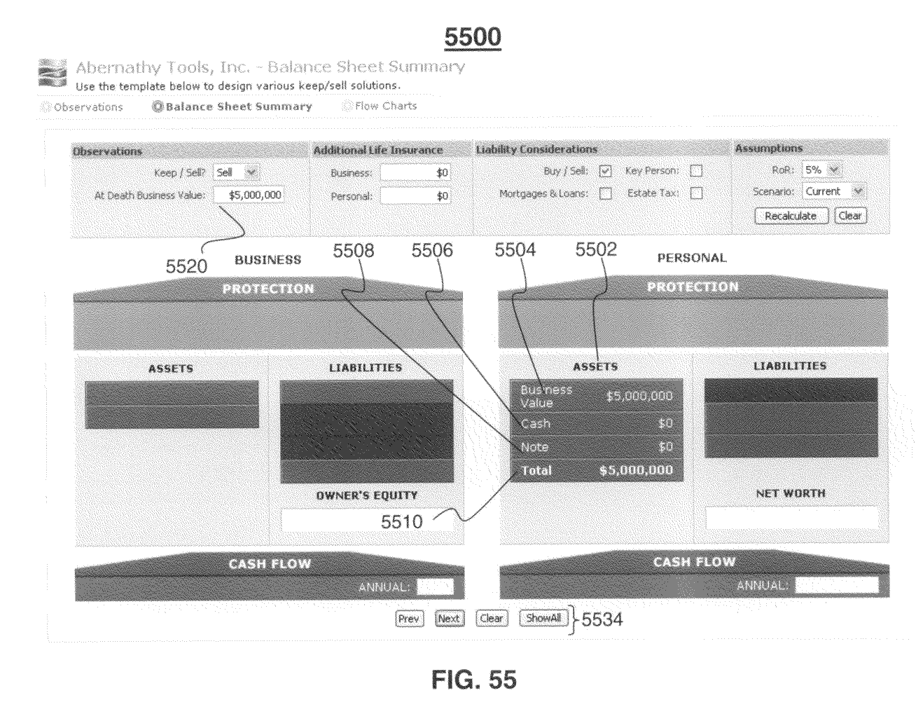

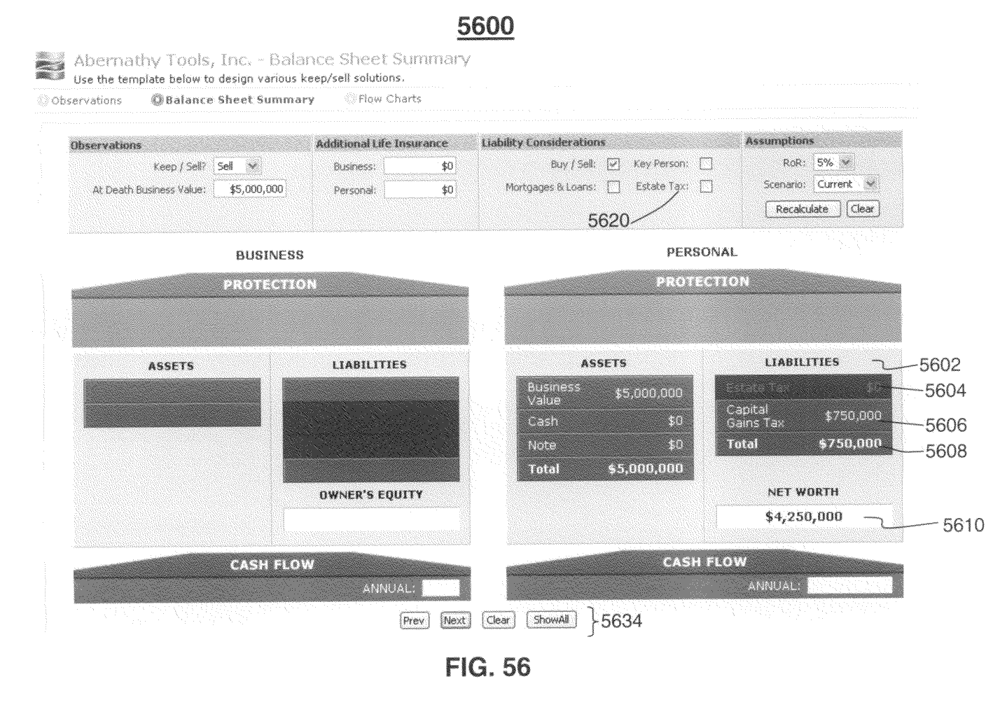

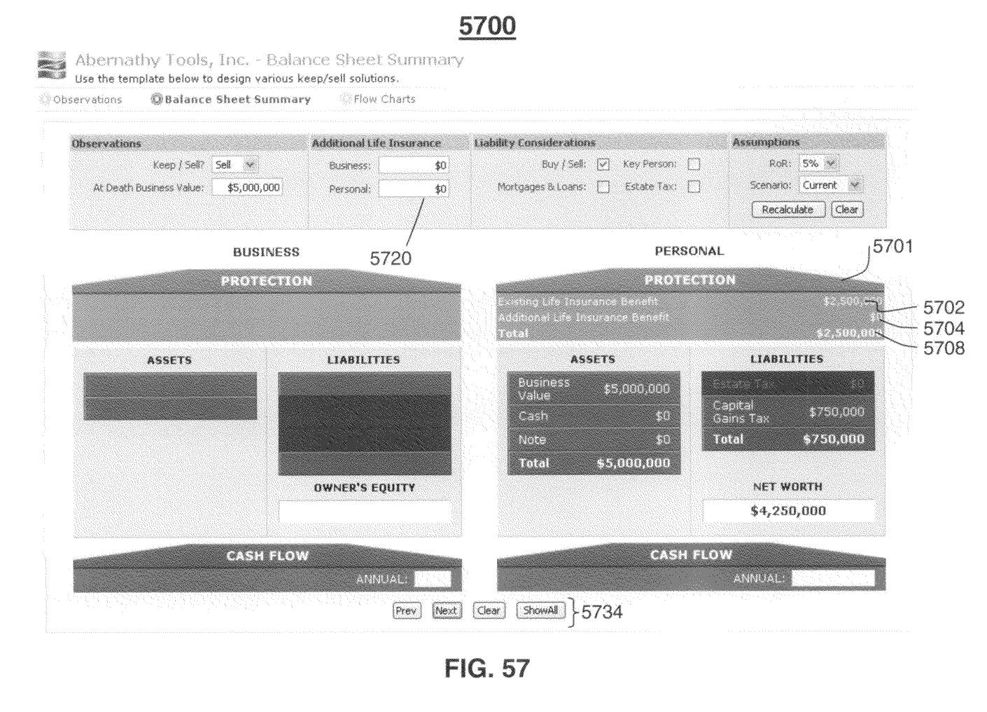

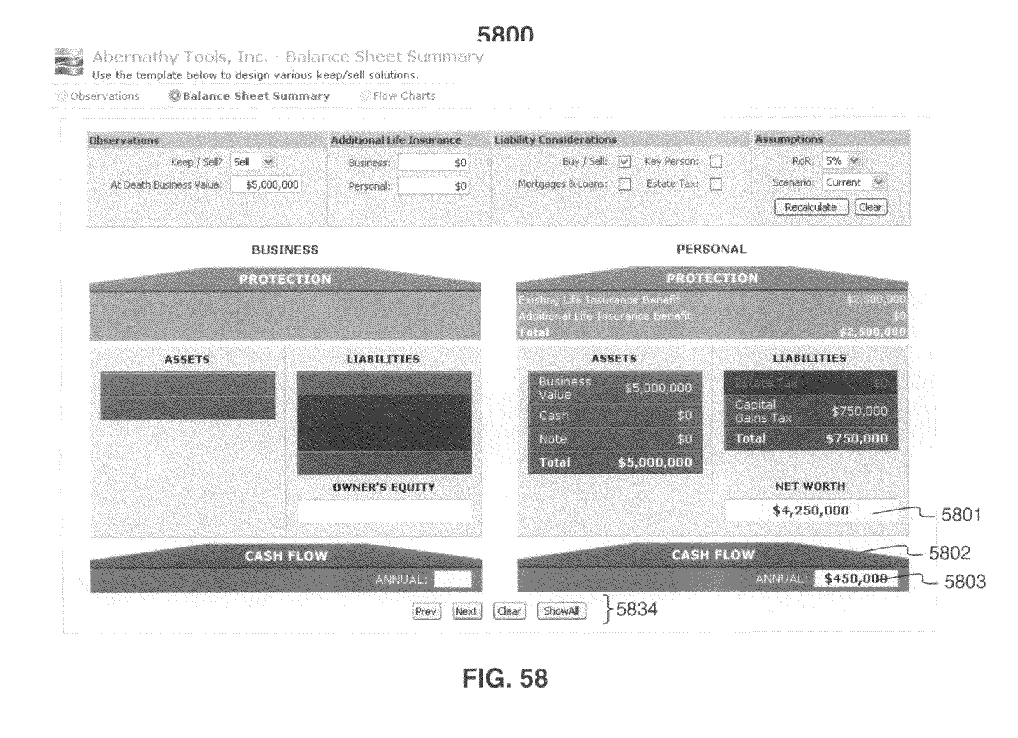

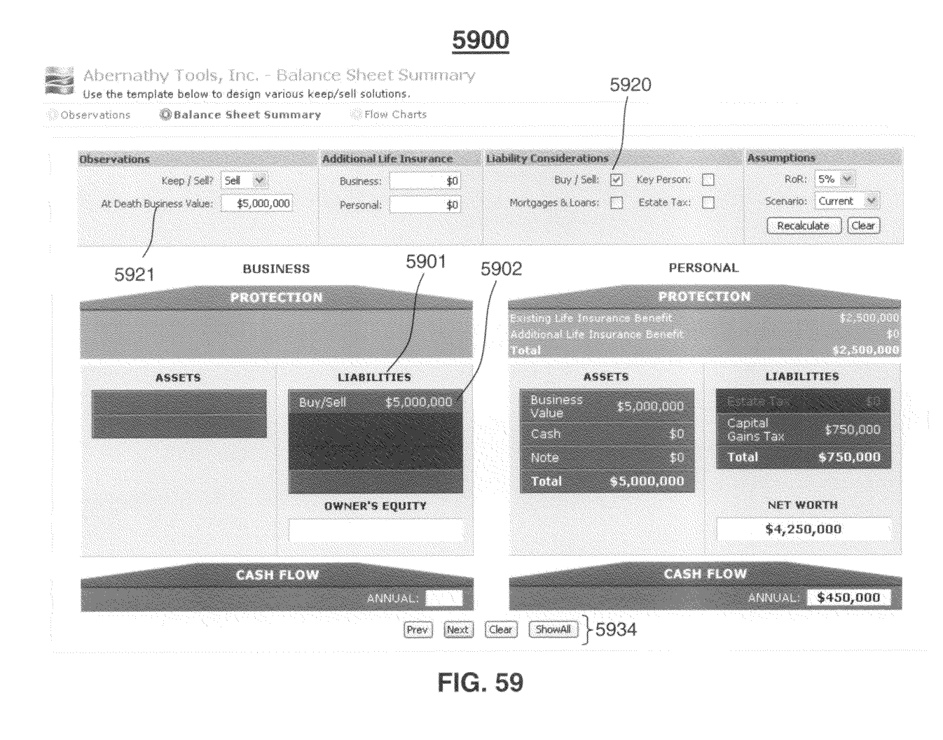

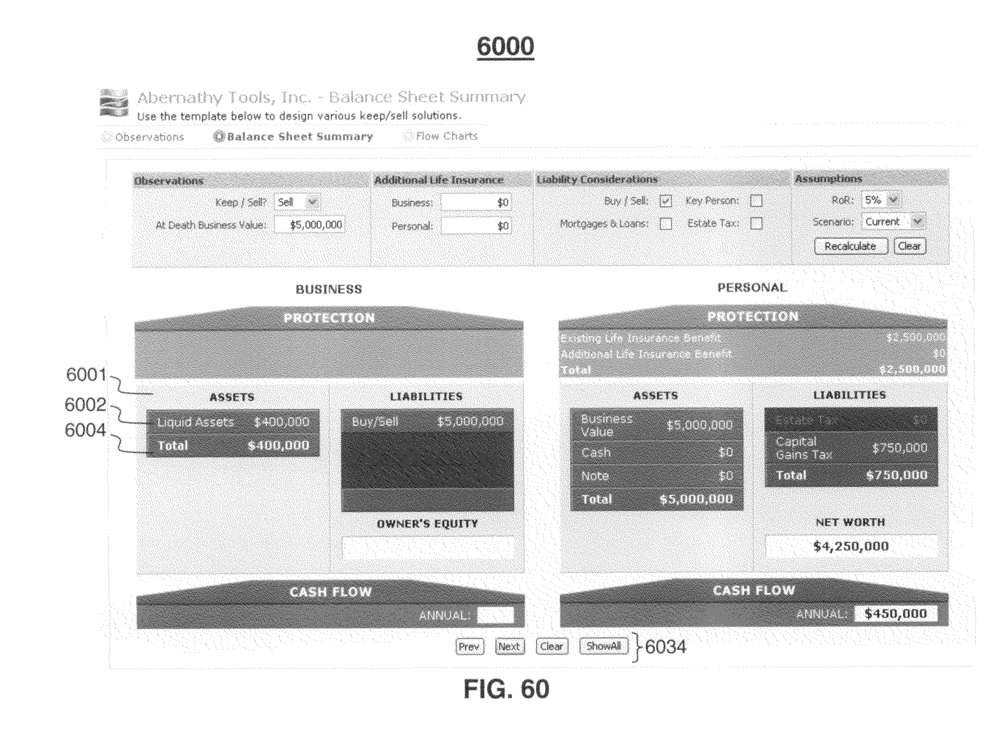

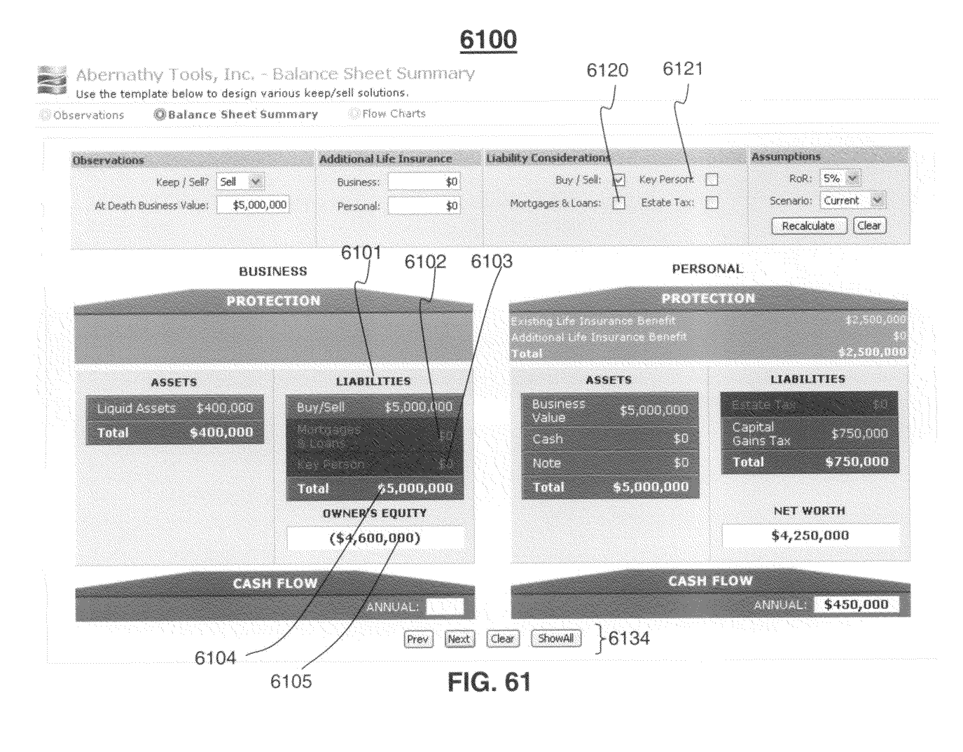

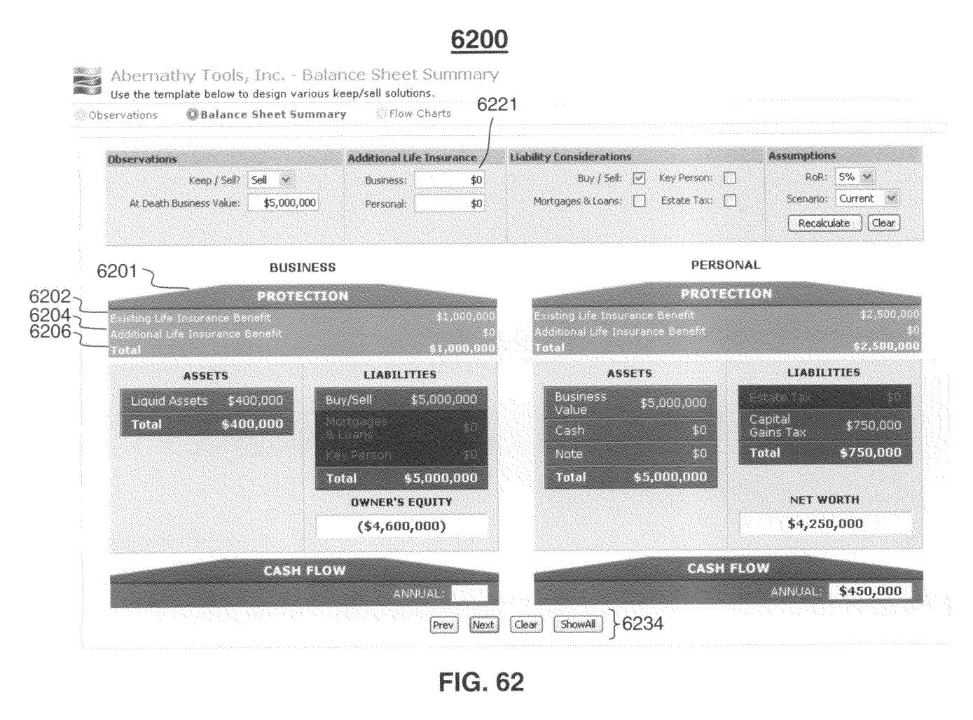

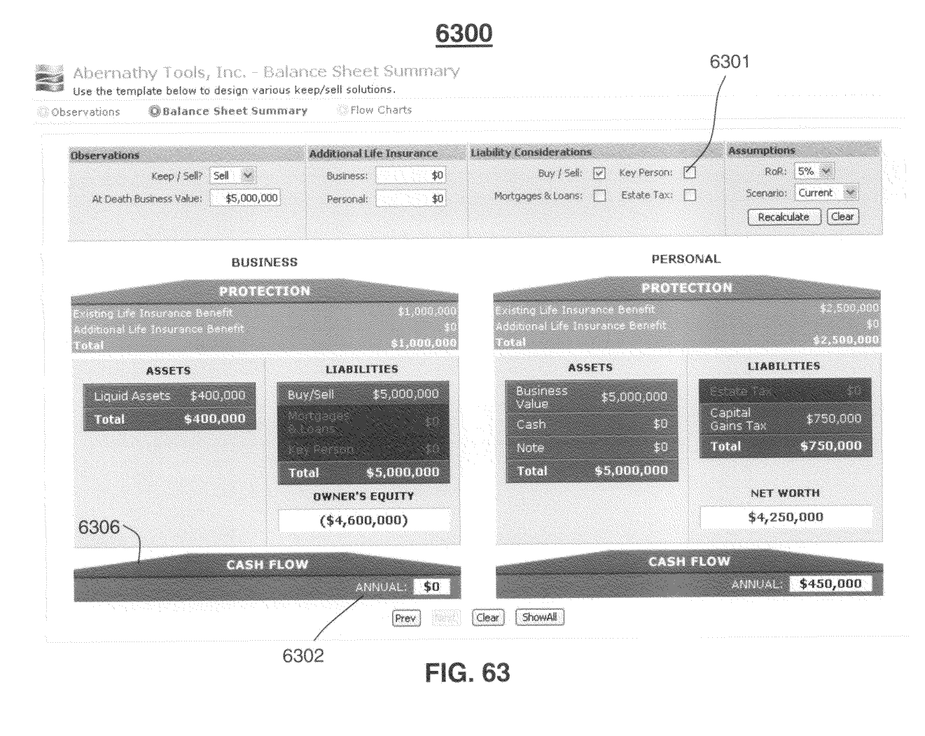

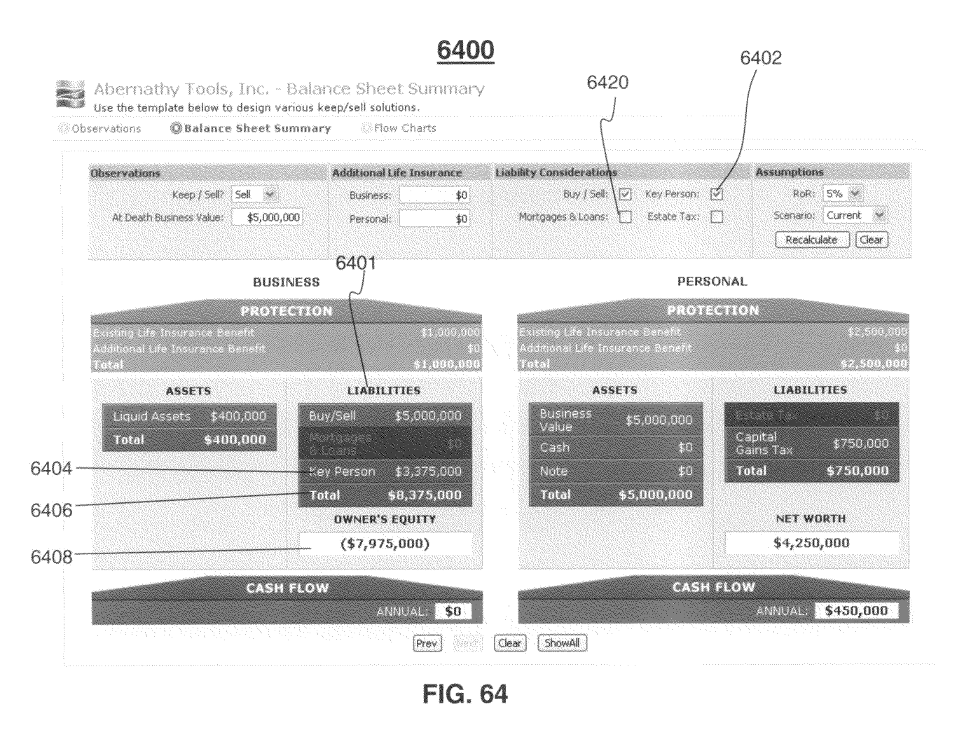

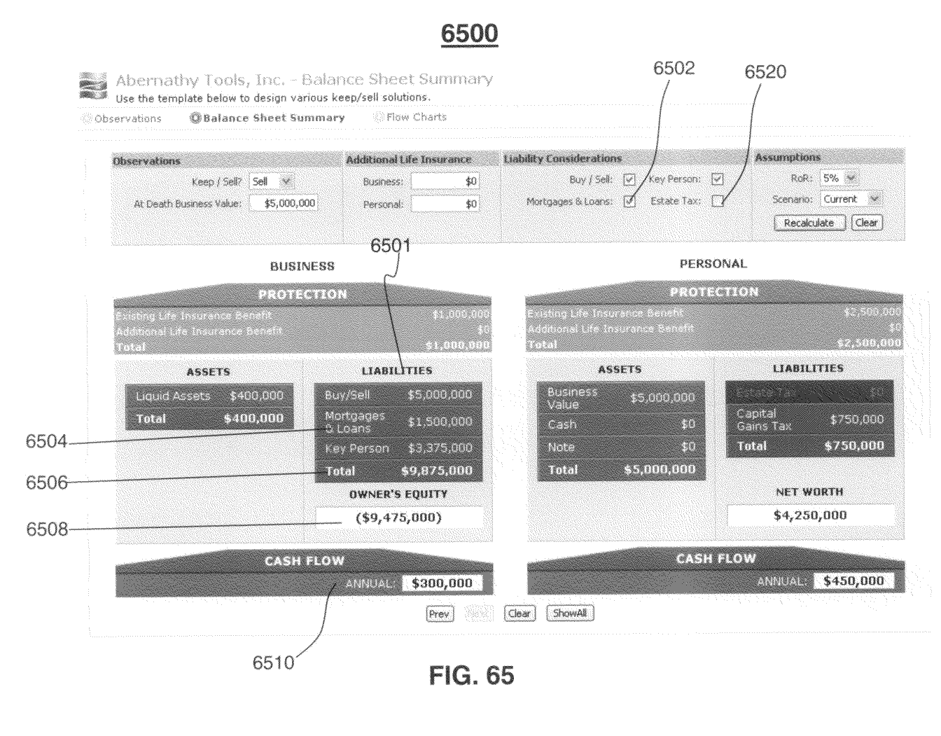

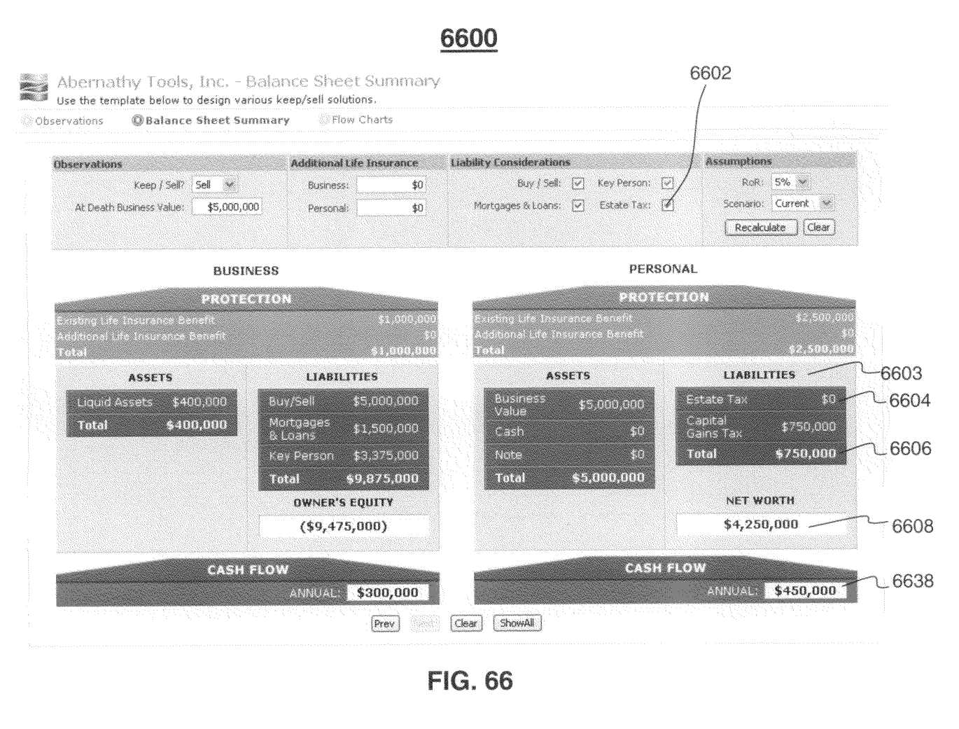

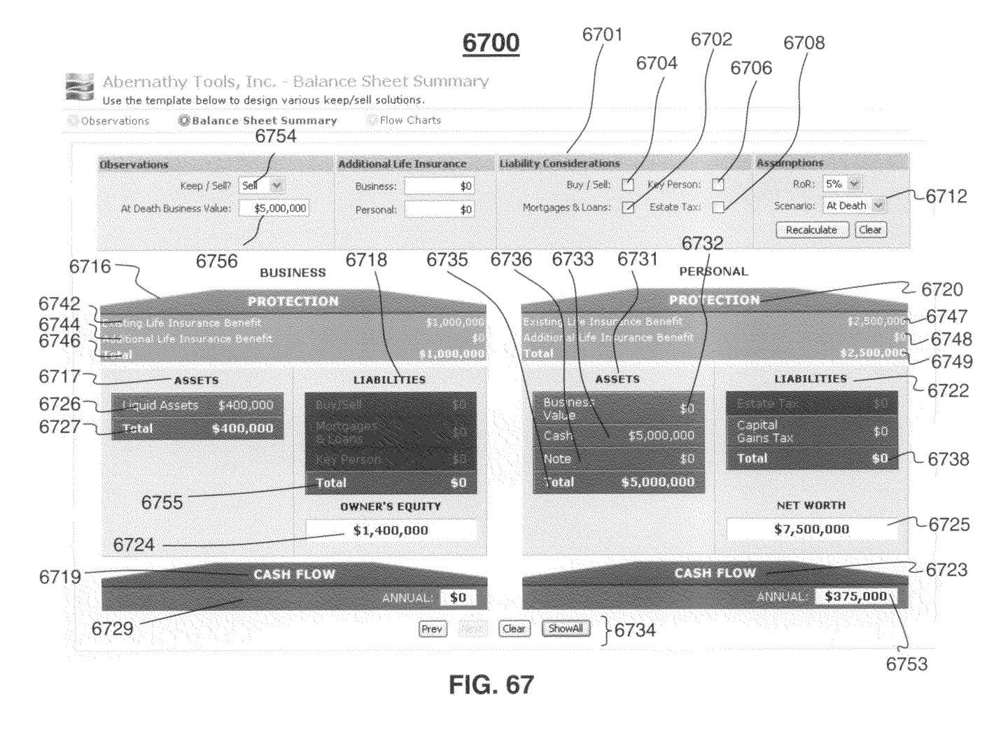

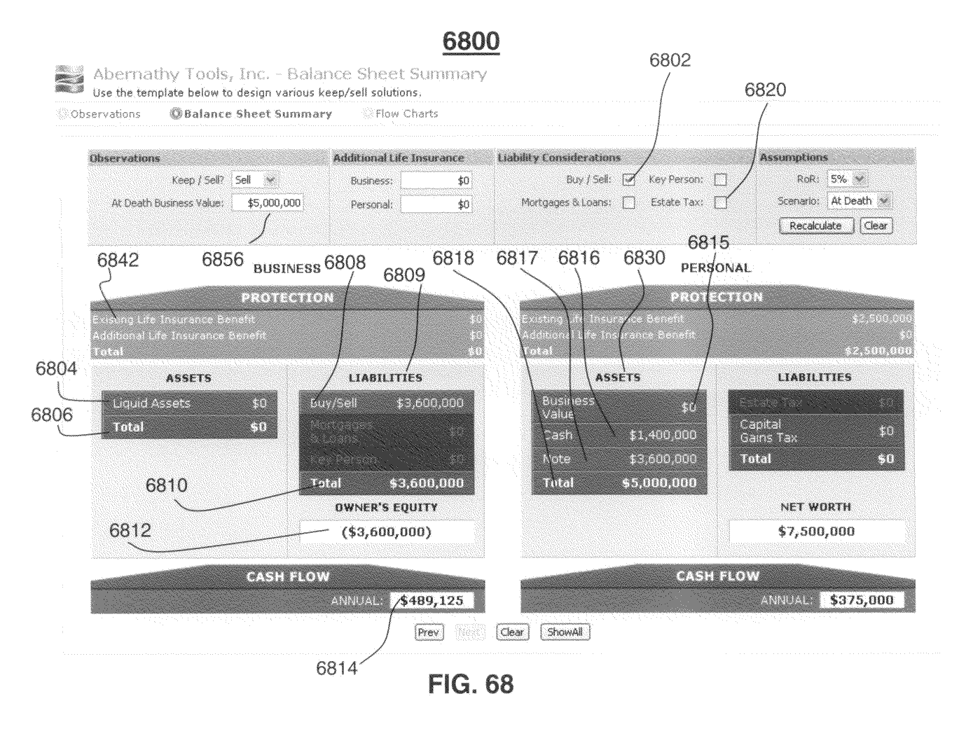

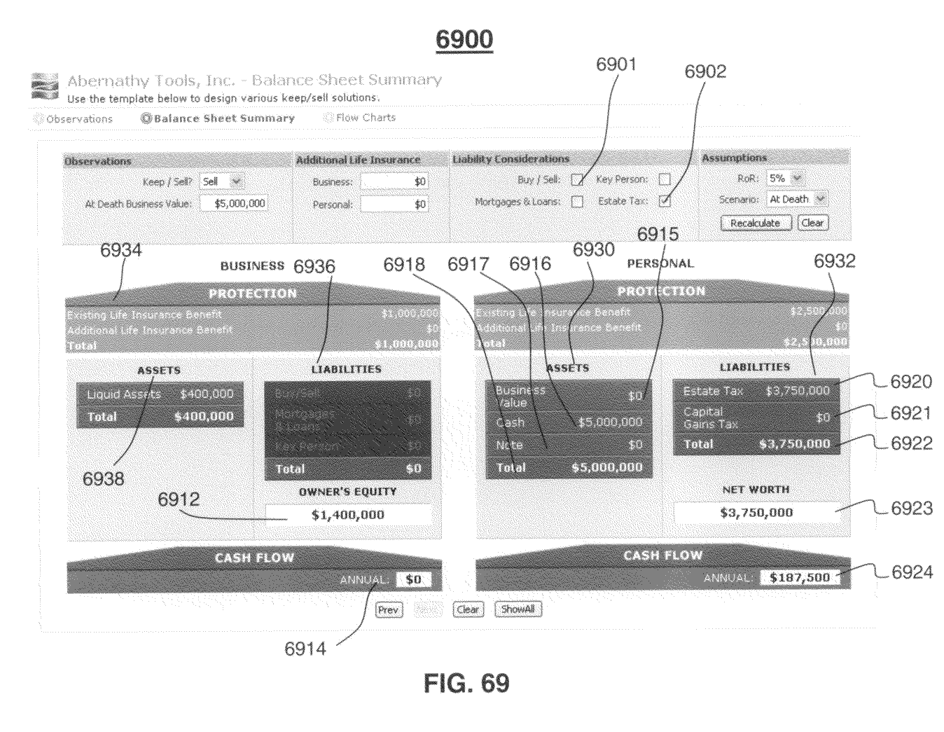

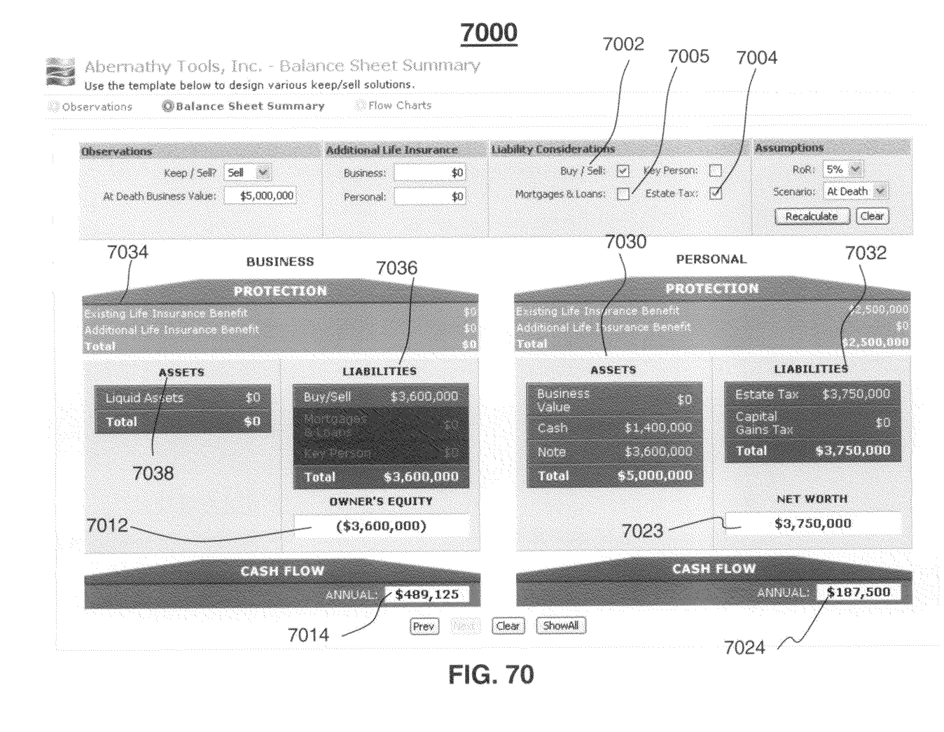

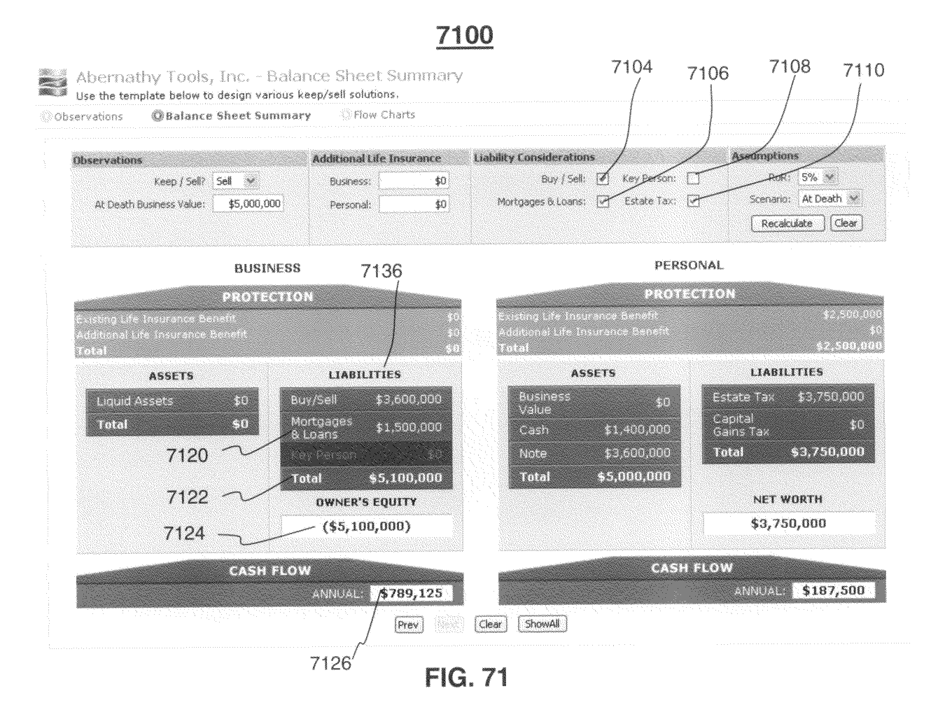

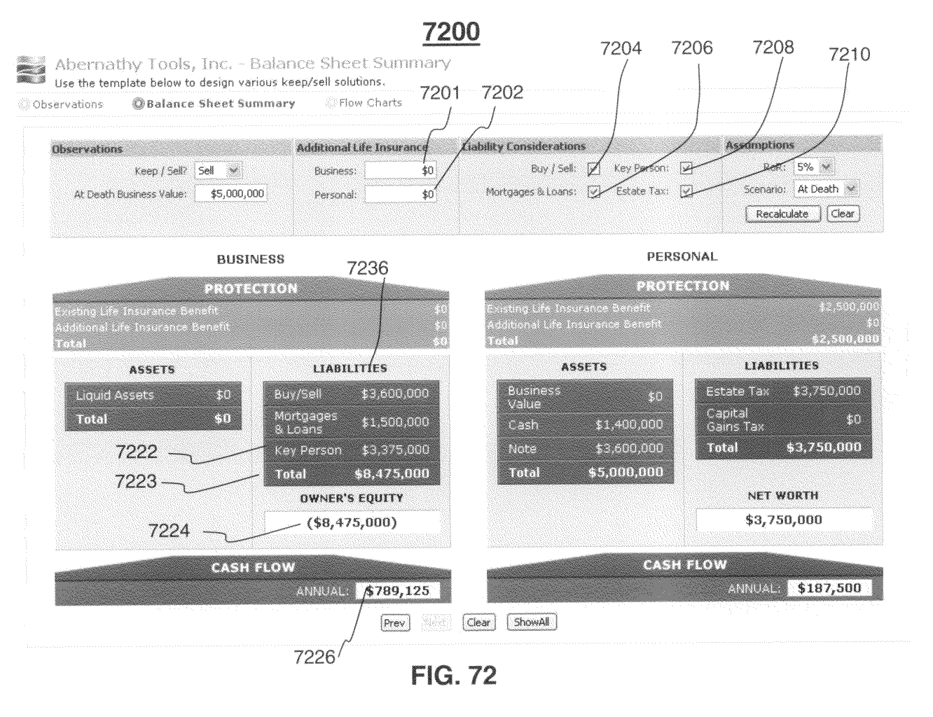

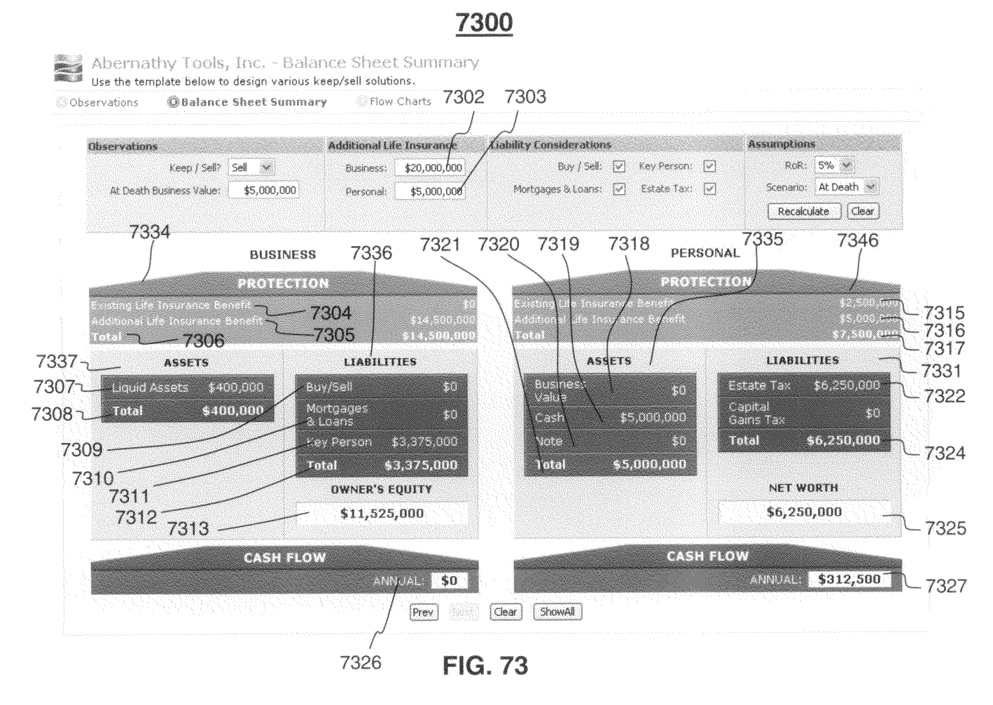

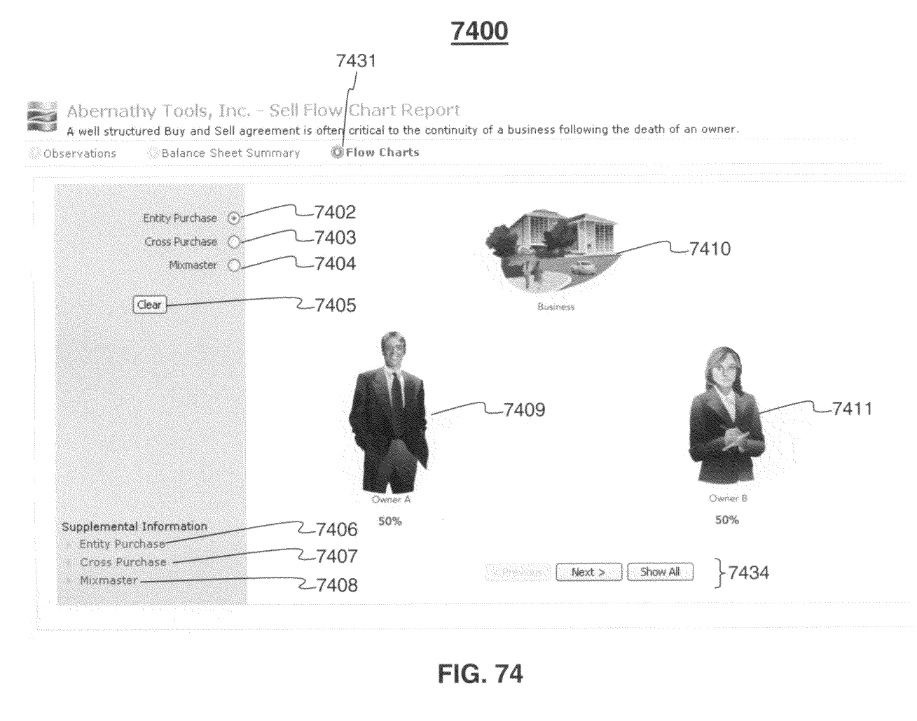

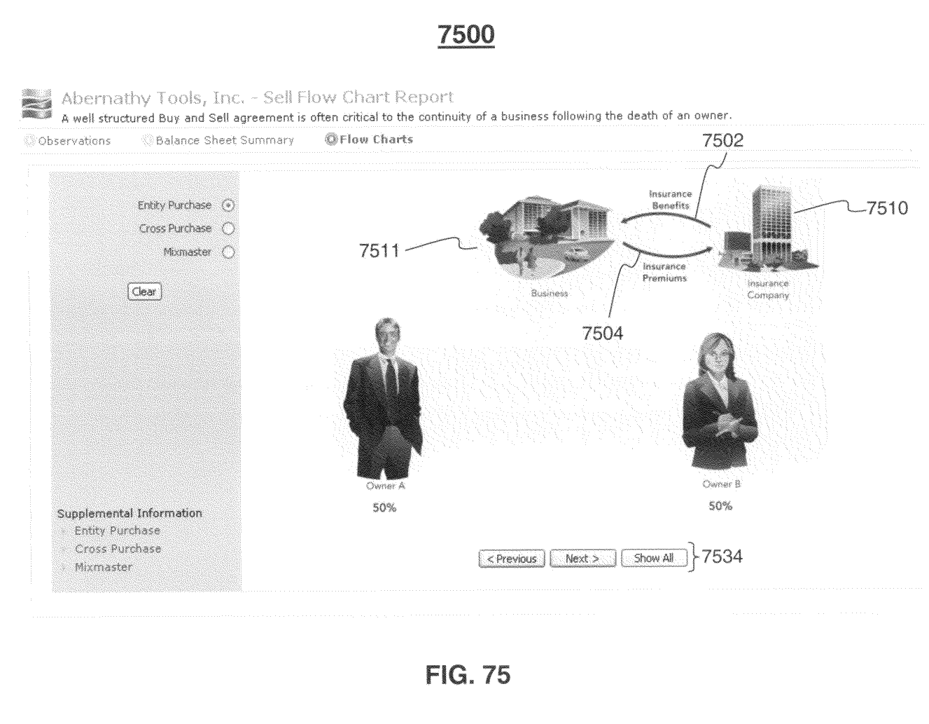

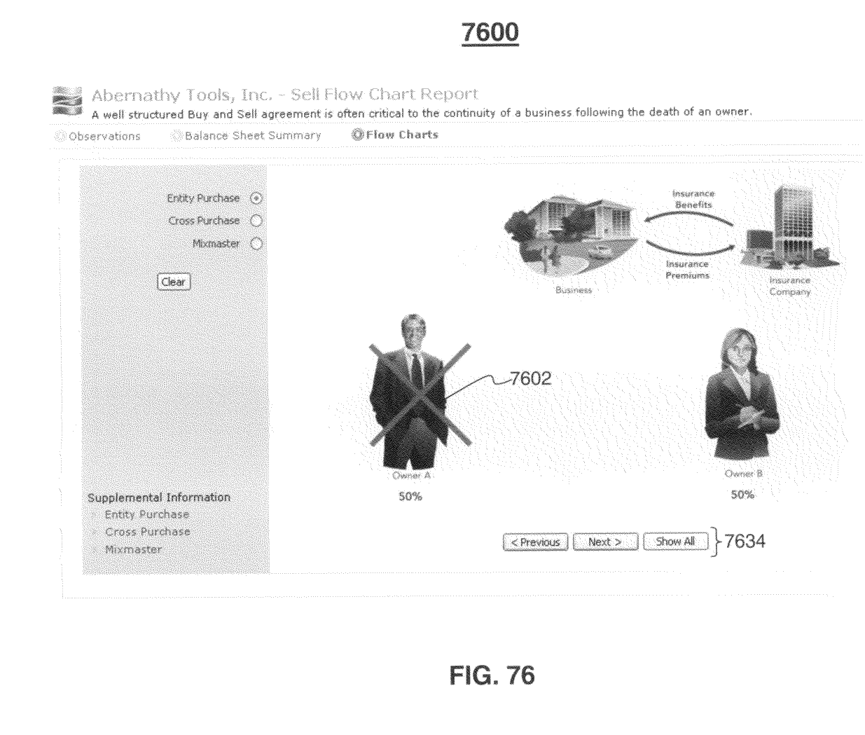

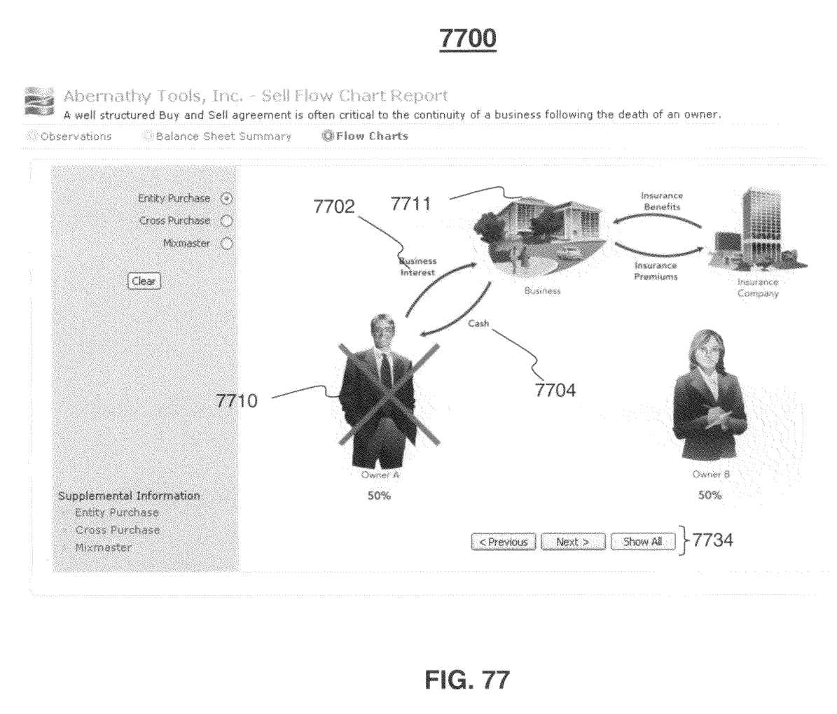

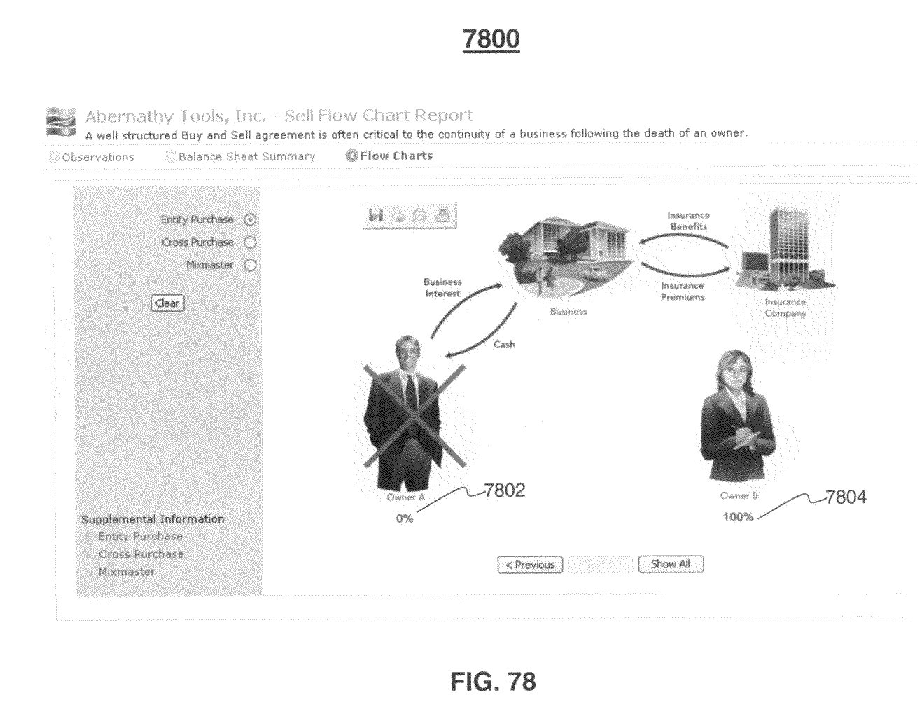

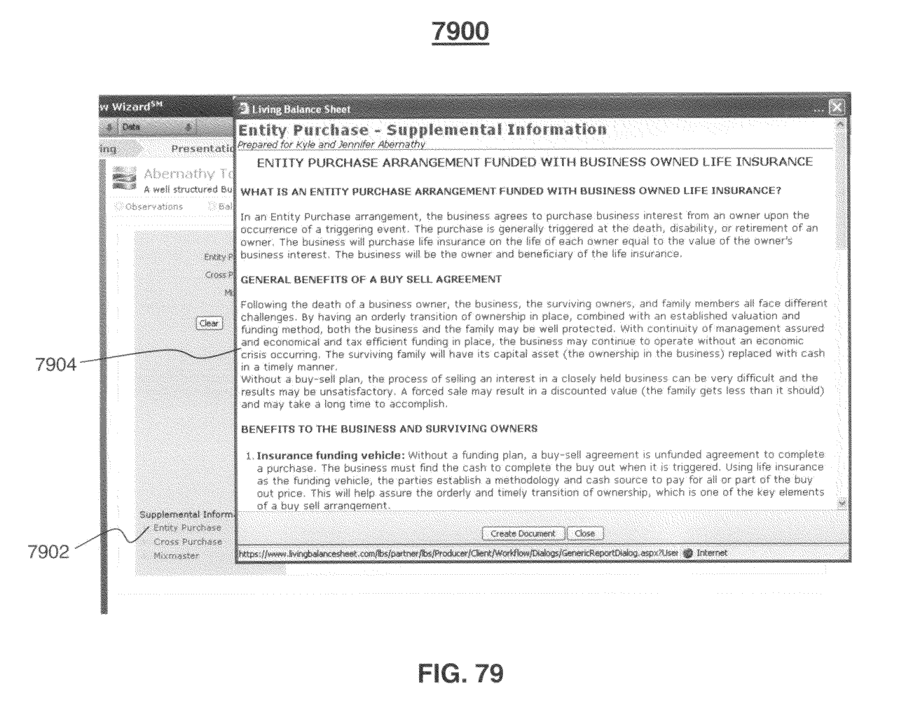

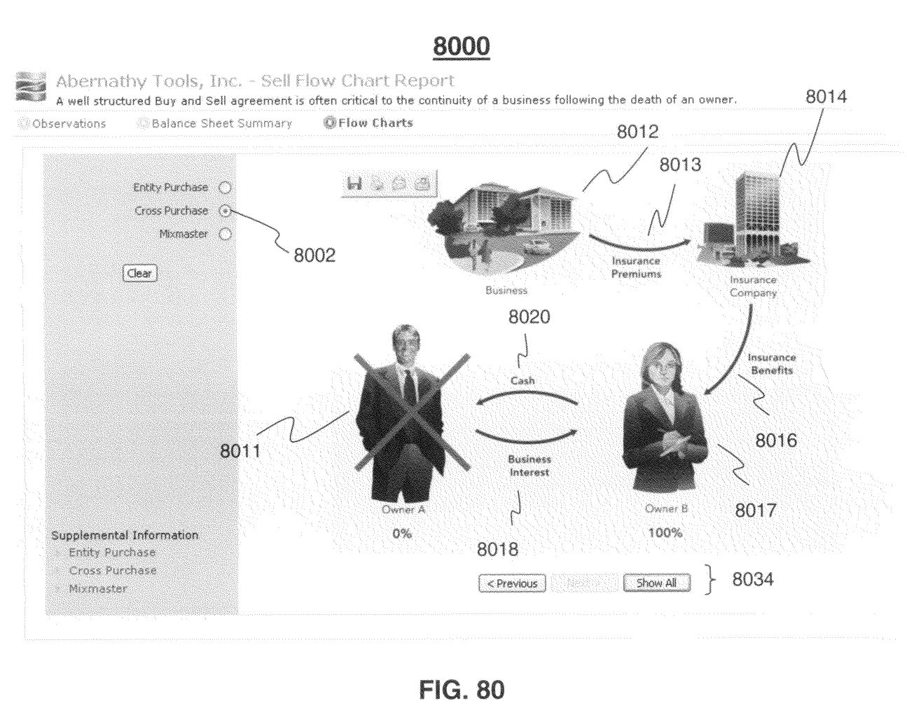

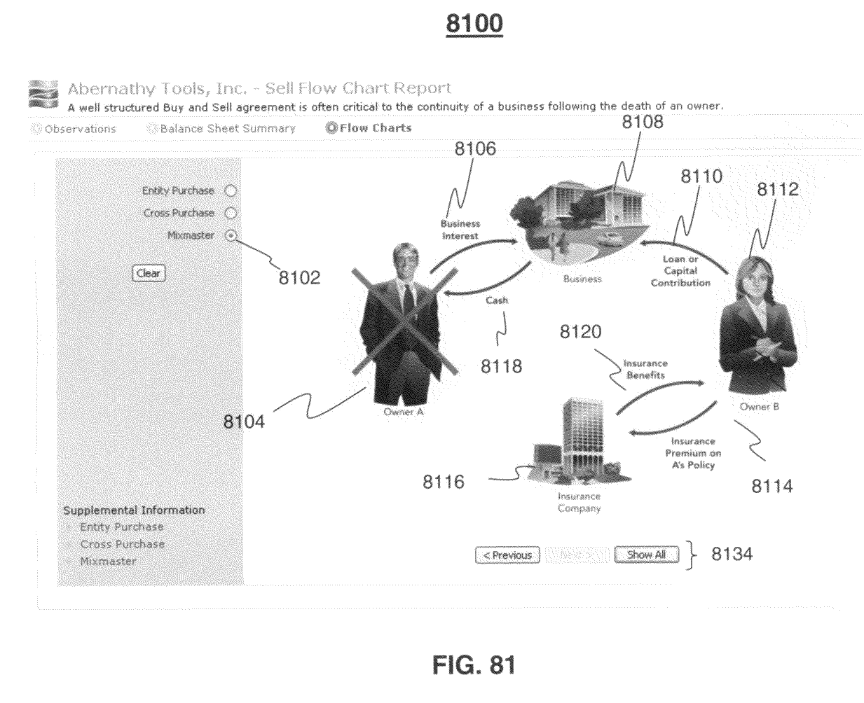

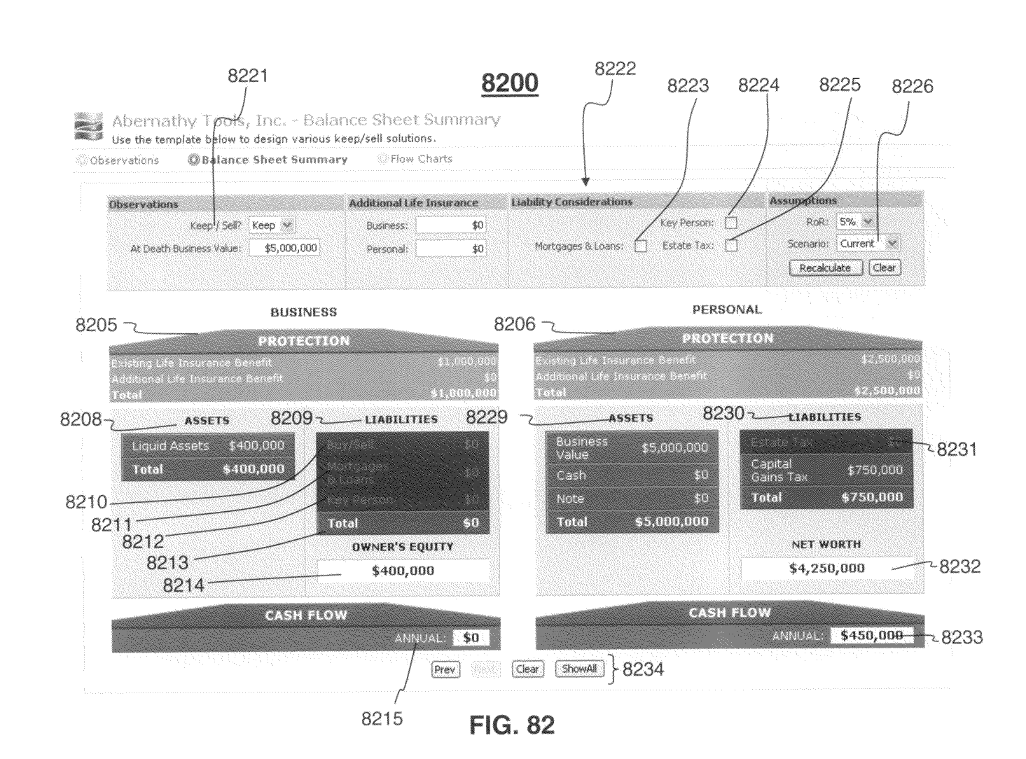

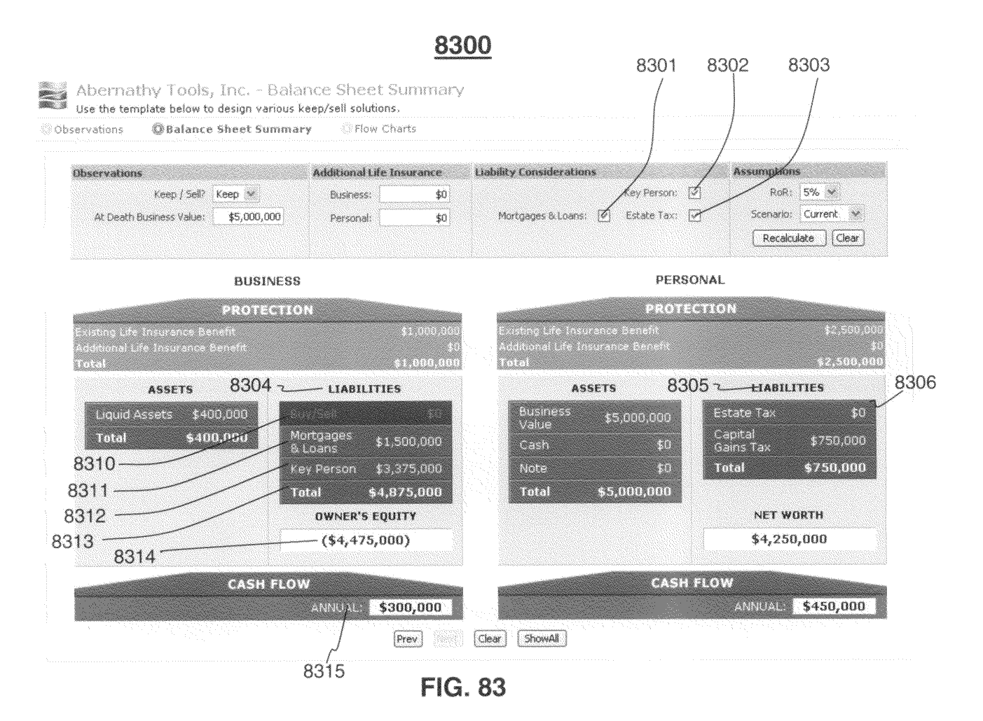

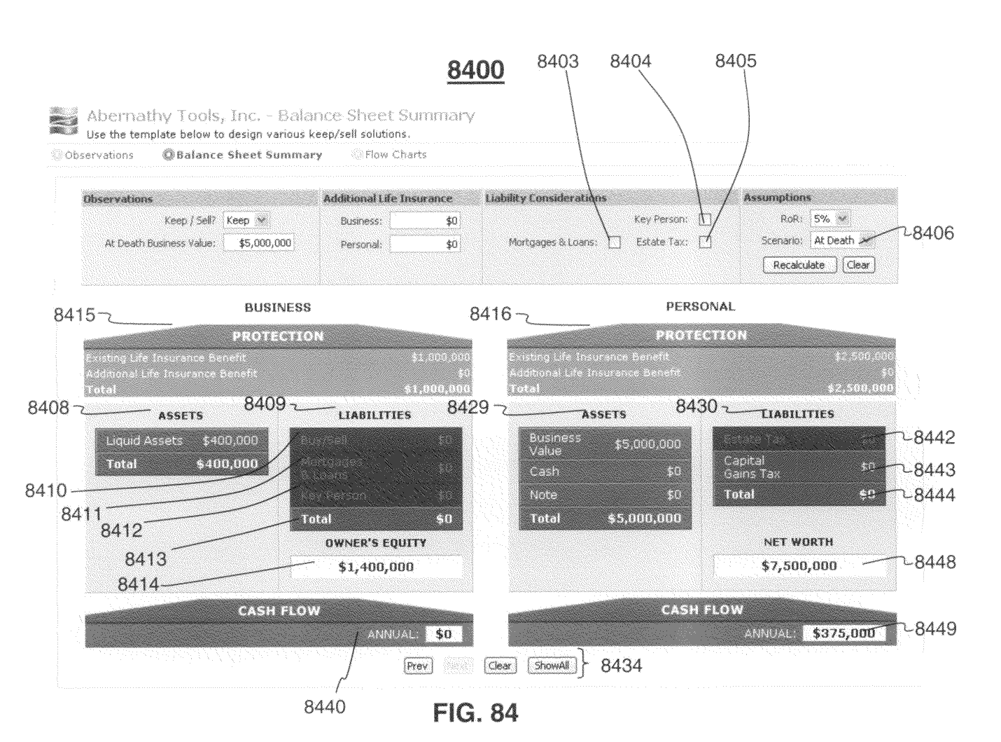

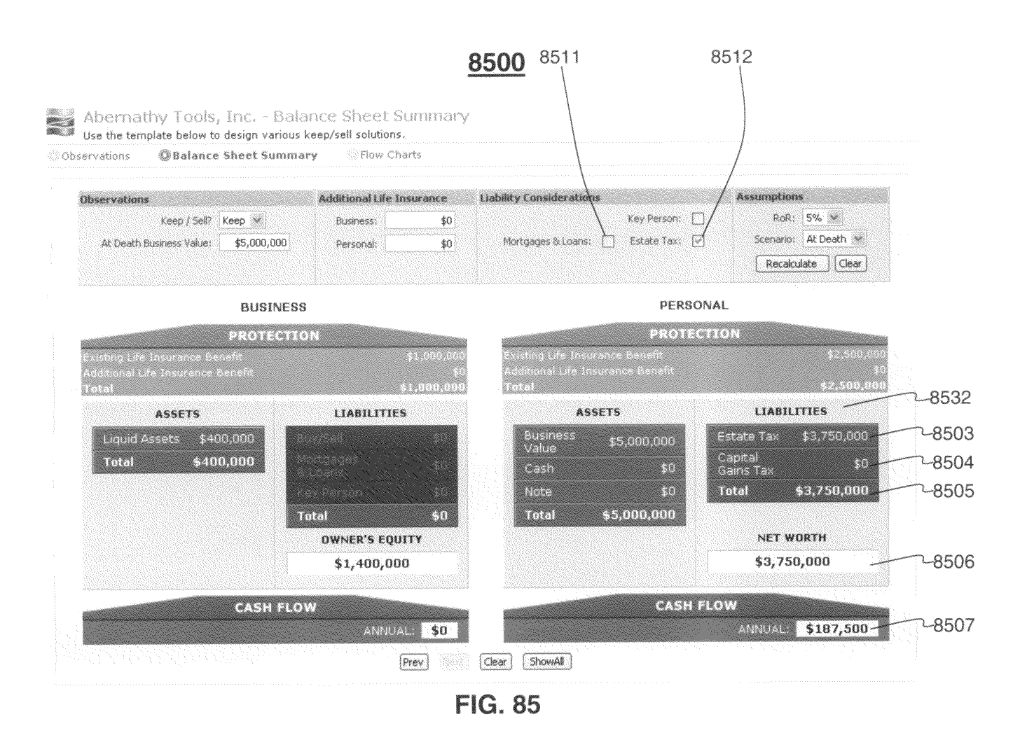

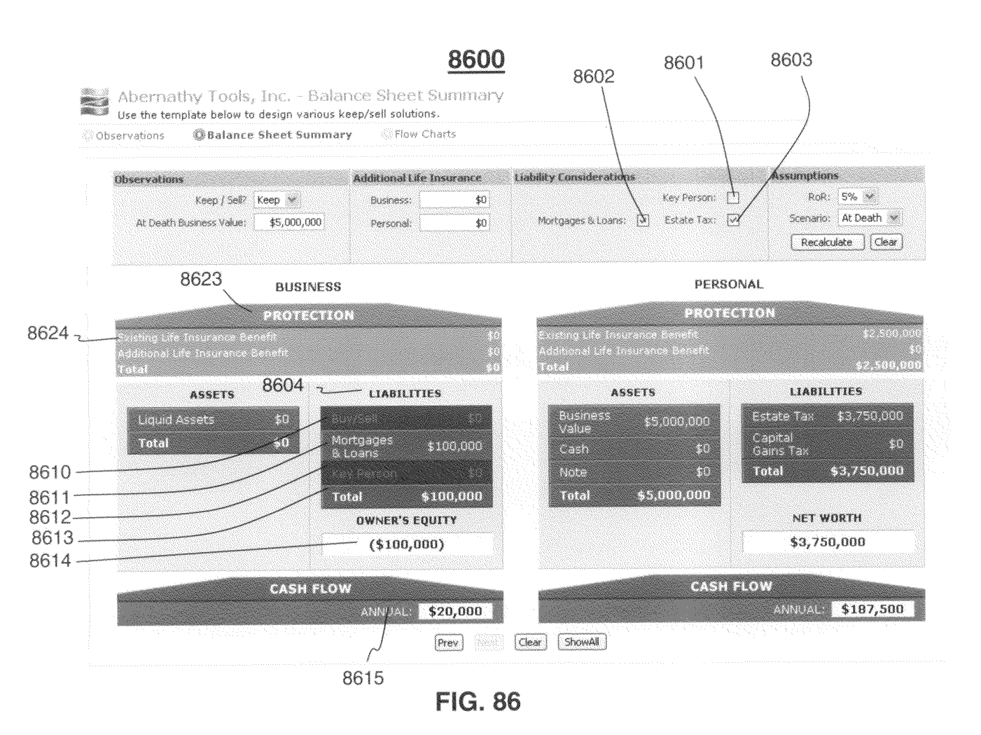

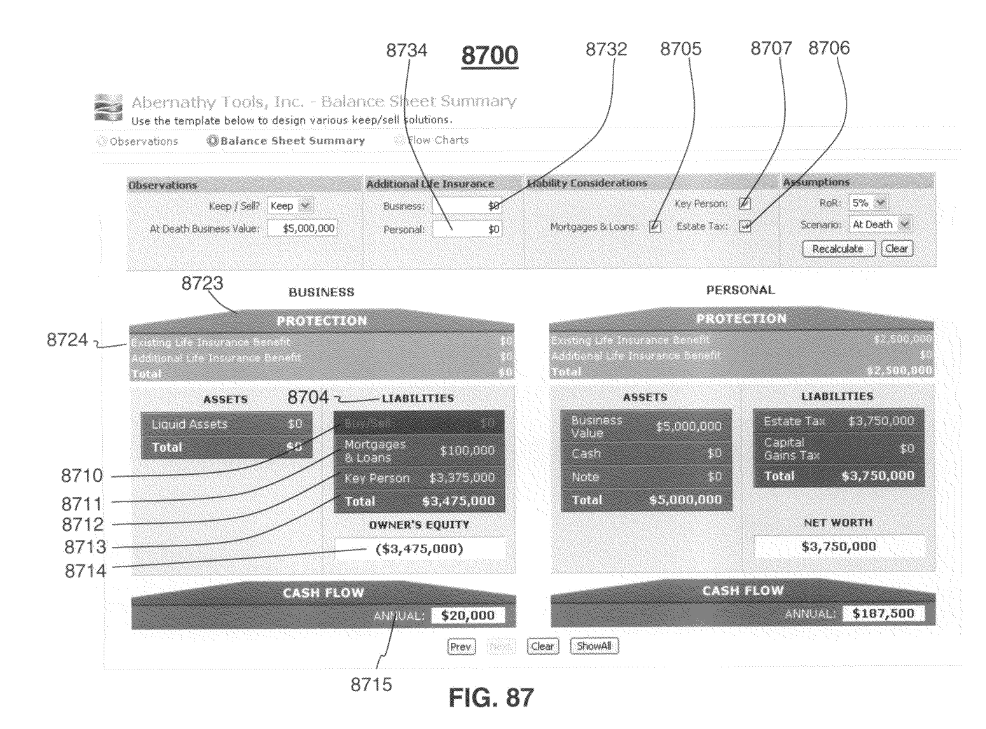

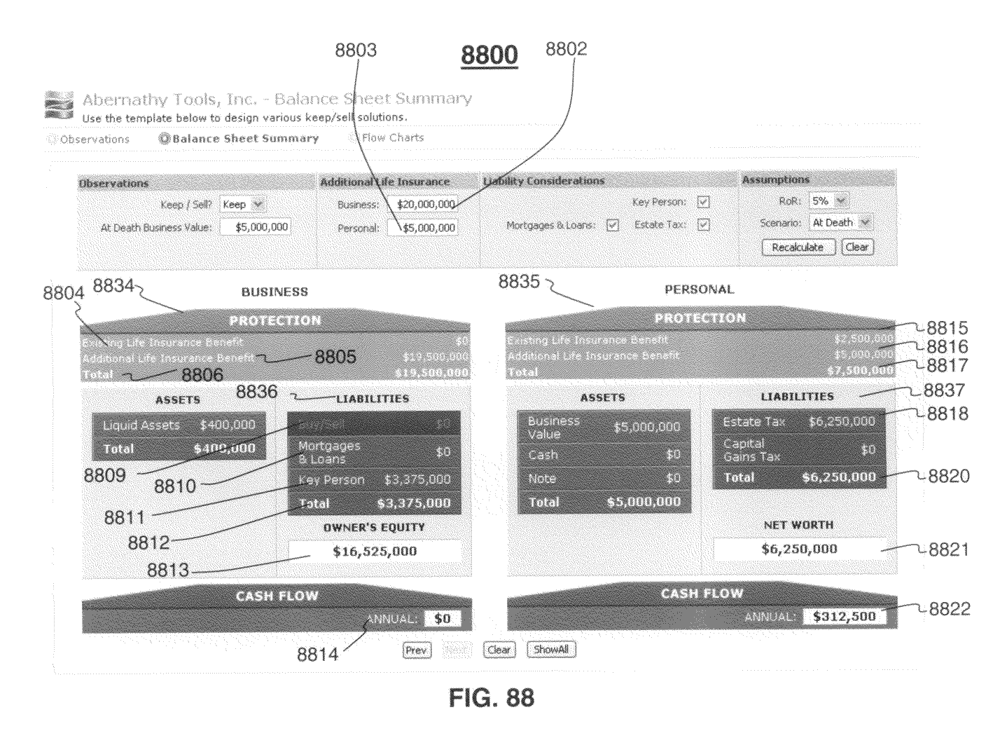

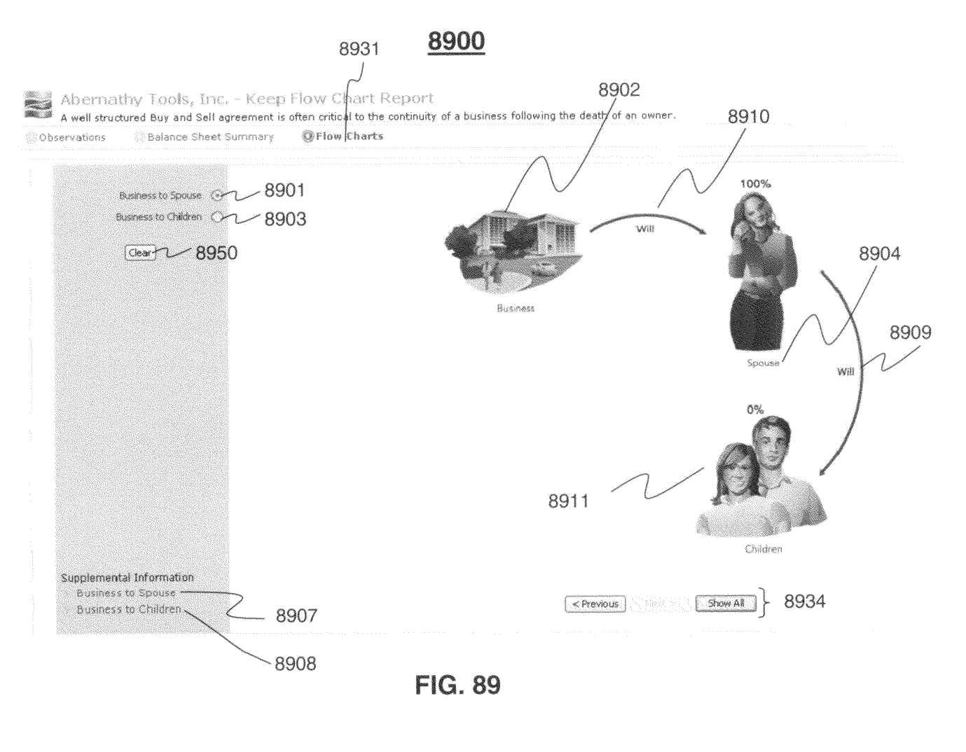

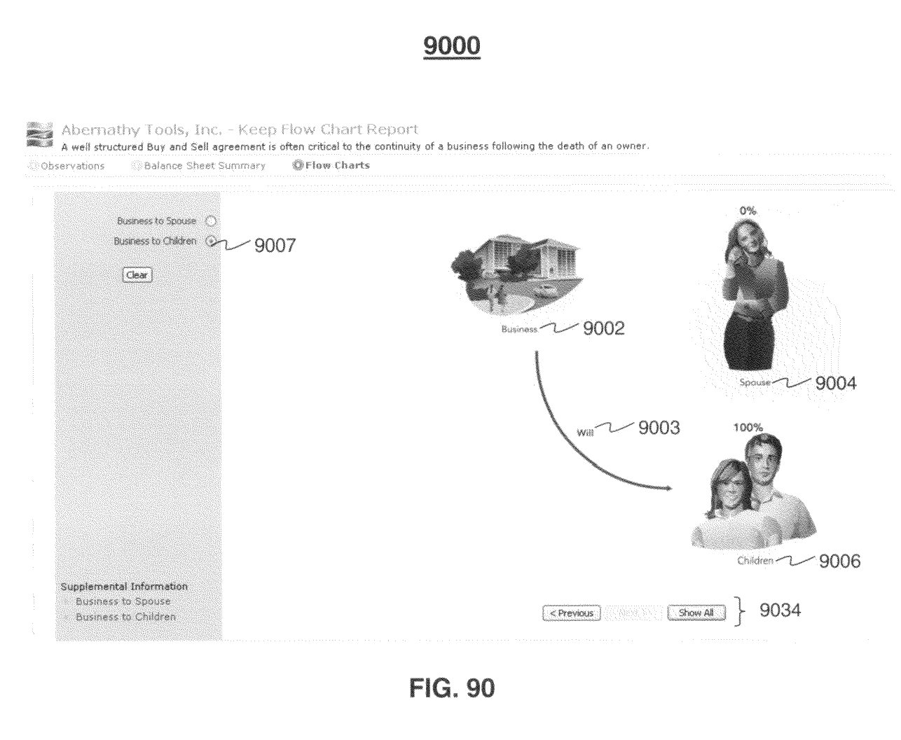

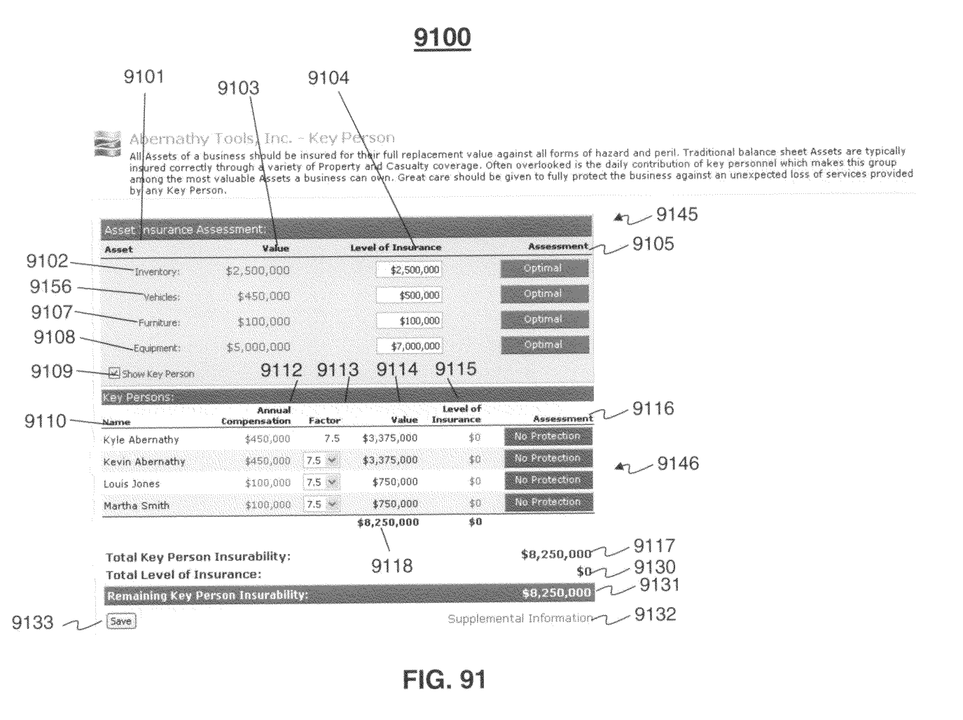

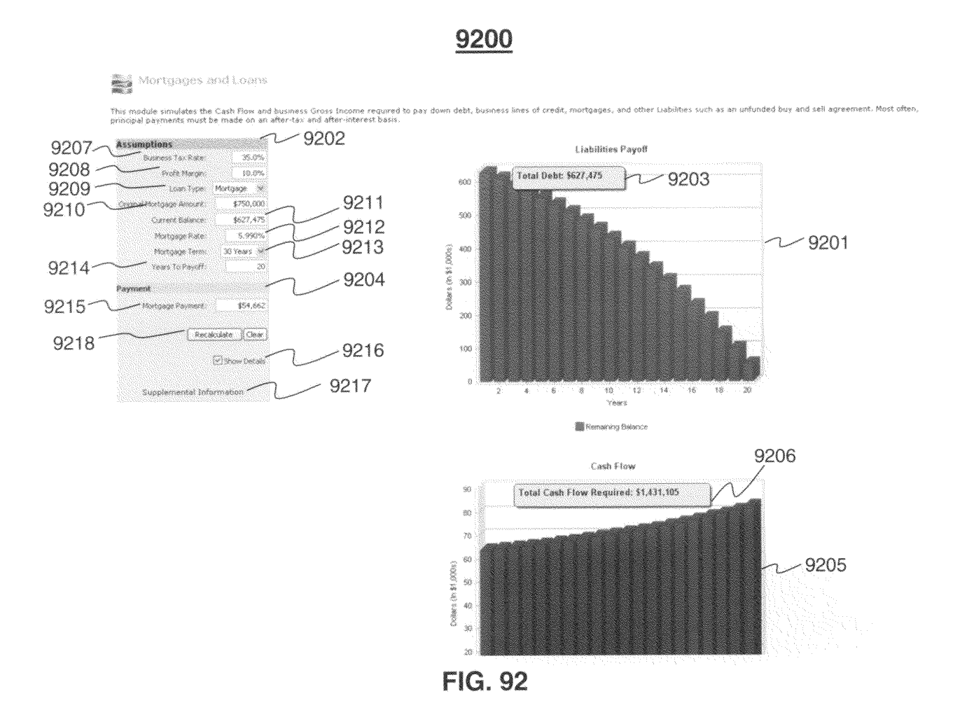

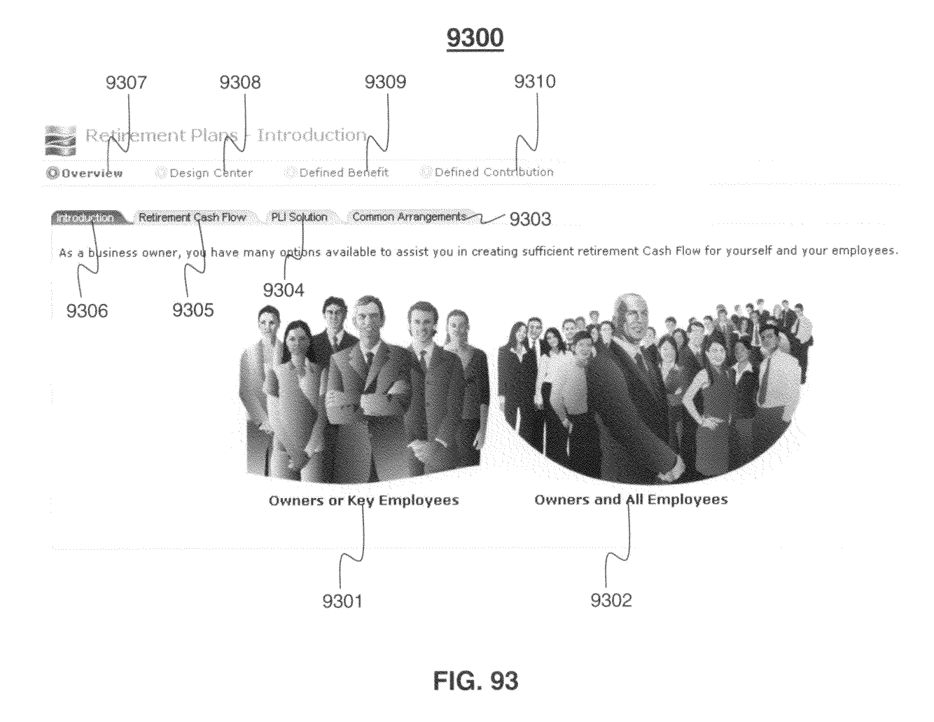

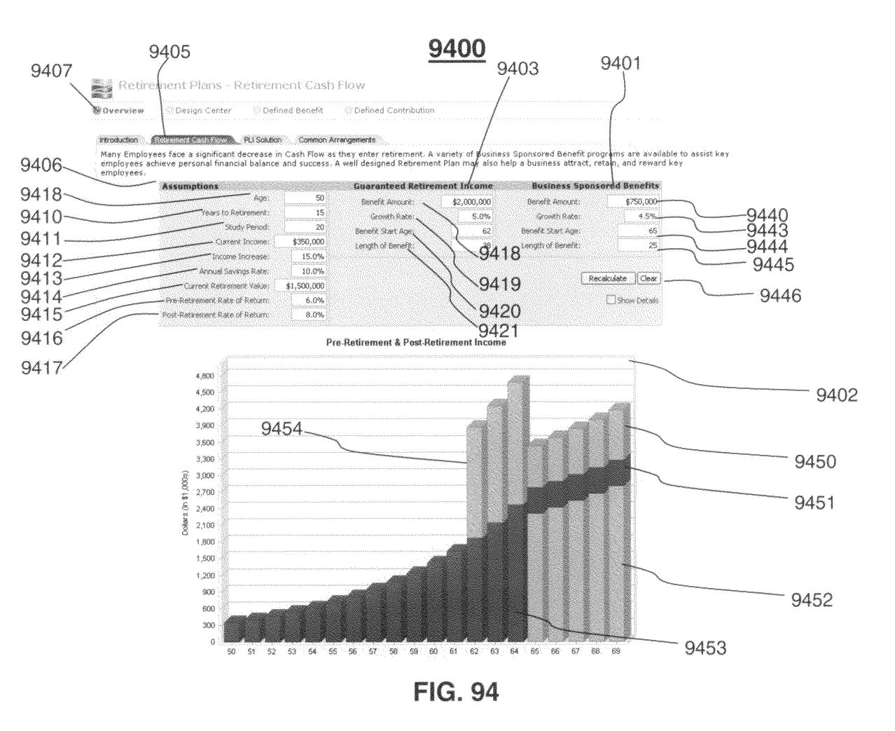

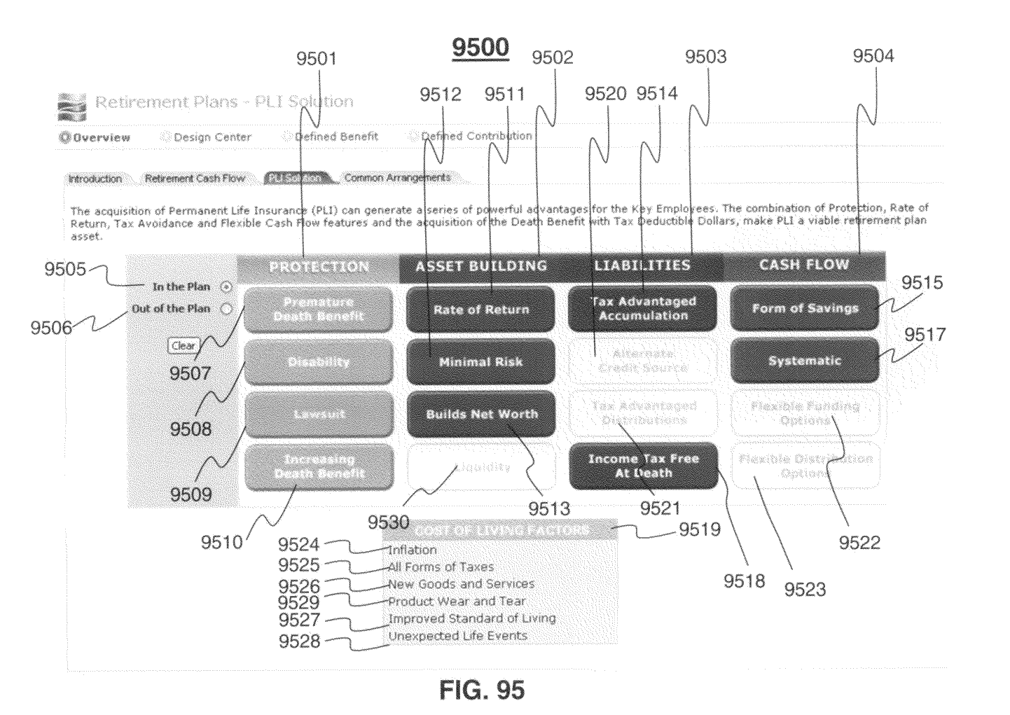

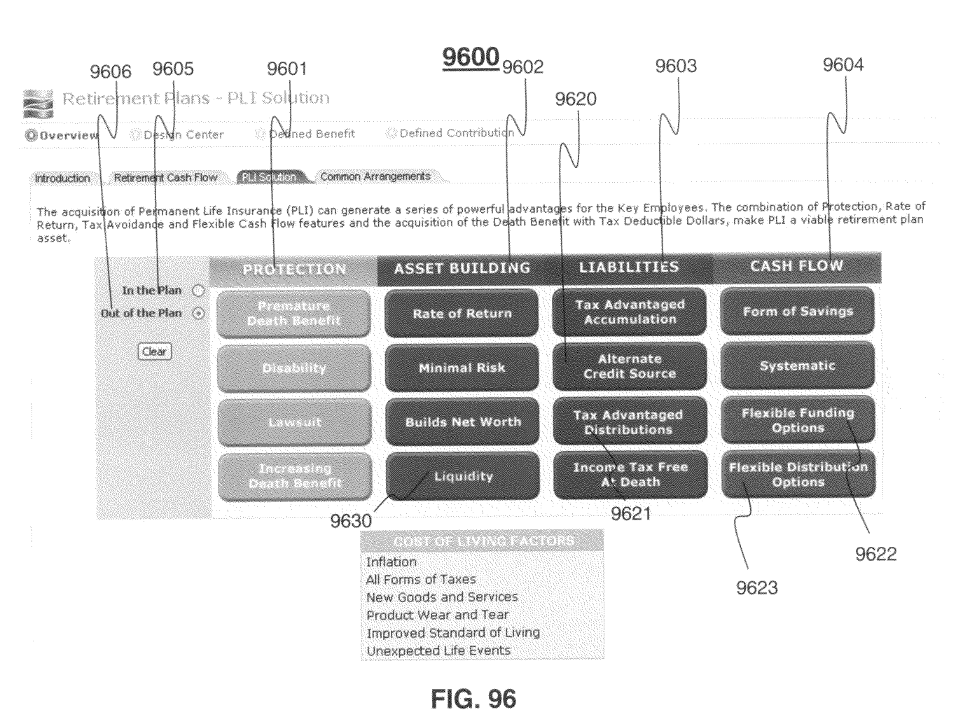

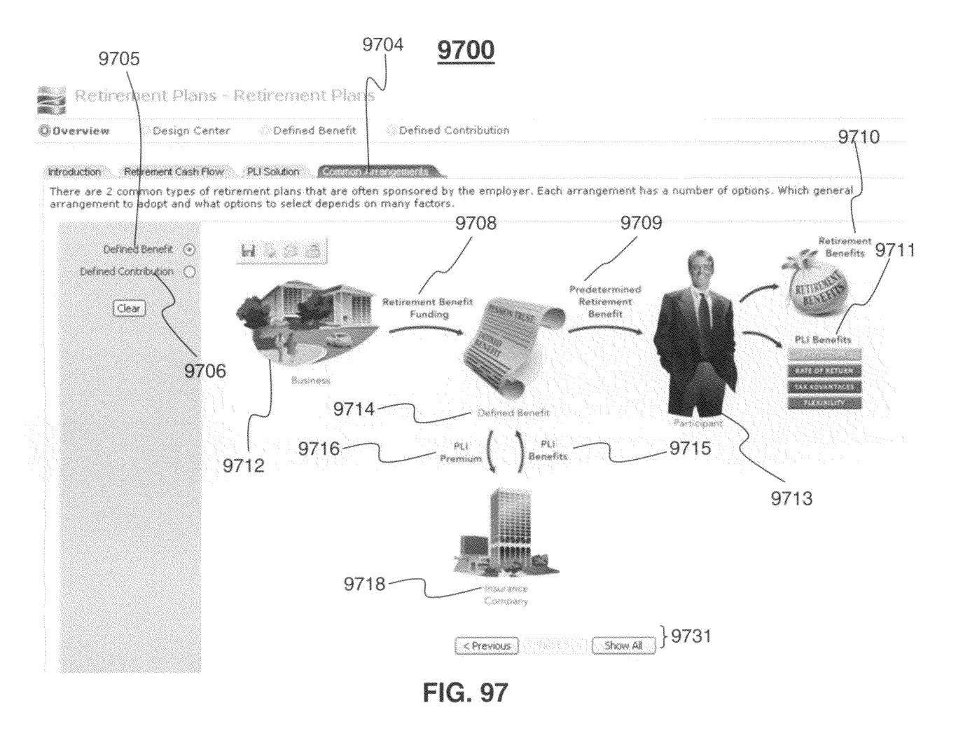

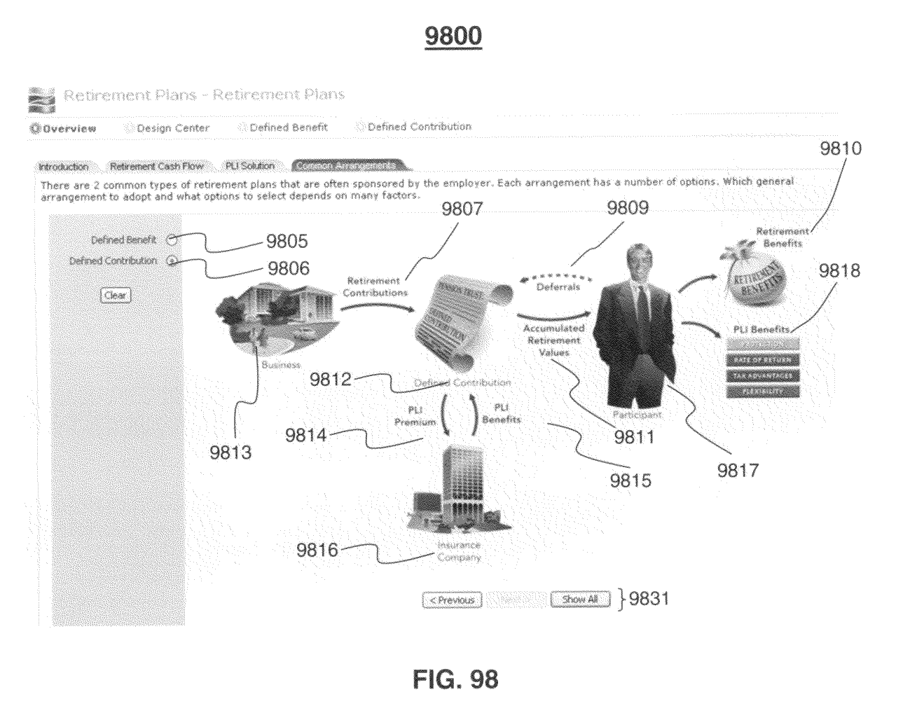

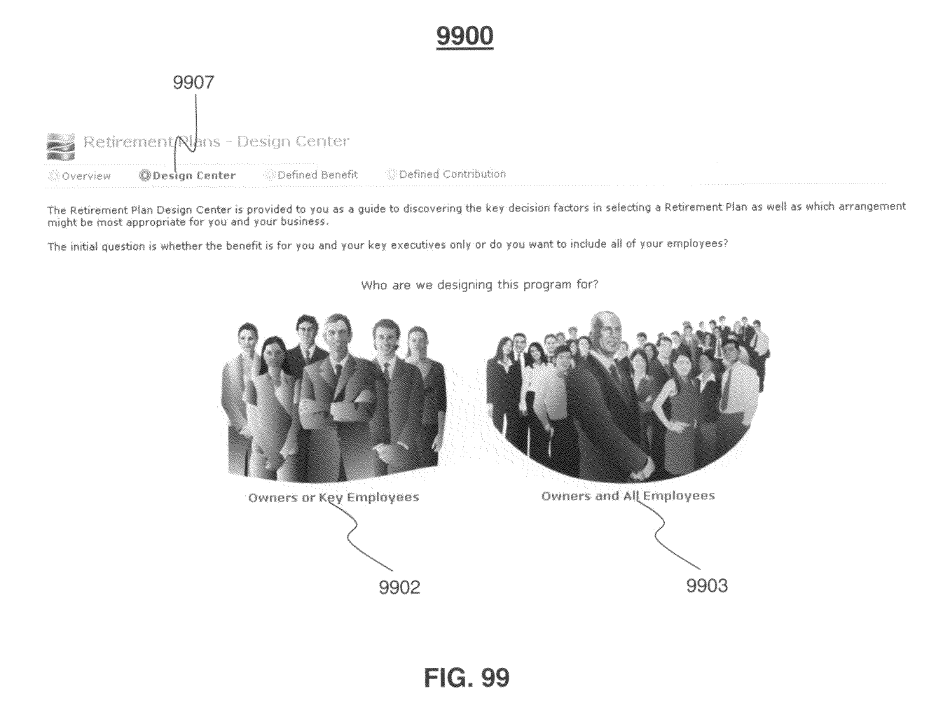

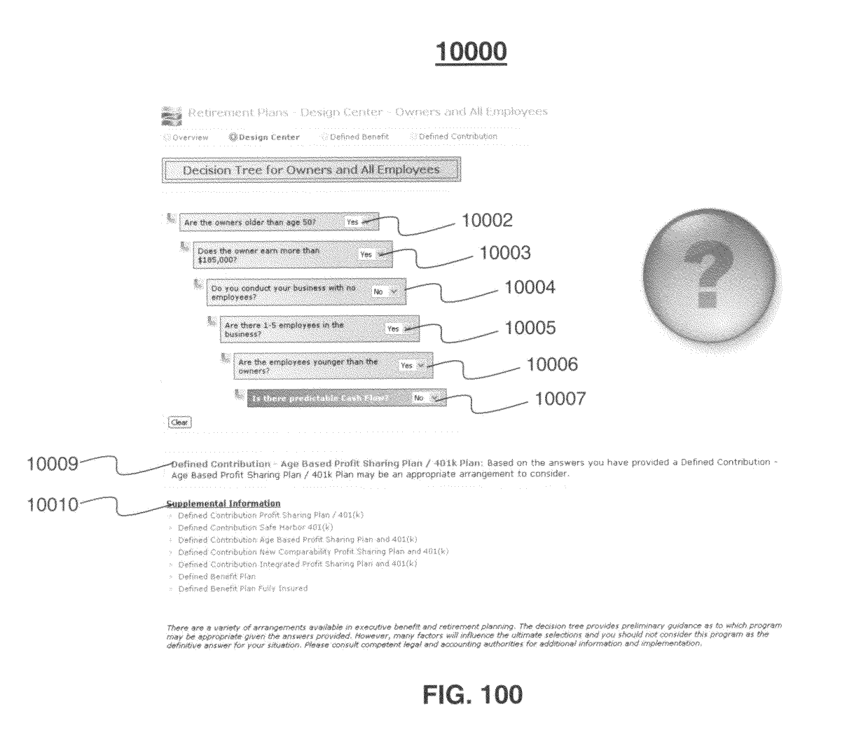

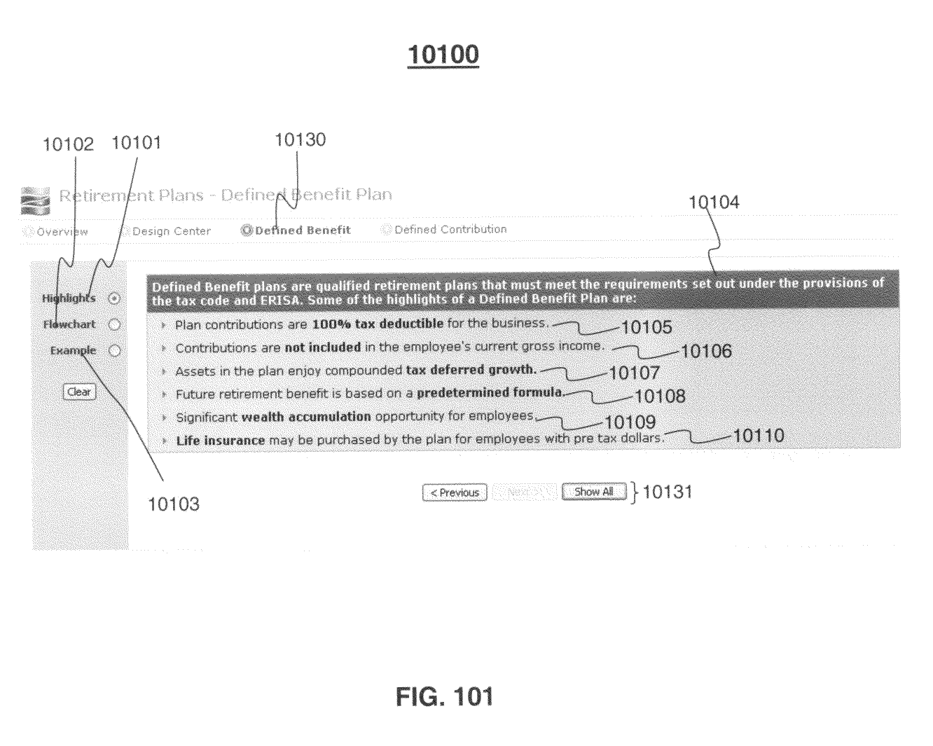

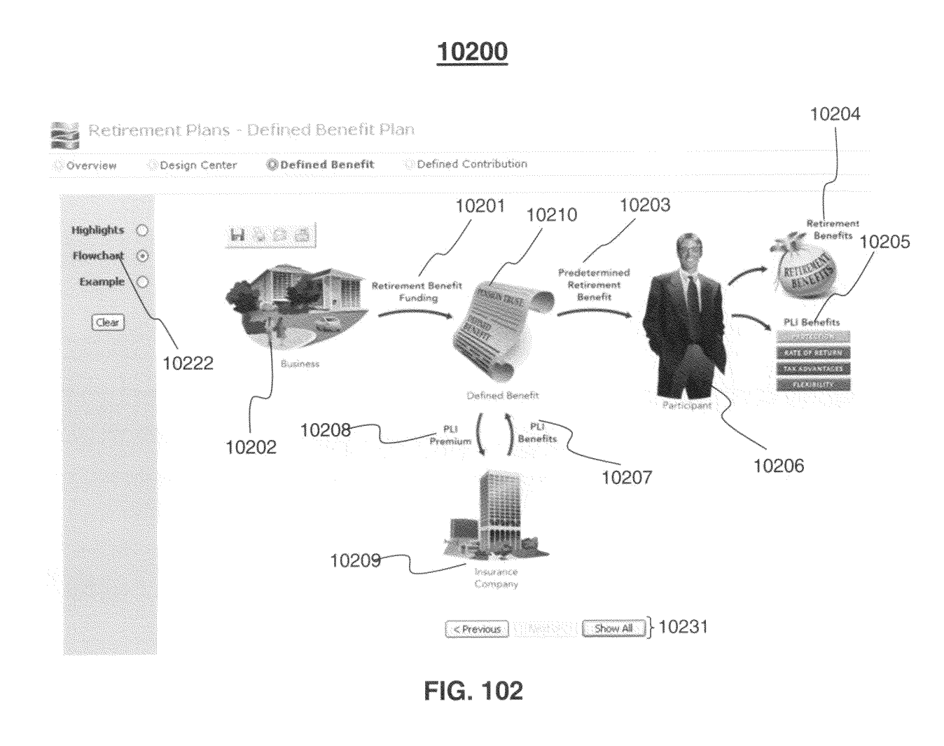

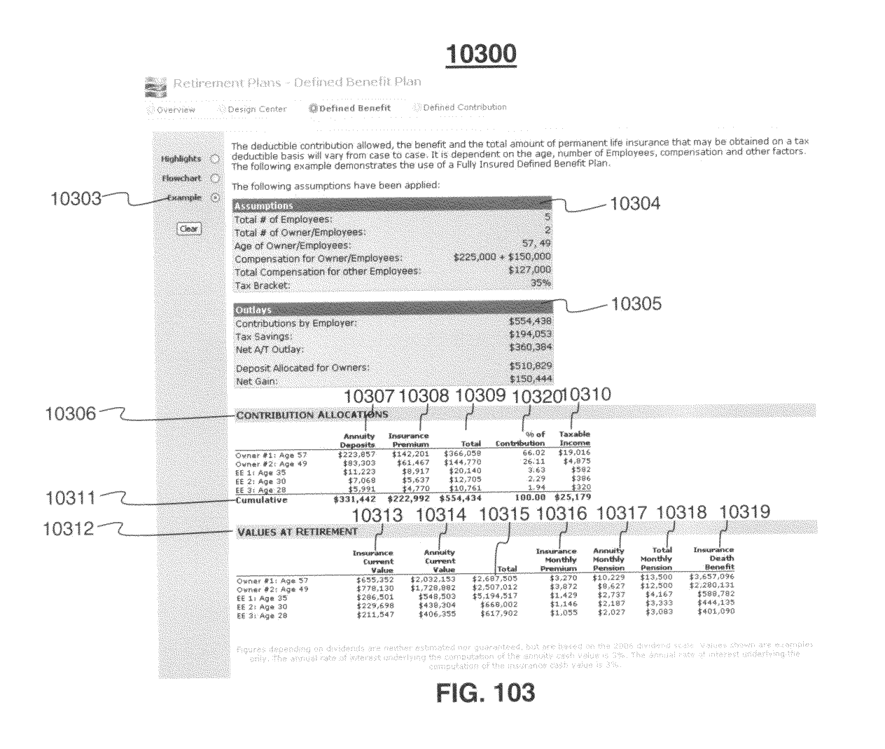

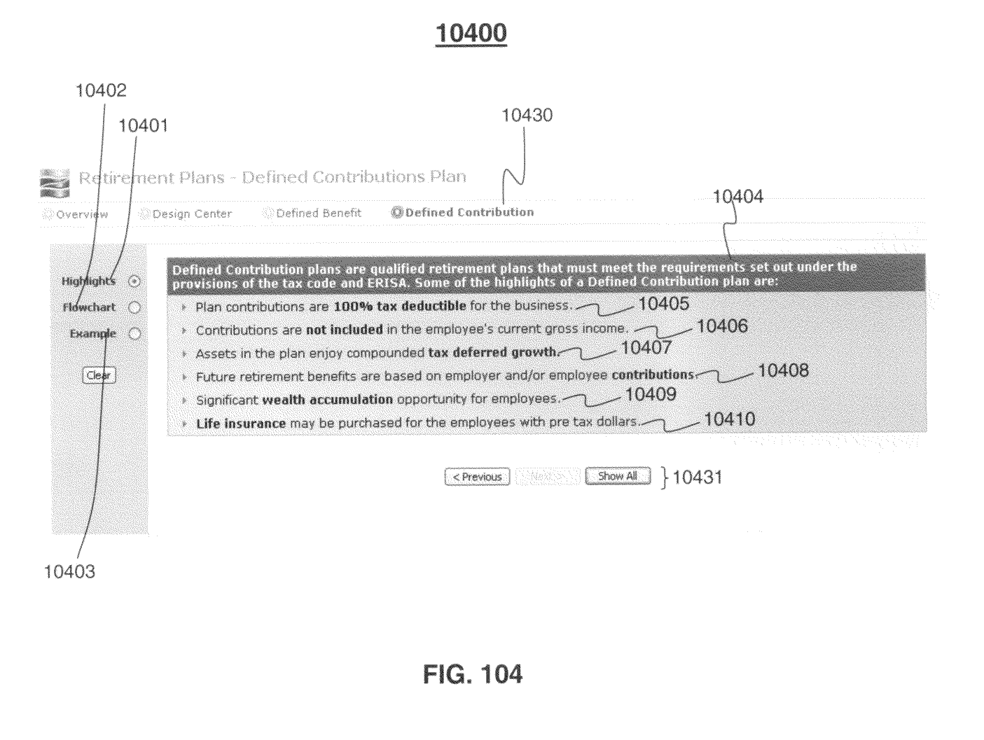

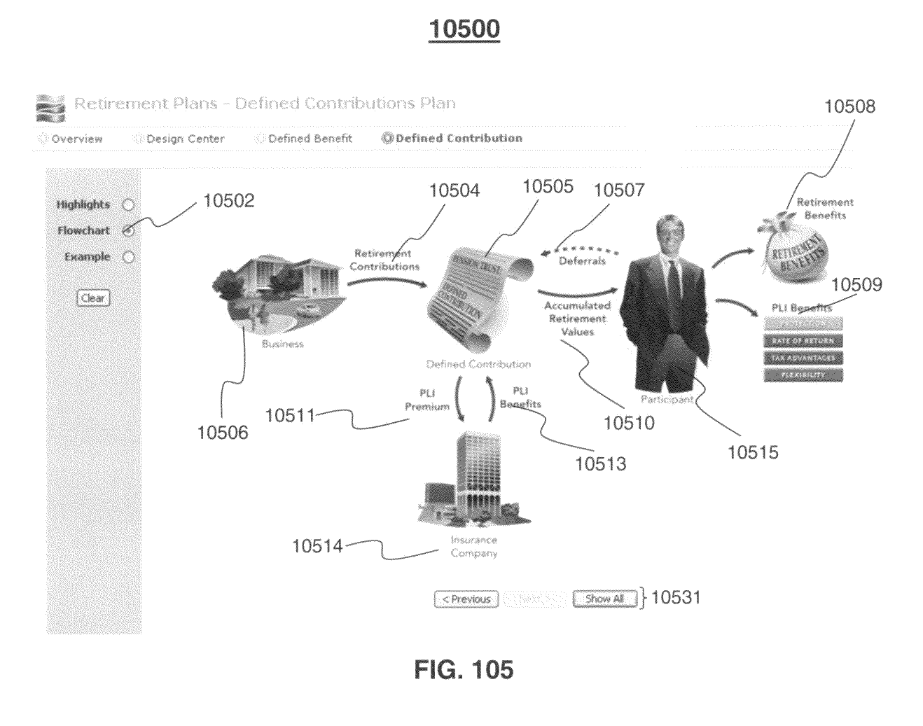

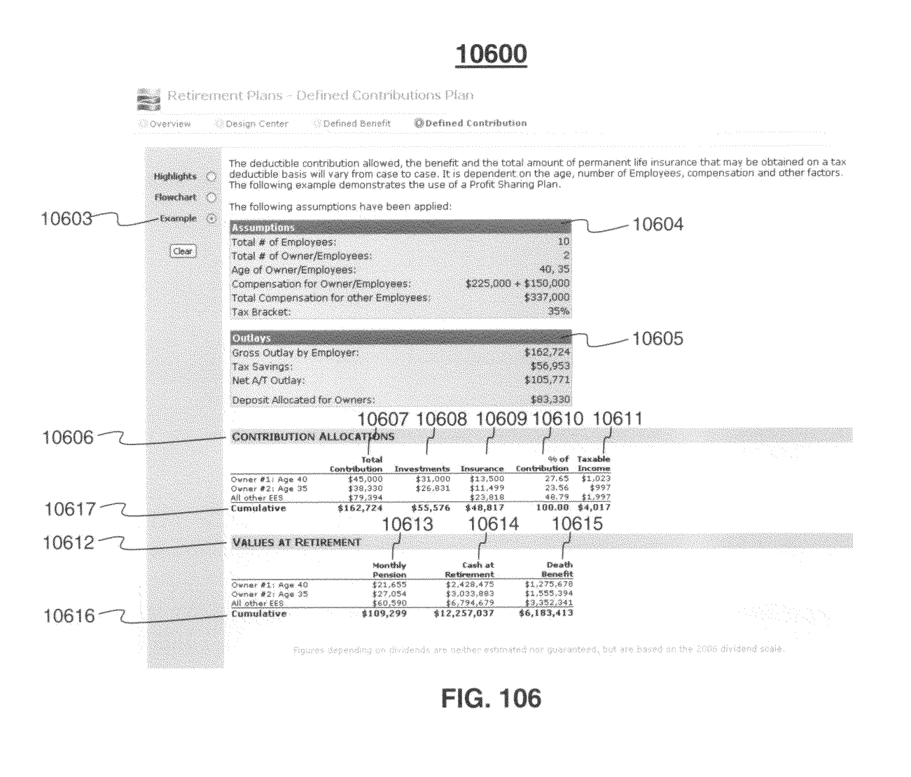

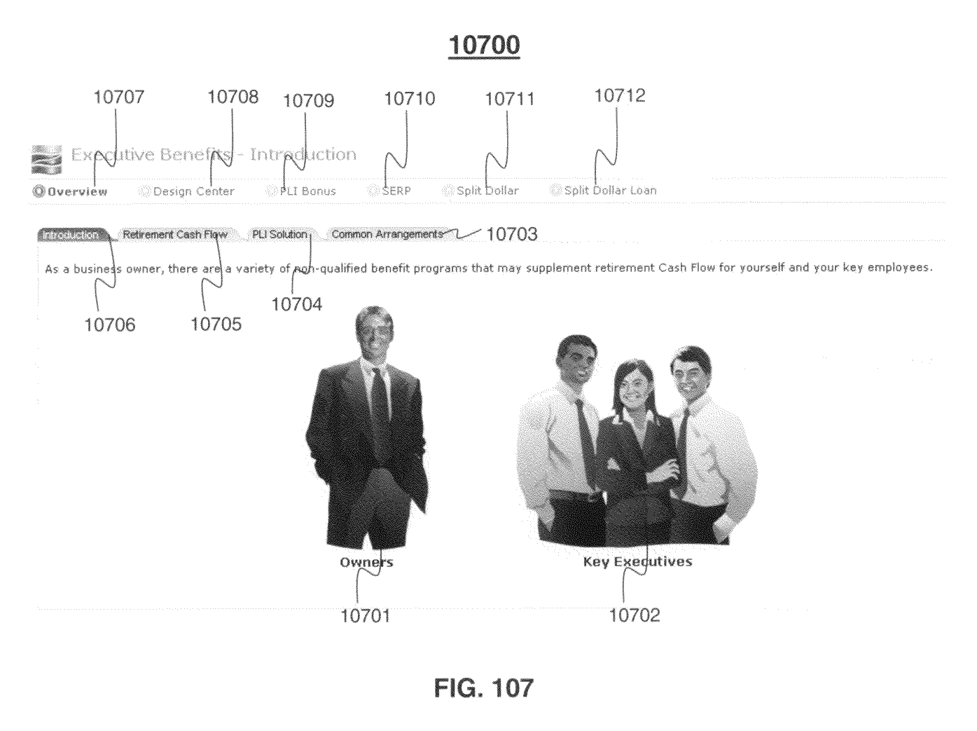

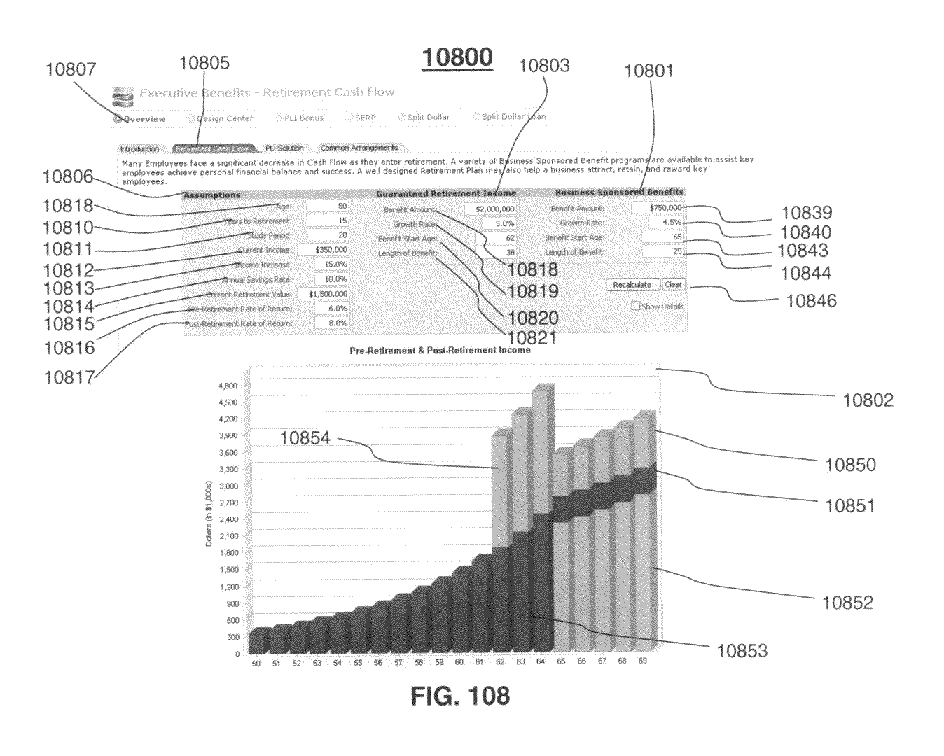

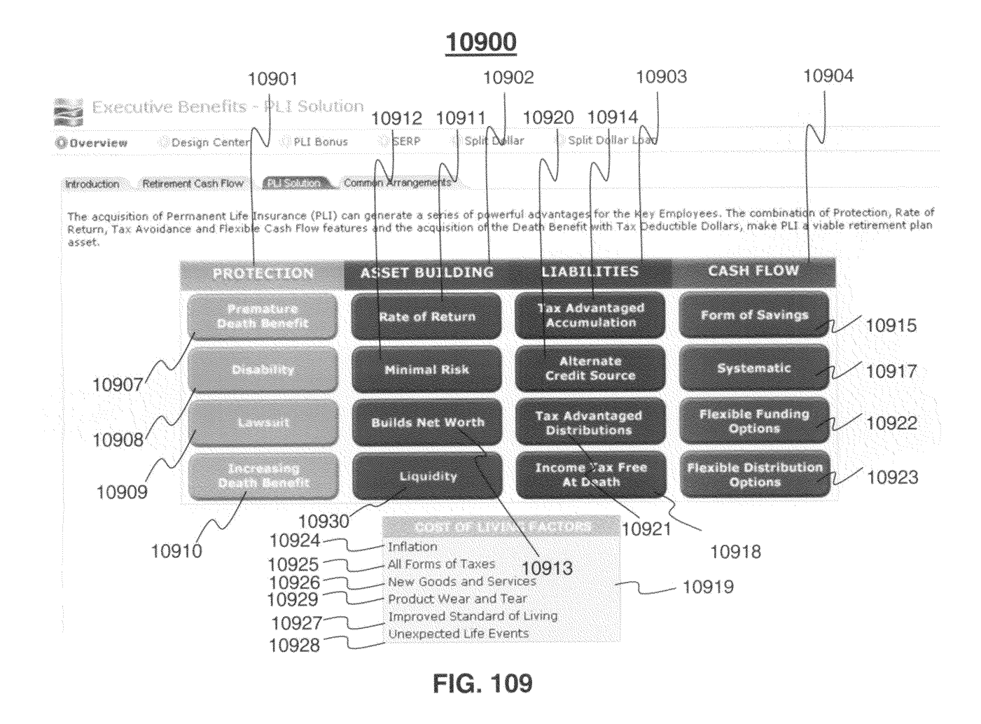

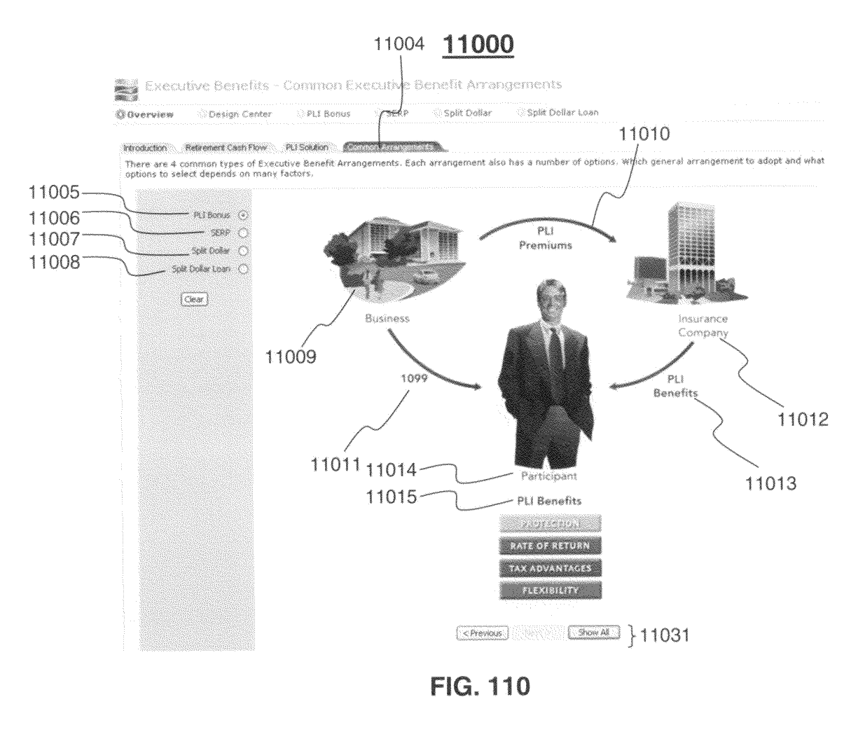

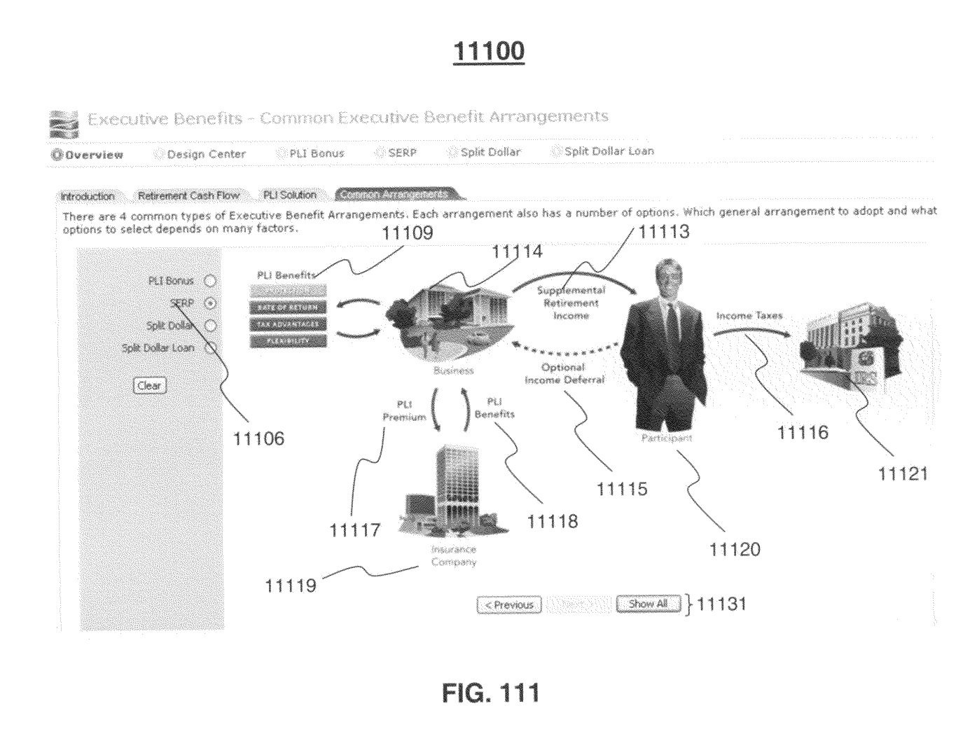

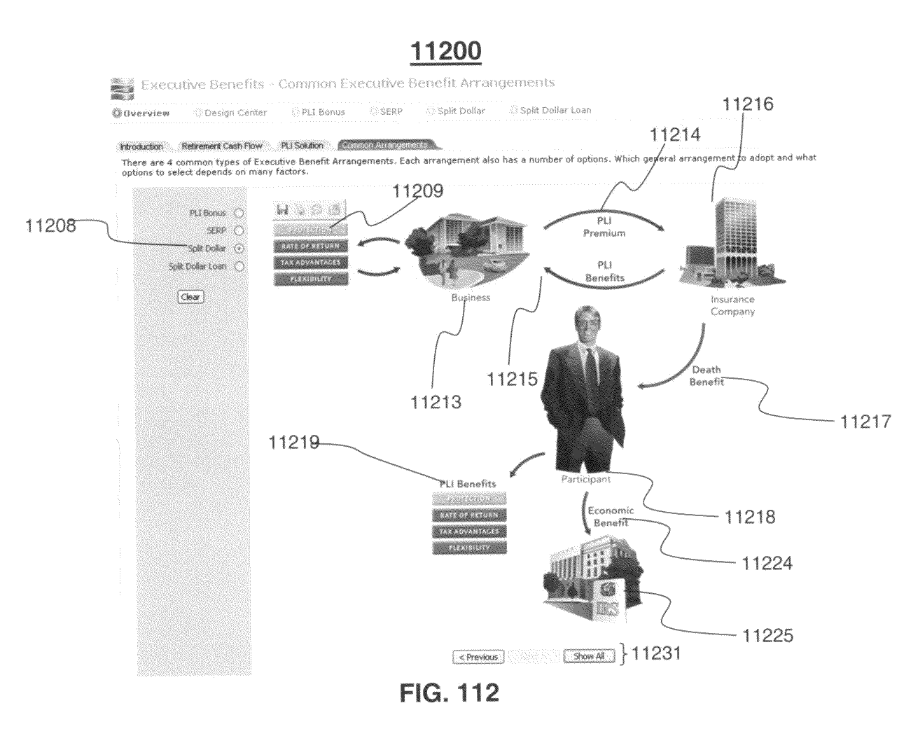

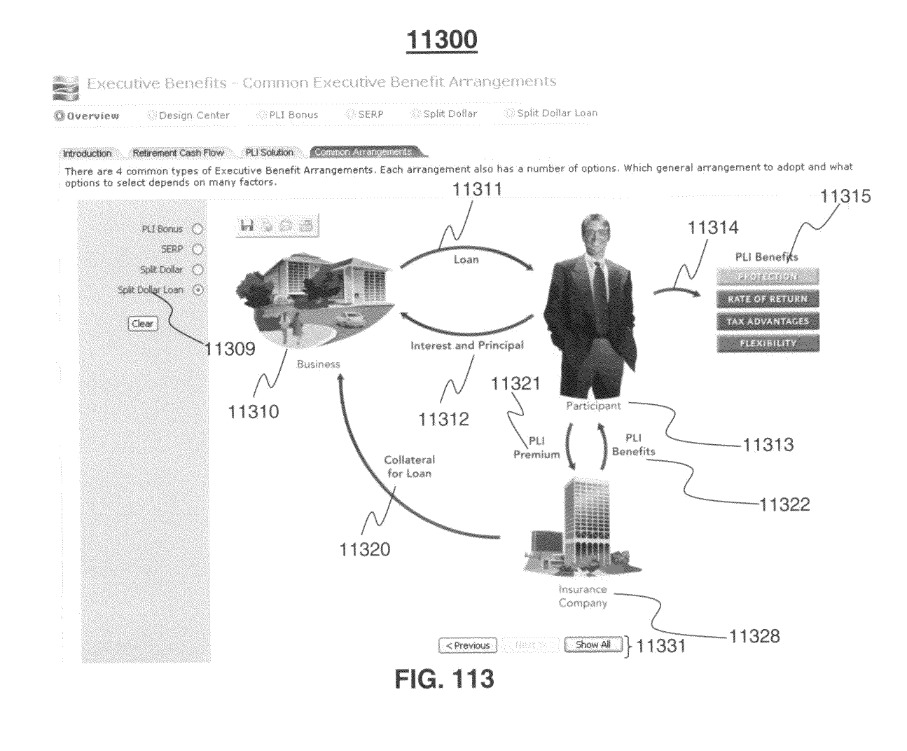

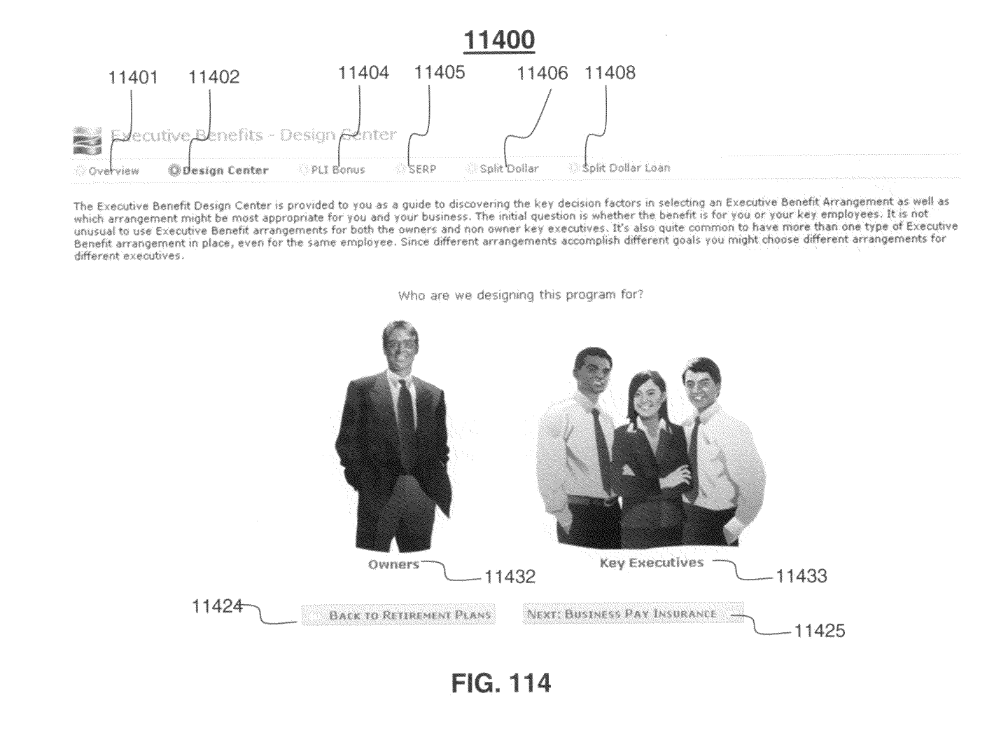

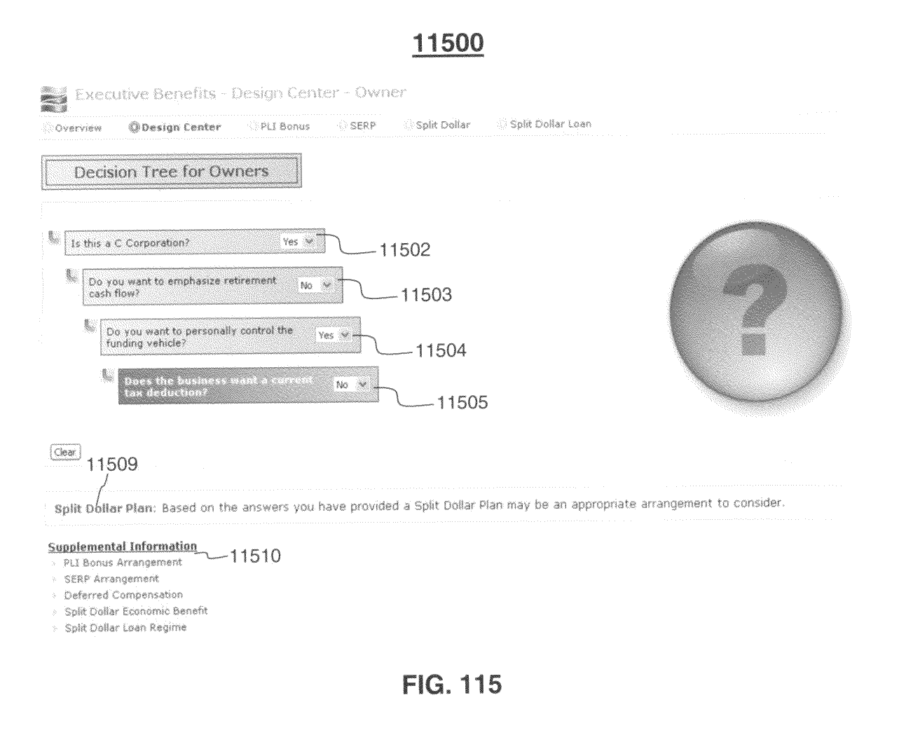

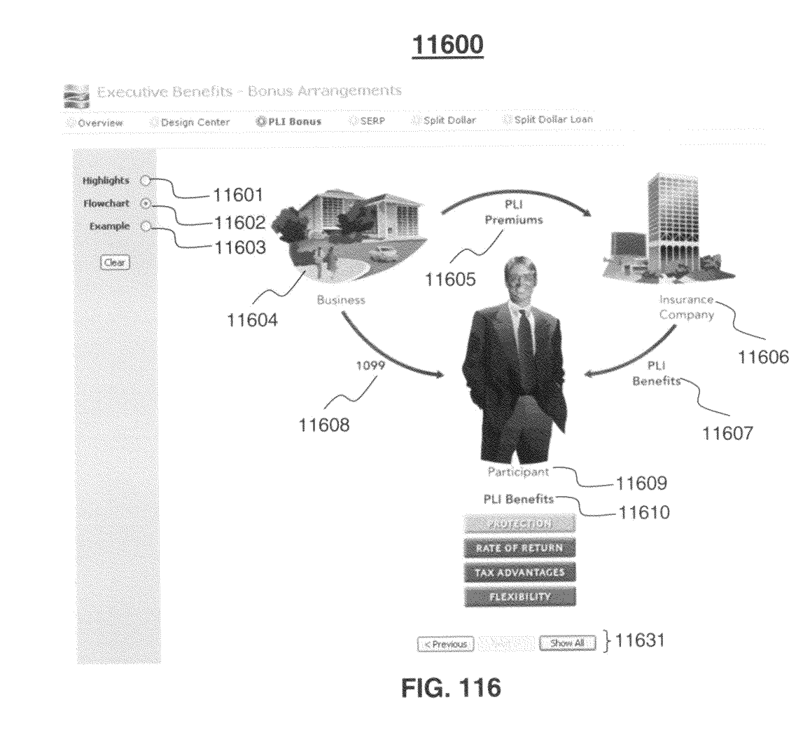

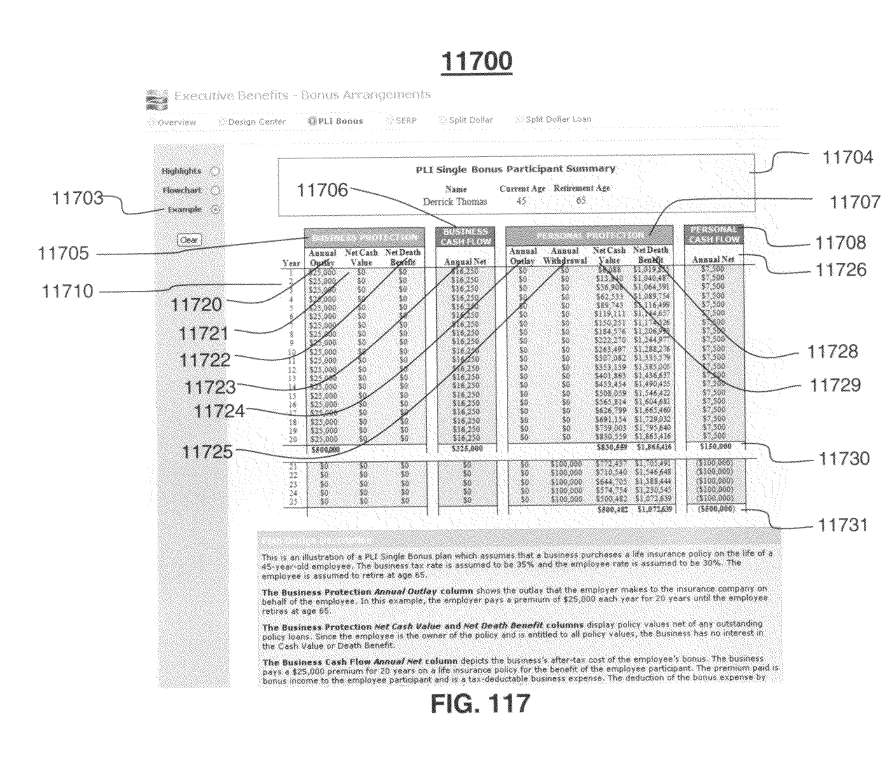

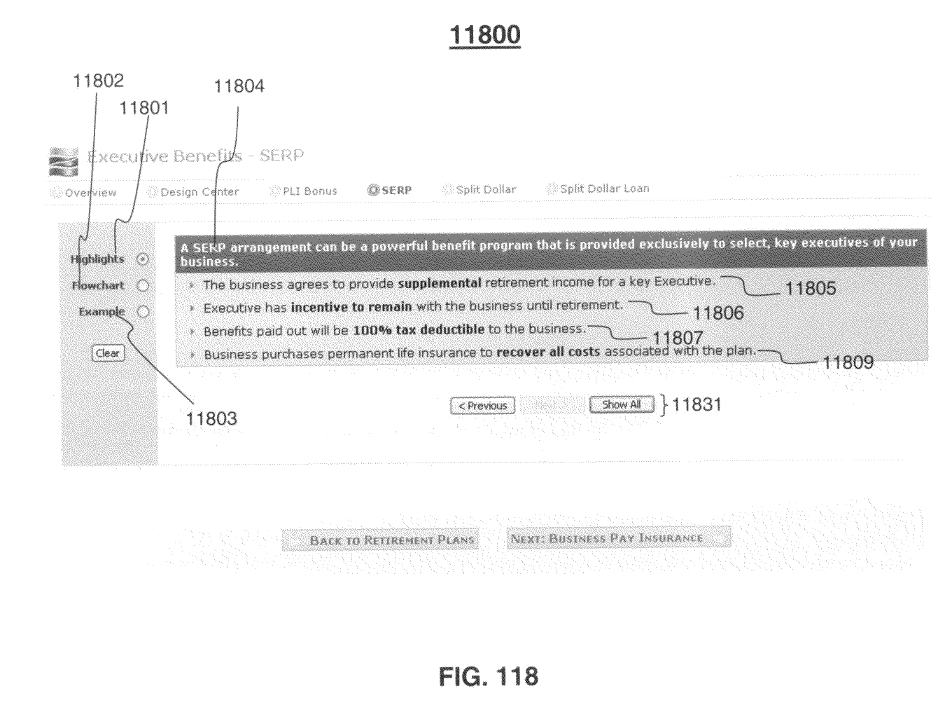

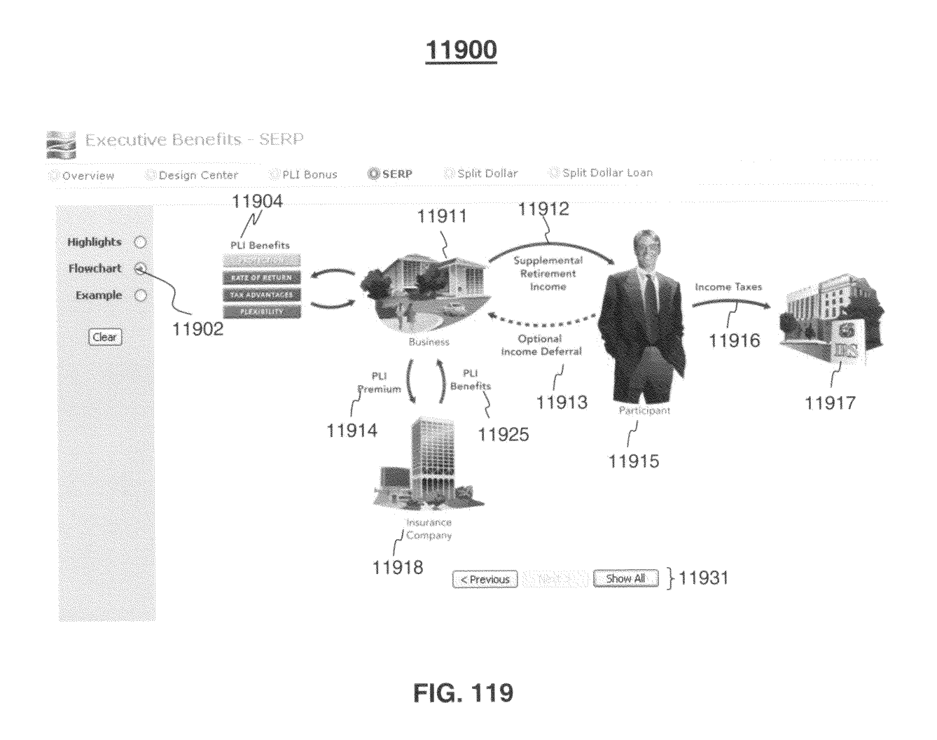

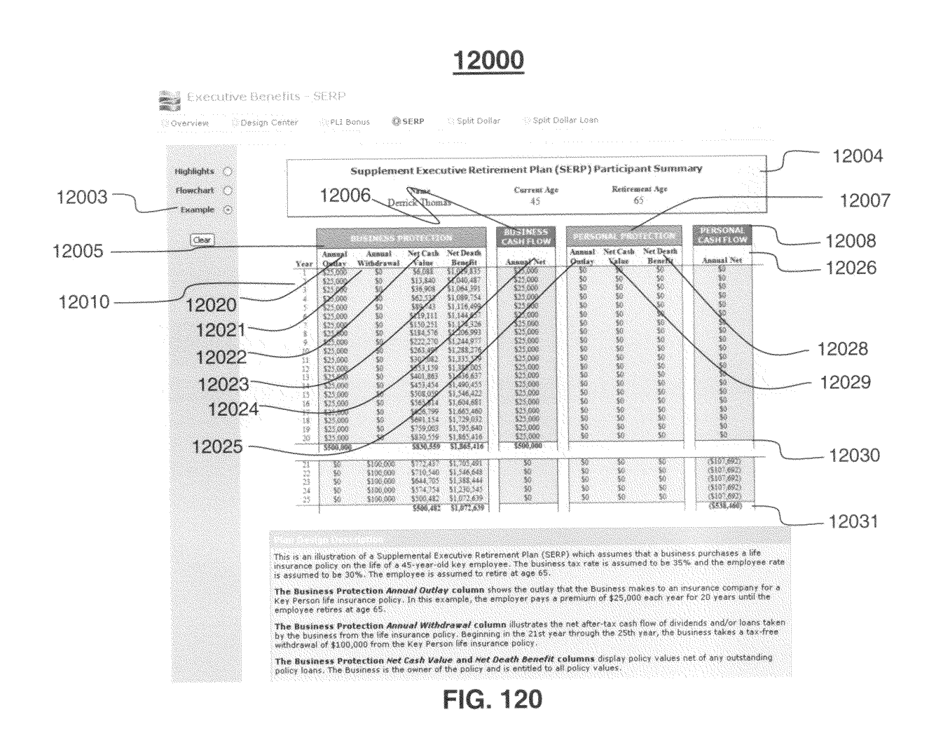

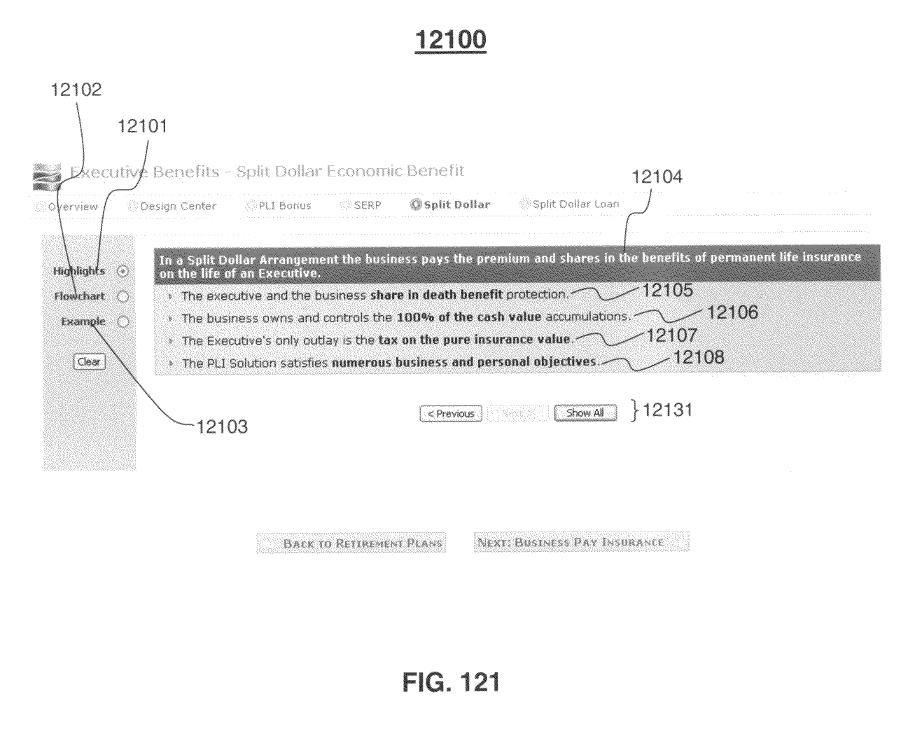

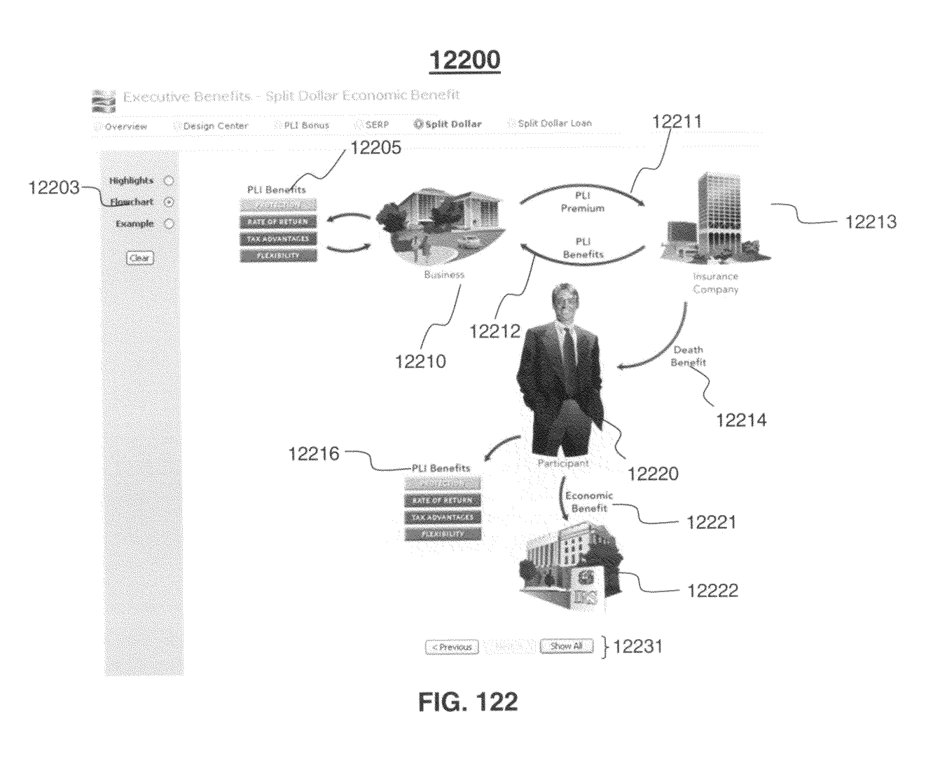

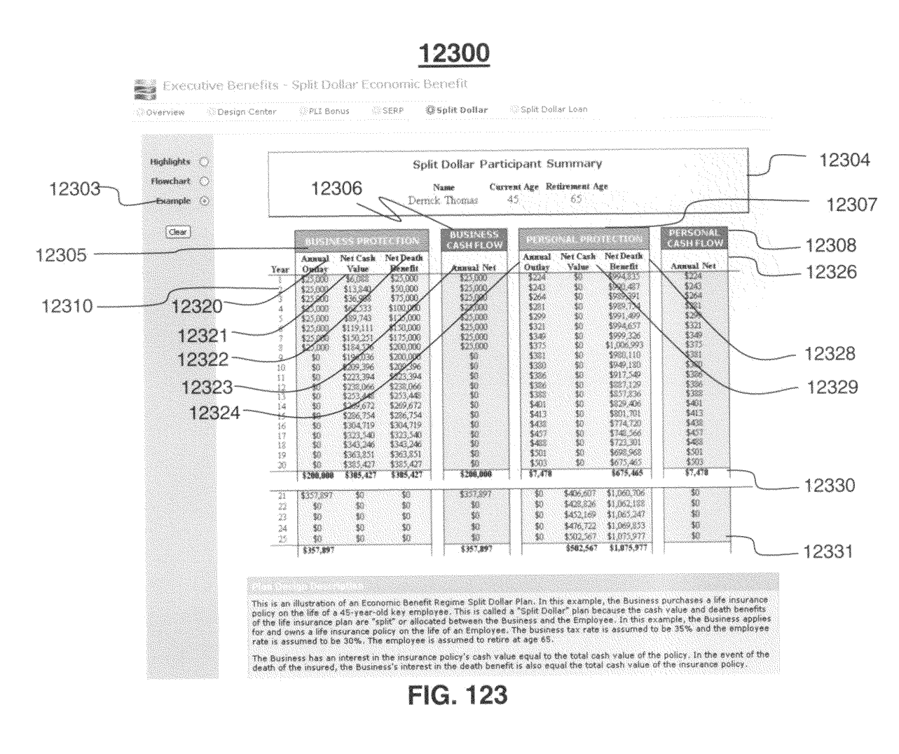

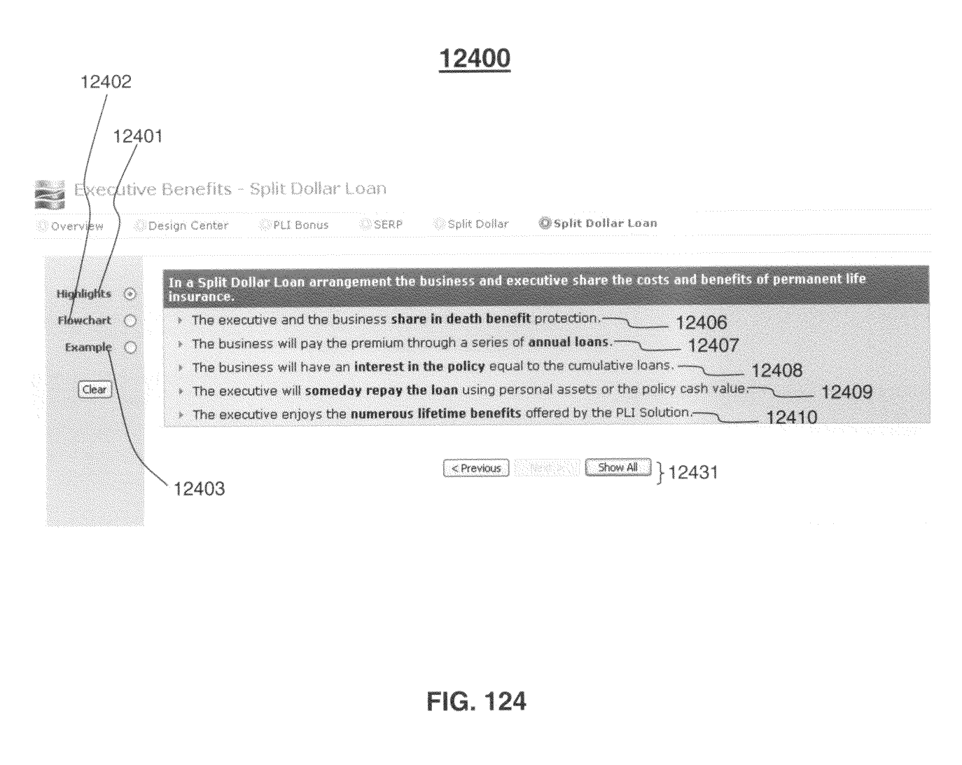

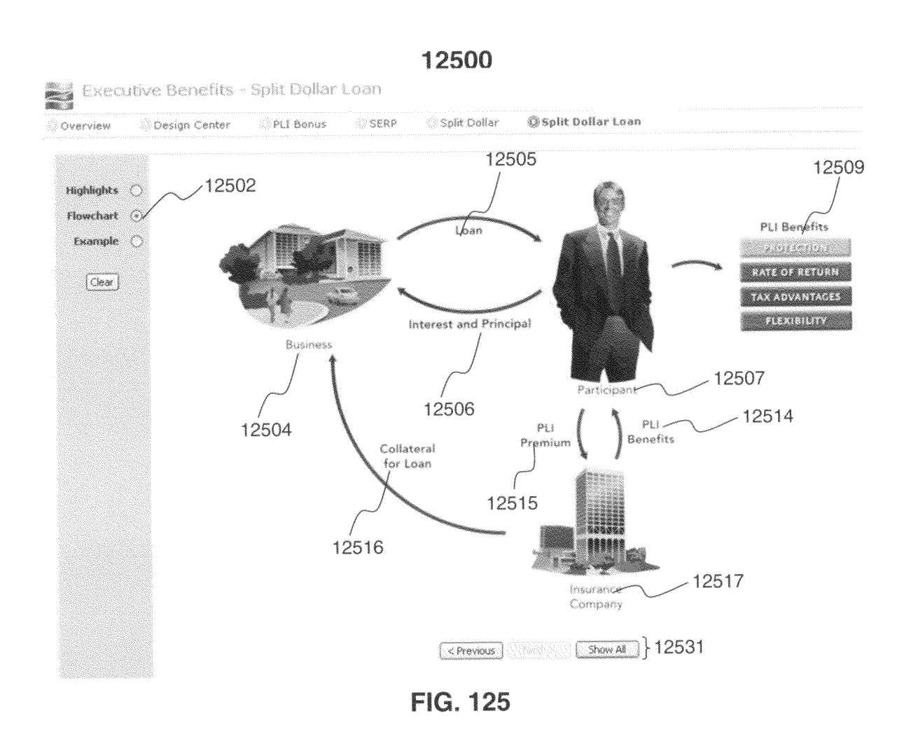

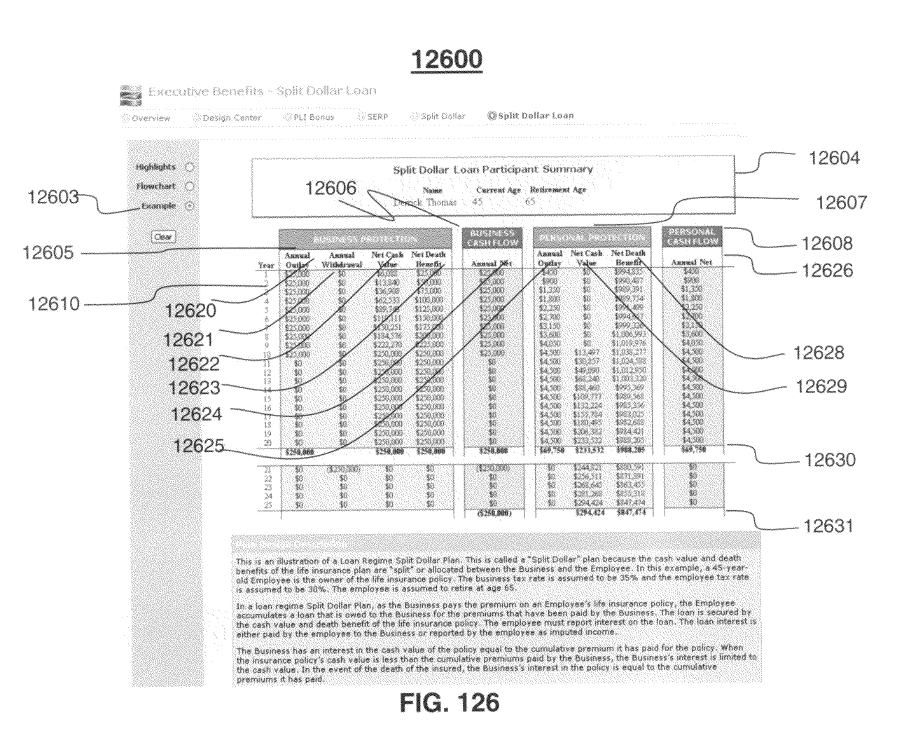

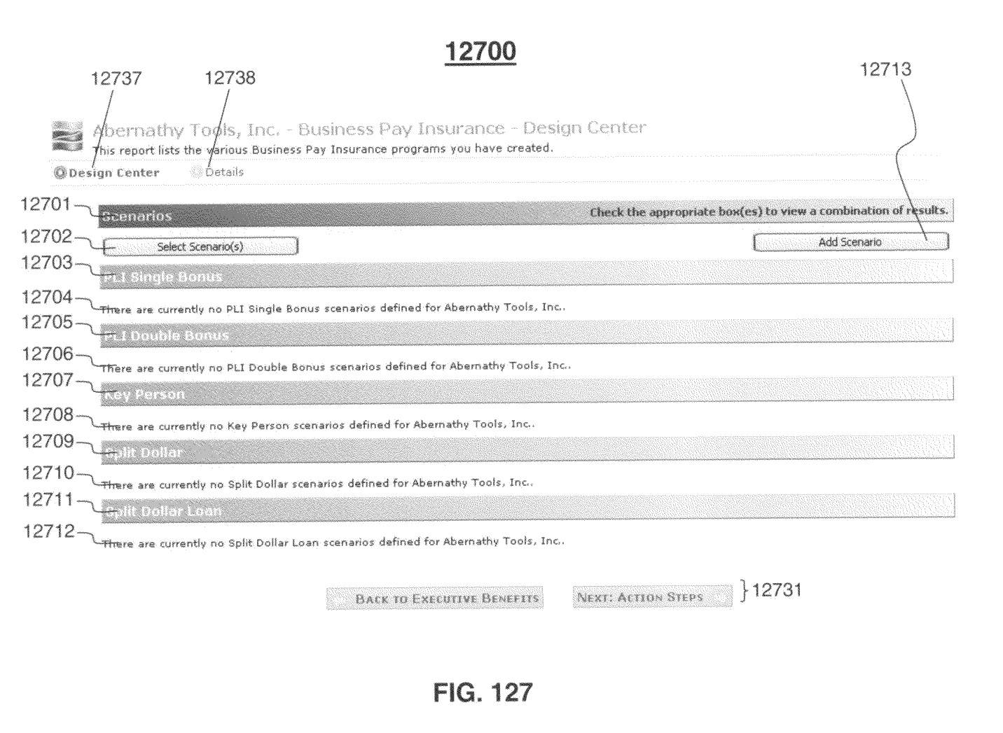

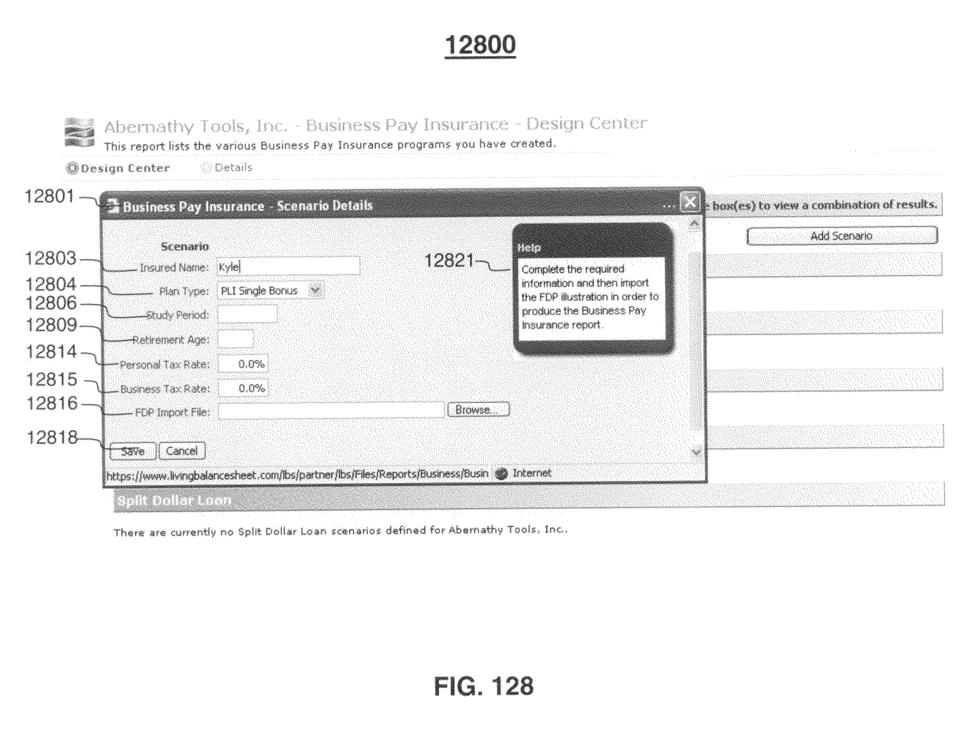

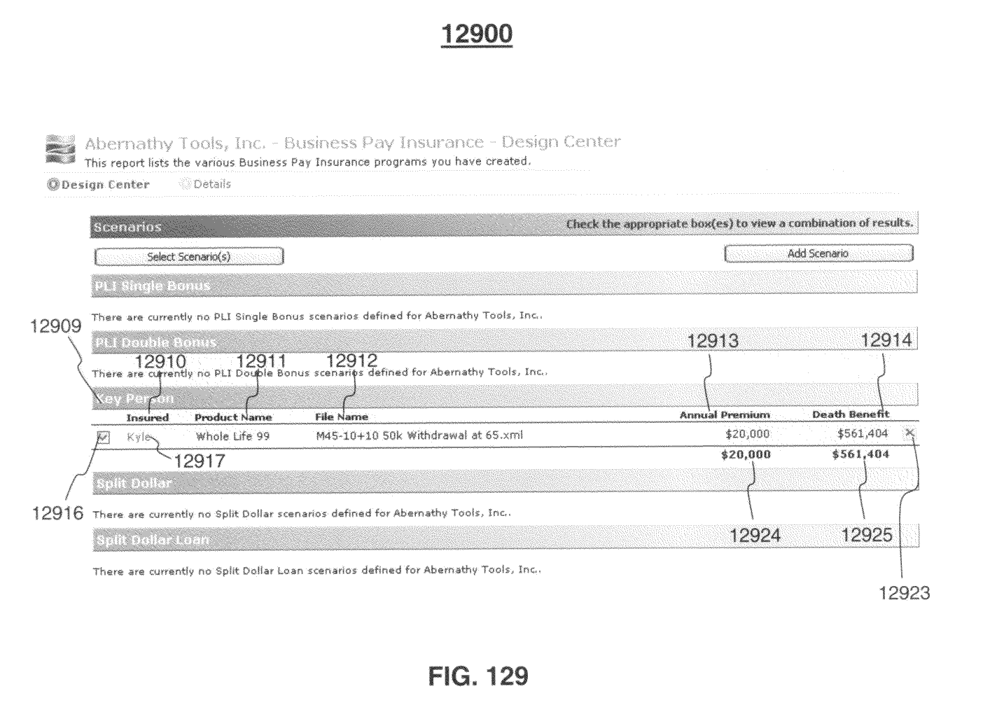

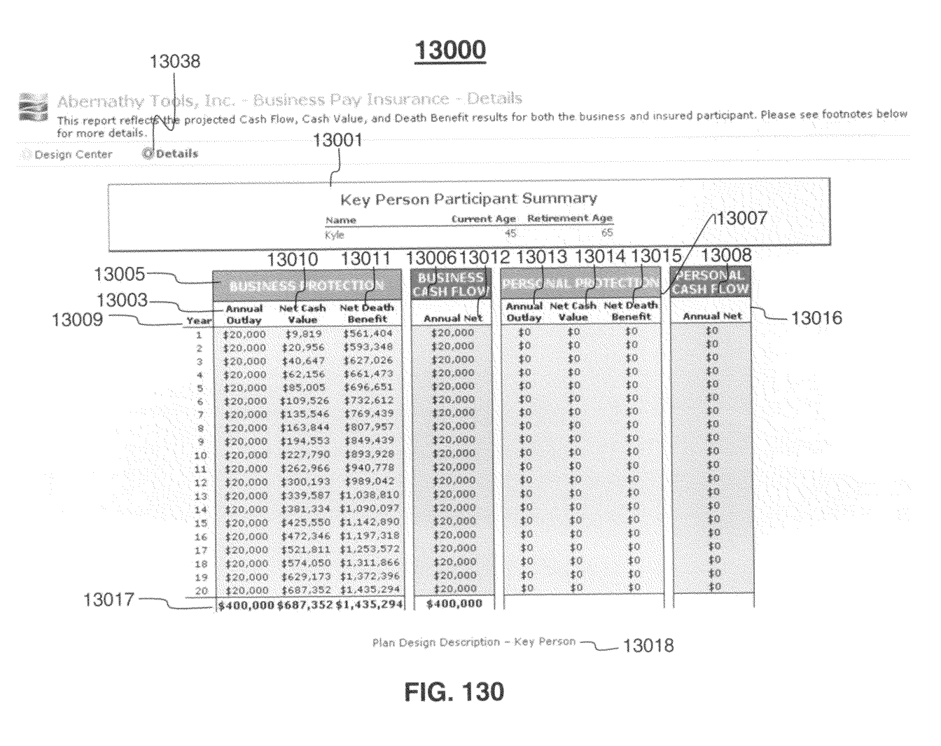

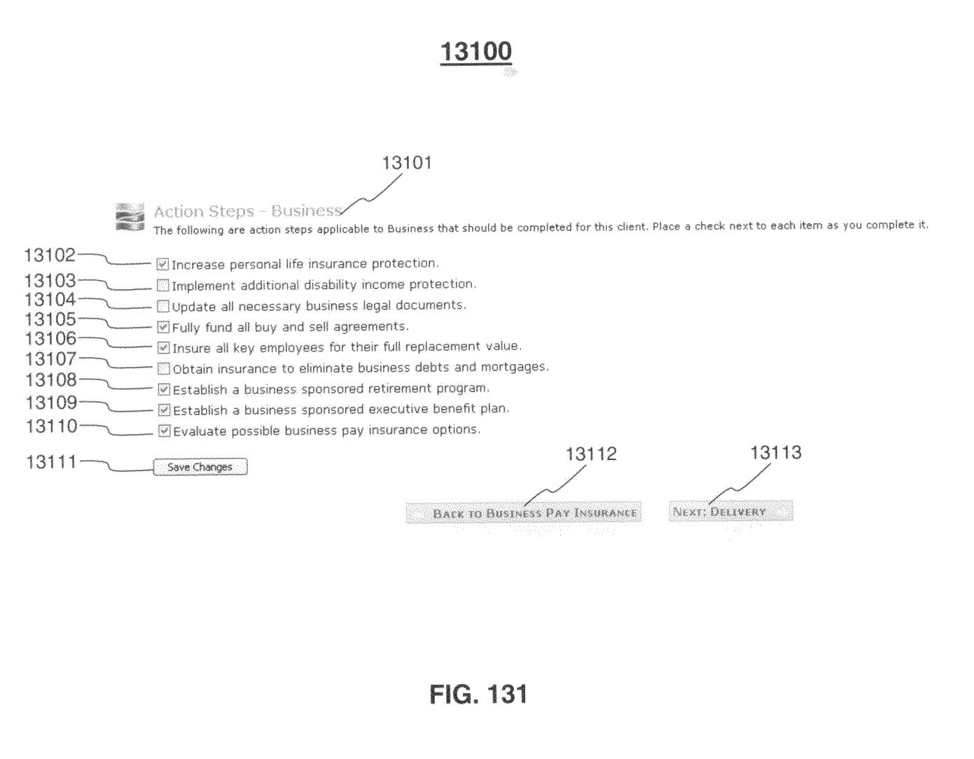

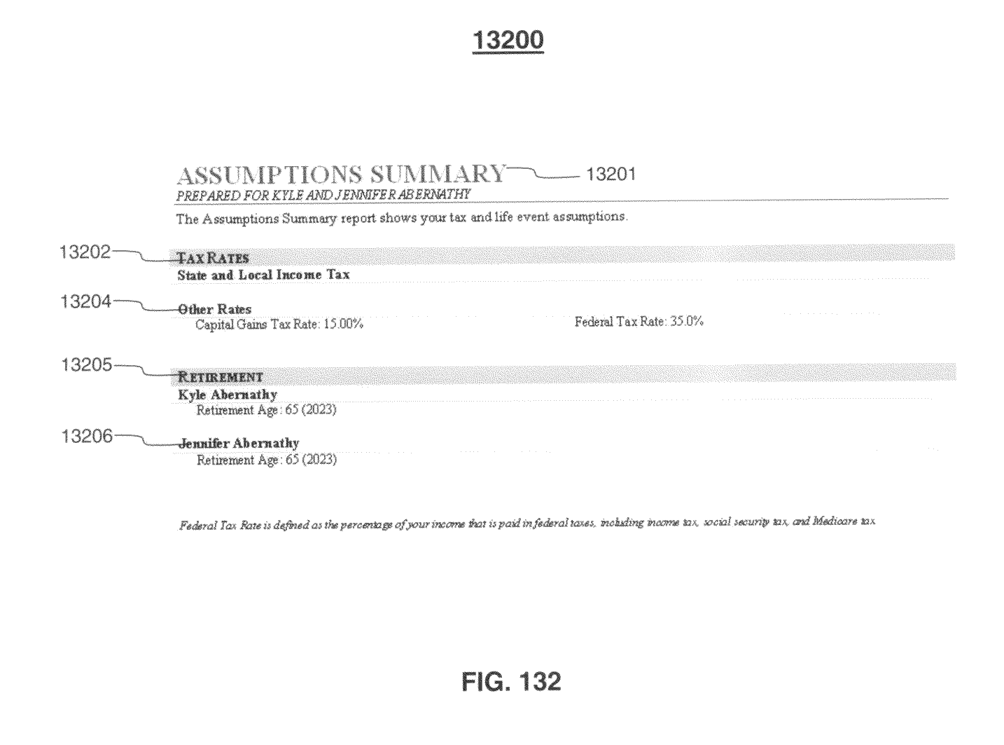

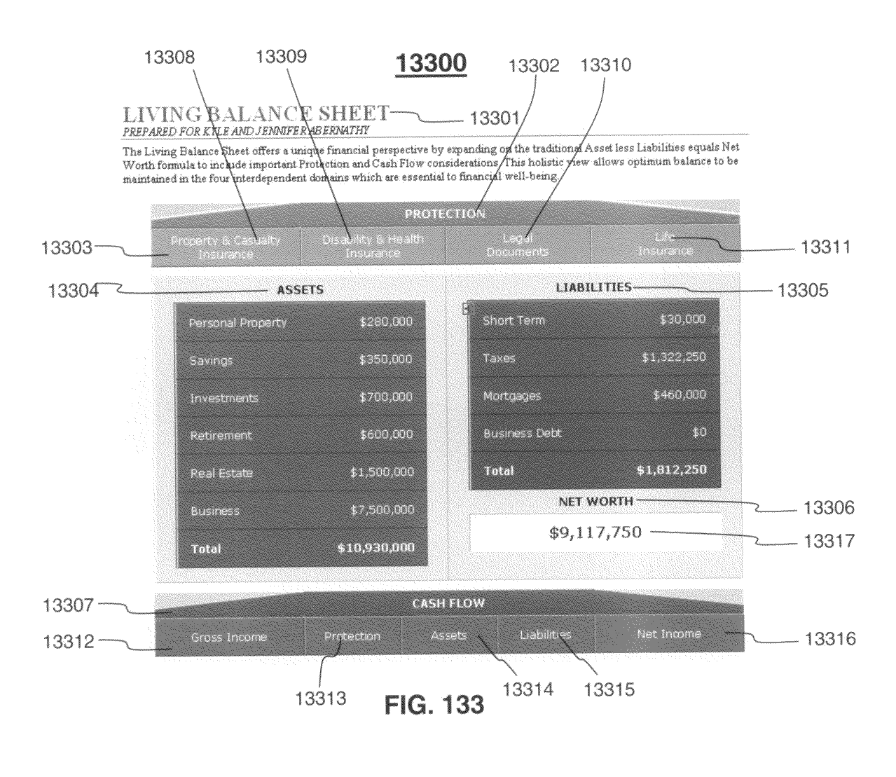

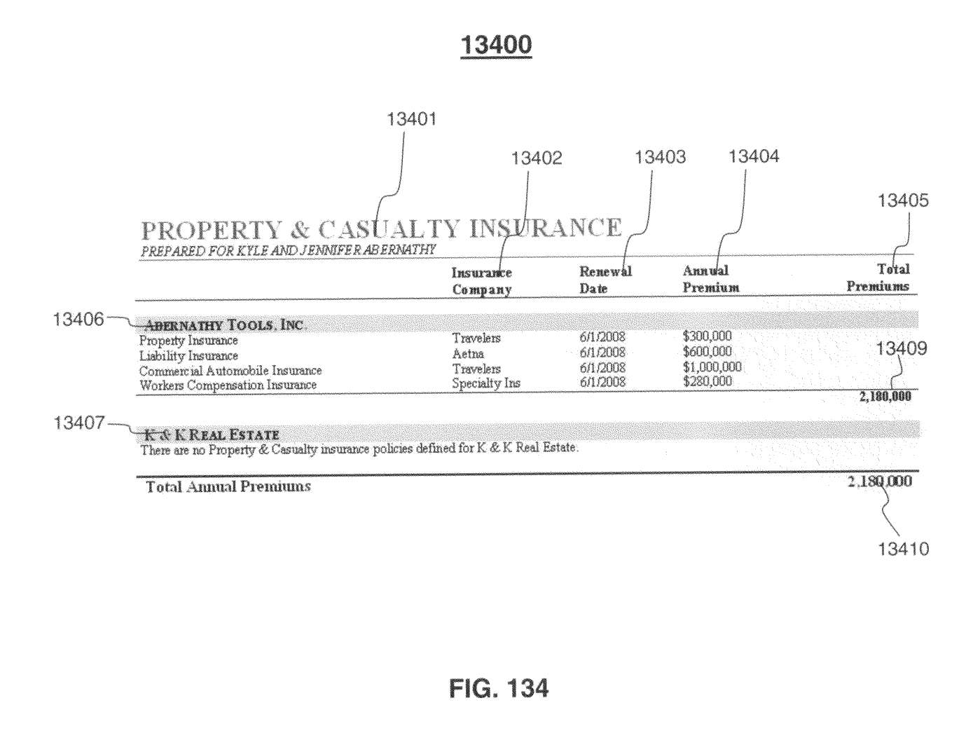

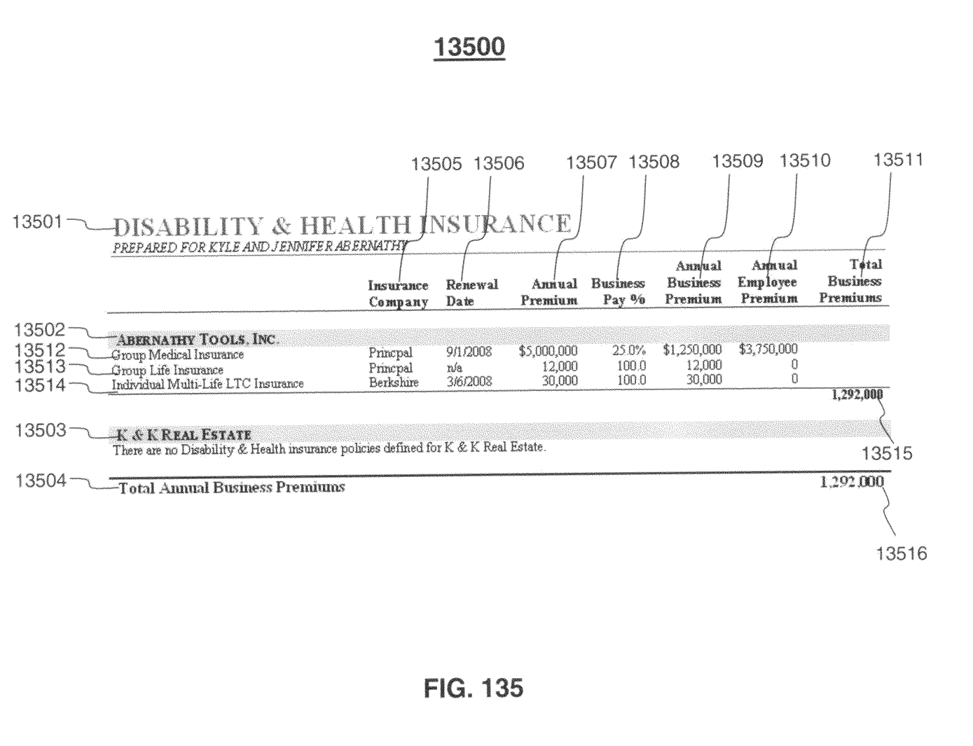

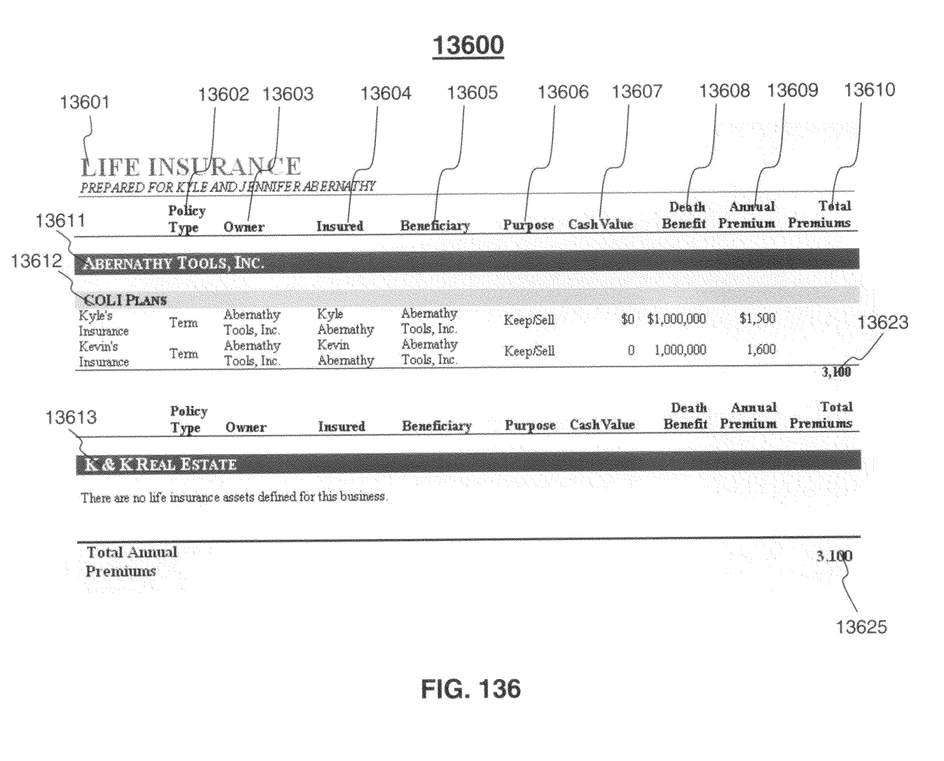

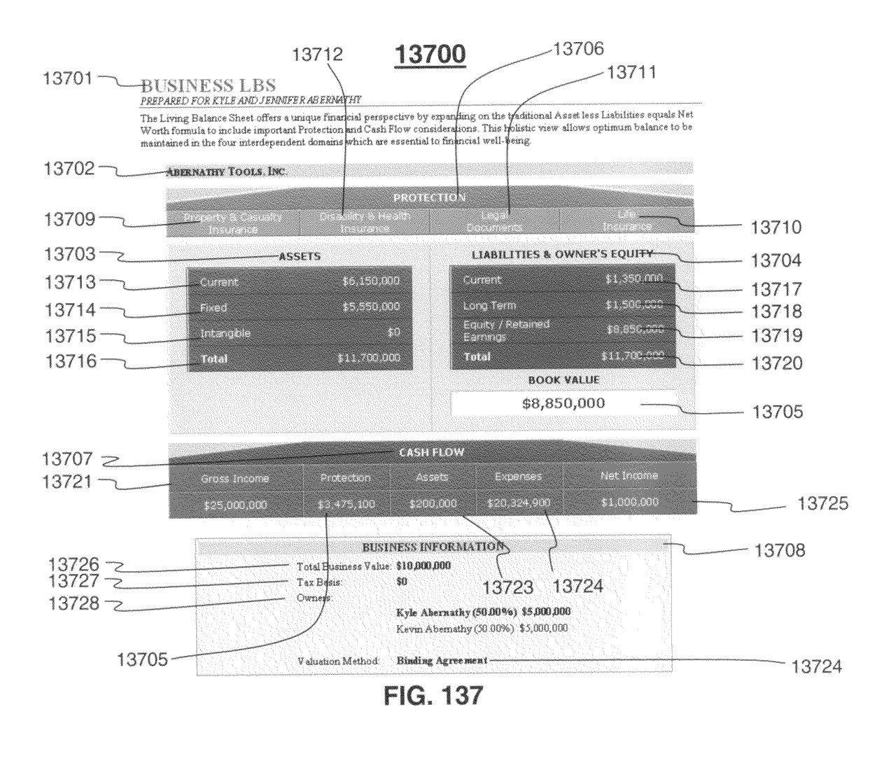

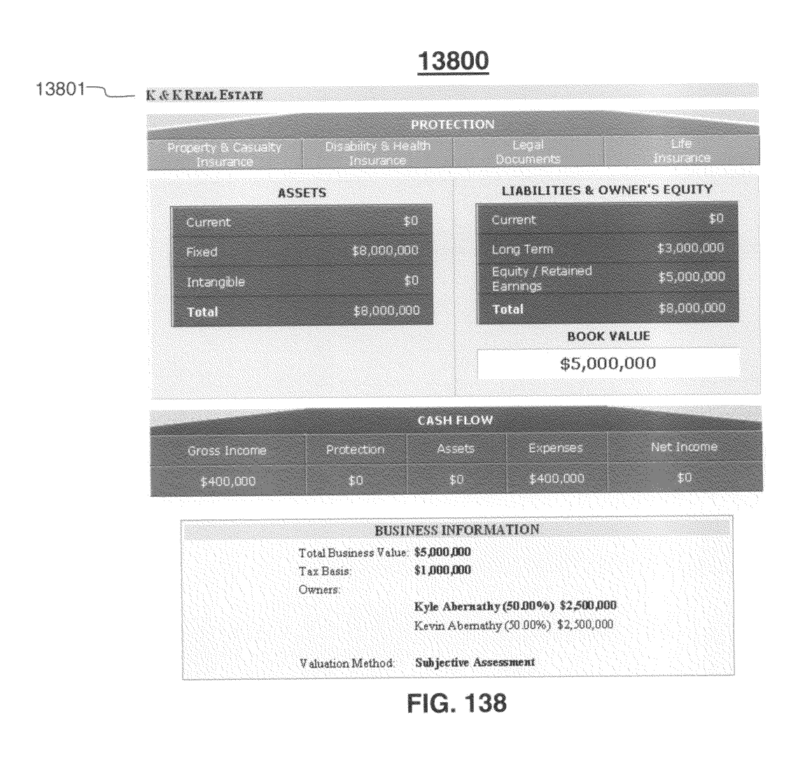

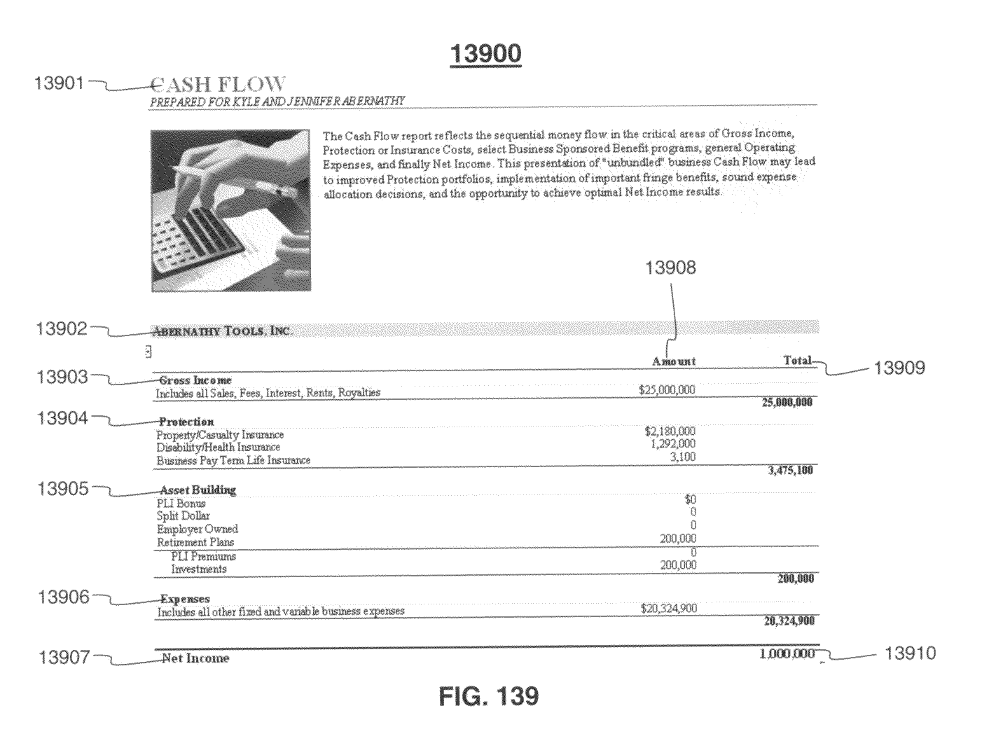

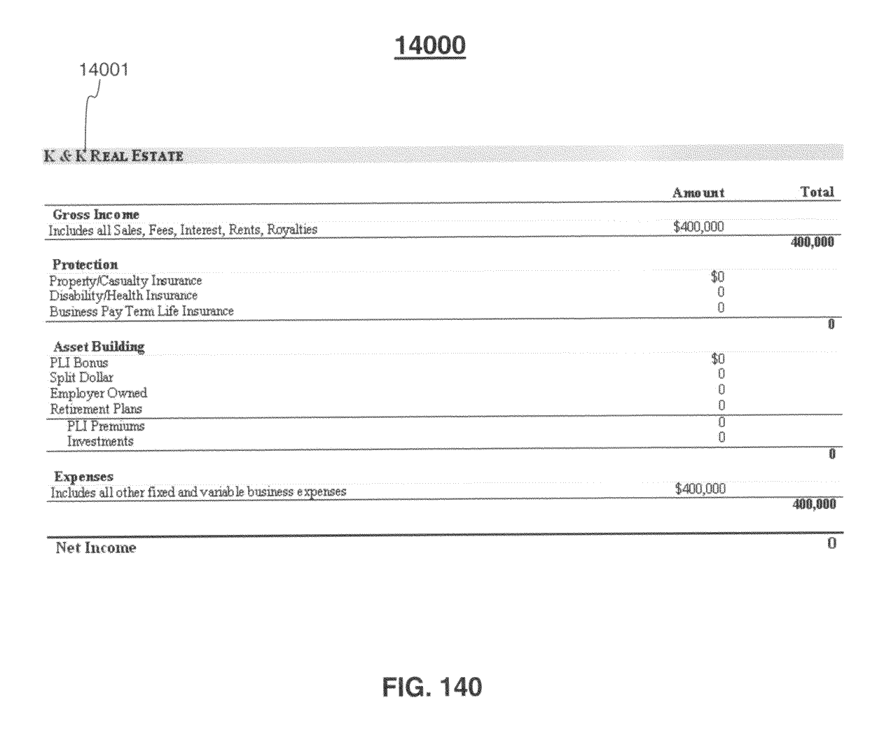

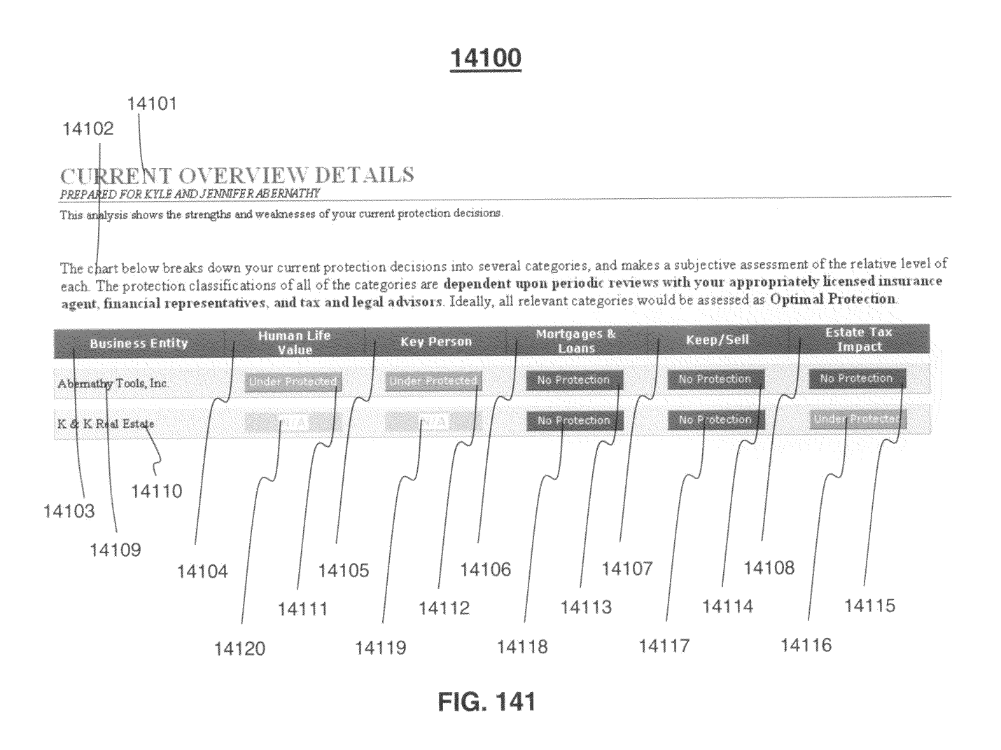

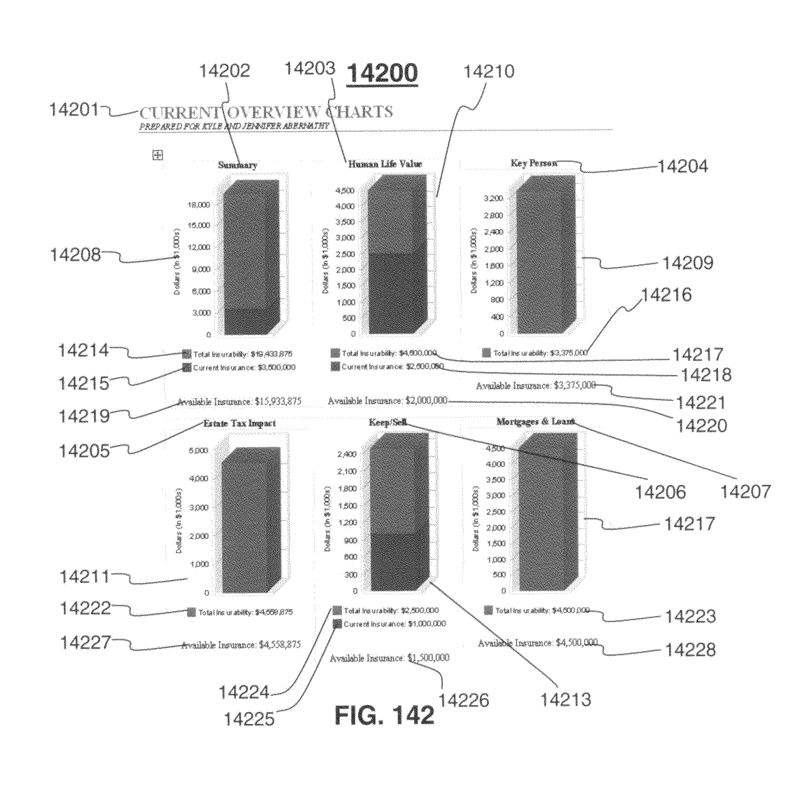

Client device 1002 comprises components in communication with each other, including input/output control 1012, processor/memory 1016, display 1014 and browser 1018. Input/output control 1012 provides an interface for entering user commands and/or receiving feedback from the device. The control 1012 can comprise a keyboard, mouse, sound output, haptic output, visual output, etc. Processor/memory 1016 includes any computing component and/or computer memory component. For example, the processor includes any device for performing computerized operations, such as running a program based on processor-readable instructions stored within a memory such as RAM, ROM, EEPROM, hard-disk drive, etc. Browser 1018 includes any component for providing a user interface. Browser 1018 can provide interfaces for providing insurance related services as described herein. Browser 1018 can provide business data management interfaces, personal data management interfaces, insurance interfaces, or the like. The interfaces provided can be the interfaces of FIGS. 11-142. A user can manage the services provided in the browser and over display 1014 using input/output control 1012.

Server 1050 comprises components in communication with each other, including business data manager 1022, processor/memory 1026, personal data manager 1024, and insurance data manager 1028. Processor/memory 1026 includes a computing component and/or computer memory component suitable or sufficient for performing processing. In one embodiment, Processor/memory 1026 can perform at least some of the operations of the processes of FIGS. 2-9, 143-151.

The components of the devices can be managed by separate functional multi-layer components, wherein the layers can be software and/or hardware and can be rendered or represented as visual components, for example, on a display. For example, a layer can manage a financial domain of a business or client. Another (sub) layer can manage a sub-domain of the domain, and the like. For example, a business's protection domain may include a layer directed to managing a type of insurance protection for the business, wherein the layer can be represented visually and enabled in hardware, software and/or over a network.

Business data manager 1022 includes a component for managing information related to a business of a client, including information about the domains of the business (e.g., assets, liabilities, cash flow, and protections). Business information can be received using a process and/or interface as disclosed in FIGS. 13-32. The business data can be stored in a database, indexed by the identity of the client, or the like. The database can be SQL database, flat file, XML file, or any formatted data. Fields of the business database can be associated with procedures, such as stored procedures, triggers, event based routines, or the like. When business data is entered into the database, the routines can trigger and compute other information for the database or other databases (e.g., for business, personal, or insurance data), such as net worth, tax amounts, valuation, etc., automatically, and store such computed information in the business database associated with the entered business data.

Personal data manager 1024 includes a component for managing information related to the client, the client's family, home, or other personal data. The personal information can include information about the domains of the client (e.g., assets, liabilities, cash flow, and protections). Personal information can be received using a process and/or interface as disclosed in FIGS. 33-45. The personal data can be stored in a database, indexed by the identity of the client, or the like, substantially similar to the business data described above. Routines and/or triggers can be associated with the fields of the database such that when personal data is entered, other data can be computed, such as personal tax rates, mortgage amounts, projected incomes, etc.

Business data (e.g., provided by business data manager 1022) can be different than personal data in several respects. Business data can be based on or related to the financial condition or state of the business including the ownership of the business (e.g., corporation, corporate entity, LLP, LLC, partnership, sole proprietorship, etc.), tax structure for the business, and obligations unique to the business such as paying taxes for employees, stock or bonds obligations, etc. As described herein, the apparatuses, processes, user interfaces, or other mechanisms for providing business data provides added benefit beyond only displaying personal data (e.g., provided by personal data manager 1024), because the business information enables a user or client to understand the unique problems of a business and to manage the future financial conditions of the business with respect to insurance and insurability. Also, providing business data in conjunction with personal data allows the user or client to understand the interrelationship between the business financial condition and the personal financial condition.

Insurance data manager 1028 includes a component for managing information related to mechanisms for protecting the financial value (e.g., cash flow, owner's equity, net worth, life value) of the business and/or client at disability and/or death of the client. Insurance information can be data associated with the protection domains for the client and/or the client's business. Insurance information can include actual current insurance owned by the client and/or business to cover the loss of the client and/or key persons. Scenarios at death and/or disability can also be stored and managed by the manager 1028. Insurance information can be stored in a database substantially similar to business and/or personal information as described above. Information about projected insurance protection coverage to create a positive cash flow for the business and/or client's family can also be stored. Routines and/or triggers can be associated with the fields of the database such that when insurance data is entered, other data can be computed, such as adequate insurance coverage for particular at-death or at-disability scenarios, a change in cash flow, owner's equity, and/or net worth due to more or fewer protections, or the like.

Other Illustrative Possesses

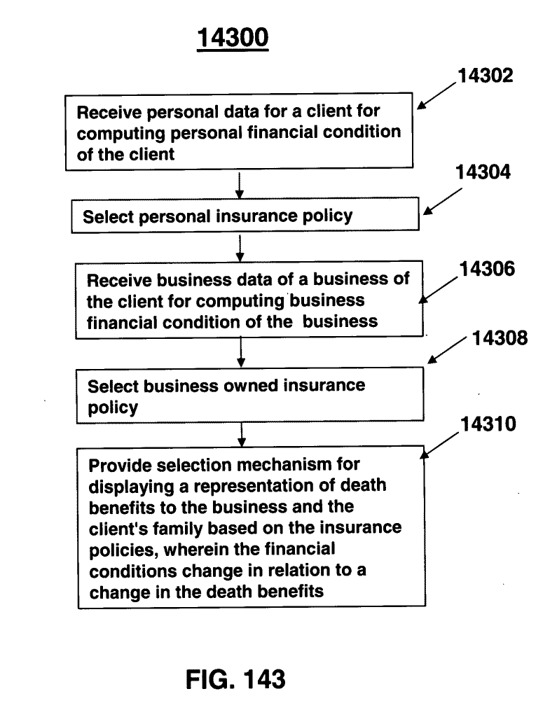

FIGS. 143-152 show examples of processes for managing an insurance marketing platform configured to analyze the value of business owned life insurance/corporate owned life insurance (BOLI or COLI) on owners and key employees, among other things and cash flow scenarios for the business and the client's family at the death of the client can be provided relative to different coverage of business and personal life, health, disability, or other insurance. The processes and interfaces disclosed herein are described with respect to a client and a client's business, but the processes and interfaces are not limited to a single client and business and can be an aggregate for a plurality of clients or businesses, without departing from the scope of the invention.

The possesses and interfaces shown can be executed within the web host 110, consumer interfaces 104, or other components of FIG. 1. The interfaces can be provided as web pages, desktop applications, or other interactive applications on the client devices of FIG. 1. The interfaces can be provided in real-time over networks 102/106 of FIG. 1. The interfaces can also be a standalone application on a computer, wherein saving and/or interacting with data can store data locally, and then periodically, sends the stored data over networks 102/106 of FIG. 1.

Access to user processes and interfaces described below can be enabled the process of FIG. 2. Access to user processes and interfaces described below can be provided over a network as described in FIG. 3.

As described below, a user can use the processes or interfaces to navigate between different interfaces. Navigation can be enabled by a user interaction, such as a mouse press, touch screen input, gesture, voice, etc. “Clicking”, “pressing”, or “pushing” a user interface element described below is non-limiting and can include any user interface input. Navigation can also be automatic and/or timed and can not require user input.

While a sequence of sections or steps of a process flow between interfaces are also described, other sequences can also be used without departing from the scope of the invention. For example, a user can navigate backwards and forwards in the step, or even skip certain steps, or jump from one step of one process to another step of another process. The sequence of steps can be stored in processor readable media and presented to or selected or chosen by the user, chosen by user preferences (e.g., based on past behavior of the user or other similar users), or the like.

FIG. 143 is a flow chart of a process for providing insurance related services to insurance professionals on a platform in accordance with one embodiment of the invention. A need for business owned life insurance on owners and key employees of a business can be analyzed for the client using the process of FIG. 143. The platform can comprise hardware, software, a network, or combinations thereof. For example, the combination of the application and the platform can be considered agent-interface equipment (e.g., agent interface equipment 116 of FIG. 1).

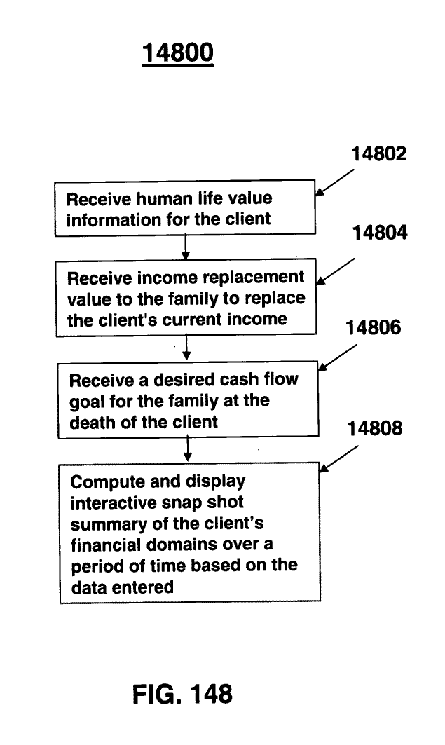

Personal data of a client for computing a personal financial condition for the client's family at a death of the client can be received (step 14302). Receiving personal data can include receiving data about the human life value of the client, insurance protection levels for the client and/or personal financial domain for the client (protection, assets, liabilities, cash flow). Receiving the personal data can be performed by a personal data entry interface configured to receive information about at least a portion of the plurality of personal financial domains. Receiving the personal data can also be performed by a personal cash flow interface configured to determine a cash flow of the family at the death or disability of the client. Examples of processes, interfaces, and other mechanisms for receiving and managing personal data are shown in FIG. 148 and/or FIGS. 33-45, 144, 148.

A personal interactive snapshot summary can be configured to provide (e.g., display) the received personal information about a plurality of personal financial domains of the client. A plurality of layers of the personal summary can display each of the different plurality of personal financial domains. Examples of processes, interfaces, and other mechanisms for providing the personal interactive snapshot summary are shown in FIGS. 54-73, 82-88, 144. The summary balance sheet offers a unique financial perspective for the client by expanding on the traditional asset less liabilities equals net worth formula to include important protection and cash flow considerations. This holistic view allows optimum balance to be maintained in the four interdependent domains which are essential to the financial well-being of the client.

Step 14302 can be used in conjunction with, for example, the steps of FIGS. 4, 5, 6, 8, and 9 to retrieve information about the client and/or display the information, for example, as a personal interactive snapshot summary and/or to retrieve and display such information within a process or methodology particular to an insurance professional, insurance carrier, or the like.

A personal life or other type of insurance policy for the client can be selected (step 14304). The personal insurance policy can insure against the death or disability of the client for up to a plurality of amounts. The personal insurance policy can be an existing policy that the client already owns or an additional policy for up to an amount insurable for the client. The personal insurance policy can be part of an assumption of the personal and business condition of the client. Selection off the information about the identity, types, levels, and quantities of personal insurance can comprise editing, managing, and/or receiving the information. Examples of processes, interfaces, and other mechanisms for selecting the personal insurance policy are shown in FIGS. 54-73, 82-88.

Step 14304 can be used in conjunction with, for example, the steps of FIGS. 4, 5, 6, 8, and 9 to receive a selection of personal life or other type of insurance policy for the client.

Business data of a business for computing a business financial condition of the business at the death of the client can also be received (step 14306). Receiving personal data can include receiving data about the financial domain for the business (protection, assets, liabilities, cash flow). Receiving business data can be performed by a business cash flow design interface configured to compute a cash flow of the business based on a business valuation and at least a portion of the business financial domains. Receiving business data can also be performed by a business protection interface configured to determine a degree of protection for at least a portion of the business financial domains. Examples of processes, interfaces, and other mechanisms for receiving business data are shown in FIGS. 12-33, 46-130, 145-147.

Business data an also be received using an aggregation mechanism for retrieving the business data from definable or selectable sources, over a network, from network devices, from financial institutions specified by the client, or the like. Such aggregation can be performed, by for example, step 49 of FIG. 4.

A business interactive snapshot summary can be configured to provide (e.g., display) the received business information about a plurality of business financial domains of the business. A plurality of layers of the business summary can display each of the different plurality of business financial domains. Examples of processes, interfaces, and other mechanisms for providing the business interactive snapshot summary are shown in FIGS. 54-73, 82-88, 146. The summary balance sheet offers a unique financial perspective for the client's business by expanding on the traditional asset less liabilities equals net worth formula to include important protection and cash flow considerations. This holistic view allows optimum balance to be maintained in the four interdependent domains which are essential to the financial well-being of the client's business. The domains of the client and the domains of the client's business can also be interdependent.

Step 14306 can be used in conjunction with, for example, the steps of FIGS. 4, 5, 6, 8, and 9 to retrieve information about the client's business and/or display the information, for example, as a business interactive snapshot summary and/or to retrieve and display such information within a process or methodology particular to an insurance professional, insurance carrier, or the like.

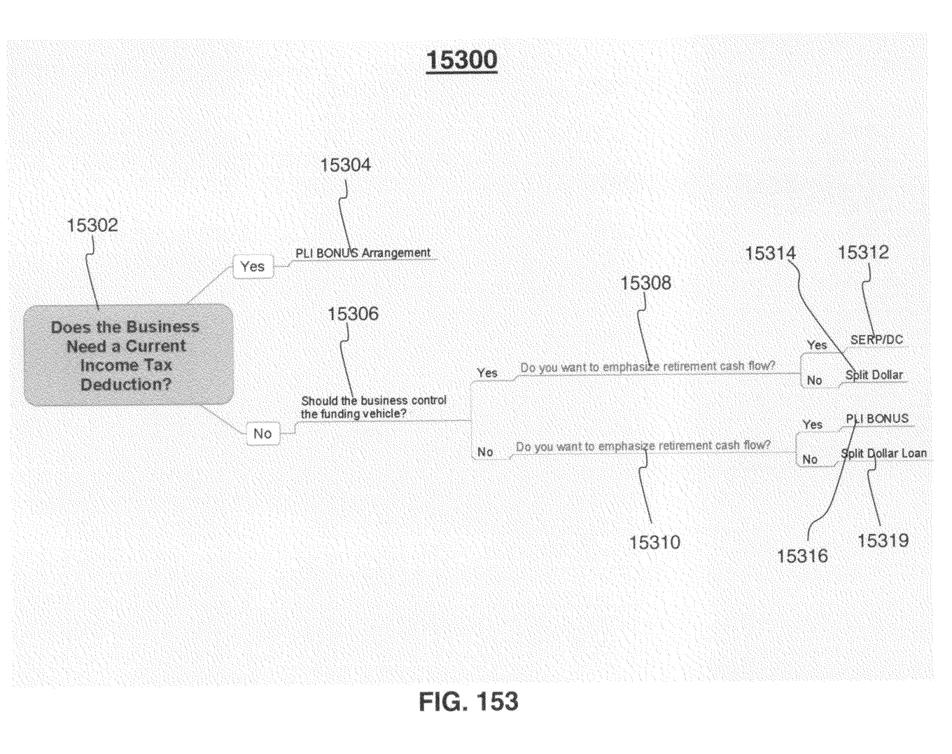

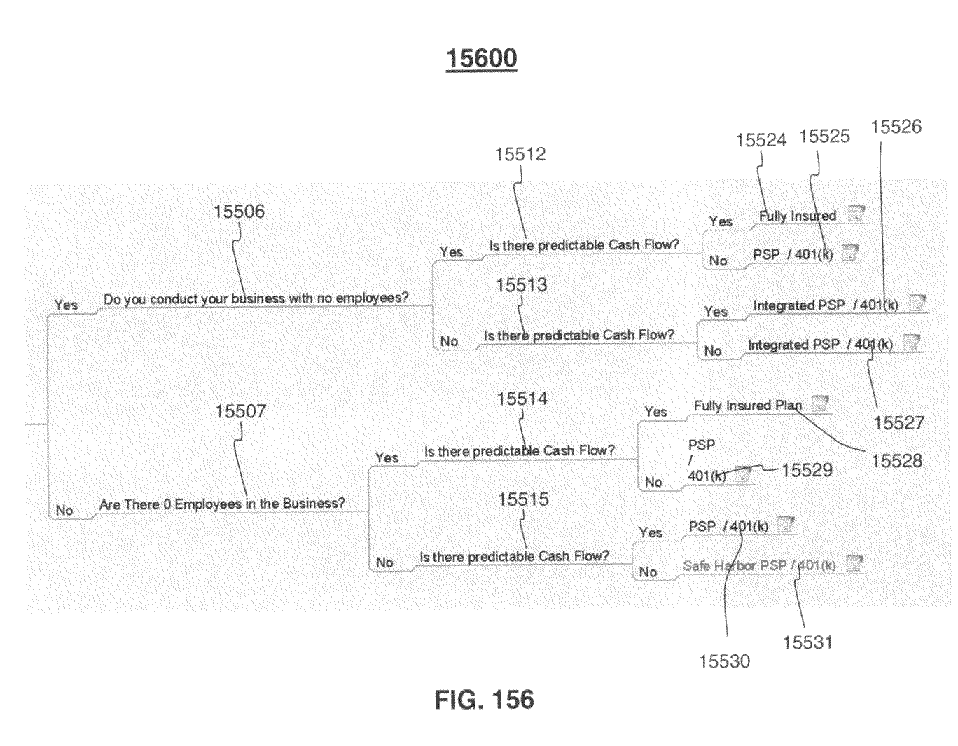

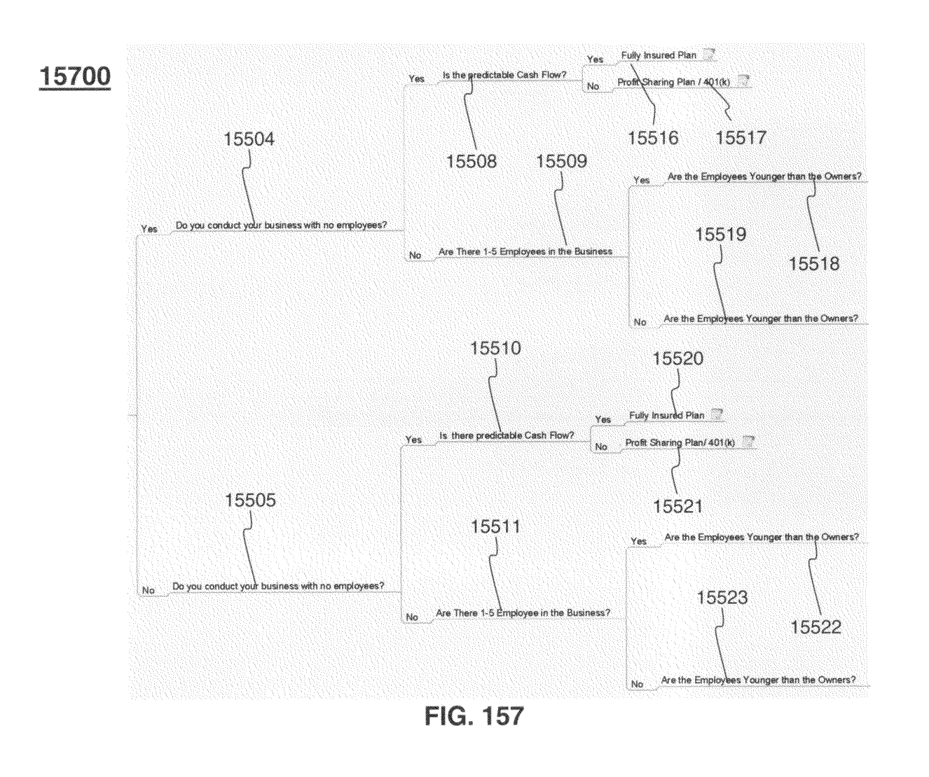

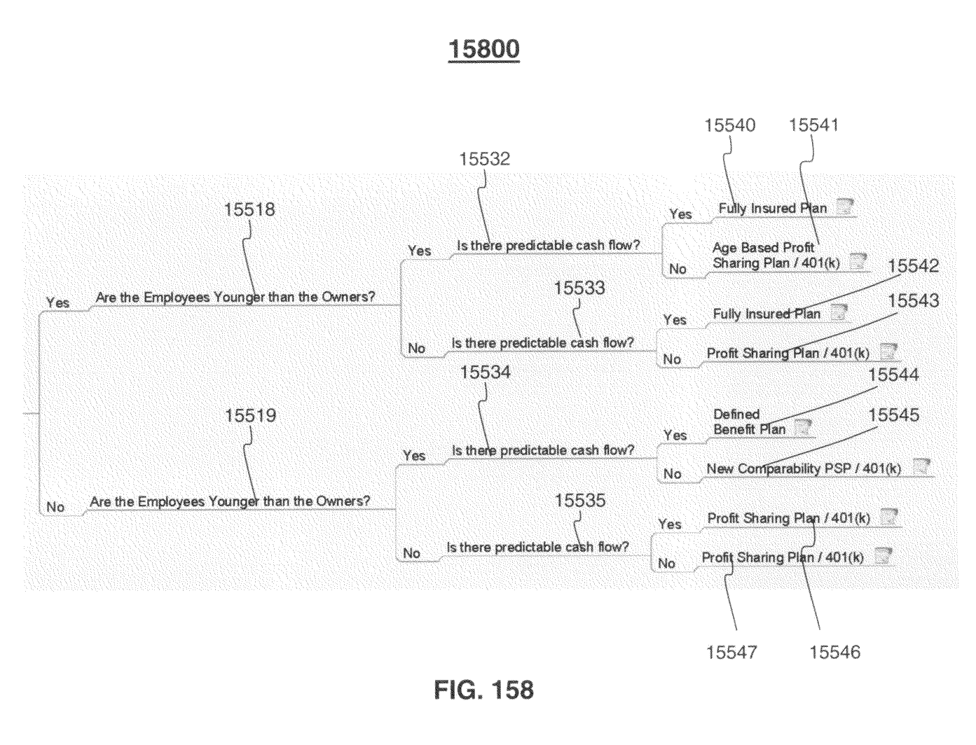

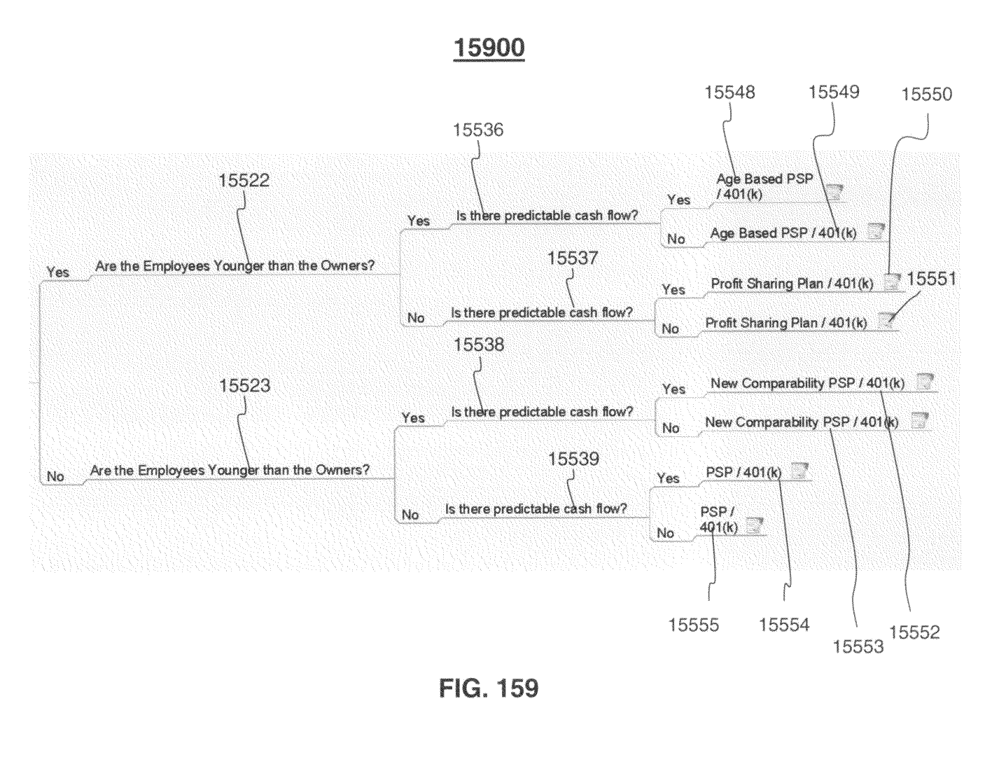

A business owned life or other type of insurance policy for the business's covered person(s) can be selected (step 14308). The covered person can include the client, owner(s) and/or key person(s), or the like. Benefits for the business owned life or other type of insurance policy can be paid to the business if an insured event such as the death of an owner, key employee, or the like, occurs. The business insurance policy can insure against the death or disability of the covered person for up to a plurality of amounts. The business insurance policy can be an existing policy that the client already owns or an additional policy for up to an amount insurable for the covered person. The amount of business owned insurance possible for a covered person can be a different or greater amount than the amount of possible (existing or additional) personal insurance. The business insurance policy can be part of an assumption of the personal and business condition of the client. Selection of the information about the identity, types, levels, and quantities of business insurance can comprise editing, managing, and/or receiving the information. Selecting or otherwise managing the business owned life insurance can also be performed by an interface mechanism for establishing a business sponsored retirement program or executive benefit plan based on a decision tree data structure. Examples of decision trees for managing qualified plans, retirement plans, and executive plans are shown in FIGS. 153-159. The decision tree data structure can comprise rules based on a type of the business, the business financial condition, and an employee characteristic. Examples of processes, interfaces, and other mechanisms for selecting the personal insurance policy are shown in FIGS. 54-73, 82-88, 93-130, 151.

Step 14308 can be used in conjunction with, for example, the steps of FIGS. 4, 5, 6, 8, and 9 to retrieve information about the client's business and/or display the information, for example, as a business interactive snapshot summary and/or to retrieve and display such information within a process or methodology particular to an insurance professional, insurance carrier, or the like.

A selection mechanism for displaying a representation of a personal death benefit to the client and a representation of a business death benefit to the business, based on the modified assumption can be provided (step 14310). The display of the death benefits can be shown within the interactive snapshot summaries. The selection mechanism configured can be configured to modify the assumptions about the personal financial domains and the business financial domains. Modifying the assumption of the business financial condition can include selecting a business owned life insurance policy for a key person of the business. The modification of the assumption can change a display of the personal information and the business information. The personal financial condition and the business financial condition can change in relation to a change in the assumptions, (e.g., a change in the personal death benefit and the business death benefit that is enabled by the selection mechanism). The change in the personal financial condition information can also be a function of a change in the business information and whether the assumption comprises sufficient levels of an additional insurance protection to fund a liability of the client and the business.

The selection mechanism can be configured to maintain a business cash flow of the business at the death of the client within a threshold of a desired percentage of another business cash flow of the business prior to the death of the client, based on the modified assumption. The selection mechanism can also be configured to maintain a personal cash flow of the family at the death of the client within a threshold of another desired percentage of another personal cash flow of the family prior to the death of the client, based on the modified assumption, wherein the modified assumption comprises an addition of business owned life insurance. In this way, the selection mechanism can show the client an optimal level of assumptions to maintain adequate cash flow for the business and/or family at the death of the client.

The selection mechanism can be configured to vary a display of the personal financial condition for a client's family and a display of the business financial condition of the business (e.g., within the respective interactive summaries) based on a combination of at least two of a scenario for keeping an ownership of the business with the family, a scenario for selling the ownership, a scenario for changing a business owned life insurance policy, and a scenario for changing a personal life insurance policy. In this way, various assumptions of scenarios can be shown to affect the financial conditions in different and interrelated ways.

The selection mechanism can also include a navigation mechanism configured to modify the information displayed in the personal and business information (e.g., summaries) based on a sequence of displays of information within the personal financial domains and the business financial domains. Examples of processes, interfaces, and other mechanisms for providing the selection mechanism are shown in FIGS. 54-73, 82-88, 149-150. Step 14310 can be used in conjunction with, for example, the steps of FIGS. 6, 8, and 9 to provide the selection mechanism.

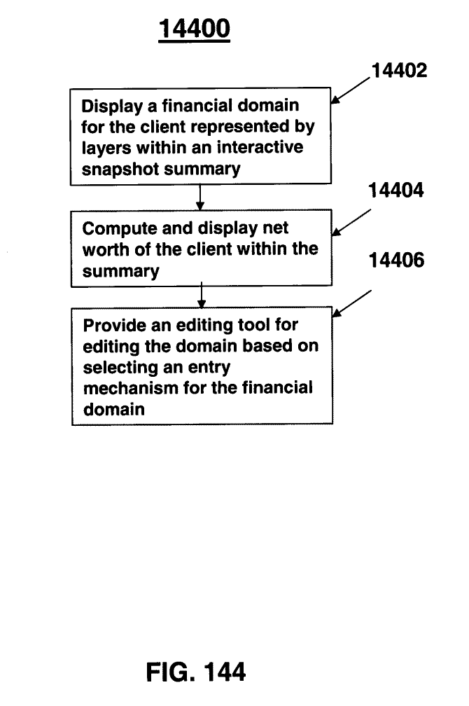

FIG. 144 is a flow chart of a process for providing a current balance sheet mechanism of a client for managing a personal life insurance or other insurance needs to insurance professionals on a platform in accordance with one embodiment of the invention. The steps of FIG. 144 can be used in conjunction with, for example, the steps of FIGS. 4, 5, 6, 8, and 9 to provide the current balance sheet mechanism.

Financial domain for the client and client's family represented by layers are displayed within an interactive snapshot summary (step 14402). At least four domains for the client can be displayed. The four domains include protection, assets, liabilities, and cash flow. Net worth of the client is also computed and displayed (step 14404). A user can select to edit the information of the domains by selecting an entry mechanism for the domains (step 14406). For example, the user can click on the layer for each of the financial domains to navigate to a page for managing the financial domains. FIG. 11 shows an example of the interactive snapshot summary with layers for a client and the client's family.

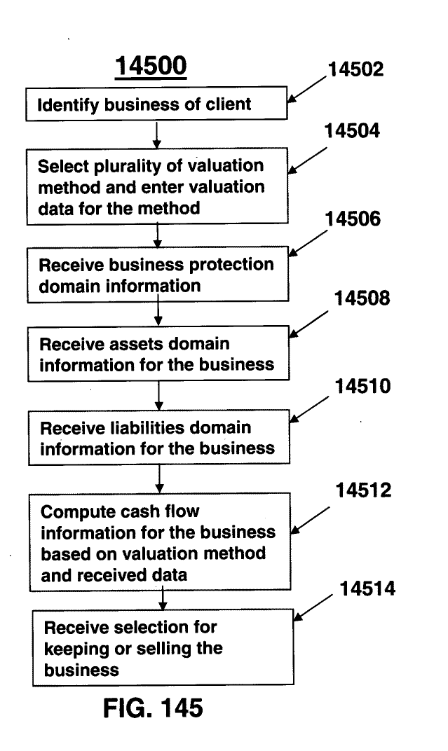

FIG. 145 is a flow chart of a process for providing a business data entry mechanism to insurance professionals on a platform in accordance with one embodiment of the invention. A business of the client is identified and entered (step 14502), for example, a name of the business, owners of the business and the percentage of ownership, total business value, type of business (e.g., LLC, LLP, partnership, sole proprietorship, etc.), tax information (e.g., tax basis) of the business, or the like. The processes and interfaces used for identifying the business are described in more detail in U.S. patent application Ser. Nos. 12/113,087, 11/891,616, 11/510,537, and/or 60/763,200. An example of business information is shown in more detail in FIG. 12. The steps of FIG. 145 can be used in conjunction with, for example, the steps of FIGS. 4, 5, 6, 8, and 9 to provide an entry mechanism for business data related to the client.

A plurality of valuation method is selected and valuation data for the method is entered (step 14504). Valuation data for a business can be entered to estimate the worth of the business. Valuation data can include information, such as gross or net income. An example of business valuation entry is shown in more detail in FIG. 12.

Business protection domain information can be received (step 14506). Business protection information can include property and casualty insurance information (e.g., insurance company name, renewal date, annual premium), disability and health insurance information (e.g., insurance name, annual premium, percentage that a business pays), legal documents information, or current overview of the business information. Disability and health insurance information includes scenarios where a business pays and/or employee pays for the insurance premiums. Legal documents information includes information about the business's legal document (e.g., date established; date last reviewed). Life insurance or other insurance information includes business owned/paid life insurance. The current overview information includes whether each of the human life value, key person, mortgages and loans, keep/sell, estate tax impact, and/or section has no protection, is under protected, optimal, or other options. FIGS. 14-18 show examples of processes, mechanisms, or interfaces for managing a protection domain of a business.

Assets domain information can also be entered and/or received (step 14508). Asset information can include current, fixed, intangible assets, or the like. The asset domain for a business can be derived from a company's financial statement. Assets can also include annual retirement plan contribution. Assets can also include key persons, which can be entered with the other assets information or elsewhere on the site. Annual compensation of the key persons can also be entered for the assets. FIGS. 19-20 show examples of processes, mechanisms, or interfaces for managing an asset domain of a business.

Liabilities domain information can be entered and/or received (step 14510). Liabilities information can include the business's current liabilities, long term liability, owner equity, and/or annual debt service. FIG. 21 shows an example of an entry screen for managing a liability domain of a business.

Cash flow domain information can also be computed based on (step 14512). The cash flow can be computed by a business cash flow design interface configured to compute a cash flow of the business based on a business valuation and at least a portion of the business financial domains. The cash flow information can provide an overview of the net income of the business. FIG. 22 shows an example of a screen for displaying computation of a cash flow of the business.

An option to keep or sell the business at the death of the client can be entered and/or received (step 14514). Information regarding the desired transfer of the client's business interest can include answers for business questions, family questions, and/or business value questions. FIGS. 23-24 show examples of processes, mechanisms, or interfaces for managing entry of keep/sell options for the business.

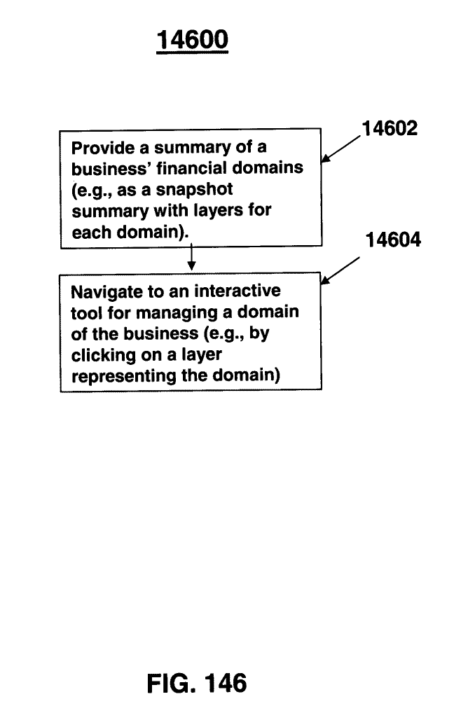

FIG. 146 is a flow chart of a process for providing a business's financial domains mechanism to insurance professionals on a platform in accordance with one embodiment of the invention. The steps of FIG. 146 can be used in conjunction with, for example, the steps of FIGS. 4, 5, 6, 8, and 9 to provide the business's financial domains to the client/user.

A summary of business current financial condition is provided based on the business's financial domains information previously entered, e.g., from the process of FIG. 145 (step 14602). A snapshot summary with layers for each domain can be displayed. FIG. 25 shows an example of a summary of the financial domains of the business. A user can navigate to an interactive tool for managing a domain of the business (step 14604). For example, a user can click on a layer representing the domain.

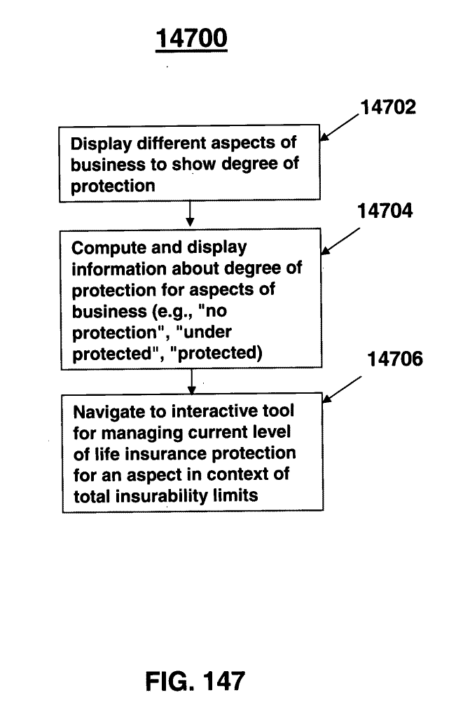

FIG. 147 is a flow chart of a process for providing a current overview of a business protection mechanism to insurance professionals on a platform in accordance with one embodiment of the invention. The steps of FIG. 147 can be used in conjunction with, for example, the steps of FIGS. 4, 5, 6, 8, and 9 to provide the current overview of the business protection.

Different aspects of the business are displayed to show a degree of protection for the aspects (step 14702). A plurality of aspects for a plurality of businesses can be displayed. Such information can include human life value, key person, mortgages and loans, business transfers, and/or estate tax impact. The aspects can be a component of different financial domains of the business. FIG. 26 shows an example of a table showing the aspects of different businesses.

Information about a degree of protection for the aspects of the business can be computed and displayed (step 14704). The displayed degrees can include “protected”, “under protected” or “no protection.” FIG. 25 shows an example of a table showing degrees of protections for different aspects of different businesses.

A user can navigate to an interactive tool for managing current level of life insurance protection for an aspect in context of total insurability limits (step 14706). For example, the user can click on a button for “no protection” under the “key person” aspect of a business. A chart for the degree of protection for an aspect (or an aggregate of all the aspects) can be displayed. The chart for the aspect can be a bar chart comprising a bar for the current level of insurance protection and another bar for available insurance protection. FIGS. 27-32 show examples of interactive tools for managing degrees of protections for the different aspects of the business.

FIG. 148 is a flow chart of a process for providing a personal planning mechanism of insurance coverage for a client and the client's family to insurance professionals on a platform in accordance with one embodiment of the invention. The processes and interfaces for entering personal planning information for life insurance or other insurance purposes is also described in conjunction with FIGS. 33-45 and/or in related U.S. patent application Ser. Nos. 12/113,087, 11/891,616, 11/510,537, and/or 60/763,200. Briefly, information entered in the following steps can be used to compute, generate, or otherwise predict and plan the personal financial condition of the client/client's family and the business financial condition of the business at the death of the client. The steps of FIG. 148 can be used in conjunction with, for example, the steps of FIGS. 4, 5, 6, 8, and 9 to provide the personal planning mechanism.

Human life value information is received (step 14802). Human life value information can include the personal financial domains information for the client currently (e.g., protection insurance, income producing assets, liabilities, cash flow). At death human life value information can also be entered. Assumptions about the different financial domains of the client at the death of the client (e.g., such as additional life insurance, tax rates, business values, short and long term expenses due to death, different types of cash flows, etc). The assumptions and the current human life value can be used to compute and display the at-death human life value (e.g., through projection cost of living increases, interest payments on loans, etc.). FIGS. 33-34 show examples of interfaces for managing the human life value information for the client.

Income replacement value is received (step 14804). Income replacement value includes information about the current personal financial domains of the client. Based on at-disability assumptions about the client (e.g., amount of disability insurance), at-disability income replacement values can also be projected for each of the personal financial domains. FIG. 35-37 show examples of interfaces for managing the income replacement value information for the client.

A desired cash flow goal of the client is received (step 14806). A plurality of scenarios and/or strategies can be entered. The scenario information can include information about the protection (e.g., type of benefits and protections), assets (e.g., value of assets, time value of money, appreciation or depreciation in value), liability (e.g., short/long term loan, mortgage, tax rate) and personal financial domain of the client. A cash flow for each of the domains can be computed based on cash in and out flow for each of the domains (e.g., annual insurance premiums out low for protection domain, annual contribution in flow for assets, loan payment for liability). FIGS. 38-40 show examples of interfaces for managing the cash flow for the client.

Interactive snap shot summary of the client's financial domains over a period of time can be computed and displayed based on the data entered (step 14808). A plurality of scenarios showing different aspects of the financial domains of the client at different time periods can be displayed. For example, two summaries for a first age (current age), and a second age (retirement age, or near death age) can be displayed. Different domains can be displayed in a sequence (e.g., display liability for first age, display liability for second age, display assets for first age, etc.) Cash flow and net worth at the different ages can also be computed and displayed. Based on the summaries, the user can re-enter and modify the data entered to modify the financial condition of the client's family at the first and/or second age. For example, processing can step back to step 14802. FIGS. 41-52 show an example of interactive snap shot summaries of the client's financial domains, including cash flow, over a period of time.

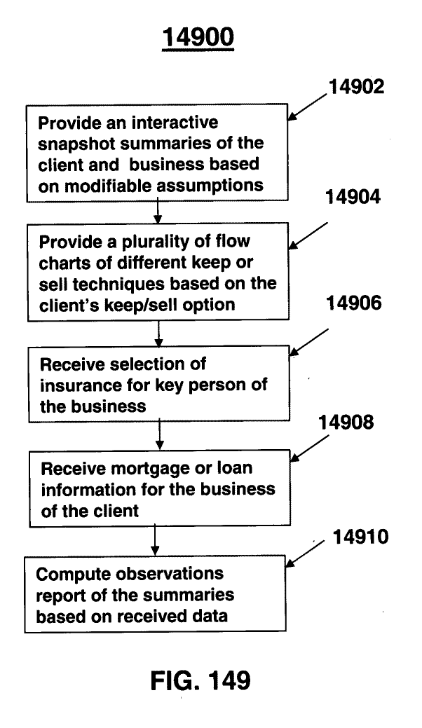

FIG. 149 is a flow chart of a process for providing an information and analysis for a client's business continuity mechanism to insurance professionals on a platform in accordance with one embodiment of the invention. Generally, the process provides different graphically represented scenarios for planning from the perspective of a business, surviving owner of a business, and/or surviving family members at the death of the owner (client) of the business. This is because these stakeholders face different challenges at the owner's death. Thereby, business continuity can be realized through implementation of sound keep/sell oriented strategies and products. The process identifies potential problems with the client's current situation and allows a user to design appropriate life insurance or other insurance solutions. The steps of FIG. 149 can be used in conjunction with, for example, the steps of FIGS. 4, 5, 6, 8, and 9 to provide information and analysis for the client's business continuity.

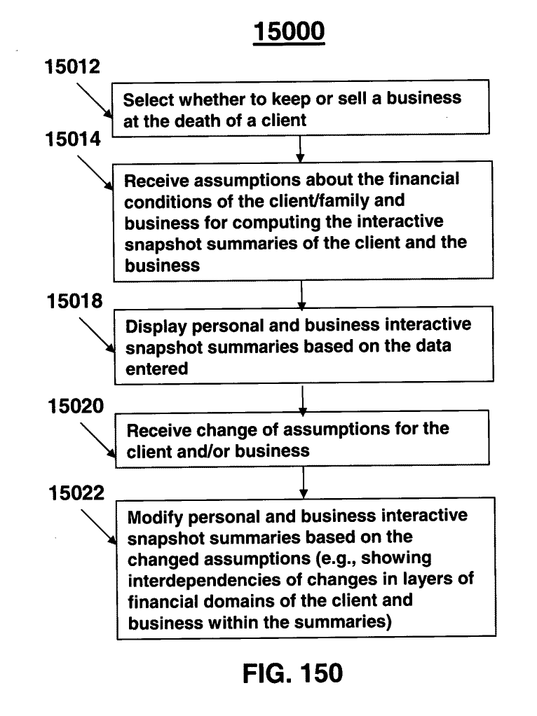

An interactive snapshot summaries of the client and business is provided based on modifiable assumptions (step 14902). For example, a personal interactive snapshot summary can be provided side-by-side with a business interactive snapshot summary. The summaries can provide information about different financial domains for a current situation or an at-death scenario. FIGS. 54-73, 82-89 show examples of interfaces for managing the summaries. The process for performing this step can be the process of FIG. 150.

A plurality of flow charts of different keep or sell techniques/strategies based on the client's goals is provided based on selected keep/sell options (step 14904). The flow charts can show icons representing entities, such as the business, insurance company, IRS, key person/participant, owners, etc. The flow chart can show arrows between the icons to represent flows of monies, benefits, rights, or obligations (e.g., from legal documents). The keep or sell techniques/strategies can differ based on the previous information entered (death value, liability considerations, life insurance amount, etc). Supplemental information about the techniques can also be displayed. Selecting a technique will display a story flow chart of the technique. FIGS. 74-81, 89-90 show examples of flow charts of different keep or sell techniques/strategies.

Insurance for key person(s) of the business can be received (step 14906). The amount of key person insurance a company can or should purchase for an employee can be received. Factors to estimate economic loss of key person (e.g., the factor ratio of the worth of the key person to the business) can also be received. Assessments of whether the insurance for the key person(s) are adequate can also be computed and provided. FIG. 91 shows an example of an entry screen for managing key person insurance.

Mortgage and/or loan information for the business of the client can be received (step 14908). Assumptions about the mortgage and/or loan can be entered, including business tax rate, profit margins, loan types, original mortgage amounts, current balance, mortgage rate, mortgage term, years to payoff, mortgage payment, etc. A simulation of necessary cash flow and business gross income to pay down any liabilities (e.g., mortgages and/or loans) can be computed based on the assumptions provided. For example, the cash flow (out-flow) can be computed as the mortgage payment over a time period for the amount of the original loan amount compounded by the mortgage rate over the time period. Assumption and payment information can be entered. Total debt and total cash flow required can also be displayed.

Additionally, observations reports of the summaries can also be computed, including buy and/or sell reports, based on questions asked of the client and entered into the system using various user interface screens (step 14910). The observations report can include the snapshot summary, assumptions entered, personal financial information, and the like. FIGS. 132-142 show examples of observations reports of the summaries for the business and/or client.

FIG. 150 is a flow chart of a process for providing a balance sheet summary of the business for a keep/sell option to insurance professionals on a platform in accordance with one embodiment of the invention. The steps of FIG. 150 can be used in conjunction with, for example, the steps of FIGS. 4, 5, 6, 8, and 9 to provide the balance sheet summary of the business for a keep/sell option.

A user selects whether to keep or sell a business at the death of a client (step 15012). The keep/sell options can be entered in an observations entry screen or other selection mechanism for a business. The keep/sell information entered can comprise answers to question about the business (e.g., how will ownership pass, do employees have incentive to stay, etc.), and/or family (e.g., who will be buying business interest, what is current fair market value of business). A template to design various keep/sell solutions can also be provided. FIGS. 23-24 show examples of processes, mechanisms, or interfaces for managing keep/sell options information. FIG. 53 shows an example of a screen for providing keep/sell selection information.

Assumptions about the financial conditions of the client/family and business can be received for computing the interactive snapshot summaries of the client (personal) and the business (step 15014). The user can also select whether to keep or sell by modifying the assumptions. Assumptions can include observations (e.g., whether to keep or sell the business, value of the business), additional life insurance (e.g., additional life insurance for business or personal family), liability considerations (e.g., whether information about buy/sell, key person, mortgage or loan, or estate tax or a combination thereof are to be considered in the summary and displayed), and other assumptions (e.g., rate of return on monies and the scenario to display—current, or predicted at-death). FIGS. 54-73, 82-88 show examples of interfaces for managing the assumptions.

A personal interactive snapshot summary and a business interactive snapshot summary can be displayed based on the data entered (e.g., keep/sell option and assumptions) (step 15018). The snapshot summary can display a plurality of layers for different aspects of the domains. For example, the business and personal summary can show the same four main domains (protection, assets, liabilities, and cash flow). The business summary can show specific business layers such as types of protection, assets, liabilities, and owner's equity. The personal summary can show specific client/family layers such as types of protection, assets, liabilities, and net worth. The interactive snapshot summaries can be shown side-by-side to show the interdependencies of the financial domains of the business and the client and the impact of the financial domains on each other. A user can step through displaying various portions of the domains in a sequence, to better understand the impact and interdependencies. FIGS. 54-73, 82-88 show examples of interfaces for managing the interactive snapshot summaries.

A change of assumptions for the business and/or client can be received (step 15020). Modifying the assumption of the business and/or client, and/or the business and/or personal financial condition can comprise selecting a business owned life insurance policy for a key person of the business. The user can change the assumptions by re-entering or changing the information, such as providing additional life insurances for the business and/or client, toggling between keeping and selling the business, or the like. FIGS. 54-73, 82-88 show examples of interfaces for changing the assumptions.

A change of the interactive snapshot summaries can be displayed based on the change in the assumptions (step 15022). Various financial domains of the business and/or client and their interdependencies can be computed based on the changed assumptions. Interdependencies of changes in layers of financial domains of the client and business within the summaries can be shown.

Displaying the change(s) of the business summary can include displaying an impact on the liability of the business based on a business death benefit. The business death benefit can include payments for business owned life insurance. The liability includes funding a purchase of an ownership in the business, paying a mortgage or loan of the business, or replacing lost profits due to the death of a key person of the business. Displaying the change of business summary can include displaying an impact on an asset of the family as a debt in an amount of a value of the business less at least a portion of the business death benefit.

Displaying the change(s) of personal summary can include computing a personal cash flow of the personal financial condition based on at least two of a savings rate of the family, a spending rate of the family, an income of the family, and an income replacement comprising disability insurance payments, retirement income, or savings; computing a net worth of the family based on an asset of the family, a liability of the family, and the change in the personal death benefit; and displaying the computed personal cash flow and net worth in the personal summary.

Displaying the change(s) can be based on options entered as part of modified assumptions. For example, if an option is selected to sell an ownership of the business by the family at the death of the client, an owner's equity of the business financial condition can be computed and displayed based on a mortgage or loan liability of the business, a contractual requirement to purchase the ownership by the business for a value of the business, and the change in the business death benefit. A business cash flow of the business financial condition can also be computed and displayed based on the mortgage or loan liability of the business and the change in the business death benefit. A liability of the personal financial condition can also be computed and displayed based on a debt owed by the business for at least a portion of a value of the business that is unfunded by the change in the business death benefit. And, a cash flow of the personal financial condition can be computed and displayed based on any assets paid by the business for the ownership.

In another example, if an option is selected to keep an ownership of the business by the family at the death of the client, an owner's equity of the business financial condition can be computed and displayed based on a mortgage or loan liability of the business and the change in the business death benefit. And, a business cash flow of the business financial condition can be computed and displayed based on the mortgage or loan liability of the business and the change in the business death benefit.

In another example, liabilities of the business can be funded by additional business owned life insurance. One of the business liabilities could be a requirement to fund the purchase of the business ownership from the family. Net worth of the business can increase because the liabilities are funded by the additional funds and/or any excess additional funds. Cash flow of the business can improve (increase inflow and decrease outflow) because of additional funds. The family's assets can also be increased via the cash from the purchase of the business. The family's net worth can increase based on the increase assets. And, cash flow of family can improve based on the additional assets. FIGS. 54-73, 82-88 show examples of a change in the assumptions causing a change in the interactive snapshot summaries.

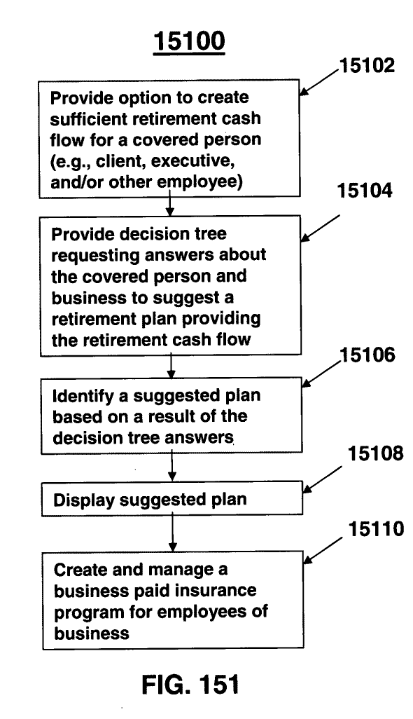

FIG. 151 is a flow chart of a process for providing a business sponsored and/or executive benefit determination mechanism to insurance professionals on a platform in accordance with one embodiment of the invention. A process for managing business sponsored benefits for retirement plans and executive plans are similar. The steps of FIG. 151 can be used in conjunction with, for example, the steps of FIGS. 4, 5, 6, 8, and 9 to provide the business sponsored and/or executive benefit determination mechanism.

The option to create sufficient retirement cash flow for a covered person (client, employee(s), and/or executive) is provided (step 15102). A plurality of assumptions about the covered person can be entered, including age of the person, years to retirement, study period for providing the cash flow analysis, current income of the person, income increase over a period, annual savings rate, current retirement value, rate of return (pre and post retirement), any guaranteed retirement income and/or any business sponsored benefits. The income can be computed by the current income growing at the income increase rate and the retirement income can be the savings amount (based on the savings rate over the period), any guaranteed retirement income and/or business sponsored benefits. FIGS. 93-94, 99, 107-108, and 114 show examples of interfaces for managing retirement cash flow for the client and/or employee(s). FIGS. 95-98, and 109-113 show examples of other interfaces for providing information different retirement plans.

A decision tree requesting answers about the covered person and business is provided to suggest a retirement plan providing the retirement cash flow (step 15104). The decision tree can be particular to a selected key person, executives, client, employees or any combination thereof. FIGS. 100 and 115 show examples of decision tree entry interfaces for suggesting a retirement plan. Examples of decision trees for managing qualified plans, retirement plans, and executive plans are shown in FIGS. 153-159.

A suggested plan is identified based on a result of the decision tree answers (step 15106). A link and name of the plan can be provided. A plurality of menu screens about the plan (e.g., flow chart, highlights, numerical examples, etc.), can be provided. FIGS. 100 and 115 show examples of interfaces for identifying the suggested plan.

The suggested plan is displayed (step 15108). The suggested plan can be displayed as highlights, flow charts and/or numerical example(s) for the covered person and the business. FIGS. 101-106, 116-126 show examples of interfaces for displaying the suggested plan.

A business paid insurance program for employee(s) can also be created and managed (step 15110). The business paid insurance program can be based on the results of the suggested plans for a plurality of covered persons related to the business. For example, the system can provide a suggested business paid insurance program based on a plan that is optimal for the plurality of covered persons. The business paid insurance program can be created by importing/uploading an FDP illustration, generating the illustration for the insured, and generating a report of a projected cash flow, cash value, and death benefits result for both the business and insured participants. The cash flow can be a detailed numerical example. FIGS. 127-130 show examples of interfaces for managing business paid insurance program for employee(s).

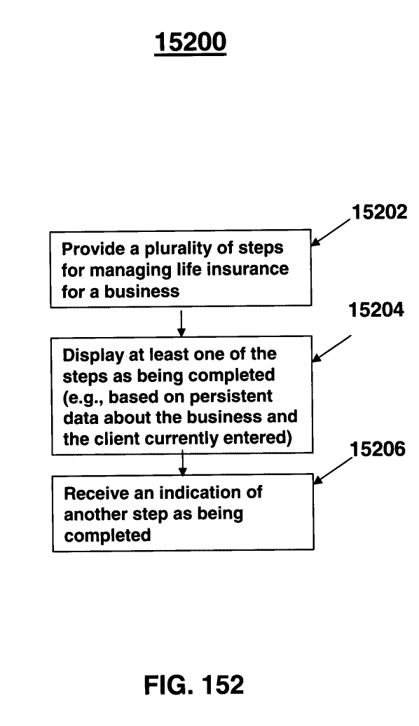

FIG. 152 is a flow chart of a process for providing confirmations of action steps mechanism to manage a life insurance or other insurance for a client with business interests to insurance professionals on a platform in accordance with one embodiment of the invention. The steps of FIG. 152 can be used in conjunction with, for example, the steps of FIGS. 6-7 to provide the confirmations of action steps mechanism.

A plurality of steps for managing life insurance or other insurance for a business is provided (step 15202). The steps include, among other things, increasing personal life insurance protection, implementing additional disability income protection, updating necessary business legal documents, funding buy and/or sell agreements, insuring key employees for their (e.g., full) replacement value, obtaining insurance to eliminate business debts and mortgages, establishing a business sponsored retirement program, establishing a business sponsored executive benefit plan, and/or evaluating possible business pay insurance options. Display at least one of the steps as being completed (step 15204). The indication of completion can be automatic and/or based on persistent data about the business and the client currently entered, e.g., generated by recorded actions of the user through the system. An indication of another step as being completed can be received (step 15206). FIG. 131 shows an example of an interface for providing confirmations of action steps.

Illustrative Interfaces and Related Possesses

FIGS. 11-142 are diagrams of illustrative display pages for implementing interactive methods and systems for insurance related activities in accordance with embodiments of the invention. FIGS. 11-142 show user interfaces and processes for managing business scenarios for life insurance or other insurance choices, among other things.

Generally, the interfaces partition the pages into different stages, including an introduction stage, data gathering stage, presentation stage, and/or delivery stage, as described in more detail in U.S. patent application Ser. Nos. 12/113,087, 11/891,616, 11/510,537, and/or 60/763,200. FIGS. 11-142 focus on the data gathering, presentation and/or delivery stage.

The interfaces described herein show various layouts of components for managing different types of data about a business of a client, a client, insurance protections for the business and the client, and the interrelationship between the types of insurance protections. The components for managing the different types of data can be shown side-by-side to show the interrelationship between the types of data.

The components can enable financial factors to be associated with one or more categories or domains such as protection, assets or asset building, liabilities and cash flow. The one or more factors can be displayed in a table on the display page, which can be arranged to illustrate the factors within each category. Moreover, the table can be arranged in columns and rows. The categories and factors can be positioned in the columns and rows. Each category can be displayed on the display page in a different color such that the one or more factors can be displayed in substantially the same color as the category with which the one or more factors is associated. In one embodiment, a cursor or pointer can be positioned proximate the one or more factors such that an indicia appears. The indicia can be a field containing a description of the factor.

For example, a layer can provide different data types associated with different financial domains of a business or a client and can show the domains side-by-side, or one on top of another, or any other arrangement, such that a user can easily see the interrelationship between the data. Also, a domains views (e.g., protection, assets, liabilities, and cash flow) for a client can be shown side-by-side with the domains views for the client's business. The types of data can be color coordinated. For example, protection data can be colored one color, while assets can be colored another, liabilities another color, and cash flow another color. In this way, a client or user can easily understand the interrelationship between the financial information between the client and the client's business.

Generally, there can be a plurality of steps to manage data provided by the interfaces, such that stepping through the steps allows the users to understand more about the financial health of the business and/or client and to better show the client the need for business and/or personal insurance protections.

The interfaces described herein can provide a plurality of screens with varying details. The screens can be navigated to by sending a request to a web host and receiving another web page, for example, or the screens can be changed dynamically within a browser of an agent or a user. The dynamic changes can be enabled by various mechanisms, including embedded objects (e.g., Flash, ActiveX), dynamic HTML, JavaScript, etc.

At least some examples shown in the interfaces described use a hypothetical scenario to illustrate a process, and does not constrain the process to the examples shown. Any client or business can be managed by the interfaces and processes shown.

In the example described, as equal partners, Kyle and Kevin Abernathy have built a successful business over the past 18 years. They have two business entities, a C Corporation that conducts the major business operations and a real estate partnership that owns the land and buildings where the business resides. A user of the business related interfaces can proceed to the business interfaces and examine the current overview assessments to discover Kyle's total insurability limits. Then, using the business continuity module, the user can analyze or review the case for additional life insurance or other insurance in order to accomplish both personal and business financial objectives.

Business Data Gathering and Presentation

A presentation for managing and/or presenting a plurality of life insurance or other insurance options to business owners, can begin with a presentation stage for providing an overview insurance needs for the client and/or client's business. FIG. 11 shows an example of a user interface including a dashboard for managing a client's life insurance or other insurance related needs (e.g., the needs of a business). As shown, a current balance sheet section is initially displayed, which can provide an effective starting point for discussion with a client and for understanding the client's life insurance needs. Interactive summary section 1100 is preferably an initial display page that is presented to a user when the user begins managing the presentation. As shown, the interface includes a data flow menu which includes introduction menu item 1101, data gathering menu item 1102, presentation menu item 1103, and delivery menu item 1104. As shown, the current option selected is presentation menu item 1103. A user can select any of the steps to display an interface for providing the appropriate information (e.g., introduction, data gathering, presentation, delivery).

The interface also includes a left hand menu which includes business left menu item 1105, current balance sheet menu item 1109 (shown as currently selected), business data menu item 1112, business LBS menu item 1113, current overview menu item 1106, personal planning menu item 1114, business continuity menu item 1115, business sponsored benefits menu item 1116, action steps left menu item 1117, tools left menu item 1118, and to do list left menu item 1119. A user can select any of the menu items to navigate to any tool for managing the client's life insurance or other insurance related needs identified by the menu item.

In operation, the user can click on any of the components to navigate to the interfaces associated with the component. For example, business left menu item 1105 can navigate the user to the pages related to business as described herein, current balance sheet menu item 1109 can navigate the user to the pages related to current balance sheet as described herein, etc.

The interface shows the interactive summary section 1100 of the client for the client's personal and family related information. Current balance sheet 1160 includes protection layer 1111 (which includes property and casualty insurance layer 1120, disability and health insurance layer 1121, legal documents layer 1122, life insurance layer 1123), assets layer 1107 (which includes personal property assets layer 1140, savings assets layer 1141, investments assets layer 1142, retirement assets layer 1143, real estate assets layer 1144, business assets layer 1145, total assets layer 1146), liabilities layer 1108 (which includes short term liabilities layer 1155, taxes liabilities layer 1156, mortgages liabilities layer 1157, business debt liabilities layer 1158, total liabilities layer 1159), the net worth total layer 1110 which shows the assets total layer 1146 less the liabilities total layer 1159, and the cash flow layer 1147 (which includes gross income cash flow layer 1148, protection cash flow layer 1149, assets cash flow layer 1150, liabilities cash flow layer 1151, net income cash flow layer 1152).

In operation, the user can click on any of the layers to navigate to the interfaces associated with the layer. For example, protection layer 1111 can navigate the user to a page related to the personal (life) insurance protection pages as described herein, casualty insurance layer 1120 can navigate the user to a page related to the personal casualty insurance pages as described herein, assets layer 1107 can navigate the user to a page related to the personal assets pages of the client as described herein, etc.

The user can also select and/or press element “Back to Data Gathering” button 1153 and/or “Business Data” button 1154 to navigate to interfaces for data gathering of personal data of the client, and/or for providing business data for a business of the client, respectively.

The user can choose to manage the business data of the client. A section in the stage for managing business data can be the display shown in FIG. 12. FIG. 12 shows an example of a user interface for managing business data including valuation information. As shown, the interface includes a valuation component 1200 that comprises business information component 1202, valuation component 1203, and help box 1204 which displays information about the operation of the page. Business information component 1202 includes total business value component 1205, tax basis component 1206, owners component 1207, ownership % component 1208 (which shows as an example Kyle Abernathy owning 50.0% of the business), and ownership % component 1209 (which shows as an example Kevin Abernathy owning 50.0% of the business). Valuation component 1203 includes valuation method component 1210, which shows binding agreement component 1213 as selected, as an example, gross income component 1211, net income component 1212, and supplemental information link 1214. Valuation method component 1210 can be selected to be any of a variety of methods, including Adjusted Book Value, Capitalized Earnings, Subjective Assessments, Binding Agreement, or other, as shown in menus 1230. Supplemental information link 1214 enables navigating to more information about the business information and valuation data and/or methodology.

In operation, a user can select and/or press element 1218, and in response information entered in the interface, such as the valuation method 1210, the split of ownerships between the owners (Ownership % Components), gross income 1211, or net income 1212 can be saved.

The next step in the stage for managing business data can be the display shown in FIG. 13. FIG. 13 shows an example of a user interface for managing business data including management of financial domains for a business of a client, and more particularly overview information for the domains. As shown, the interface includes a financial information domains component 1300 which enables management for at least some domains. Domains component 1300 includes protection layer 1302, assets layer 1303, liabilities layer 1304, and cash flow layer 1305. In operation, a user can select and/or press elements 1302-1305 to manage any of the particular domains (e.g., navigating to a data entry page for the domains). A user can also enable the interface shown by checking radio box 1306, and a user can select another view radio box to navigate to another view of the financial information domains.

The next step in the stage for managing business data can be the display shown in FIG. 14. FIG. 14 shows an example of a user interface for managing business data including management of financial domains for protection of assets for a business of a client, and more particularly property and casualty insurance information. As shown, the interface includes a menu tab for managing the protection domain, which includes property and casualty insurance menu tab 1402, disability and health insurance menu tab 1403, legal documents menu tab 1404, life insurance menu tab 1405, and current overview menu tab 1406.

The interface also shows property and casualty insurance component 1400 which includes a plurality of coverage types 1408 for particular insurance company names 1409, renewal dates 1411, and annual premiums 1410. The coverage types 1408 includes property insurance layer 1413, liability insurance layer 1414, commercial automobile insurance layer 1415, worker's compensation insurance layer 1416, business interruption insurance layer 1417, errors and omission malpractice liability insurance layer 1418, employment practice liability insurance layer 1419. Information for the layers can be entered as shown. The total for the annual premiums 1410 is displayed in total annual premiums 1412.

In operation, the total annual premiums 1412 can be updated as the user enters the information for the coverage type rows. The information can be saved by clicking on save button 1423. A user can also enable the interface shown by checking radio box 1422, and a user can select another view radio box to navigate to another view of the financial information domains.

The next step in the stage for managing business data can be the display shown in FIG. 15. FIG. 15 shows an example of a user interface for managing business data including management of financial domains for protection of assets for a business of a client, and, more particularly, disability and health insurance information. As shown, disability and health insurance menu tab 1502 is highlighted in the navigation menu bar indicating that the interface is for disability and health insurance component 1500. Disability and health insurance component 1500 includes coverage types 1507 of a plurality of types for different insurance companies 1508, annual premiums 1509, renewal dates 1510, business pay %'s 1511, and annual premiums 1506 (annual premiums for the business 1512, and annual premiums for employees 1513). The coverage types 1507 include values for group medical layer 1515, group life layer 1516, group dental layer 1517, group short term disability layer 1518, group long term disability layer 1519, individual multi-life DI layer 1520, individual multi-life LTC layer 1521, retirement plan contribution DI layer 1522, business overhead DI layer 1523, and disability buyout layer 1524. The annual premiums 1506 are subtotaled in amount layer 1535. The annual premiums 1506 for the business are also shown in total annual business premiums 1536.

In operation, the total annual business premiums 1536 can be updated as the user enters the information for the coverage type rows. The information can be saved by clicking on save button 1540. A user can also enable the interface shown by checking radio box 1541, and a user can select another view radio box to navigate to another view of the financial information domains.

The next step in the stage for managing business data can be the display shown in FIG. 16. FIG. 16 shows an example of a user interface for managing business data including management of financial domains for protection of assets for a business of a client, and more particularly legal documents information. As shown, the interface that includes legal documents menu tab 1603 is currently highlighted in the navigation menu bar indicating that the interface is for legal documents component 1600. Legal documents component 1600 includes a plurality of document types 1606 for a plurality of dates established 1607, and dates last reviewed 1608. Document types 1606 include business organization agreement layer 1609, buy/sell agreement layer 1610, employment agreements layer 1611, bonus plans layer 1612, deferred compensation agreements layer 1613, SERP agreements layer 1614, split dollar layer 1615, disability salary continuation layer 1616, qualified sick pay plan layer 1617, vacation pay plan layer 1618, and qualified plans layer 1619.

In operation, the information entered can be saved by clicking on save button 1620. A user can also enable the interface shown by checking radio box 1622, and a user can select another view radio box to navigate to another view of the financial information domains.

The next step in the stage for managing business data can be the display shown in FIG. 17. FIG. 17 shows an example of a user interface for managing business data including management of financial domains for protection of assets for a business of a client, and more particularly life insurance or other insurance information. As shown, the interface that includes life insurance menu tab 1704 is currently highlighted in the navigation menu bar indicating that the interface is for life insurance component 1700. Life insurance component 1700 includes Permanent Life Insurance (PLI) bonus component 1707, split dollar component 1708, split dollar loan component 1709, employer owned component 1710, policy component 1711, and retirement plan component 1712 which enables adding life insurance assets for the business (e.g., by clicking an “add” button). Total annual business premiums component 1713 is also provided and shows the total of the annual premiums of all the insurance assets. Each insurance asset can include a policy type component 1714, owner component 1715, insured component 1716, beneficiary component 1717, purpose component 1718, cash value component 1719, death benefit component 1720, annual premium component 1721, and total amount layer 1722 to show the associated information for the insurance asset.

In operation, the insurance assets can be added by clicking the appropriate “add” button, information for the particular insurance assets can be modified, and the premium totals can be displayed. A user can also enable the interface shown by checking radio box 1725, and a user can select another view radio box to navigate to another view of the financial information domains.

The next step in the stage for managing business data can be the display shown in FIG. 18. FIG. 18 shows an example of a user interface for managing business data including management of financial domains for protection of assets for a business of a client, and more particularly current overview information of the protection domain for the business. As shown, the interface that includes current overview menu tab 1805 is currently highlighted in the navigation menu bar indicating that the interface is for current overview component 1800. Current overview component 1800 includes human life value column 1807 with protection choice human life value menu 1812, key person column 1808 with protection choice key person menu 1813, mortgages and loans column 1809 with protection choice mortgages and loans menu 1814, keep/sell (of a business or its assets) column 1810 with protection choice keep/sell menu 1815, and estate tax impact column 1811 with protection choice estate tax impact menu 1816. The menu items enable the user to choose or indicate protection levels for the particular aspects of the business at the death of an owner (client): protected, under protected, or not protected by appropriate life insurance or other insurance choices.

In operation, the information can be saved by clicking the appropriate “save” button 1830. A user can also enable the interface shown by checking radio box 1831, and a user can select another view radio box to navigate to another view of the financial information domains.

The next step in the stage for managing business data can be the display shown in FIG. 19. FIG. 19 shows an example of a user interface for managing business data including management of financial domains for assets for a business of a client. As shown, the interface includes a menu which includes assets menu tab 1901 (highlighted) and key persons menu tab 1902. The interface also includes assets layer 1900, which comprises current assets column 1903, fixed assets column 1904, intangible assets column 1905, total assets column 1906, and annual retirement plan contributions column 1907.

Current assets layer 1903 includes current assets cash input 1908, current assets accounts receivable input 1909, current assets savings input 1910, current assets investments input 1911, current assets prepaid expenses input 1912, current assets notes receivable input 1913, current assets inventory input 1914, and other current assets input 1915 for managing the associated information. A user can enter information in the appropriate current assets rows, and current assets total 1926 will be updated with the layers' total.

Fixed assets layer 1904 includes fixed assets vehicles input 1916, fixed assets furniture input 1917, fixed assets equipment input 1918, fixed assets buildings input 1919, fixed assets land input 1920, and other fixed assets input 1921 for managing the associated information. A user can enter information in the appropriate current assets rows, and fixed assets total 1925 will be updated with the layers' total.

Intangible assets layer 1905 includes intangible assets goodwill input 1926, intangible assets contracts/patents input 1922, and other intangible assets input 1923 for managing the associated information. A user can enter information in the appropriate current assets rows, and intangible assets total 1924 will be updated with the layers' total.

Total assets layer 1906 shows the total of the current assets total 1926, fixed assets total 1925, and intangible assets total 1924. Annual retirement plan contributions input 1907 shows annual retirement plan contributions information entered for the client and/or the client's business.

In operation, the information can be saved by clicking the appropriate “save” button 1930. A user can also enable the interface shown by checking radio box 1931, and a user can select another view radio box to navigate to another view of the financial information domains.

The next step in the stage for managing business data can be the display shown in FIG. 20. FIG. 20 shows an example of a user interface for managing business data including management of financial domains for assets for a business of a client and more particularly key person(s) information. As shown, the interface includes a menu which includes key persons menu tab 2022 (highlighted). Key persons component 2000 includes key persons add component 2003, key person name column 2004, and annual compensation column 2010. As an example, as shown, Kyle Abernathy layer 2005 is associated with $450,000 annual compensation in amount column 2011; Kevin Abernathy layer 2006 is associated with $450,000 annual compensation in amount column 2012; Louis Jones layer 2007 is associated with $100,000,000 annual compensation in amount column 2013; and Martha Smith layer 2008 is associated with $100,000 annual compensation in amount column 2014. The total of the amount columns are displayed in total annual compensation column 2009 (e.g., $1,100,000).

In operation, a user can add another key person of the business and their associated compensation by clicking add component 2003. A user can also enable the interface shown by checking radio box 2031, and a user can select another view radio box to navigate to another view of the financial information domains.

The next step in the stage for managing business data can be the display shown in FIG. 21. FIG. 21 shows an example of a user interface for managing business data including management of financial domains for liabilities for a business of a client. The interface shows liabilities layer 2100 which comprises current liabilities chart column 2101, long term liabilities chart column 2102, and owner's equity chart column 2103.

Current liabilities chart column 2101 includes current liabilities accounts payable layer 2107, current liabilities business taxes layer 2108, current liabilities short term notes layer 2109, current liabilities income taxes layer 2110, and current liabilities other layer 2111 for managing the associated information. A user can enter information in the appropriate current assets rows, and total of current liabilities total layer 2119 will be updated with the layers' total. Long term liabilities chart column 2102 includes long term liabilities long term notes layer 2112, long term liabilities mortgages layer 2113, and long term liabilities other layer 2114 for managing the associated information. A user can enter information in the appropriate current assets rows, and long term liabilities total layer 2120 will be updated with the layers' total. Owner's equity chart column 2103 includes owner's equity contributed capital layer 2115, owner's equity other layer 2116, and owner's equity equity/retained earnings column 2117 (e.g., $8,850,000) for managing the associated information. A user can enter information in the appropriate current assets rows, and owner's equity total column 2121 will be updated with the layers' total. The total of current liabilities total layer 2119, long term liabilities total layer 2120, and owner's equity total column 2121 is displayed in total liabilities and owner's equity column 2104 (e.g., $11,700,000). A user can also enter the business's annual debt service column 2105 (e.g., $300,000).

In operation, the information can be saved by clicking the appropriate “save” button 2130. A user can also enable the interface shown by checking radio box 2131, and a user can select another view radio box to navigate to another view of the financial information domains.

The next step in the stage for managing business data can be the display shown in FIG. 22. FIG. 22 shows an example of a user interface for managing business data including management of financial domains for cash flow(s) for a business of a client. The interface shows cash flow layer 2200 which comprises a plurality of rows, each layer having amounts shown in amount column 2208 and totals shown in total column 2209. The layers show aspects of cash flow, including gross income 2203 with a total in total gross income column 2220, protection 2204 with a total in total protection column 2221, asset building 2205 with a total in total asset column 2222, expenses column 2206 with a total in total expenses column 2223. The totals are summed into net income total column 2224. Protection 2204 includes property/casualty insurance 2211, disability/health insurance 2212, and business pay term life insurance 2213. Asset building 2205 includes PLI bonus column 2214, split dollar column 2215, employer owned column 2216, retirement plans column 2217 (which includes PLI premiums column 2218 and investments column 2219).

In operation, the information for each of the totals are determined or generated from information stored for each of the other domains of the business described above (e.g., assets, liabilities; and protections) and used to determine the amount in net income total column 2224. A user can also enable the interface shown by checking radio box 2231, and a user can select another view radio box to navigate to another view of the financial information domains.

The next step in the stage for managing business data can be the display shown in FIG. 23. FIG. 23 shows an example of a user interface for managing business data including management of keep or sell options of the business at the death of an owner and, more particularly, overview information of the keep or sell options. The interface shows keep/sell overview menu 2302, which provides a pull-down choice 2303 (undecided/keep/sell) menu. In operation, the user can select any of the choices for the client's business or business assets at the death of the owner (client). A user can also enable the interface shown by checking radio box 2331, and a user can select another view radio box 2332 to navigate to another view of the keep/sell management tool. If “sell” is chosen, radio box 2332 displays “sell”, otherwise radio box 2332 displays “keep”.

If the user selects radio box 2332, business questions 2301 can be displayed as a pop-up, or the interface can navigate to a new page with business questions 2301 displayed. The questions can be answered by text entry or pull-down lists with appropriate answer types of the questions.

Business questions 2301 includes question “What will control how your business passes?” 2304 with answers including an “Agreement” or other type of control mechanisms, question “Will relationships with outside vendors or customers be adversely affected?” 2305, question “Will it be difficult for the business to collect outstanding receivables?” 2306, question “Will your existing employees work for the new owners?” 2307, question “Do the key employees have incentive to stay with the business?” 2308, question “Are there any notes or mortgages that become immediately callable?” 2309, and question “Will the borrowing capability of the business be impaired?” 2310.

In operation, the user can select the type of keep or sell scenario and enter the questions presented. The answers are stored in a database and/or can generate operations on other data related to the user, including indicating that a display of a summary chart of the business data side-by-side with personal data should take into account selling the business (e.g., transferring the value of the business due to the deceased to the beneficiary of the deceased, from the business's balance sheet to the personal/family balance sheet). Answers to the questions can also indicate presentation of other options along with the side-by-side business/personal view, including presenting insurance or other benefits options to key persons to motivate the key persons to stay with the business if the business is sold.

The next step in the stage for managing business data can be the display shown in FIG. 24. FIG. 24 shows an example of a user interface for managing business data including management of keep or sell options of the business at the death of an owner, and more particularly sell information. As shown, the interface includes keep or sell information component 2400 which includes a plurality of questions. If the sell option is selected, family questions 2402 and business value question 2403 can be provided. If the keep option is selected, family questions 2432 and business value question 2433 can be provided. The questions can also include business questions 2301 of FIG. 23. The questions can be answered by text entry or pull-down lists with appropriate answer types of the questions.

Family questions 2402 includes question “Who will be buying your business interest?” 2411 with answers including “Co-Owners” or other entities, question “What is the current fair market value of your business?” 2412, question “How will this amount be paid?” 2413 including answers of “combination”, or other methods of payment, question “Are the terms of sale part of a binding agreement?” 2414, question “Is the agreement funded by insurance?” 2415, question “Is the sales price fair?” 2416, question “Will the business value be reduced by estate taxes?” 2417, question “Will your family rely on these proceeds for income?” 2418, and question “Will the sale of your business interest adversely affect your family legacy objectives?” 2419.

Business value question 2403 includes question “Based on these questions, what will the value of your interest in [business entity name] be at your death?” 2420. A different particular name of the business can be used for a different business of the client being managed by the interface.

Family questions 2432 includes question “What is the current fair market value of your business?” 2441, question “Will the state have sufficient liquidity to pay estate taxes on the business?” 2442, question “Can the business continue to provide adequate income for your family?” 2443, question “Will each family member receive their appropriate share of the business?” 2444, question “Will those not in the business be treated equitably?” 2445, question “Will the family be required to personally guarantee any business debt?” 2446, and question “Will your family work well with your non-family business partner?” 2447.

Business value question 2433 includes question “Based on these questions, what will the value of your interest in [business entity name] be at your death?” 2449. A different particular name of the business can be used for a different business of the client being managed by the interface.

In operation, the user can save the answers to the questions by clicking “save” buttons 2430 or 2450 for the appropriate question sets. A user can also enable the interface shown by checking radio box(es) (not shown) to navigate to another view of the keep/sell management tool.

The next step in the stage for managing business data can be the display shown in FIG. 25. FIG. 25 shows an example of a user interface for managing business data including management of a plurality of domains for the business, and more particularly a detailed view of the plurality of domains. As shown, the interface includes business domains component 2500, which comprises protection layer 2501, assets layer 2503, liabilities and owner's equity component 2502, and cash flow layer 2505.

Protection layer 2501 includes property and casualty insurance component 2507, disability and health insurance component 2508, legal documents component 2509, and life insurance component 2510.

Assets layer 2503 includes current assets layer 2511, fixed assets layer 2512, intangible assets layer 2513, and total assets layer 2514.

Liabilities and owner's equity layer 2502 includes current liabilities 2515, long term liabilities 2516, equity/retained earnings 2517, total of liabilities and equity 2518, and book value 2504 of the business (e.g., equity/retained earnings).

Cash flow layer 2505 includes gross income cash flow 2519, protection cash flow 2521, assets cash flow 2522, expenses cash flow 2523, net income cash flow 2530, and amount gross income 2520.

The interface also includes business information chart 2506, which summarizes the business. The chart includes total business value column 2524 (e.g., shown as $10,000,000), tax basis column 2525 (e.g., shown as $0), owners column 2526 which shows the owners by percentages 2527 and 2528 (e.g., Kyle Abernathy (50.00%) $5,000,000, Kevin Abernathy (50.00%) $5,000,000), and valuation method column 2531 (e.g., binding agreement).

In operation, the user can click on any of the components to navigate to the business data entry interfaces associated with the component. For example, casualty insurance component 2507 can navigate the user to the pages related to casualty insurance as described herein, health insurance component 2508 can navigate the user to the pages related to health insurance as described herein, legal documents component 2509 can navigate the user to the pages related to legal documents as described herein, etc.

The next step in the stage for managing business data can be the display shown in FIG. 26. FIG. 26 shows an example of a user interface for managing business data including a current overview of the business. The interface includes the current overview component 2600 including a plurality of layers of businesses for business entity column 2602, human life value column 2603, key person 2617, mortgages and loans column 2604, keep/sell column 2605, and estate tax impact 2606. Each of the layers shows the level of protections for each of the businesses. As an example, business entity layer 2607 has under protected human life value 2609, under protected key person 2610, no protection mortgages and loans 2611, no protection keep/sell 2612, no protection estate tax impact 2613. Business entity layer 2608 has no protection mortgages and loans 2614, no protection keep/sell 2615, and under protected estate tax impact 2616. The interface also describes the various protection levels for each of the columns.

In operation, the user can save the answers to the questions by clicking on any of the protection level buttons to manage the associated protection. A user can also enable the interface shown by checking radio box 2631, and a user can select another view radio box to navigate to another view of the keep/sell management tool.

The next step in the stage for managing business data can be the display shown in FIG. 27. FIG. 27 shows an example of a user interface for managing business data including a current overview of the business and more particularly summary information in chart form. As shown, the interface includes overview chart summary component 2700 which includes a navigation menu 2701. Navigation menu 2701 includes human life value radio box 2702, key person radio box 2703, mortgages and loans radio box 2704, keep/sell radio box 2705, estate tax impact radio box 2706, and summary radio box checked 2708 (highlighted).

Summary chart 2701 includes a comparison between total insurability versus current insurance for the business. The axis for the chart is in dollars (in $1,000s) 2713. As shown, total insurability 2710 (e.g., $24,433,875), and current insurance 2711 ($3,500,000) and the total of the two values in available insurance layer 2712 (e.g., $20,933,875).

In operation, the user can change the total insurability 2710 versus current insurance 2711 levels by, for example, clicking at the appropriate dollar amounts for the two values. A user can also enable the interface shown by checking radio box 2731, and a user can select another view radio box to navigate to another view of the keep/sell management tool.

The next step in the stage for managing business data can be the display shown in FIG. 28. FIG. 28 shows an example of a user interface for managing business data including a current overview of the business and more particularly human life value in chart form. As shown, current overview chart shows human life value radio box 2802 is selected to show human life value chart 2801. Human life value chart 2801 includes total insurability versus current insurance for the life (net) value of the business at the death of the client. The axis for the chart is in dollars (in $1,000s) 2812. The chart includes total insurability 2809 (e.g., $4,500,000), and current insurance 2810 (e.g., $2,500,000). The sum of the two values is displayed in available insurance 2811 (e.g., $2,000,000).

In operation, the user can change the total insurability 2809 versus current insurance 2810 levels by, for example, clicking at the appropriate dollar amounts for the two values. A user can also enable the interface shown by checking radio box 2831, and a user can select another view radio box to navigate to another view of the keep/sell management tool.

The next step in the stage for managing business data can be the display shown in FIG. 29. FIG. 29 shows an example of a user interface for managing business data including a current overview of the business and more particularly key person in chart form. As shown, current overview chart shows key person radio box 2903 is selected to show key person chart 2901. Key person chart 2901 includes total insurability versus current insurance for a key person of the business. The axis for the chart is in dollars (in $1,000s) 2911. The chart includes total insurability 2909 (e.g., $3,375,000). The sum of the two values is displayed in available insurance 2910 (e.g., $3,375,000).

In operation, the user can change the total insurability versus current insurance levels by, for example, clicking at the appropriate dollar amounts for the two values. A user can also enable the interface shown by checking radio box 2931, and a user can select another view radio box to navigate to another view of the keep/sell management tool.

The next step in the stage for managing business data can be the display shown in FIG. 30. FIG. 30 shows an example of a user interface for managing business data including a current overview of the business and more particularly mortgages and loans information in chart form. As shown, current overview chart shows mortgages and loans information radio box 3005 is selected to show mortgages and loans information chart 3001. Mortgages and loans information chart 3001 includes total insurability versus current insurance for mortgages and loans information of the business. The axis for the chart is in dollars (in $1,000s) 3011. The chart includes total insurability 3009 (e.g., $4,500,000). The sum of the two values is displayed in available insurance 3010 (e.g., $4,500,000).

In operation, the user can change the total insurability versus current insurance levels by, for example, clicking at the appropriate dollar amounts for the two values. A user can also enable the interface shown by checking radio box 3031, and a user can select another view radio box to navigate to another view of the keep/sell management tool.

The next step in the stage for managing business data can be the display shown in FIG. 31. FIG. 31 shows an example of a user interface for managing business data including a current overview of the business and more particularly keep or sell information in chart form. As shown, current overview chart shows keep or sell information radio box 3106 is selected to show keep or sell information chart 3101. Keep or sell information chart 3101 includes total insurability versus current insurance for a keep or sell information of the business. The axis for the chart is in dollars (in $1,000s) 3111. The chart includes total insurability 3109 (e.g., $7,500,000) and current insurance 3110 (e.g.: $1,000,000). The sum of the two values is displayed in available insurance interface 3112 (e.g., $6,500,000).

In operation, the user can change the total insurability versus current insurance levels by, for example, clicking at the appropriate dollar amounts for the two values. A user can also enable the interface shown by checking radio box 3131, and a user can select another view radio box to navigate to another view of the keep/sell management tool.

The next step in the stage for managing business data can be the display shown in FIG. 32. FIG. 32 shows an example of a user interface for managing business data including a current overview of the business and more particularly estate tax impact information in chart form. As shown, current overview chart shows estate tax impact information radio box 3206 is selected to show estate tax impact information chart 3201. Estate tax impact information chart 3201 includes total insurability versus current insurance for estate tax impact information of the business. The axis for the chart is in dollars (in $1,000s) 3209. The chart includes total insurability 3210 (e.g., $4,558,875). The sum of the two values is displayed in available insurance interface 3211 (e.g., $6,500,000).

In operation, the user can change the total insurability versus current insurance levels by, for example, clicking at the appropriate dollar amounts for the two values. A user can also enable the interface shown by checking radio box 3231, and a user can select another view radio box to navigate to another view of the keep/sell management tool.

Personal Data Gathering and Presentation

The user can choose to manage the personal financial information of the client. Personal financial information can be entered at various data gathering stages, including processes and interfaces for managing a client's personal data described in U.S. patent application Ser. Nos. 12/113,087, 11/891,616, 11/510,537, and/or 60/763,200. In conjunction with, or as an alternative to, the data gathering stages described therein, a section in the stage for personal insurance and financial planning can be the display shown in FIG. 33. FIG. 33 shows an example of a user interface including a personal planning component with a human life value management component, and more particularly displaying current information for the human life value. As shown, the interface of the current human life value component 3300 includes human life value calculator chart 3301 and assumptions 3302. Assumptions 3302 can be entered by various data gathering stages described in U.S. patent application Ser. Nos. 12/113,087, 11/891,616, 11/510,537, and/or 60/763,200. A user can modify the assumptions about the client by clicking on the assumptions 3302 and navigating to the appropriate fact finder entry pages for entering personal data about the client.

Human life value calculator chart 3301 includes a plurality of layers of different value types for the current financial situation for a client and the associated current value in current column 3304 for each row. The layers includes protection layer 3303 (which includes existing life insurance benefit layer 3306), income producing assets layer 3308 (which includes savings layer 3309, investments layer 3310, retirement layer 3311) and the total for income producing assets layers 3312, liabilities layer 3313 (which includes short term layer 3314, mortgages layer 3315) and the total of liabilities layer 3316, cash flow layer 3317 (which includes total family income layer 3318, protection costs layer 3319, annual asset building layer 3320, liability costs layer 3321, and net family income layer 3322).

In operation, the user can change values for the current human life value of the client by, for example, clicking on the appropriate rows. A user can also enable the interface shown by checking radio box 3331, and a user can select another view radio box to navigate to another view of the human life value.

The next step in the stage for personal insurance and financial planning can be the display shown in FIG. 34. FIG. 34 shows an example of a user interface including a personal planning component with a human life value management component, and more particularly displaying at the human life value at the client's death. As shown, the at-death radio box checked 3451 is selected and the at-death human life value component 3400 is displayed. As shown, the interface of the at-death human life value component 3400 includes the at-death human life value calculator chart 3402 and the at-death assumptions 3401.

At-death assumptions 3401 includes protection layer 3403, assets layer 3409, liabilities layer 3413, cash flow layer 3418. The current income levels shown in FIG. 34 can be used to project income at death, using various methods, including rate of appreciation or depreciation of assets, rate of income increase per demographics of the individuals, or the like. Similarly, liabilities can be projected to at death value using for, example, rate of pay-off of the liabilities, rate of interest, or the like. Moreover, protections for the death of the client can also be incorporated into the income levels (total and/or net family income) and/or cash flows.

Protection layer 3403 includes the projected death of a selected person (client). For example, death of input 3406 shows Kyle Abernathy, as an example. Information related to the chosen person is entered into the assumptions. Protection layer 3403 further includes additional life insurance layer 3407 (e.g., used to provide at death benefits for the death of the selected person) and lookup available insurance layer 3408 (e.g., used to design and choose other insurance options for the selected person). Clicking on the lookup option can navigate to the page of FIG. 37, for example.

Assets layer 3409 includes after tax rate of return input 3410 (e.g., used to compute the income after taxes), add business value input 3411 (e.g., used to select whether to add the business value to the net income, cash flow, or net worth), and create reserve fund input 3412 (e.g., used to provide a fund to the family at death).

Liabilities layer 3413 includes final expenses layer 3414 (e.g., used to define expenses for the person at death, including funeral costs, health costs, etc., e.g., shown as $50,000), pay off short-term debt input 3415 (e.g., used to select whether to pay off short-term debt of the person at death, e.g., from the person's estate), pay off mortgages input 3416 (e.g., used to select whether to pay off mortgages of the person at death, e.g., from the person's estate), and pay off business debt input 3417 (e.g., used to select whether to pay off business debt of the person at death, e.g., from the person's estate).

Cash flow layer 3418 includes annual asset building input 3419 (e.g., used to define additional assets from the person at death), add S.S. survivor benefits input 3420 (e.g., used to define additional cash flow from social security benefits of the person at death), and additional family income input 3421 (e.g., used to define the amount of additional family income at death).

The information entered in the At-death assumptions 3401 for the selected person and the current human life value, (e.g., from FIG. 33), can be used to compute the at-death human life value calculator chart 3402. A user can click on recalculate choice button 3422 to calculate the chart, or click a “clear” button to clear the choices in the assumptions.

At-death human life value calculator chart 3402 includes layers for different aspects of a human life value and the associated current value 3404 and the at death value 3405. The layers include protection layer 3423 (which includes existing life insurance benefit layer 3424, additional life insurance benefit layer 3425), total of protection layers 3426, income producing assets layer 3427 (which includes savings layer 3428, investments layer 3429, and retirement layer 3430), total of income producing assets layers 3431, liabilities layer 3432 (which includes short term layer 3433 and mortgages layer 3434), total of liabilities layers 3435 and cash flow layer 3436 (which includes total family income layer 3437, protection costs layer 3438, annual asset building layer 3439, liability costs layer 3440, and net family income layer 3441).

In operation, the user can change the assumptions or the current human life values for the current human life value and/or recalculate the at-death human life value. A user can also enable the interface shown by checking radio box 3451, and a user can select another view radio box to navigate to another view of the human life value.

The next step in the stage for personal insurance and financial planning can be the display shown in FIG. 35. FIG. 35 shows an example of a user interface including a personal planning component with an income replacement management component, and more particularly displaying income replacement for a current income of a client. FIG. 35 is similar to FIG. 33 except FIG. 35 shows the replacement income for the client in the event that the client is not able to earn income (e.g., at-disability).

As shown, the interface of the income replacement component 3500 includes income replacement chart 3501 and assumptions 3502. Assumptions 3502 can be entered by various inputs, including processes and interfaces for managing a client's personal data described in U.S. patent application Ser. Nos. 12/113,087, 11/891,616, 11/510,537, and/or 60/763,200. A user can modify the assumptions about the client by clicking on the assumptions 3502 and navigating to the appropriate fact finder entry pages for entering personal data about the client.

Income replacement chart 3501 includes a plurality of layers of different value types for the current financial situation for a client and the associated current value in current column 3504 for each row. The layers includes protection layer 3505 (which includes existing disability insurance benefit layer 3506), income producing assets layer 3507 (which includes savings layer 3508, investments layer 3509, retirement layer 3510 and the total for income producing assets layers 3511), liabilities layer 3512 (which includes short term layer 3513, mortgages layer 3514 and the total of liabilities layer 3515), cash flow layer 3516 (which includes total family income layer 3517, protection costs layer 3518, annual asset building layer 3519, liability costs layer 3520, and net family income layer 3521).

In operation, the user can change values for the income replacement for the current income value of the client by, for example, clicking on the appropriate rows. A user can also enable the interface shown by checking radio box 3531, and a user can select another view radio box to navigate to another view of the human life value.

The next step in the stage for personal insurance and financial planning can be the display shown in FIG. 36. FIG. 36 shows an example of a user interface including a personal planning component with an income replacement management component, and more particularly displaying income replacement for a current income and income at disability of a client. FIG. 36 is similar to FIG. 34 except FIG. 36 shows the replacement income for the client in the event that the client is not able to earn income (e.g., at-disability).

As shown, the at-disability radio box checked 3651 is selected and the at-disability income replacement value component 3600 is displayed. As shown, the interface of the at-disability income replacement value component 3600 includes at-disability income replacement value calculator chart 3601 and the at-disability assumptions 3602.

At-disability assumptions 3602 includes protection layer 3603, assets layer 3611, liabilities layer 3614, and cash flow layer 3619. The current income levels shown in FIG. 35 can be used to project income at disability, using various methods, including rate of appreciation or depreciation of assets, rate of income increase per demographics of the individuals, or the like. Similarly, liabilities can be projected to at disability value using, for example, rate of pay-off of the liabilities, rate of interest, or the like. Moreover, protections for the disability of the client can also be incorporated into the income levels (total and/or net family income) and/or cash flows.

Protection layer 3603 includes the projected disability of a selected person (client) for example, disability of input 3607 (e.g., used to provide at disability benefits for the disability of the selected person, e.g., Kyle Abernathy, as an example). Information related to the chosen person is entered into the assumptions. Protection layer 3603 further includes additional annual disability 3608 (e.g., used to design and choose other insurance options for the selected person), and lookup available coverage layer 3610 (e.g., used to design and choose other insurance options for the selected person). Clicking on the lookup option can navigate to the page of FIG. 37, for example.

Assets layer 3611 includes after tax rate of return input 3612 (e.g., used to compute the income after taxes), and create reserve fund input 3613 (e.g., used to provide a fund to the family at disability).

Liabilities layer 3614 includes additional one-time expense input 3615 (e.g., used to define any one time expenses such as uncovered hospital bills for the disability), pay off short-term debt input 3616 (e.g., used to select whether to pay off short-term debt of the person at disability), pay off mortgages input 3617 (e.g., used to select whether to pay off mortgages of the person at disability), and pay off business debt input 3618 (e.g., used to select whether to pay off business debt of the person at disability).

Cash flow layer 3619 includes annual asset building input 3620 (e.g., used to define additional assets from the person at disability), and add S.S. disability benefits input 3621 (e.g., used to define additional cash flow from social security benefits of the person at the disability of the person).

The information entered in the at-disability assumptions 3602 for the selected person and the current income replacement value, e.g., from FIG. 35, can be used to compute the at-disability income replacement value calculator chart 3601. A user can click on recalculate choice button 3622 to calculate the chart, or click a “clear” button to clear the choices in the assumptions.

At-disability income replacement calculator chart 3601 includes layers for different aspects of an income replacement value and the associated current value 3605 and the at-disability value 3606.

The layers include protection layer 3604 (which includes existing disability benefit layer 3623 and additional annual disability benefit layer 3624), the total annual benefit for protections layer 3625, income producing assets layer 3626 (which includes savings layer 3627, investments layer 3628, retirement layer 3629 and the total income producing assets layer 3630), liabilities layer 3631 (which includes short term layer 3632, mortgages layer 3633 and total of liabilities layer 3634), cash flow column 3635 (which includes total family income layer 3636, protection costs layer 3637, annual asset building layer 3638, liability costs layer 3639, and net family income layer 3640).

In operation, the user can change the assumptions or the at-disability values for the current income and/or recalculate the at-disability income values. A user can also enable the interface shown by checking radio box 3651, and a user can select another view radio box to navigate to another view of the income replacement view.

The next step in the stage for personal insurance and financial planning can be the display shown in FIG. 37. FIG. 37 shows an example of a user interface including a personal planning component with an income replacement management component, and more particularly displaying a lookup table for available coverage for a client and/or business for income replacement. The interface shows lookup table 3700. Lookup table 3700 can be stored in memory, such as on database, received over a network from an insurance carrier, or the like. The lookup table 3700 can be provided on an interface display, as shown in FIG. 37. A user can review the client's insurance options based on one of the rows 3711 associated, selected, or accommodating the client, based on, for example, annual income 3706 of the client. Each row for each annual income 3706 shows the available monthly indemnity levels 3707-3710 for different insurance options. For an individual paid insurance, for the tax free policy, the monthly indemnity levels 3707 are displayed. For an individual paid participation insurance with taxable group Long Term Disability (LTD), the monthly indemnity levels 3708 are displayed. For an employer-paid insurance treated as a taxable benefit, the monthly indemnity levels 3709 are displayed. For an employer-paid participation insurance with taxable group LTD, the monthly indemnity levels 3710 are displayed. The insurance options shown here are examples, and other insurance options, including life insurance options can also be used.

In operation, the user can select the appropriate insurance option for the client, by clicking on a row, for example. Clicking on the row can change the disability (or life insurance) option selected, stored, and/or associated with the client. Human life value, at-death value, income replacement value, and/or at-disability value can be changed as described above, based on a selection of the type of insurance.

The next step in the stage for personal insurance and financial planning can be the display shown in FIG. 38. FIG. 38 shows an example of a user interface including a personal planning component with a cash flow layer, and more particularly displaying a design center for a current strategy of the client and/or business.

As shown, the interface includes cash flow scenarios component 3800. Component 3800 includes a selection of possible scenarios, including savings 1 for current and alternate cash flow input 3802. A user can check the input and click the select scenario(s) button 3803 to edit the selected choice.

The user can also enter a new scenario in scenario assumptions column 3804, by entering the scenario's name, strategy, and period in scenario 3805, strategies 3806, and study period (in years) 3807, respectively. The user can start the new scenario by clicking start new scenario button 3812.

As shown, a menu of the different strategy is displayed. The menu includes current strategy radio box 3813 (checked), alternate strategy radio box 3814, and retirement strategy radio box 3815. The interface shows the checked current strategy. A user can navigate to the other strategies by clicking on the appropriate radio boxes.

The strategy includes a plurality of layers representing different aspects of cash flow. The layers include protection layer 3816, assets layer 3817, liabilities layer 3818, protection cash flow layer 3829, assets cash flow layer 3828, and liabilities cash flow layer 3827.

Protection layer 3816 includes coverage type input 3819 (e.g., term, permanent, disability, etc.), benefit input 3820 (e.g., for entering the amount of premium payout), gender input 3821, age input 3822, permanent protection design component 3823, and years to pay premium input 3824 (e.g., for entering the number of years before premium is paid).

Protection cash flow layer 3829 includes annual premium input 3830 (displaying the cash flow of the annual premium protection), include term premium component 3831 (which shows whether the term premium is included), FDP import filename upload input 3832 (e.g., for uploading an FDP file), and an indication of FDP illustration chosen 3833.

Assets layer 3817 includes asset value input 3834 (e.g., for entering the value of the asset of the person/client), tax status input 3835 (e.g., taxable, non-taxable), basis input 3836 (displaying the basis for the tax), asset return rate input 3837 (e.g., for selecting the rate of return on the asset), taxable input 3838 (e.g., for entering the amount of asset that is taxable), realized input 3839 (e.g., for entering the amount of asset that is realized), unrealized input 3840 (e.g., for entering the amount of asset that is unrealized), and time-value money rate input 3841 (e.g., for entering the rate of the time-value of money).

Assets cash flow layer 3828 includes annual contribution input 3860 (e.g., for entering the contribution paid by the client per year), annual inflow input 3861 (e.g., for entering the overall cash inflow into the client/client's family), funds transfer changes column 3862 (e.g., for entering any changes in funds owned by the client/family), interest only input 3863 (e.g., for entering amount of interest paid by a fund), amortization input 3864 (e.g., for entering any amortization amount for the funds), and flat withdrawal input 3865 (e.g., for entering any amount of withdrawal from a fund).

Liabilities layer 3818 includes tax rate input 3842, tax deferred input 3843, loan type input 3844, short term loan column 3825, loan amount input 3845, loan rate input 3846, years to payoff input 3847, mortgage column 3826, mortgage amount input 3848, mortgage term input 3849, mortgage rate input 3850, current balance input 3851, years to payoff input 3852, and home exclusion input 3853.

Liabilities cash flow layer 3827 includes loan payment input 3854, additional loan payment input 3855, one time loan payment input 3856, and cash flow savings input 3857.

In operation, the associated data for the different layers can be entered. Cash flow based on assets and/or funds inflow less liabilities outflow can be computed. The assets can be appreciated and/or depreciated based on rates of returns, and/or income can be decreased based on taxes at particular tax rates. Cash flow can also be based on the protection income inflow. For example, at the event of death, cash flow can be supplemented by the protection elements. A user can save the data by clicking on a “save” button 3880. A user can also enable the interface shown by checking radio box 3881, and a user can select another view radio box to navigate to another view of the income replacement view.

The next step in the stage for personal insurance and financial planning can be the display shown in FIG. 39. FIG. 39 shows an example of a user interface including a personal planning component with a cash flow layer, and more particularly displaying a design center for designing a retirement strategy based on the cash flow at retirement for a client and/or business.

As shown, the interface includes cash flow scenarios component 3900. Component 3900 includes a selection of possible scenarios, including savings 1 for current and alternate cash flow input 3932 which is selected. Thereby, the information shown corresponds to the current and alternate cash flow of the client and/or business.

Component 3900 includes retirement layer 3901, protection layer 3904, assets layer 3909, liabilities layer 3911, current cash flow layer 3913, and alternate cash flow layer 3919. Information associated with cash flow at retirement can be entered to project the amount of income available to the client and/or client's family at retirement.

Retirement layer 3901 includes years in retirement input 3902 (e.g., for entering the number of year a client will be in retirement), and retirement inflow input 3903 (e.g., for entering the amount of income inflow to the client/family during retirement, e.g., over a period such as annually).

Protection layer 3904 includes distribution start age input 3905 (e.g., for entering the age of the client for starting distribution of any protection income, such as certain retirement income), distribution end age input 3906 (or entering the age of the client for ending distribution of any protection income), desired distribution input 3907 (e.g., for entering the amount of desired distribution during the ages entered), and last distribution legacy input 3908 (e.g., for entering the amount of the last distribution amount and/or remaining balance from the protection, if any and/or the entity receiving the last distribution).

Assets layer 3909 includes asset return rate input 3910 (e.g., for entering the return rate of the assets, e.g., during retirement).

Liabilities layer 3911 includes tax rate input 3912 (e.g., for entering the tax rate, e.g., during retirement).

Current cash flow layer 3913 includes initial asset value input 3914 (e.g., for entering the estimated value of assets at retirement), funds transfer changes component 3915 which includes interest only from a starting year to an ending year 3916 (e.g., for entering the amount of cash flow due to interest payments from a fund from a starting year to an ending year), amortization from a starting year to and ending year input 3917 (e.g., for entering the amortization of a fund from a starting year to an ending year), and flat withdrawal box from a starting year to an ending year input 3918 (e.g., for entering the amount of withdrawal from a fund from a staring year to ending year, e.g., shown as checked).

Alternate cash flow layer 3919 includes initial asset value input 3920, funds transfer changes component 3921 which includes interest only from a starting year to an ending year input 3922, amortization from a starting year to an ending year 3923, and flat withdrawal input 3924. The data enterable for alternate cash flow layer 3919 is similar to current cash flow layer 3913. Alternate cash flow shows an alternate strategy for creating cash flow during retirement. A user can enter different data to determine the alternate scenario.

In operation, the associated data for the different layers can be entered. Retirement cash flow during the retirement period and/or ages are computed based on the retirement income inflow, which can be based on assets and/or funds inflow less liabilities outflow. The assets can be appreciated and/or depreciated based on rates of returns, and/or income can be decreased based on taxes at particular tax rates. Retirement cash flow can also be based on the retirement protection income inflow. For example, during the distribution ages for the client, retirement cash flow can be supplemented by the protection elements. A user can save the data by clicking on a “save” button 3980. A user can also enable the interface shown by checking radio box 3981, and a user can select another view radio box to navigate to another view of the income replacement view.

FIG. 40 shows the operation of scenario assumptions column of FIGS. 38-39 to create a new scenario. The user can also enter a new scenario by entering the scenario type 4002, and strategy 4004 and clicking on the “Start New Scenario” button 4008. Scenario type 4002 includes Savings, Investments, Retirement, Real Estate, Short Term Liabilities, Mortgage, and Insurance. The type selected can change the behavior of the cash flow, e.g., changing the rate of in-flow or out-flow of cash based on the type, for example. Strategy 4004's selection allows the user to select to create a single scenario (current or alternate only) or a current and alternate scenario. Information about Strategy Type 4006 can also be displayed.

The next step in the stage for personal insurance and financial planning can be the displays shown in FIGS. 41-45. FIGS. 41-45 show an example of a sequence of user interfaces including a personal planning component with a cash flow design and more particularly current strategy information. The sequence shown is an example, and more detailed information can be provided with additional steps, or multiple steps can be combined to show an aggregation of several domains, without departing from the scope of the invention.

The page of FIG. 41 can be the beginning of a sequence of steps to display the cash flow comparison based on age of a current strategy (e.g., current strategy radio box 4130 is selected). As shown, the interface includes savings scenario 4100, which includes a snapshot at age 4101 and age 4103. Snapshot for age 4101 includes a plurality of domains 4104 including protection, assets, liabilities, net worth, and cash flow. Snapshot for age 4103 includes a plurality of domains 4105 including protection, assets, liabilities, net worth, and cash flow. As shown, the values for the domains are currently empty and the user can select to fill in the values to show the different cash flow within the domains by using input component 4131. The user can click “next”, “prev”, “clear”, or “show all” to step to the next screen to fill in another component, step to a previous screen to empty that component, to clear all components, or to show all components filled in, respectively.

In operation, the user can select button 4130 to enable the interface shown. The user can click on the “next” button of 4131. The next step in the stage for personal insurance and financial planning can be the displays shown in FIG. 42. FIG. 42 is substantially similar to FIG. 41, except FIG. 42 shows that assets 4204, liabilities 4201, and net worth 4202 (assets less liabilities) are filled in for a first age.

The user can click on the “next” button of 4231 to display the page of FIG. 43. FIG. 43 is substantially similar to FIG. 42, except FIG. 43 shows cash flow 4302 filled in. The cash flow can be computed by the type of income generated by the business and/or assets and the cash out-flow to pay outstanding debt due to the liabilities.

The user can click on the “next” button of 4331 to display the page of FIG. 44. FIG. 44 is substantially similar to FIG. 43, except FIG. 44 shows life insurance 4402 filled in.

The user can click on the “next” button of 4431 to display the page of FIG. 45. FIG. 45 is substantially similar to FIG. 44, except FIG. 45 shows the different portions of the snapshot for ages 4501 and 4503 filled in. There can be intermediate steps of filling in different portions of the snapshot for ages 4501 and 4503.

As shown, the interface includes savings scenario 4500, which includes a snapshot at age 4501 and age 4503. Snapshot for age 4501 includes protection layer 4502 with current life insurance value 4505, assets layer 4508, liabilities layer 4507 with net worth 4520, and cash flow layer 4510 with annual cash flow 4509. Snapshot for age 4503 includes protection layer 4504 with current life insurance value 4512, assets layer 4513, liabilities layer 4515 with net worth 4516, and cash flow layer 4518 with cumulative cash flow 4517. The net worth and cash flows of FIG. 45 can be computed by a process and/or table as shown in FIG. 46. For example, the net worth 4516 and cumulative cash flow 4517 can be the total cash flow 4618 and net value over a life time 4619 and can additionally include a net value at death 4620.

In operation, a user can enter or modify the amount of life insurance 4505 and/or 4512 for the client at various ages, and therefore change the current scenario into an alternate strategy/scenario (e.g., thereby changing the business and family's value—owner's equity, net worth, cash flows). A user can enable the interface shown by checking radio box 4530, and a user can select another view radio box to navigate to another view of the personal planning component. A user can also use input 4531 to step through the scenario to fill different portions of the components (e.g., life insurance value 4505 to assets 4508, etc.) with dollar values by clicking on the “next” button or back up to a “previous” view, or select “show all” to show the final view at the final age 4503.

The next step in the stage for personal insurance and financial planning can be the display shown in FIG. 46. FIG. 46 shows an example of a user interface including a personal planning component with a cash flow design and more particularly current details information. As shown, the interface includes savings scenario 4600, which includes protection layer 4602, assets layer 4604, liabilities layer 4606, cash flow layer 4608, and net worth layer 4610. Protection layer 4602 includes annual premium column 4625, net cash value column 4603, and net death benefit column 4605. Assets layer 4604 includes beginning year value 4607, net annual inflow column 4609, net annual outflow column 4611, and end year value 4612. Liabilities layer 4606 includes annual income tax column 4613, and debt balance column 4614. Cash flow layer 4608 includes annual net column 4615. Net worth layer 4610 includes net value lifetime column 4616, and net value at death column 4620. Each column includes a monetary value at an age 4601 and a total at the end of the age range. Protection layer 4602 includes total 4626; assets layer 4604 includes total 4621; liabilities layer 4606 includes total 4622; cash flow layer 4608 includes total 4617; and net worth layer 4610 includes totals 4623 and 4624. A 20 year summary is displayed with total cash flow 4618, net value over a life time 4619, and net value at death 4630 (e.g., net value over a life time plus any protection paid at death). The net value at death 4630 can be used to show the value of purchasing personal life insurance or other insurance policies.

In operation, the data for table can be populated from the computations and data entered for the scenario(s). A user can enable the interface shown by checking radio box 4627, and a user can select another view radio box to navigate to another view of the personal planning component.

The next step in the stage for personal insurance and financial planning can be the displays shown in FIGS. 47-49. FIGS. 47-49 shows an example of a sequence of user interfaces including a personal planning component with a cash flow design and more particularly alternate strategy information. The sequence shown is an example, and more detailed information can be provided with additional steps, or multiple steps can be combined to show aggregation of several domains, without departing from the scope of the invention.

The page of FIG. 47 can be the beginning of a sequence of steps to display the cash flow comparison based on age of an alternate strategy (e.g., alternate strategy radio box 4721 is selected). As shown, the interface includes savings scenario 4700, which includes a snapshot at age 4701 and age 4703. Snapshot for age 4701 includes a plurality of domains 4704 including protection, assets, liabilities, net worth, and cash flow. Snapshot for age 4703 includes a plurality of domains 4705 including protection, assets, liabilities, net worth, and cash flow. As shown, the values for the domains are currently empty and the user can select to the fill in the values to show the different cash flow within the domains by using input component 4731. The user can click “next”, “prev”, “clear”, or “show all” to step to the next screen to fill in another component, step to a previous screen to empty that component, to clear all components, or to show all components filled in, respectively.

In operation, the user can click on the “next” button of 4731. The next step in the stage for personal insurance and financial planning can be the displays shown in FIG. 48. FIG. 48 is substantially similar to FIG. 47, except FIG. 48 shows that assets 4801 filled in for a first age. There can be intermediate steps of filling in different portions of the snapshot for age 4703.

The user can click on the “next” button of 4831 to display the page of FIG. 49. FIG. 49 is substantially similar to FIG. 48, except FIG. 49 shows the different portions of the snapshot for ages 4902 and 4903 filled in. There can be intermediate steps of filling in different portions of the snapshot for ages 4902 and 4924.

As shown, the interface includes savings scenario 4900, which includes a snapshot at age 4902 and age 4924. Snapshot for age 4902 includes protection layer 4906 with current life insurance value 4901, assets layer 4903, liabilities layer 4905 with net worth 4914, cash flow layer 4916 with annual cash flow 4919. Snapshot for age 4904 includes protection layer 4908 with current life insurance value 4910, assets layer 4907, liabilities layer 4909 with net worth 4913, cash flow layer 4915 with cumulative cash flow 4920. The net worth and cash flows of FIG. 49 can be computed by a process and/or table as shown in FIG. 50. For example, the net worth 4913 and cumulative cash flow 4920 can be the total cash flow 5020 and net value over a life time 5021/net value at death 5022.

In operation, a user can enter or modify the amount of life insurance 4901 and/or 4910 for the client at various ages, and therefore change the current scenario into an alternate strategy/scenario (e.g., thereby changing the business and family's value—owner's equity, net worth, cash flows). A user can enable the interface shown by checking radio box 4921, and a user can select another view radio box to navigate to another view of the personal planning component. A user can also use input 4931 to step through the scenario to fill different portions of the components (e.g., life insurance value 4901 to assets 4903, etc.) with dollar values by using the “next” button or back up to a “previous” view, or select “show all” to show the final view at the final age 4904.

The next step in the stage for personal insurance and financial planning can be the display shown in FIG. 50. FIG. 50 shows an example of a user interface including a personal planning component with a cash flow design and more particularly alternate details information. The alternate scenario/strategy shown can be created by entering data in the interface of FIG. 49. As shown, the interface includes scenario 5000, which includes protection layer 5002, assets layer 5004, liabilities layer 5006, cash flow layer 5008, and net worth component 5010. Each of the components has columns for various ages substantially similar to FIG. 46, except that scenario 5000 can include different values for different columns and ages, and correspondingly a different 20 year summary 5012 which includes total cash flow 5020, net value over a lifetime 5021 and net value at death 5022. In this way, different scenarios can be entered and/or shown to the client. In operation, a user can enable the interface shown by checking radio box 5025, and a user can select another view radio box to navigate to another view of the personal planning component.

The next step in the stage for personal insurance and financial planning can be the display shown in FIG. 51. FIG. 51 shows an example of a user interface including a personal planning component with a cash flow design and more particularly charts information. As shown, the interface includes scenario 5100, which includes a chart 5102 for a net value over a lifetime of a client for a current strategy and chart 5104 for a net value over the lifetime of the client for an alternate strategy. The charts show graphically the dollar value at various ages 5105-5106. Chart 5102 also shows cumulative net value at death 5101 for the current strategy. And shown in comparison, chart 5104 shows cumulative net value at death 5103 for the alternate strategy. In this way, a client can see the value of modifying his life insurance or other insurance holdings or purchases.

In operation, the data for charts 5102 and 5104 can be populated from the computations and data entered for the scenario(s). A user can enable the interface shown by checking radio box 5110, and a user can select another view radio box to navigate to another view of the personal planning component.

The next step in the stage for personal insurance and financial planning can be the display shown in FIG. 52. FIG. 52 shows an example of a user interface including a personal planning component with a cash flow design and more particularly summary information. As shown, the interface includes scenario 5200, which includes the retirement summary after 20 years 5202. The summary 5202 includes layer 5201 for year 1 retirement cash flow, layer 5203 for total retirement cash flow, layer 5204 for end retirement asset value, layer 5205 for end retirement Permanent Life Insurance (PLI) cash value, layer 5206 for end retirement/life insurance, and layer 5207 for end retirement legacy value. For current scenario column 5208, various values for the layers are displayed. And for the alternate scenario 5209, various values for the layers are displayed. In operation, the data for summary 5202 can be populated from the computations and data entered for the scenario(s). A user can enable the interface shown by checking radio box 5215, and a user can select another view radio box to navigate to another view of the personal planning component.

Business Continuity Data Gathering and Presentation

The user can choose to manage the business continuity of a business of a client at or after the death or disability of the client. The business continuity can be based on data about the business, for example, entered through the processes and associated interfaces of FIGS. 12-32 and/or personal data entered through the processes and associated interfaces of FIGS. 33-45.

A section in the stage for business continuity management can be the display shown in FIG. 53. FIG. 53 shows an example of a user interface including a business continuity component with keep/sell observations and more particularly displaying general observations information. The interface shows component 5300 which includes various questions and answers about a client and/or the client's business directed to determining a course of action to take with regards to the business at the death of the client. The questions and answers can be entered for example, using the interface of FIGS. 23-24.

As shown, at-death/sell—question summary component 5302 includes business questions 5301, family questions 5303, and business value question 5307. Business questions 5301 is displayed associated with business answers 5304. Questions can include “What will control how your business passes?”, “Will relationships with outside vendors or customers be adversely affected?”, “Will it be difficult for the business to collect outstanding receivables?”, “Will your existing employees work for the new owners?”, “Do the key employees have incentive to stay with the business?”, “Are there any notes or mortgages that become immediately callable?”, “Will the borrowing capability of the business be impaired?”, or the like.

Family questions 5303 is displayed associated with family answers 5305. Questions include “Who will be buying your business interest?”, “What is the current fair market value of your business?”, “How will this amount be paid?”, “Are the terms of sale part of a binding agreement?”, “Is the agreement funded by insurance?”, “Will the business value be reduced by estate taxes?”, “Will your family rely on these proceeds for income?”, “Will the sale of your business interest adversely affect your family legacy objectives?”, or the like.

Business value question 5307 is displayed associated with includes business value answers 5306. Questions include “Based on these questions, what will the value of your interest in [business entity name] be at your death?”. As shown, the question can be focused specifically to at least one of the businesses owned by the client (or aggregated over several businesses).

In operation, the information for the business continuity is provided to the client and the user can continue with the presentation and/or data gathering from the client about the business continuity.

The next step in the stage for business continuity management can be the display shown in FIGS. 54-116. FIGS. 54-116 show flow charts for a balance sheet summary of “current” financial state of the client and the client's business. FIGS. 54-116 show different domains for business and personal information which are navigable (e.g., clickable) to drill down to more details about the particular domains. FIGS. 54-116 show one possible sequence of using the interfaces, providing one possible sequence of display of aspects of the business and personal balance sheet summary. Other sequences, such as information for the businesses balance sheet summary appearing before information for personal balance sheet summary, can be provided, or different orders of information for the domains for a particular balance sheet summary (e.g., protection->assets->liabilities->cash flow; cash flow->assets->liabilities->protection; or portions of one domains appearing, then portions of another domain appearing) or between balance sheet summary (e.g., domain information can appear concurrently, such as business protection and personal protection) can be provided without departing from the scope of the invention.

FIG. 54 shows a balance sheet summary of a business and the client in a side-by-side view such that a user and/or client can understand how different insurance options under different circumstances affects the client/family and the business, and how the effect can be interrelated between the client/family and the business. A user can select a plurality of options in a navigation menu, including observations radio box 5470, balance sheet summary radio box 5471 (selected to show the balance sheet summary), and flow charts radio box 5472.

Scenarios and insurance options can be entered into observations layer 5402, additional life insurance layer 5403, liability considerations layer 5411, and assumptions layer 5405. Observations layer 5402 includes an option 5406 to keep or sell the business. Observations layer 5402 also includes at-death business value 5407 (e.g., for entering the value of the business at the death of a key person (e.g., client), e.g., $5,000,000). A user can modify the components of observations layer 5402 to change the financial value (e.g., net worth, owner's equity, cash flow) of the business and/or the family (personal) at the death of the client based on the at-death business value entered.

Additional life insurance layer 5403 includes the amount of insurance 5408 for protecting the business in the event of the death of a key person (e.g., client) and the amount of insurance 5409 for protecting the client's family in the event of the death of the client. A user can modify the components of additional life insurance layer 5403 to view the modified financial impact, including owner's equity, net worth, and cash flow of the business and/or the family (personal) at the death of the client. For example, the amount of the insurance will be paid out to the business and/or client at the death of the client.

Liability considerations layer 5460 includes buy/sell check box 5411 (e.g., for selecting whether to present insurance options relating to buying/selling the business and/or for considering the costs and/or benefits due to the buying/selling when computing cash flow, e.g., checked), key person check box 5412 (e.g., for selecting whether to present insurance options related to key persons of the business and/or for considering the costs and/or benefits due to key persons, e.g., unchecked), mortgages & loans check box 5410 (e.g., for selecting whether to present insurance options relating to mortgages and loans and/or for considering the costs and/or benefits due to mortgages and loans, e.g., unchecked), and estate tax check box 5413 (e.g., for selecting whether to present insurance options related to estate tax and/or for considering the estate tax, e.g., unchecked). A user can modify the components of liability considerations layer 5460 to take into account the associated considerations with the liabilities of the business and/or the client. For example, selecting buy/sell check box 5411 will cause a scenario where the cost of selling the business as a liability in the business's balance sheet. Other scenarios based on different considerations are described in conjunction with FIGS. 55-123.

Assumptions layer 5405 includes a rate of return selection 5415 (e.g., for entering the rate of return on investments, assets, funds, etc. e.g., selected at 5%), a scenario selection 5416 (e.g., for selecting the scenario for summarizing in the balance sheets, e.g., selected as “Current” or “At Death”), recalculate button 5417, and clear button 5418. A user can modify the components of assumptions layer 5405 to change the value of assets owned by the business and/or client and to change the owner's equity, and net worth, respectively. The user can click recalculate button 5417 to recalculate the summary based on new observations, life insurance, liability considerations and/or assumptions. The user can click clear button 5418 to clear the entered values.

Interface 5400 includes a summary of a balance sheet summary of the business's financial domains and a balance sheet summary of the client's financial domains. As shown, balance sheet summary for the business includes layers for displaying financial domains about the business including protection layer 5442, assets layer 5443, liabilities layer 5444, owner's equity layer 5445, and cash flow layer 5446. Balance sheet summary of the client includes layers for displaying financial domains about the client including protection layer 5447, assets layer 5448, liabilities layer 5449, net worth layer 5450, and cash flow layer 5451. The balance sheet summaries of the various domains of the business and/or client are empty and can be the first screen in a sequence of screens. For example, the screens can be navigated back and forward in the sequence by clicking on the “Prev”, or “Next” button of input interface 5460. At least some portions of the domains can be displayed based on the input provided (e.g., from observations layer 5402, additional life insurance layer 5403, liability considerations layer 5411, and assumptions layer 5405) as the user navigates. The user can also clear the options entered by clicking on the “clear” button of input interface 5460.

By clicking on the “next” button of input interface 5460, the user can navigate to the page of FIG. 55. As shown, information for assets layer 5502 for the client/family (personal) is displayed based on the input provided. Business value 5504 is the business value at death 5520 entered previously (e.g., on this interface or on the personal data interfaces described herein). Cash 5506 is the cash on hand for the family and note 5508 is the debt owed to the family. These amounts can be determined or generated by the personal data entered in the personal data interfaces described herein. Total 5510 can be computed by the total of the other components (business value 5504, cash 5506, and note 5508) in assets layer 5502.

By clicking on the “next” button of input interface 5534, the user can navigate to the page of FIG. 56. As shown, information for liabilities layer 5602 for the client/family (personal) is displayed based on the input provided. Estate tax 5604 is the estate tax to be paid by the family at the death of the client. Estate tax 5604 is shown as grayed out and as $0 because the estate tax liability consideration 5620 is not selected. Capital gains tax 5606 (shown as $750,000) is the amount of tax on capital gains computed by the tax rate of the family members (e.g., client, spouse and/or children), based on the capital (e.g., assets) owned by the client/family and the tax rate and/or income entered in the personal data interferences described herein. Total 5608 can be computed by the total of the other components (estate tax 5602, capital gains tax 5604) in liabilities layer 5602. Net worth 5610 can be computed as the assets less the liabilities.

By clicking on the “next” button of input interface 5634, the user can navigate to the page of FIG. 57. As shown, information for protection layer 5701 for the client/family (personal) is displayed based on the input provided. Existing life insurance benefit row 5702 (shown as $2,500,000) shows the amount of existing personal life insurance for the client. Additional life insurance benefit row 5704 (shown as $0) shows the amount of additional personal life insurance 5720 for the client entered previously. Total 5708 can be computed by the total of the other components (existing life insurance benefit row 5702, additional life insurance benefit row 5704) in protection layer 5701.

By clicking on the “next” button of input interface 5734, the user can navigate to the page of FIG. 58. As shown, net worth 5801 for the client and/or client's family (personal data) is provided. The net worth 5801 can be computed as the assets less the liabilities. Cash flow layer 5802 for the client/family (personal) can also be computed and shown in annual cash flow 5803 (e.g., shown as $450,000). Annual cash flow 5803 can represent the predicted yearly outflow of monies and can be computed based on personal data entered in the personal data gathering interfaces described herein (e.g., FIGS. 38-53), and can be based on for example, the family's standard of living and cost of living, the income from assets, employment income, business income, capital gains income, etc.

By clicking on the “next” button of input interface 5834, the user can navigate to the page of FIG. 59. Liabilities layer 5901 for the business can appear based on the input provided. Because buy/sell consideration 5920 is selected, the buy/sell amount 5902 (shown as $5,000,000) is displayed as a component of liabilities layer 5901. The buy/sell amount 5902 can be the at-death business value 5921 entered previously. Liabilities layer 5901 shows that if the business were to be bought from the client (owner) at death, the buy/sell amount must be raised (e.g., through a loan, insurance proceeds, or otherwise), and is therefore a liability for the business.

By clicking on the “next” button of input interface 5934, the user can navigate to the page of FIG. 60. Assets layer 6001 for the business can appear based on the input provided. Liquid assets 6002 (shown as $400,000) is displayed as a component of assets layer 6001. The information for Assets layer 6001 can be determined from business information entered in the business data gathering interfaces described herein. Total 6004 can be computed as the sum of the components in assets layer 6001.

By clicking on the “next” button of input interface 6034, the user can navigate to the page of FIG. 61. Other portions of liabilities layer 6101 for the business can appear based on the input provided. Mortgages & loans 6102 (shown as $0) can appear as grayed out and as $0 because mortgages & loans consideration 6120 is not selected and not considered as part of the liabilities for the business. Key person 6103 (shown as $0) can appear as grayed out and as $0 because key person consideration 6121 is not selected and not considered as part of the liabilities for the business. Total 6104 (shown as $5,000,000) can be computed as the sum of the components of liabilities layer 6101 (buy/sell, mortgages & loans, key person, etc.). Owner's equity 6105 for the business (shown as −$4,600,000) can be computed as the assets less the liabilities for the business.

By clicking on the “next” button of input interface 6134, the user can navigate to the page of FIG. 62. Protection layer 6201 for the business can appear based on the input provided. Existing life insurance benefit row 6202 (shown as $1,000,000) shows the amount of existing business owned life insurance for the client, with benefits going to the business at the death of the client. Additional life insurance benefit row 6204 (shown as $0) shows the amount of additional business owned life insurance 6221 for the client entered previously. Total 6206 can be computed by the total of the other components (existing life insurance benefit row 6202, additional life insurance benefit row 6204) in protection layer 6201.

By clicking on the “next” button of input interface 6234, the user can navigate to the page of FIG. 63. Cash flow layer 6306 for the business can also be computed and shown in annual cash flow 6302 (e.g., shown as $0). Annual cash flow 6302 can represent the predicted yearly outflow of monies and can be computed based on business data entered in the business data gathering interfaces described herein (e.g., FIGS. 38-53), and can be based on, for example, predicted debt, predicted cost of doing business, etc.

A user can take into account other liability considerations. By clicking on key person consideration 6301 and clicking on “recalculate”, the user can navigate to the page of FIG. 64. As shown, key person consideration 6402 is selected and liabilities layer 6401 is modified based on the input entered. Key person 6404 is modified and no longer grayed out (showing $3,375,000) based on the business data entered in the business data gathering interfaces described herein. Key person 6404 shows the worth of key persons of the business and the amount of income that would need to be substituted if the key person were lost. Total 6406 (showing $8,375,000) can be computed based on the sum of the modified components of liabilities layer 6401. Owner's equity 6408 can also be modified based on the assets less the liabilities for the business.

A user can take into account other liability considerations. By clicking on mortgages & loans consideration 6420 and clicking on “recalculate”, the user can navigate to the page of FIG. 65. As shown, mortgages & loans consideration 6502 is selected and liabilities layer 6501 is modified based on the input entered. Mortgages & loans 6504 is modified and no longer grayed out (showing $1,500,000) based on the business data entered in the business data gathering interfaces described herein. Mortgages & loans 6504 shows the mortgages owed on property of the business and the loans owed by the business. Total 6506 (showing $9,875,000) can be computed based on the sum of the modified components of liabilities layer 6501. Owner's equity 6508 can also be modified based on the assets less the liabilities for the business. Annual cash flow 6510 (e.g., $300,000) can also be modified to take into account the amount of cash used to pay the mortgaged and loaned amounts.

A user can take into account other liability considerations. By clicking on estate tax consideration 6520 and clicking on “recalculate”, the user can navigate to the page of FIG. 66. As shown, estate tax consideration 6602 is selected and liabilities layer 6603 of the client/family (personal) is modified based on the input entered. Estate tax 6604 is modified and no longer grayed out (showing $0) based on the personal data entered in the personal data gathering interfaces described herein. Total 6606 is recomputed based on the modified components of liabilities layer 6603. Net worth 6608 of the client/family (personal) can also be recomputed based on the assets less the liabilities. Annual cash flow 6638 displays the amount of cash flow (e.g., outflow) from the client/family, for example, to maintain the family and the family's lifestyle, and can be based on personal information, e.g., entered in personal data gathering interfaces as described herein.

By selecting different combinations of liability considerations and stepping to the previous or next steps described above, a user can show the importance and impact of different aspects of the business and the personal (client/family) financial situation.

The next step in the stage for business continuity management can be the display shown in FIGS. 67-123. FIGS. 67-123 show flow charts for a balance sheet summary for the client and the client's business at the death and/or disability of the client if the client's estate/family sells the business. FIGS. 67-123 show different domains for business and personal information which are navigable (e.g., clickable) to drill down to more details about the particular domains. FIGS. 67-123 show one possible sequence of using the interfaces, providing one possible sequence of display of aspects of the business and personal balance sheet summary. Other sequences can also be used without departing from the scope of the invention.

FIG. 67 shows an interface substantially similar to the interface of FIGS. 54-116 except that the scenario selection 6712 is set to “At-Death” and the liability considerations 6701 is cleared (buy/sell check box 6704, key person check box 6706, mortgages & loans check box 6702, and estate tax check box 6708 are de-selected). Accordingly, the balance sheet summary for the business and the client are modified to show the changed financial condition such as changed annual cash flow at death taking into account the additional protection amounts, but not taking into consideration the liabilities.

The summaries shown in FIG. 67 can be the summary shown after the user has clicked on the “next” button of input 6734 through all the steps of the summary, or by clicking on “show all” of input 6734.

In particular, at the death of the client, insurance proceeds as shown in protection layer 6716 for the business including existing life insurance benefit 6742 ($1,000,000) and additional life insurance benefit 6744 ($0) for total 6746 is paid to the business and contributes to the owner's equity 6724. Assets layer 6717 includes liquid assets 6726 ($400,000) and asset total 6727 ($400,000). Because the buy/sell consideration is not taken into account in this scenario, the assets remain with the business. Because the liability considerations are not taken into account in this scenario, liabilities layer 6718 shows total 6755 of $0. As shown, owner's equity 6724 can be computed as the assets less the liabilities plus the insurance protection proceeds ($1,400,000). Cash flow layer 6719 shows an annual cash flow 6729 ($0) based on business data entered previously.

Also, at the death of the client, insurance proceeds as shown in protection layer 6720 for the client's family/estate including existing life insurance benefit 6747 ($2,500,000) and additional life insurance benefit 6748 ($0) for a total shown in total 6749 is paid to the family/estate of the client and contributes to the net worth 6725 of the family/estate. Assets layer 6731 includes business value 6732 which is $0 because the business is selected to be sold at the death of the client in this scenario (keep/sell option 6754 is selected to “sell”). Cash 6733 for assets 6731 is set to $5,000,000 which is the at-death value of the business 6756. Note 6736 ($0) is based on the personal data entered for the client. And total 6735 ($5,000,000) sums the components of assets 6731. Because the liability considerations are not taken into account in this scenario, liabilities layer 6722 shows total 6738 of $0. As shown, net worth 6725 can be computed as the asset less the liabilities plus the insurance protection proceeds ($7,500,000). Cash flow layer 6723 shows an annual cash flow 6753 ($375,000) based on personal data entered previously.

A user can take into account other liability considerations. By clicking on buy/sell consideration 6704 and clicking on “recalculate”, the user can navigate to the page of FIG. 68. As shown, buy/sell consideration 6802 is selected. Because the buy/sell consideration is taken into account, existing life insurance benefit 6842 is set to $0 to show that the payout occurred to fund the buying of the business interest from the family/estate, and liquid assets 6804 is set to $0 for a total of total 6806 ($0) to indicate that liquid assets (formerly $400,000) was used to fund the buying of the business interest from the family/estate. Buy/sell liabilities 6808 ($3,600,000) can be calculated as the at-death value (e.g., $5,000,000) of the business 6856 less the assets sold ($400,000) and less the insurance protection paid out ($1,000,000). The total liabilities 6810 is the sum of the components of liabilities layer 6809, which is the amount owed to the family/estate. Owner's equity 6812 (−$3,600,000) can be computed as the assets less liabilities. Annual cash flow 6814 ($489,125) can be computed as the amount of annual cash outflow necessary to fund the sale of the business.

As shown in this scenario, the business's monies are used by the business to buy the client's interest in the business from the client's family/estate. At the death of the client, business value 6815 is set to $0. Cash 6816 is set to $1,400,000, which is the liquid cash amounts available from the business to fund the purchase of the business interest (e.g., from the business's liquid assets plus insurance benefits). Note 6817 is set to $3,600,000 because this is the amount owed by the business to the family/estate for the remainder of the value of the business at the death of the client. This note 6817 amount is the same as the total liabilities 6810 of the business, as shown, because this scenario only takes into account the buy/sell considerations. Total assets 6818 is the sum of the components of the assets layer 6830.

A user can take into account other liability considerations. By de-selecting buy/sell consideration 6802 and selecting estate tax consideration 6820 and clicking on “recalculate”, the user can navigate to the page of FIG. 69. Thereby, the user can see the impact of the estate tax considerations on the balance sheet summary without the buy/sell considerations. As shown, estate tax consideration 6902 is selected.

Protection layer 6934 of the business, assets layer 6938 of the business, liabilities layer 6936 of the business, owner's equity 6912 of the business, and cash flow 6914 of the business have been modified to show the values of the corresponding layers in FIG. 67 in order to not take into account the buy/sell considerations.

Business value 6915 of assets layer 6930 of the estate is set to $0 because the business is sold. Cash 6916 is reset to $5,000,000 and note 6917 is reset to $0 because the buy/sell scenario is no longer considered. Total 6918 can be computed by the sum of the components of assets layer 6930.

Because estate tax consideration 6920 is selected, liabilities layer 6932 of the estate is modified. Estate tax 6920 (e.g., $3,750,000) is set to the amount of taxes for the assets transferred at the death of the client based on the tax rate for the client previously entered, e.g., in the personal data gathering interfaces. Capital gains tax 6921 ($0) is adjusted for any capital gains. And total 6922 ($3,750,000) can be computed by the sum of the components of liabilities layer 6932.

Net worth 6923 ($3,750,000) can be computed as the assets less the liabilities plus any protection life insurance for the client paid to the estate/family. Annual cash flow 6924 ($187,500) can be computed as the net outflow of monies of the estate/family based on the data input and previous business and personal data gathered.

A user can further take into account other liability considerations. By selecting buy/sell consideration 6901 and selecting estate tax consideration 6902 and clicking on “recalculate”, the user can navigate to the page of FIG. 70. Thereby, the user can see the impact of the estate tax considerations on the balance sheet summary with the buy/sell considerations. As shown, buy/sell consideration 7002 is selected, and estate tax consideration 7004 is selected.

Protection layer 7034 of the business, assets layer 7038 of the business, liabilities layer 7036 of the business, owner's equity 7012 of the business, and annual cash flow 7014 of the business have been modified to show the values of the corresponding layers in FIG. 68 in order to take into account the buy/sell considerations. Also, assets layer 7030 of the estate/family has been modified to take into account the buy/sell considerations.

Liabilities layer 7032 of the estate/family has also been modified to show the values of liabilities layer 6932 of FIG. 69 to take into account the estate tax on the estate of the client. Net worth 7023 and annual cash flow 7024 of the estate/family have also been modified to take into account the buy/sell considerations and the estate tax. As shown, owner's equity 7012, net worth 7023, cash flow 7014 and cash flow 7024 can be modified based on a plurality of combinations of considerations (e.g., buy/sell 7002 and estate tax 7004).

A user can further take into account other liability considerations. By selecting mortgages & loans consideration 7005 and clicking on “recalculate”, the user can navigate to the page of FIG. 71. As shown, buy/sell consideration 7104, mortgages & loans consideration 7106, and estate tax consideration 7110 are selected.

FIG. 71 is substantially similar to FIG. 70, except that liabilities layer 7136 of FIG. 71 has been modified to take into account the mortgages & loans owed by the business at the death of the client. As shown, mortgages & loans 7120 ($1,500,000) can be computed based on the business data previously entered. Total 7122 ($5,100,000) can be computed as the sum of the components of liabilities layer 7136. Owner's equity 7124 can be modified based on the assets less the modified and any protection life insurance for the death of the client. Annual cash flow 7126 can be computed as the cash flow (e.g., outflow) needed to pay debts of the business, including the mortgages & loans.

A user can further take into account other liability considerations. By selecting key person 7108 and clicking on “recalculate”, the user can navigate to the page of FIG. 72. As shown, buy/sell consideration 7204, mortgages & loans consideration 7206, key person 7208, and estate tax consideration 7210 are selected.

FIG. 72 is substantially similar to FIG. 71, except that liabilities layer 7236 has been modified to take into account the key person(s) consideration of the business. As shown, key person(s) 7222 ($3,375,000) can be computed based on the business data previously entered, and in particular the income generated by the key person(s) of the business. Total 7223 ($8,475,000) can be computed as the sum of the components of liabilities layer 7236. Owner's equity 7224 can be modified based on the assets less the modified liabilities plus any protection life insurance for the death of the client. Annual cash flow 7226 can be computed as the cash flow (e.g., outflow) needed to pay debts of the business, including the value of the key person(s).

A user can further take into account additional life insurance for the balance sheet summaries. By modifying the values of the additional life insurance 7201 to be paid to the business and/or the additional life insurance 7202 to be paid to the estate, and clicking on “recalculate”, the user can navigate to the page of FIG. 73. As shown, additional life insurance 7302 to be paid to the business is modified to be $20,000,000 and/or the additional life insurance 7303 to be paid to the estate is modified to be $5,000,000. The values can be limited by pre-set or computed limits. For example, the value of additional personal life insurance can be less than the limits for the business owned life insurance.

Protection layer 7334 of the business is modified to take into account the additional insurance benefits paid to the business at the death of the client. As shown, the existing business owned life insurance benefit 7304 is $0 because that amount ($1,000,000) is used to fund the purchase of the business interest from the client's estate. As shown, the additional business owned life insurance benefit 7305 ($14,500,000) is $20,000,000 less any amounts needed to fund the purchase of the business from the estate/family and/or pay the mortgages and/loans. Total 7306 is the sum of the components of protection layer 7334.

Assets layer 7337 of the business retains the liquid asset 7307 ($400,000) for a total 7308 ($400,000) because the liquid assets need not be used to fund the purchase since the additional life insurance benefit is used to fund the purchase of the business interest from the estate/family.

Liabilities layer 7336 of the business is modified to take into account the additional funds from the additional business owned life insurance. Buy/sell 7309 is set to $0 because the insurance benefits completely funds the buy sell. Mortgages & loans 7310 is also set to $0 because the insurance benefits completely funds the payment of the mortgages & loans. Key person 7311 remains $3,375,000 because the loss of income the key person (the client) remains a liability on the business. Total 7312 can be computed as the sum of the components of liabilities layer 7336.

Owner's equity 7313 ($11,525,000) of the business is the assets less the liabilities and optionally plus any additional business owned life insurance benefits. Annual cash flow 7326 is $0 because the business no longer needs to pay monies to pay the mortgages & loans. As shown, because of the additional monies from the life insurance benefit to the business, the owner's equity 7313 is positive and the business's health remains strong after the death of the client.

Protection layer 7346 of the estate/family is modified to take into account the additional personal life insurance 7303. The existing personal life insurance benefit ($2,500,000) 7315 remains the same, but the additional personal life insurance benefit ($5,000,000) 7316 is increased. Total 7317 can be computed as the sum of the components of protection layer 7346.

Assets layer 7335 of the estate/family is modified to take into account that the business owned life insurance benefit is used to completely fund the purchase of the estate's interest in the business. Business value 7318 is set to $0 to show that the estate/family no longer owns the business. Cash 7319 is set to $5,000,000, the value of the business at the death of the client. Note 7320 is set to $0 because the business no longer owes monies to the estate/family for the purchase. Total 7321 ($5,000,000) can be computed as the sum of the components of assets layer 7335.

Liabilities layer 7331 of the estate/family is modified to take into account the additional monies paid to the estate/family from the additional personal life insurance. Estate tax 7322 ($6,250,000) is increased based on the additional monies. Accordingly, total 7324 ($6,250,000) is also increased.

Net worth 7325 ($6,250,000) of the family/estate can be computed as the assets less the liabilities and any additional life insurance benefits paid to the estate/family. Because of the additional monies from the life insurance benefit to the estate, the net worth 7325 of the family is increased and the annual cash flow 7327 ($312,500) is also increased to levels similar to when the client was still alive, such as, for example, annual cash flow 6638 of FIG. 66. The user and/or client can compare FIG. 73 against, for example, FIGS. 66 and 72 to understand how additional life insurance for both the business and the client can benefit the business and the client's estate after the death of the client.

The next step in the stage for business continuity management can be the display shown in FIGS. 74-81. FIGS. 74-81 show flow charts for a “sell” option strategy for the business to sell the business by the family of the client. The “sell” option strategies can be used to sell the business by the client/client's estate at the death of the client, as described in the scenarios of FIGS. 67-73. FIG. 74 shows an example of a user interface including a summary of different strategy flow charts for keeping or selling a business. As shown, interface 7400 shows a flow chart for one type of purchase scenario, including icons for showing the interrelationships between entities during the purchase. Interface 7400 includes a left hand menu which includes entity purchase option radio box 7402 (currently selected and shown), cross purchase radio box 7403, and mix master radio box 7404. A user can clear the selection by clicking clear button 7405. A user can retrieve more information about an entity purchase, cross purchase, or mix master purchase by clicking links 7406, 7407 and 7408 respectively.

Interface 7400 also includes iconic representation for the selected purchase (e.g., entity purchase), which includes owner A icon 7409 (shown as owning a percentage of the business), owner B icon 7411 (shown as owning a percentage of the business), and the business icon 7410. A user can step through the purchase process by using input interface 7434, by clicking a “previous”, “next”, or “show all” button to show the previous step, next step, or all the steps, respectively.

In operation, a user can click on radio box 7431 to enable the interface shown. The user can also navigate to other interfaces for managing sell flow chart reports by clicking on other radio boxes shown.

By clicking on the “next” button of input interface 7434, the user can navigate to the page of FIG. 75. Arrows 7502 is displayed to show a transfer of insurance benefits from insurance company 7510 to business 7511. Arrow 7504 is displayed to show the transfer of insurance premiums from business 7511 to insurance company 7510.

By clicking on the “next” button of input interface 7534, the user can navigate to the page of FIG. 76. Owner A 7602 will appear crossed out to show that the owner has either died, become disabled, or otherwise no longer in the business.

By clicking on the “next” button of input interface 7634, the user can navigate to the page of FIG. 77. Arrow 7702 is displayed to show that the business interest is transferred from owner A 7710 to business 7711. Arrow 7704 is displayed to show that cash is provided by the business 7711 to owner A 7710 and/or a family of the owner A 7710.

By clicking on the “next” button of input interface 7734, the user can navigate to the page of FIG. 78. The percentage of ownership 7802 of owner A is shown as 0% to show that ownership passes from the owner A. The percentage of ownership 7804 of owner B is shown as 100% to show that ownership passes to the owner B.

FIG. 79 shows a pop-up box 7904 that shows more information about an entity purchase shown in FIGS. 74-78. A user can click on link 7902 to bring up the pop-up box 7904.

FIG. 80 shows an interface displaying all the steps of a cross purchase option for a business. Interface 8000 shows cross purchase option radio box 8002 selected and the complete scenario for the associated cross purchase option shown. The flow chart shows the steps after selecting the “next” button of 8034 through all the steps of the strategy and/or clicking on the “show all” button of 8034. As shown, the flow chart differs from the flow charts of FIGS. 74-79 in that the business 8012 pays insurance premiums 8013 to the insurance company 8014. The insurance benefits 8016 flow to the owner B 8017, and the owner B 8017 pays cash 8020 to owner A 8011 (e.g., estate) in return for the business interest 8018. Owner B 8017 then has 100% of the business and owner A 8011 has 0%.

FIG. 81 shows an interface showing all the steps of a mix master purchase option for a business. Interface 8100 shows mix master purchase option radio box 8102 selected and the complete scenario for the associated mix master purchase option shown. The flow chart shows the steps after selecting the “next” button of 8134 through all the steps of the strategy and/or clicking on the “show all” button of 8134. As shown, the flow chart differs from the flow charts of FIGS. 74-79 and/or FIG. 80 in that owner B 8112 pays the insurance premiums 8114 on owner A 8104's policy to insurance company 8116 and receives the insurance benefits 8120; owner B 8112 provides a loan or capital contribution 8110 to business 8108 which business 8108 uses to pay cash 8118 to owner A 8104 (estate) in return for owner A 8104's business interest 8106.

The next step in the stage for business continuity management can be the display shown in FIGS. 82-88. FIGS. 82-88 show balance sheet summaries for a “keep” option for the business to keep the business by the family of the client. FIGS. 82-88 show different domains for business and personal information which are navigable (e.g., clickable) to drill down to more details about the particular domains. FIGS. 82-88 show one possible sequence of using the interfaces, providing one possible sequence of display of aspects of the business balance sheet summary and personal balance sheet summary. Other sequences can also be used without departing from the scope of the invention.

As shown, FIGS. 82-88 are substantially similar to the summaries of FIGS. 54-73, except that the user has selected to view the scenario of keeping ownership of the business interest by the client's family. The user can show the client the difference in impact to the cash flows, owner's equity, and net worth between a “sell” scenario, (e.g., of FIGS. 54-73), and the “keep” scenario of FIGS. 82-138. As shown in FIG. 82, keep/sell option 8221 is selected to “keep”. Liability considerations layer 8222 does not have a buy/sell option because the keep/sell option 8221 is selected to “keep”. Liability considerations layer 8222 includes mortgages & loans consideration 8223, key person consideration 8224, and estate tax consideration 8225. Scenario assumption 8226 is selected to “current” to show that the summary shown is that of the current situation before the client has died.

The summaries shown in FIG. 82 can be the summary shown after the user has clicked on the “next” button of input 8234 through all the steps of the summary, or by clicking on “show all” button of input 8234. In operation, the user can also click on the radio box 8235 to enable the display shown.

As shown, protection layer 8205 of the business, assets layer 8208 of the business, protection layer 8206 of the client/family (personal), assets layer 8229 of the client, liabilities layer 8230 of the client, net worth 8232 of the client, and cash flow 8233 of the client are substantially similar to the corresponding components of FIGS. 54-66. Estate tax 8231 of liabilities layer 8230 is grayed out and set to $0 because estate tax consideration 8225 is de-selected.

The difference between FIG. 82 and FIGS. 54-66 is that liabilities layer 8209 has buy/sell 8210, mortgages & loans 8211, and key person 8212 grayed out and set to $0 to indicate that these components are not taken into account for the business. Total 8213 is accordingly summed to $0. Owner's equity 8214 ($400,000) is the asset less the liabilities for the business. Annual cash flow 8215 is $0 because there is no outflow for liabilities for the business in the “current” scenario.

A user can take into account other liability considerations or combinations of liability considerations. By clicking on mortgages & loans consideration 8223, key person consideration 8224, and estate tax consideration 8225, and clicking on “recalculate”, the user can navigate to the page of FIG. 83. As shown, mortgages & loans consideration 8301, key person consideration 8302, and estate tax consideration 8303 are selected and liabilities layer 8304 of the business and liabilities layer 8305 of the client are modified based on the input entered. Liabilities layer 8305 of the client has estate tax 8306 non-grayed out to indicate that the estate tax is taken into consideration. Liabilities layer 8304 of the business now takes into account mortgages & loans 8311 ($1,500,000), key person 8312 ($3,375,000), but does not take into account buy/sell 8310 ($0) because the scenario is a “keep” scenario. Total 8313 ($4,875,000) is the sum of the components of liabilities layer 8304. Owner's equity 8314 (−$4,475,00) is the assets less the liabilities. Annual cash flow 8315 ($300,000) shows the outflow of cash needed to pay for the liabilities.

The next step in the stage for business continuity management can be the display shown in FIGS. 84-88. FIGS. 84-88 show flow charts for a balance sheet summary for the client and the client's business at the death and/or disability of the client when the client's estate/family keeps the ownership of the business. The user can show the client the difference in impact to the cash flows, owner's equity, and net worth between a “sell” scenario, (e.g., of FIGS. 54-73), and the “keep” scenario of FIGS. 82-88. FIGS. 84-88 show different domains for business and personal information which are navigable (e.g., clickable) to drill down to more details about the particular domains. FIGS. 84-88 show one possible sequence of using the interfaces, providing one possible sequence of display of aspects of the business and personal balance sheet summary. Other sequences can also be used without departing from the scope of the invention.

The summaries shown in FIG. 84 can be the summary shown after the user has clicked on the “next” button of input 8434 through all the steps of the summary, or by clicking on “show all” of input 8434.

As shown in FIG. 84, mortgages & loans 8403, key person 8404, and estate tax 8405 is de-selected. Scenario assumptions 8406 is set to “At-Death”, and the value at protection layers 8415 and 8416, and assets 8408 and 8429 are substantially similar to the corresponding components of FIGS. 82-88.

Liabilities layer 8409 of the business has buy/sell 8410, mortgages & loans 8411, and key person 8412 grayed out and set to $0 because those components are not taken into account in this scenario. Total 8413 ($0) can be the sum of the components of liabilities layer 8409. Owner's equity 8414 is the assets less the liabilities plus any protection insurance, e.g., from protection layer 8415. Annual cash flow 8440 is $0 because no cash is paid by the business to pay for its liabilities.

Liabilities layer 8430 of the client/estate has estate tax 8442 grayed out and set to $0 because estate tax 8405 is not taken into account. Capital gains tax 8443 is $0 because the estate does not sell the business in this scenario (“keep” scenario). Total 8444 is the sum of the components of liabilities layer 8430. Net worth 8448 ($7,500,000) is the assets less the liabilities plus any protection insurance, (e.g., from protection layer 8416). Annual cash flow 8449 ($375,000) can be the amount of cash paid by the family/estate to maintain the family/estate, lifestyle, cost of living, etc.

A user can take into account other liability considerations. By selecting estate tax 8405 and clicking on “recalculate”, the user can navigate to the page of FIG. 85. As shown, estate tax 8512 is selected. Estate tax 8503 is non-grayed out and set to $3,750,000 to account for the tax on the value of the business retained by the estate/family based on the tax rate previously entered into the personal data interfaces described herein. Capital gains tax 8504 ($0) remains $0 because no sale of the business occurs. Total 8505 ($3,750,000) is the sum of the components of liabilities layer 8532. Net worth 8506 ($3,750,000) is the assets less the liabilities plus any protection insurance. Annual cash flow 8507 ($187,500) can the amount of cash paid by the family/estate to maintain the family/estate after the death of the client.

The user can show the client that net worth 8506 and annual cash flow 8507 is substantially less than the net worth 8448 and the annual cash flow 8449 of FIG. 84 given the at-death protection scenario in FIG. 85.

A user can further take into account other liability considerations. By selecting mortgages & loans 8511 and clicking on “recalculate”, the user can navigate to the page of FIG. 86. As shown, mortgage & loans 8602 and estate tax 8603 are selected. FIG. 86 is substantially similar to FIG. 85, except liabilities layer 8604 of the business is modified to take into account the mortgages & loans consideration. Buy/sell 8610 remains grayed out and set to $0 because this is a “keep” scenario. Mortgages & loans 8611 ($100,000) is set to the amount owed by the business that was previously entered with business data entry interfaces described herein. Key person 8612 remains grayed out and set to $0. Total 8613 ($100,000) is the total of the components in liabilities layer 8604. Owner's equity 8614 (−$100,000) can be computed as the liabilities less the assets plus any protection from protection layer 8623. Existing life insurance benefit 8624 of protection layer 8623 is set to $0 to show that the benefit is paid to the business. Annual cash flow 8615 ($20,000) is the amount of cash paid by the business to satisfy liabilities, annually.

The user can show the client owner's equity 8614 and annual cash flow 8615 compared to owner's equity 8414 and annual cash flow 8440 of FIG. 84 to show the benefit of added life insurance for the client with benefits paid to the business.

A user can further take into account other liability considerations. By selecting key person 8601 and clicking on “recalculate”, the user can navigate to the page of FIG. 87. As shown, mortgages & loans 8705, estate tax 8706, and key person 8707 are selected. FIG. 87 is substantially similar to FIG. 86, except, liabilities layer 8704 of the business is modified to take into account the value due to the key person of the business (e.g., the client). Buy/sell 8710 remains grayed out and set to $0 because this is a “keep” scenario. Mortgages & loans 8711 ($100,000) is set to the amount owed by the business that was previously entered with business data entry interfaces described herein. Key person 8712 ($3,375,000) is modified based on the business data entered in business data interfaces described herein. The key person 8712 value can be based on the income generated by the key person. Total 8713 ($3,475,000) is the total of the components in liabilities layer 8704. Owner's equity 8714 (−$3,475,000) can be computed as the liabilities less the assets plus any protection from protection layer 8723. Existing life insurance benefit 8724 of protection layer 8723 is set to $0 to show that the benefit is paid to the business. Annual cash flow 8715 ($20,000) is the amount of cash paid by the business to satisfy its liabilities, annually.

A user can further take into account additional life insurance for the balance sheet summaries. By modifying the values of the additional life insurance 8732 to be paid to the business and/or the additional life insurance 8734 to be paid to the estate, and clicking on “recalculate”, the user can navigate to the page of FIG. 88. As shown, additional life insurance 8802 to be paid to the business is modified to be $20,000,000 and/or the additional life insurance 8803 to be paid to the estate is modified to be $5,000,000. The values can be limited by pre-set or computed limits. For example, the value of additional personal life insurance can be less than the limits for the business owned life insurance. FIG. 88 is similar to FIG. 87, except that the additional insurance is taken into account in the different domains of the summaries.

Protection layer 8834 of the business is modified to take into account the additional insurance benefits paid to the business at the death of the client. As shown, the existing business owned life insurance benefit 8804 is $0 because that amount ($1,000,000) is paid to the business. The additional business owned life insurance benefit 8805 ($19,500,000) is $20,000,000 less any amounts needed to pay the liabilities of the business, e.g., to pay the mortgages and/loans. Total 8806 is the sum of the components of protection layer 8834.

Liabilities layer 8836 of the business is modified to take into account the additional funds from the additional business owned life insurance. Buy/sell 8809 is set to $0 and grayed out because the business is not sold in this scenario. Mortgages & loans 8810 is also set to $0 because the insurance benefits completely funds the payment of the mortgages & loans. Key person 8811 remains $3,375,000 because the loss of income of the key person (the client) remains a liability on the business. Total 8812 ($3,375,000) can be computed as the sum of the components of liabilities layer 8836.

Owner's equity 8813 ($16,535,000) of the business is the assets less the liabilities and optionally plus any additional business owned life insurance benefits. Annual cash flow 8814 is $0 because the business no longer needs to pay monies to pay the mortgages & loans. As shown, because of the additional monies from the life insurance benefit to the business, the owner's equity 8814 is positive and the business's health remains strong after the death of the client.

Protection layer 8835 of the estate/family is modified to take into account the additional personal life insurance. The existing personal life insurance benefit ($2,500,000) 8815 remains the same, but the additional personal life insurance benefit ($5,000,000) 8816 is increased. Total 8817 can be computed as the sum of the components of protection layer 8835.

Liabilities layer 8837 of the estate/family is modified to take into account the additional monies paid to the estate/family from the additional personal life insurance. Estate tax 8818 ($6,250,000) is increased based on the additional monies. Accordingly, total 8820 ($6,250,000) is also increased.

Net worth 8821 ($6,250,000) of the family/estate can be computed as the assets less the liabilities and any additional life insurance benefits paid to the estate/family. Because of the additional monies from the life insurance benefit to the estate, the net worth 8821 of the family is increased and the annual cash flow 8822 ($312,500) is also increased to levels when the client was still alive, such as, for example, annual cash flow 8223 of FIG. 82. The user and/or client can compare FIG. 88 against the other summaries shown to understand how additional life insurance for both the business and the client benefits the business and the client's estate after the death of the client.

The next step in the stage for business continuity management can be the display shown in FIGS. 89-90. FIGS. 89-90 show flow charts for a “keep” option for the business to keep the business by the family of the client. FIG. 89 shows an example of a user interface including business continuity keep/sell observations and more particularly keep flow charts. Interface 8900 includes a left hand menu for controlling the display of various flow charts to show strategies for keeping a business by a family. The left hand menu includes business to spouse radio box 8901 (shown checked to indicate that the business to spouse flow chart is shown), and business to children radio box 8903. Clear button 8950 can be used to clear the selection. The left hand menu also includes supplemental information, which includes business to spouse link 8907 usable for retrieving more information about the business to spouse strategy, and business to children link 8908 usable for retrieving more information about the business to children strategy.

As shown, by arrow 8910, 100% of the interest in business 8902 is willed to spouse 8904. Arrow 8909 shows that spouse 8904 wills the business to children 8911 at spouse 8904's death. Currently, children have 0% of the business.

In operation, a user can select button 8931 to enable the interface shown. A user can use the “previous”, “next”, and “show all” buttons of input interface 8934 to step back and forth through the flow chart to show different parts of the flow chart and/or to show the complete flow chart (as shown).

The next step in the stage for business continuity management can be the display shown in FIG. 90. FIG. 90 shows an example of a user interface including business continuity keep/sell observations and more particularly keep flow charts. Interface 9000 includes a left hand menu which includes business to children radio box 9007 (checked to show that the business to children flow chart is shown).

As shown in the business to children flow chart, arrow 9003 shows that 100% interest of the business 9002 is willed by the client to the children 9006. Spouse 9004 receives 0% of the business 9002.

In operation, a user can use the “previous”, “next”, and “show all” buttons of input interface 9034 to step back and forth through the flow chart to show different parts of the flow chart and/or to show the complete flow chart (as shown).

The next step in the stage for business continuity management can be the display shown in FIG. 91. FIG. 91 shows an example of a user interface including a business continuity component with key person(s) insurability information. Interface 9100 includes asset insurance assessment table 9145. Each row of table 9145 describes one type of asset 9101 for the business, a value 9103 of the asset, the level of insurance 9104 of the asset, and an assessment 9105 of the level of insurance (e.g., optimal, no protection, etc.). The types of assets 9101 includes inventory 9102, vehicles 9156, furniture 9107, and equipment 9108.

The table 9145 also includes show key person check box 9109 (shown as checked). Checking check box 9109 shows information associated with the key person of the business, thereby showing that the key person is also an asset of the business.

Key persons table 9146 includes for each key person of the business, the name 9110 of the person (e.g., Kyle Abernathy, Kevin Abernathy, Louis Jones, Martha Smith), annual compensation 9112 of the person, factor 9113 of the person (which allows selection of the number of multiples of the annual compensation 9112 the person is valued at), value 9114 (which is the annual compensation 9412 times the factor 9113), level of insurance 9115, and assessment of the adequacy of the insurance protection 9116 for the key person (e.g., shown as “No Protection” because there is no current insurance for the key persons). Total 9118 shows the total of the value of the key persons and the level of insurance to give the user/client a comparison about how well the key person's assets of the business are protected.

Total 9117 also provides the total of the value of the key persons. Total 9130 provides the total of the insurance for the key persons. Remaining key person insurability 9131 shows the amount of insurance still needed to insure the key persons.

In operation, a user can change the level of insurance 9104, factor 9113, or other components of interface 9100 to recompute the assessments 9105 and/or 9116 and/or the totals shown. The user can also click on “save” button 9133 to save the current key person's insurability scenario. The user can also click on supplemental information link 9132 to navigate to a page with more information about the insurability of a key person.

The next step in the stage for business continuity management can be the display shown in FIG. 92. FIG. 92 shows an example of a user interface including business continuity information with information about mortgages & loans pay out versus the business's cash flow. Interface 9200 includes a left hand menu for controlling the assumptions 9202 and payment 9204 for the mortgages & loans. Assumptions component 9202 includes business tax rate 9207 (e.g., selected at 35.0%), profit margin 9208 (e.g., selected at 10.0%), loan type 9209 (e.g., for entering the type of loan, e.g., mortgage), original mortgage or loan amount 9210 (e.g., entered as $750,000), current balance 9211 (e.g., entered as $627,475), mortgage or loan rate 9212 (e.g., entered as 5.990%), mortgage term 9213 (e.g., entered as 30 years), years to payoff 9214 (e.g., entered as 20 years).

Payment component 9204 includes mortgage payment 9215 (e.g., entered as $54,662).

In operation, a user can click on the “recalculate” button of input 9218 to display the graphs/charts. The user can click on the “clear” button to clear the left hand inputs. The user can click on show details radio box 9216 (shown as checked) to show the full details of the left hand menu, or de-select the radio box 9216 to show less information. The user can click on supplemental information link 9217 to navigate to page with additional information about mortgages & loans for a business.

Interface 9200 also includes liabilities payoff chart 9201 which is based on the input entered. As shown, the chart shows the liability payoff for the mortgage or loan entered in dollars over a period of years (e.g., years to payoff 9214 and/or mortgage term 9213). The total debt 9203 is also shown in conjunction (e.g., overlaid) chart 9201 and can be computed as the principle plus interest (e.g., based on the rate) paid on the debt.

Cash flow chart 9205 shows the cash flow required in dollars over a period of years (e.g., years to payoff 9214 and/or mortgage term 9213) to pay the loan amount entered based on the mortgage payment amount 9215, principal, and/or rate entered.

Total cash flow required 9206 also shows the total cash flow required summed over the period of years needed to pay the loan or mortgage entered. Thereby, the user can use interface 9200 to show the client the comparison between the mortgage and/or loan debt versus the cash flow of the businesses needed to pay off the debt.

Business Sponsored Benefits Data Gathering and Presentation

The user can choose to manage business sponsored benefits of a business of a client. FIGS. 93-130 show interfaces for managing retirement benefits. FIG. 93 shows an example of a user interface including business sponsored benefits with information for retirement plans, and in particular an overview introduction of retirement plans. The interface includes retirement plans component 9300. Component 9300 includes menu items for navigating to different aspects of retirement planning, including overview radio box 9307 (checked to show that the current interface is the overview), design center radio box 9308, defined benefits radio box 9309, and defined contribution radio box 9310. A user can select any of the radio boxes to navigate to the associated pages for retirement planning. Component 9300 further includes menu items specific to the overview information which includes introduction menu tab highlighted 9306 (currently highlighted and currently shown), retirement cash flow menu tab 9305, Permanent Life Insurance (PLI) solution menu tab 9304, and common arrangements menu tab 9303. A user can click on any of the menu items to navigate to the associated planning component. On the current page, as shown, a user can select to manage insurance for owners or key employees 9301 or insurance for owners and all employees 9302 by clicking on the appropriate icon.

The next step in the stage for business sponsored benefits management can be the display shown in FIG. 94. FIG. 94 shows an example of a user interface for managing business sponsored benefits, and in particular retirement plans and retirement cash flow information. As shown, the overview section is still displayed and the associated overview radio box 9407 is checked. Retirement cash flow menu tab 9405 is selected and the associated retirement cash flow information is presented. Component 9400 includes assumptions layer 9406, guaranteed retirement income layer 9403, and business sponsored benefits layer 9401. A user can use input 9446 to recalculate and render pre-retirement and post-retirement income chart 9402.

Pre-retirement and post-retirement income chart 9402 shows bar charts over time of pre-retirement income up to an age (e.g., 65), and post-retirement income beginning at or around that age (e.g., 62). The income bars can be stacked one on top of the other to shown an aggregation of income. Different income sources (e.g., post-retirement income) can be shown in different colors.

Assumptions layer 9406 includes age layer under assumptions column 9418, years to retirement 9410, study period 9411, current income 9412, income increase 9413, annual savings rate 9414, current retirement value 9415, pre-retirement rate of return 9416, and post-retirement rate of return 9417. Pre-retirement and post-retirement income chart 9402 shows for the study period 9411, the current income bars 9453 starting from the current age, growing until the year to retirement 9410. For each year, income increases by increase rate 9413. Moreover, a savings amount of the current retirement value 9415 can grow at an annual savings rate 9414, and with pre-retirement rate of return 9416 before retirement and a post-retirement rate of return 9417 after retirement. The savings can supplement the income in retirement. As shown, savings bar charts 9451 can also be shown as stacked bar charts.

Guaranteed retirement income layer 9403 includes benefit amount 9418, growth rate 9419, benefit start age 9420, and length of benefits 9421. Pre-retirement and post-retirement income chart 9402 shows the guaranteed retirement income charts 9454, 9452 starting at start age 9420 which can be before retirement age, and continuing for the length of the benefits 9421, and growing at growth rate 9419.

Business sponsored benefits layer 9401 includes benefit amount 9440, growth rate 9443, benefit start age 9444, and length of benefits 9445. Pre-retirement and post-retirement income chart 9402 shows business sponsored benefits bar charts 9450 supplementing retirement income for the specified benefit amount 9440, growing at the specified growth rate 9443 from the benefit start age 9444 for the duration of the length of benefits 9445.

The next step in the stage for business sponsored benefits management can be the display shown in FIG. 95. FIG. 95 shows an example of a user interface including business sponsored benefits with retirement plans overview information and more particularly Permanent Life Insurance (PLI) solution information. The interface includes component 9500. A menu of the current page of component 9500 includes in the plan radio box 9505 (checked to show that the current display is of “in the plan” benefits), and out of the plan radio box 9506. A user can clear the selection by clicking on the “clear” button.

Component 9500 includes protection layer 9501, asset building layer 9502, liabilities layer 9503, cash flow layer 9504, and cost of living factors component 9519.

Protection layer 9501 includes premature death benefit tab 9507, disability tab 9508, lawsuit tab 9509, and increasing death benefit tab 9510. As shown, for “in the plan” benefits, protection can cover all the highlighted tabs for this layer.

Asset building layer 9502 includes rate of return tab 9511, minimal risk tab 9512, builds net worth tab 9513, and liquidity tab 9530. As shown, for “in the plan” benefits, protection can cover all the highlighted tabs for this layer. The un-highlighted tabs (liquidity 9530) show that there is inadequate liquidity for this plan.

Liabilities layer 9503 includes tax advantaged accumulation tab 9514, alternate credit source tab 9520, tax advantaged distributions tab 9521, and income tax free at death tab 9518. As shown, for “in the plan” benefits, protection can cover all the highlighted tabs for this layer. The un-highlighted tabs (alternate credit source tab 9520, tax advantaged distributions tab 9521) show that there are inadequate alternate credit sources and/or tax advantaged distributions for this plan.

Cash flow layer 9504 includes form of savings tab 9515, systematic tab 9517, flexible funding options tab 9522, and flexible distribution options tab 9523. As shown, for “in the plan” benefits, protection can cover all the highlighted tabs for this layer. The un-highlighted tabs (flexible funding options tab 9522, and flexible distribution options tab 9523) show that there are inadequate flexible funding options and/or flexible distribution options for this plan.

Cost of living factors component 9519 includes inflation layer 9524, all forms of taxes layer 9525, new goods and services layer 9526, product wear and tear layer 9529, improved standard of living layer 9527, and unexpected life events layer 9528. Component 9519 provides links to information about the cost of living factors affecting the type of benefits (e.g., “in the plan” versus “out of plan”).

In operation, the user can visually be given information comparing retirement options for a client's business in a side-by-side and selectable fashion.

The next step in the stage for business sponsored benefits management can be the display shown in FIG. 96. FIG. 96 shows an example of a user interface including business sponsored benefits with retirement plans overview information and more particularly Permanent Life Insurance (PLI) solution information. FIG. 96 is substantially similar to FIG. 95 except FIG. 96 includes components directed to “out of the plan” options for retirement benefits.

The interface includes component 9600 which includes a menu of the current page. In the plan radio box 9605, and out of the plan radio box 9606 (checked to show that the current display is of “out of the plan” benefits). A user can clear the selection by clicking on the “clear” button.

As shown, protection layer 9601 has each component highlighted. Asset building layer 9602 has each component highlighted including liquidity 9630 to show that there is adequate liquidity for this plan.

Liabilities layer 9603 has each component highlighted including alternate credit source tab 9620 and tax advantaged distributions tab 9621 highlighted to show that there are adequate alternate credit sources and/or tax advantaged distributions for this plan.

Cash flow layer 9604 has each of its components highlighted including flexible funding options tab 9622, and flexible distribution options tab 9623 highlighted to show that there are adequate flexible funding options and/or flexible distribution options for this plan.

In operation, the user can visually be given information comparing retirement options for a client's business in a side-by-side and selectable fashion.

The next step in the stage for business sponsored benefits management can be the display shown in FIG. 97. FIG. 97 shows an example of a user interface including business sponsored benefits for retirement plans overview and more particularly common arrangements and defined benefits information. Component 9700 includes a navigation menu with common arrangements menu tab 9704 highlighted to show that common arrangements information is shown. Additionally, particular common arrangements are shown. Defined benefits radio box 9705 is checked to show the defined benefits scenario. Defined contribution radio box 9706 is unchecked. A user can click the “clear” button to clear these choices.

Component 9700 shows a flow chart of the cash flow for a defined benefits retirement plan to be presented to a user and/or client. Each of the icons and arrows can be displayed one at a time in a sequence of steps by using input 9731. A user can see the next step in the flow chart by clicking “next”, see the previous step by clicking “prev”, and/or show all the steps at once by clicking “show all”.

In one sequence, business 9712 can appear to show that the cash for the retirement begins with the business. Retirement benefit funding arrow 9708 pointing to defined benefits can appear next to show that the funding for the retirement can transfer from the business to the defined benefits 9714.

Next, predetermined retirement benefit arrow 9709 pointing to participant can appear to show that the benefit can flow from the defined benefits plan to the participant 9713. Next, an arrow can be displayed to show cash moving from participant 9713 to retirement benefits flow 9710. Next, an arrow can be displayed to show the benefits of the plan for the participant 9713: PLI benefits displaying protection/rate of return/tax advantages/flexibility 9711.

Also, PLI premium arrow 9716 can appear to show PLI premium for the defined benefits 9714 flowing to the insurance company 9718. From insurance company 9718, PLI benefits arrow 9715 is displayed to show the PLI benefits realized for the defined benefits plan.

The next step in the stage for business sponsored benefits management can be the display shown in FIG. 98. FIG. 98 shows an example of a user interface including business sponsored benefits for retirement plans overview and more particularly common arrangements and defined benefits information. Component 9800 includes particular common arrangements for retirement plans. Defined contribution radio box 9806 is checked to show the defined contribution scenario. Defined benefits radio box 9805 is unchecked. A user can click the “clear” button to clear these choices.

Component 9800 shows a flow chart of the cash flow for a defined contribution retirement plan to be presented to a user and/or client. Each of the icons and arrows can be displayed one at a time in a sequence of steps by using input 9831. A user can see the next step in the flow chart by clicking “next”, see the previous step by clicking “prev”, and/or show all the steps at once by clicking “show all.”

In one sequence, business 9813 can appear to show that the cash for the retirement begins with the business. Next, retirement contributions arrow 9807 pointing to defined contribution can appear to show that the cash funds the defined contribution 9812. Next, accumulated retirement values arrow 9811 pointing to participant 9817 can appear to show that the accumulated retirement values benefits are provided to the participant 9817. Also, deferrals dotted arrow 9809 pointing from participant to defined contribution can appear to show that optionally, the participant can defer some contributions.

Also, an arrow from participant 9817 to retirement benefits 9810 can appear to show that the participant can retain or obtain the benefits. Additionally, another arrow can appear between participant 9817 to PLI benefits displaying protection/rate of return/tax advantages/flexibility 9818 to show the advantages to the participant for receiving these retirement benefits.

Additionally, PLI premium arrow 9814 pointing to insurance company can appear to show that PLI premium flows from the defined contribution plan to the insurance company 9816. The PLI benefits arrow 9815 pointing to defined contribution can appear to show that insurance company 9816 provides the benefits to the defined contribution plan.

The next step in the stage for business sponsored benefits management can be the display shown in FIG. 99. FIG. 99 shows an example of a user interface including business sponsored benefits and retirement plans, and, in particular, showing a design center. As shown, the interface 9900 includes owners or key employees icon 9902, and owners and all employees icon 9903. A user can click on the appropriate icon to receive retirement plan information for owners or key employees and/or owners and all employees. In operation, a user can click radio box 9907 to enable the display shown, or can select other radio boxes to navigate to other sections of the retirement plans design center.

The next step in the stage for business sponsored benefits management can be the display shown in FIG. 100. FIG. 100 shows an example of a user interface including business sponsored benefits and retirement plans and more particularly owners or key employees information. As shown, interface 10000 includes a decision tree for owners and employees, configured to select answers to questions, wherein an answer leads to another question, until a final suggestion or answer is reached. The tree path can be pre-defined or generated, based on the information entered about the business and/or client. For example, for a business with income between particular ranges, particular trees can be generated or selected (e.g., asking questions about whether the owner of the business is a partnership).

As shown, an example of the decision tree for owners and employees includes question “Are the owners older than age 50?” input box 10002 (e.g., showing answer “Yes”), question “Does the owner earn more than $185,000?” input box 10003 (e.g., showing answer “Yes”), question “Do you conduct your business with no employees?” input box 10004 (e.g., showing answer “No”), question “Are there 1-5 employees in the business?” input box 10005 (e.g., showing answer “Yes”), question “Are the employees younger than the owners?” input box 10006 (e.g., showing answer “Yes”), question “Is there predictable cash flow?” input box 10007 (e.g., showing answer “No”).

A suggestion 10009 of a retirement plan for owners and/or employees is provided based on the answers to the decision tree. For example, the suggestion 10009 shown is to use a “defined contribution-age based profit sharing plan/401k plan”. A user can also provide the client with additional information about the suggested plan and/or other plans by clicking on the links under the supplemental information 10010 section. More than one suggestion can also be provided.

In operation, the user can also click on answer 10009 to receive more information about the suggested plan, as for example, shown in FIGS. 101-113.

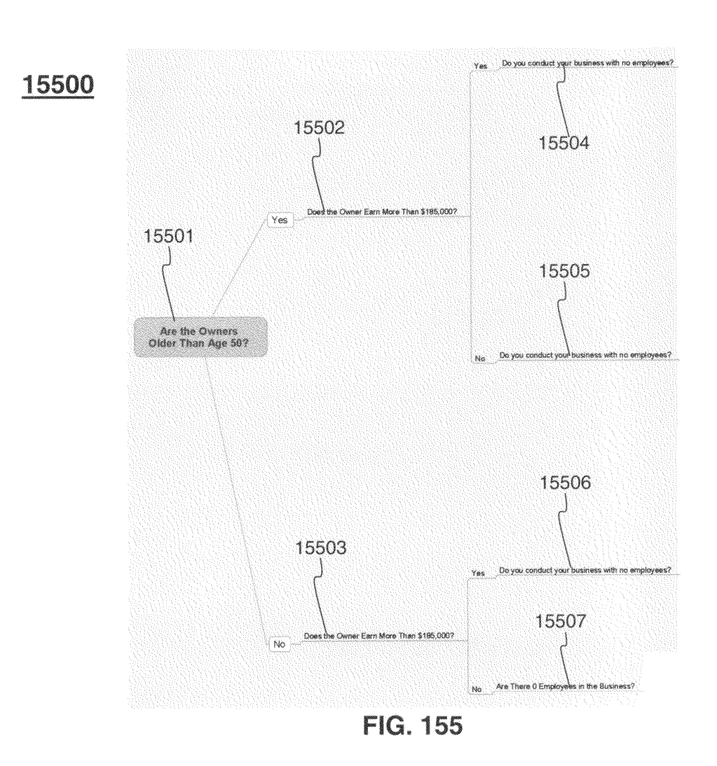

FIGS. 155-159 show an example of a decision tree for determining a qualified plan. As shown, question 15501 asks “Are the Owners Older Than Age 50?”. If the answer is “Yes”, the tree branches to question 15502, which asks “Does the Owner Earn More Than $185,000?” If the answer is “No”, the tree branches to question 15503 which asks “Does the Owner Earn More Than $185,000?”

If at question 15502, the answer is “Yes”, the tree branches to question 15504 “Do you conduct your business with no employees?” If at question 15502, the answer is “No”, the tree branches to question 15505 “Do you conduct your business with no employees?”

If at question 15503, the answer is “Yes”, the tree branches to question 15506 “Do you conduct your business with no employees?” If at question 15503, the answer is “No”, the tree branches to question 15507 “Are There 0 Employees in the Business?”

If at question 15504, the answer is “Yes”, the tree branches to question 15508 “Is there predictable Cash Flow?”. If at question 15504, the answer is “No”, the tree branches to question 15509 “Are There 1-5 Employees in the Business?”

If at question 15505, the answer is “Yes”, the tree branches to question 15510 “Is there predictable Cash Flow?”. If at question 15505, the answer is “No”, the tree branches to question 15511 “Are There 1-5 Employees in the Business?”

If at question 15506, the answer is “Yes”, the tree branches to question 15512 “Is there predictable Cash Flow?”. If at question 15506, the answer is “No”, the tree branches to question 15513 “Is there predictable Cash Flow?”.

If at question 15507, the answer is “Yes”, the tree branches to question 15514 “Is there predictable Cash Flow?”. If at question 15507, the answer is “No”, the tree branches to question 15515 “Is there predictable Cash Flow?”.

If at question 15508, the answer is “Yes”, the tree branches to answer 15516 “Fully Insured Plan”. If at question 15508, the answer is “No”, the tree branches to answer 15517 “Profit Sharing Plan/401(k)”.

If at question 15509, the answer is “Yes”, the tree branches to question 15518 “Are the Employees Younger than the Owners?” If at question 15509, the answer is “No”, the tree branches to question 15519 “Are the Employees Younger than the Owners?”

If at question 15510, the answer is “Yes”, the tree branches to answer 15520 “Fully Insured Plan”. If at question 15510, the answer is “No”, the tree branches to answer 15521 “Profit Sharing Plan/401(k)”.

If at question 15511, the answer is “Yes”, the tree branches to question 15522 “Are the Employees Younger than the Owners?” If at question 15511, the answer is “No”, the tree branches to question 15523 “Are the Employees Younger than the Owners?”

If at question 15512, the answer is “Yes”, the tree branches to answer 15524 “Age Based PSP/401(k).” If at question 15512, the answer is “No”, the tree branches to answer 15525 “Age Based PSP/401(k).”

If at question 15513, the answer is “Yes”, the tree branches to question 15526 “Profit Sharing Plan/401(k).” If at question 15513, the answer is “No”, the tree branches to question 15527 “Profit Sharing Plan/401(k).”

If at question 15514, the answer is “Yes”, the tree branches to answer 15528 “New Comparability PSP/401(k).” If at question 15514, the answer is “No”, the tree branches to answer 15529 “New Comparability PSP/401(k).”

If at question 15515, the answer is “Yes”, the tree branches to answer 15530 “PSP/401(k).” If at question 15515, the answer is “No”, the tree branches to answer 15531 “PSP/401(k).”

If at question 15518, the answer is “Yes”, the tree branches to question 15532 “Is there predictable cash flow?” If at question 15518, the answer is “No”, the tree branches to question 15533 “Is there predictable cash flow?”

If at question 15519, the answer is “Yes”, the tree branches to question 15534 “Is there predictable cash flow?” If at question 15519, the answer is “No”, the tree branches to question 15535 “Is there predictable cash flow?”

If at question 15522, the answer is “Yes”, the tree branches to question 15536 “Is there predictable cash flow?” If at question 15522, the answer is “No”, the tree branches to question 15537 “Is there predictable cash flow?”

If at question 15523, the answer is “Yes”, the tree branches to question 15538 “Is there predictable cash flow?” If at question 15523, the answer is “No”, the tree branches to question 15539 “Is there predictable cash flow?”

If at question 15532, the answer is “Yes”, the tree branches to answer 15540 “Fully Insured Plan.” If at question 15532, the answer is “No”, the tree branches to answer 15541 “Age Based Profit Sharing Plan/401(k).”

If at question 15533, the answer is “Yes”, the tree branches to answer 15542 “Fully Insured Plan.” If at question 15533, the answer is “No”, the tree branches to answer 15543 “Age Based Profit Sharing Plan/401(k).”

If at question 15534, the answer is “Yes”, the tree branches to answer 15544 “Defined Benefits Plan.” If at question 15534, the answer is “No”, the tree branches to answer 15545 “New Comparability PSP/401(k).”

If at question 15535, the answer is “Yes”, the tree branches to answer 15546 “Profit Sharing Plan/401(k).” If at question 15535, the answer is “No”, the tree branches to answer 15547 “Profit Sharing Plan/401(k).”

If at question 15536, the answer is “Yes”, the tree branches to answer 15548 “Age Based PSP/401(k).” If at question 15536, the answer is “No”, the tree branches to answer 15549 “Age Based PSP/401(k).”

If at question 15537, the answer is “Yes”, the tree branches to answer 15550 “Profit Sharing Plan/401(k).” If at question 15537, the answer is “No”, the tree branches to answer 15551 “Profit Sharing Plan/401(k).”

If at question 15538, the answer is “Yes”, the tree branches to answer 15552 “New Comparability PSP/401(k).” If at question 15538, the answer is “No”, the tree branches to answer 15553 “New Comparability PSP/401(k).”

If at question 15539, the answer is “Yes”, the tree branches to answer 15554 “PSP/401(k).” If at question 15539, the answer is “No”, the tree branches to answer 15555 “PSP/401(k).”

The next step in the stage for business sponsored benefits management can be the display shown in FIG. 101. FIG. 101 shows an example of a user interface including business sponsored benefits and retirement plans, and more particularly information and highlights about defined benefits. As shown, interface 10100 includes a left hand menu which includes highlights radio box 10101 (shown as checked to enable display of the current highlights page), flowchart radio box 10102, and example radio box 10103. Interface 10100 includes information box 10104 which provides, for example, the suggested defined benefits from FIG. 100. Information box 10104 includes a plurality of plan features 10105-10110, which can appear in a sequence when a user clicks on the “next” button of input interface 10131. The user can go to the previous feature by clicking on “previous” or show all the features by clicking on “show all” of input interface 10131.

In operation, the user can click on radio box 10130 to enable the interface shown and/or can navigate to other pages by clicking on flowchart radio box 10102, and/or example radio box 10103 to display a flowchart and/or example of the defined benefit.

The next step in the stage for business sponsored benefits management can be the display shown in FIG. 102. FIG. 102 shows an example of a user interface including business sponsored benefits and retirement plans, and, more particularly, a flow chart about defined benefits.

As shown, flow chart radio box 10222 is selected to display the flow chart. The flow chart shows business 10202 providing retirement benefit funding 10201 (represented as an arrow) to defined benefits 10210. Defined benefits 10210 provides predetermined retirement benefit 10203 to participant 10206. Defined benefits 10210 also provides PLI premium 10208 (represented as an arrow) to insurance company 10209 and receives PLI benefits 10207 (represented as an arrow) from insurance company 10209. Participant 10206 receives the retirement benefits 10204 and PLI benefits (e.g., protection; rate of return; tax advantages; flexibility) 10205.

In operation, a user can step back and forward through the flow chart causing the arrows to appear in a particular sequence by clicking on the “next” button or the “previous” button of input interface 10231. The user can also display the complete chart by clicking on “show all” of input interface 10231. The user can also show other views of the defined benefits by clicking on other radio boxes in the left hand menu.

The next step in the stage for business sponsored benefits management can be the display shown in FIG. 103. FIG. 103 shows an example of a user interface including business sponsored benefits and retirement plans and more particularly an example of a defined benefits plan. Examples radio box 10303 is checked to show that the interface relates to numerical example of a business sponsored benefit. As shown, interface 10300 includes assumptions component 10304 for displaying assumptions about the business and outlays component 10305 used to generate the contributions allocations 10306 and values at retirement 10312 of the benefits plan. Assumptions component 10304 can include information for the total # of employees, total # of owner/employees, age of owner/employees, compensation for owner/employees, total compensation for other employees, and/or tax bracket of business. Outlays component 10305 can include information for the contributions by employer, tax savings, net A/T outlay, deposit allocated for owners and/or net gain for the benefits plan.

Contribution allocations component 10306 includes for each row of owners and/or employees of particular age ranges, annuity deposits 10307, insurance premium 10308, total 10309, % of contribution 10320, and taxable income 10310. Contribution allocations component 10306 also includes cumulative totals 10311 for each row and for each column. As shown, contribution allocations component 10306 provides information about the contributions made into the plans for owners/employees.

Values at retirement component 10312 includes, for each row of owners and/or employees of particular age ranges, insurance current value 10313, annuity current value 10314, total 10315, insurance monthly premium 10316, annuity monthly pension 10317, total monthly pension 10318, and insurance death benefit 10319. As shown, values at retirement component 10312 provides information about the benefits due to owners/employees at retirement from the benefits plans.

The next step in the stage for business sponsored benefits management can be the display shown in FIG. 104. FIG. 104 shows an example of a user interface including business sponsored benefits and retirement plans and more particularly highlights and information about defined contribution plans. As shown, interface 10400 includes a left hand menu which includes highlights radio box 10401 (shown as checked to indicate that the highlights are currently shown), flowchart radio box 10402, and example radio box 10403. A user can click on one of the radio boxes to navigate to the flowchart or example of the defined contribution.

Interface 10400 includes information box 10404 which provides, for example, the suggested defined contributions from FIG. 100. Information box 10404 includes a plurality of plan features 10405-10410, which can appear in a sequence when a user clicks on the “next” button of input interface 10431. The user can go to the previous feature by clicking on “previous” or show all the features by clicking on “show all” of input interface 10431.

In operation, the user can click on radio box 10430 to enable the interface shown and/or can navigate to other pages by clicking on other radio boxes.

The next step in the stage for business sponsored benefits management can be the display shown in FIG. 105. FIG. 105 shows an example of a user interface including business sponsored benefits and retirement plans, and more particularly a flow chart about defined contributions.

As shown, flow chart radio box 10502 is selected to display the flow chart. The flow chart shows business 10506 providing retirement contribution 10504 (represented as an arrow) to defined contribution 10505. Defined contribution 10505 provides accumulated retirement values 10510 to participant 10515. Participant 10515 provides deferrals 10507 back to defined contribution 10505. Defined contribution 10505 also provides PLI premium 10511 (represented as an arrow) to insurance company 10514 and receives PLI benefits 10513 (represented as an arrow) from insurance company 10514. Participant 10515 receives the retirement benefits 10508 and PLI benefits (e.g., protection; rate of return; tax advantages; flexibility) 10509.

In operation, a user can step back and forward through the flow chart causing the arrows to appear in a particular sequence by clicking on the “next” button or the “previous” button of input interface 10531. The user can also display the complete chart by clicking on “show all” of input interface 10531. The user can also show other views of the defined benefits by clicking on other radio boxes in the left hand menu.

The next step in the stage for business sponsored benefits management can be the display shown in FIG. 106. FIG. 106 shows an example of a user interface including business sponsored benefits and retirement plans and more, particularly, an example of defined contribution. FIG. 106 is substantially similar to FIG. 103 except that FIG. 106 displays defined contribution. In the left hand menu example radio box 10603 is checked to display the example of the defined contribution.

Assumptions component 10604 can include total # of employees, total # of owner/employees, age of owner/employees, compensation for owner/employees, total compensation for other employees, and tax bracket. Outlays component 10605 includes gross outlay by employer, tax savings, net A/T outlay, and deposit allocated for owners.

Contribution allocations 10606 includes for each row of owners and/or employees of particular age ranges, total contribution 10607, investments 10608, insurance 10609, % of contribution 10610, and taxable income 10611. Contribution allocations component 10617 also includes cumulative totals 10617 for each row and for each column.

Values at retirement component 10612 includes for each row of owners and/or employees of particular age ranges, monthly pension 10613, cash at retirement 10614, and death benefit 10615. Values at retirement component 10612 also includes cumulative totals 10616 for each row and for each column.

The next step in the stage for business sponsored benefits management can be the displays shown in FIGS. 107-126. FIGS. 107-126 show interfaces for managing executive benefits. FIG. 107 shows an example of a user interface including business sponsored benefits with information for executive benefits, and, in particular, an overview introduction of executive benefits. The interface includes executive benefits component 10700. Component 10700 includes menu items for navigating to different aspects of executive benefits, including overview radio box 10707 (checked to show that the current interface is the overview), design center radio box 10708, PLI bonus radio box 10709, SERP radio box 10710, split dollar radio box 10711, and split dollar loan 10712. A user can select any of the radio boxes to navigate to the associated pages for executive benefits. Component 10700 further includes menu items specific to the overview information which includes introduction menu tab 10706 (currently highlighted and currently shown), retirement benefits cash flow menu tab 10705, Permanent Life Insurance (PLI) solution menu tab 10704, and common arrangements menu tab 10703. A user can click on any of the menu items to navigate to the associated planning component. On the current page, as shown, a user can select to manage insurance for owners or key employees 10701 or key executive 10702 by clicking on the appropriate icon.

The next step in the stage for business sponsored benefits management can be the display shown in FIG. 108. FIG. 108 shows an example of a user interface for managing business sponsored benefits, and, in particular, retirement plans and retirement cash flow information. As shown, the overview section is still displayed and the associated overview radio box 10807 is checked. Retirement cash flow menu tab 10805 is selected and the associated retirement cash flow information is presented. Component 10800 includes assumptions layer 10806, guaranteed retirement income layer 10803, and business sponsored benefits layer 10801. A user can use input 10846 to recalculate and render pre-retirement and post-retirement income chart 10802.

Pre-retirement and post-retirement income chart 10802 shows bar charts over time of pre-retirement income up to an age (e.g., 65), and post-retirement income beginning at or around the age (e.g., 62). The income bars can be stacked one on top of the other to shown an aggregation of income. Different income sources (e.g., post-retirement income) can be shown in different colors.

Assumptions layer 10806 includes age layer under assumptions column 10818, years to retirement 10810, study period 10811, current income 10812, income increase 10813, annual savings rate 10814, current retirement value 10815, pre-retirement rate of return 10816, and post-retirement rate of return 10817. Pre-retirement and post-retirement income chart 10802 shows for the study period 10811, the current income bars 10853 starting from the current age, growing until the year to retirement 10810. For each year, income increases by increase rate 10813. Moreover, a savings amount of the current retirement value 10815 can grow at an annual savings rate 10814, and with pre-retirement rate of return 10816 before retirement and a post-retirement rate of return 10817 after retirement. The savings can supplement the income in retirement. As shown, savings bar charts 10851 can also be shown as stacked bar charts.

Guaranteed retirement income layer 10803 includes benefit amount 10818, growth rate 10819, benefit start age 10820, and length of benefits 10821. Pre-retirement and post-retirement income chart 10802 shows the guaranteed retirement income charts 10854, 10852 starting at start age 10820 which can be before retirement age, and continuing for the length of the benefits 10821, and growing at growth rate 10819.

Business sponsored benefits layer 10801 includes benefit amount 10839, growth rate 10840, benefit start age 10843, and length of benefits 10844. Pre-retirement and post-retirement income chart 10802 shows business sponsored benefits bar charts 10850 supplementing retirement income for the specified benefit amount 10839, growing at the specified growth rate 10840 from the benefit start age 10843 for the duration of the length of benefits 10844.

The next step in the stage for business sponsored benefits management can be the display shown in FIG. 109. FIG. 109 shows an example of a user interface including business sponsored benefits with executive benefits overview information and more particularly Permanent Life Insurance (PLI) solution information. The interface includes component 10900. Component 10900 includes protection layer 10901, asset building layer 10902, liabilities layer 10903, cash flow layer 10904, and cost of living factors component 10919. Each of these layers show advantages or benefits provided by a PLI solution for executive benefits.

Protection layer 10901 includes premature death benefit tab 10907, disability tab 10908, lawsuit tab 10909, and increasing death benefit tab 10910. Asset building layer 10902 includes rate of return tab 10911, minimal risk tab 10912, builds net worth tab 10913, and liquidity tab 10930. Liabilities layer 10903 includes tax advantaged accumulation tab 10914, alternate credit source tab 10920, tax advantaged distributions tab 10921, and income tax free at-death tab 10918. Cash flow layer 10904 includes form of savings tab 10915, systematic tab 10917, flexible funding options tab 10922, and flexible distribution options tab 10923.

Cost of living factors component 10919 includes inflation layer 10924, all forms of taxes layer 10925, new goods and services layer 10926, product wear and tear layer 10929, improved standard of living layer 10927, and unexpected life events layer 10928. Component 10919 provides links to information about the cost of living factors affecting the type of benefits (e.g., “in the plan” versus “out of the plan”).

In operation, the user can visually be given information comparing retirement options for a client's business in a side-by-side and selectable fashion.

The next step in the stage for business sponsored benefits management can be the display shown in FIG. 110. FIG. 110 shows an example of a user interface including business sponsored benefits and executive benefits and, more particularly, common executive benefits arrangement for a PLI bonus. As shown, interface 11000 includes a menu table for navigating to various pages related to executive benefits. As shown, common arrangements menu tab 11004 is highlighted to indicate that the common arrangements are shown. Interface 11000 includes a left hand menu which enables displaying various types of executive benefits plan. The left hand menu can include PLI bonus radio box 11005 (shown as checked to indicate that the PLI bonus strategy is shown), SERP radio box 11006, split dollar radio box 11007, and split dollar loan radio box 11008. A user can click on a “clear” button to clear his/her choices. In operation, the user can click on any of the radio boxes to navigate to a different executive benefit strategy.

The flowchart for providing the executive benefits shows business 11009 paying PLI premiums 11010 (shown by an arrow) to insurance company 11012. Insurance company 11012 pays PLI benefits 11013 to participant 11014 (shown by an arrow). Business 11009 provides a 1099 form to participant 11011 (shown by an arrow) for the benefit the participant received. The PLI benefits 11015 received includes protection, rate of return, tax advantages, and flexibility.

The flowchart shown can be the summary displayed after the user has clicked on the “next” button of input 11031 through all the steps of the summary, or by clicking on “show all” of input 11031. The user can step forwards or backwards through the flowchart, causing some components to appear or disappear by clicking on the “next” and “previous” button of input 11031.

The next step in the stage for business sponsored benefits management can be the display shown in FIG. 111. FIG. 111 shows an example of a user interface including business sponsored benefits and executive benefits and, more particularly, common executive benefits arrangement for a SERP executive plan. As shown, interface 11100 includes a left hand menu, with SERP radio box 11106 checked to show that the SERP flowchart is displayed.

The flowchart shows business 11114 providing supplemental retirement income 11113 to participant 11120 (shown as an arrow). Participant 11120 provides optional income deferral 11115 to business 11114 (shown as an arrow). Participant 11120 provides income taxes 11116 to IRS 11121. Business 11114 also provides PLI premiums 11117 to insurance company 11119 (shown as an arrow), and insurance company 11119 provides PLI benefits 11118 (shown as an arrow) to business 11118 (e.g., which it uses to provide supplemental retirement income). PLI benefits 11109 received by the business includes protection, rate of return, tax advantages, and flexibility.

The flowchart shown can be the summary displayed after the user has clicked on the “next” button of input 11131 through all the steps of the summary, or by clicking on “show all” of input 11131. The user can step forwards or backwards through the flowchart and cause some components to appear or disappear by clicking on the “next” and “previous” button of input 11131.

The next step in the stage for business sponsored benefits management can be the display shown in FIG. 112. FIG. 112 shows an example of a user interface including business sponsored benefits and executive benefits and, more particularly, common executive benefits arrangement for a split dollar executive benefits plan. As shown, interface 11200 includes a left hand menu, with split dollar radio box 11207 checked to show that the split dollar flowchart is displayed.

The flowchart shows business 11213 providing PLI premiums 11214 (shown as an arrow) to insurance company 11216. Insurance company 11216 provides PLI Benefits 11215 (shown as an arrow) to business 11213. Insurance company 11216 provides death benefits 11217 (shown as an arrow) to participant 11218. Participant 11218 provides economic benefits 11224 to IRS 11225. Participant 11218 receives PLI benefits 11219 which includes protection, rate of return, tax advantages, and flexibility. Business 11213 receives PLI Benefits which also includes protection, rate of return, tax advantages, and flexibility.

The flowchart shown can be the summary displayed after the user has clicked on the “next” button of input 11231 through all the steps of the summary, or by clicking on “show all” of input 11231. The user can step forwards or backwards through the flowchart, causing some components to appear or disappear by clicking on the “next” and “previous” button of input 11231.

The next step in the stage for business sponsored benefits management can be the display shown in FIG. 113. FIG. 113 shows an example of a user interface including business sponsored benefits and executive benefits and, more particularly, common executive benefits arrangement for a split dollar loan executive benefits plan. As shown, interface 11300 includes a left hand menu, with split dollar loan radio box 11309 checked to show that the split dollar loan flowchart is displayed.

The flowchart shows business 11310 providing loan 11311 (shown as an arrow) to participant 11313. Insurance company 11328 provides collateral for loan 11320 (shown as an arrow) to business 11310. Participant 11313 provides PLI premium 11321 (shown as an arrow) to insurance company 11328 and receives PLI benefits 11322 (shown as an arrow) from insurance company 11328. PLI Benefits 11315 received by participant 11313 includes protection, rate of return, tax advantages, and flexibility.

The flowchart shown can be the summary displayed after the user has clicked on the “next” button of input 11331 through all the steps of the summary, or by clicking on “show all” of input 11331. The user can step forwards or backwards through the flowchart, causing some components to appear or disappear by clicking on the “next” and “previous” button of input 11331.

The next step in the stage for business sponsored benefits management can be the display shown in FIG. 114. FIG. 114 shows an example of a user interface including business sponsored benefits and executive benefits and more particularly design center information.

The interface includes executive benefits component 11400. Interface 11400 includes menu items for navigating to different aspects of executive benefits, including overview radio box 11401, design center radio box 11402 (checked to show that the current interface is the design center), PLI bonus radio box 11403, SERP radio box 11405, split dollar radio box 11406, and split dollar loan 11408. A user can select any of the radio boxes to navigate to the associated pages for executive benefits. Interface 11400 also includes owners icon 11432 and back to key executives icon 11433. In operation, a user can click on either icon to navigate to the page related to executive benefits relating to owners and/or key executives, respectively. The user can click on back button 11424 to navigate to a page related to retirement plans, or next button 11425 to navigate to a page related to business pay insurance.

The next step in the stage for business sponsored benefits management can be the display shown in FIG. 115. FIG. 115 shows an example of a user interface including business sponsored benefits and executive benefits and more particularly a design center for providing decision trees for owners of a business. If the user selects owner icon 11432 from FIG. 114, the interface 11500 of FIG. 115 is shown. If the user selects executive icon 11433 from FIG. 114, a decision tree for executives can also be shown substantially similar to the one shown in FIG. 115.

As shown, interface 11500 includes a decision tree for owners and employees, configured to select answers to questions, wherein an answer leads to another question, until a final suggestion or answer is reached. The tree path can be pre-defined or generated, based on the information entered about the business and/or client. For example, for a business with income between particular ranges, particular trees can be generated or selected (e.g., asking questions about whether the owner of the business is a partnership).

As shown, an example of the decision tree for owners and employees includes question “Is this a C Corporation?” input box 11502 (e.g., showing answer “Yes”), question “Do you want to emphasize retirement cash flow?” input box 11503 (e.g., showing answer “No”), question “Do you want to personally control the funding vehicle?” input box 11504 (e.g., showing answer “Yes”), and question “Does the business want a current tax deduction?” input box 11505 (e.g., showing answer “No”).

A suggestion 11509 of a retirement plan for owners and/or employees is provided based on the answers to the decision tree. For example, the suggestion 11509 shown is to use a “Split Dollar Plan”. A user can also provide the client additional information about the suggested plan and/or other plans by clicking on the links under the supplemental information 11510 section. More than one suggestion can also be provided.

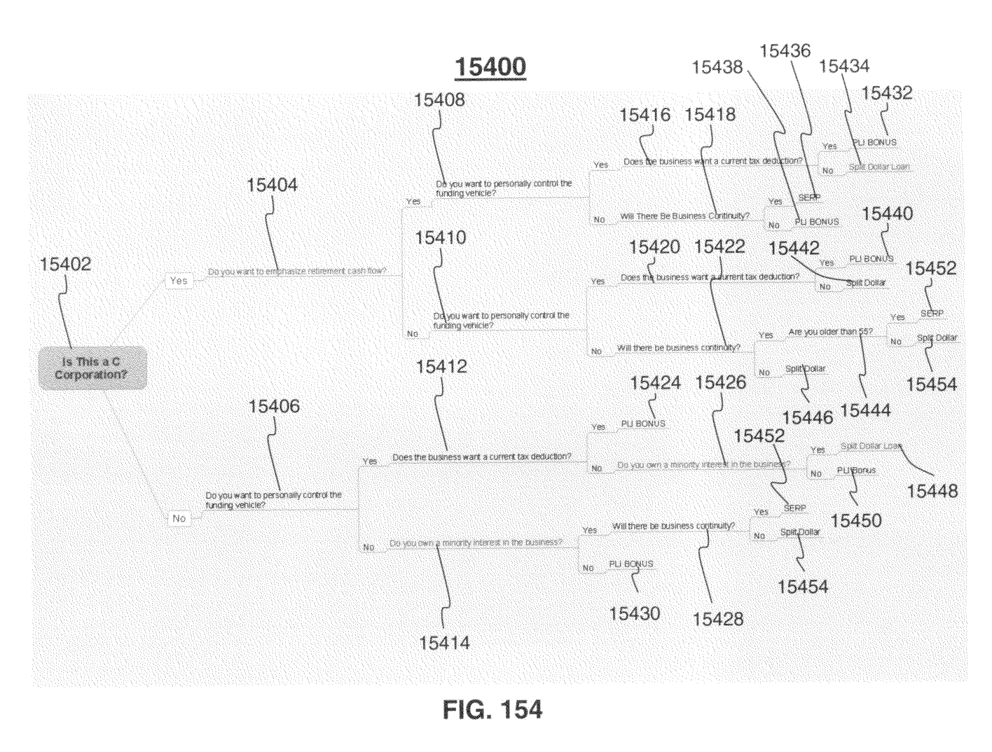

FIG. 154 shows an example of a decision tree for determining a benefits plan for owners. As shown, question 15402 asks “Is This a C Corporation?” If the answer is “Yes”, the tree branches to question 15404 which asks “Do you want to emphasize retirement cash flow?” If the answer is “No”, the tree branches to question 15506 which asks “Do you want to personally control the funding vehicle?”

If at question 15404 the answer is “Yes”, the decision tree branches to question 15408 “Do you want to personally control the funding vehicle?” If at question 15404 the answer is “No”, the decision tree branches to question 15410 “Do you want to personally control the funding vehicle?”

If at question 15406 the answer is “Yes”, the decision tree branches to question 15412 “Does the business want a current tax deduction?” If at question 15406 the answer is “No”, the decision tree branches to question 15414 “Do you own a minority interest in the business?”

If at question 15408 the answer is “Yes”, the decision tree branches to question 15416 “Does the business want a current tax deduction?” If at question 15408 the answer is “No”, the decision tree branches to question 15418 “Will There Be Business Continuity?” (e.g., will the business be kept instead of sold).

If at question 15410 the answer is “Yes”, the decision tree branches to question 15420 “Does the business want a current tax deduction?” If at question 15410 the answer is “No”, the decision tree branches to question 15422 “Will There Be Business Continuity?” (e.g., will the business be kept instead of sold).

If at question 15412 the answer is “Yes”, the decision tree branches to answer 15424 “PLI BONUS.” If at question 15412 the answer is “No”, the decision tree branches to question 15426 “Do you own a minority interest in the business?”

If at question 15414 the answer is “Yes”, the decision tree branches to question 15428 “Will there be business continuity?” If at question 15414 the answer is “No”, the decision tree branches to answer 15430 “PLI BONUS.”

If at question 15416 the answer is “Yes”, the decision tree branches to answer 15432 “PLI BONUS.” If at question 15416 the answer is “No”, the decision tree branches to answer 15434 “Split Dollar Loan.”

If at question 15418 the answer is “Yes”, the decision tree branches to answer 15436 “SERP.” If at question 15418 the answer is “No”, the decision tree branches to answer 15438 “PLI BONUS.”

If at question 15420 the answer is “Yes”, the decision tree branches to answer 15440 “PLI BONUS.” If at question 15420 the answer is “No”, the decision tree branches to answer 15442 “Split Dollar.”

If at question 15422 the answer is “Yes”, the decision tree branches to question 15444 “Are you older than 55?” If at question 15422 the answer is “No”, the decision tree branches to answer 15446 “Split Dollar.”

If at question 15426 the answer is “Yes”, the decision tree branches to answer 15448 “Split Dollar Loan.” If at question 15426 the answer is “No”, the decision tree branches to answer 15450 “PLI BONUS.”

If at question 15428 the answer is “Yes”, the decision tree branches to answer 15452 “SERP.” If at question 15428 the answer is “No”, the decision tree branches to answer 15454 “Split Dollar.”

If at question 15444 the answer is “Yes”, the decision tree branches to answer 15456 “SERP.” If at question 15444 the answer is “No”, the decision tree branches to answer 15458 “Split Dollar.”

FIG. 153 shows an example of a decision tree for determining a benefits plan for executives. As shown, question 15302 asks “Does the Business Need a Current Income Tax Deduction?” If the answer is “Yes”, the tree branches to answer 15304 “PLI BONUS Arrangement.” If the answer is “No”, the tree branches to question 15306 which asks “Should the business control the funding vehicle?”

If at question 15306 the answer is “Yes”, the decision tree branches to question 15308 “Do you want to emphasize retirement cash flow?” If at question 15306 the answer is “No”, the decision tree branches to question 15310 “Do you want to emphasize retirement cash flow?”

If at question 15308 the answer is “Yes”, the decision tree branches to answer 15312 “SERP/DC” If at question 15308 the answer is “No”, the decision tree branches to answer 15314 “Split Dollar.”

If at question 15310 the answer is “Yes”, the decision tree branches to answer 15316 “PLI BONUS.” If at question 15310 the answer is “No”, the decision tree branches to answer 15319 “Split Dollar Loan.”

The next step in the stage for business sponsored benefits management can be the display shown in FIG. 116. FIG. 116 shows an example of a user interface including business sponsored benefits and executive benefits and, more particularly, a flowchart for strategies for managing a PLI bonus arrangements executive benefits plan.

As shown, interface 11600 shows a flow chart for one type of executive benefits, including icons for showing the interrelationships between entities. Interface 11600 includes a left hand menu which includes highlights radio box 11601, flowchart radio box 11602 (checked to show that the current page displays the flowchart), and example radio box 11603. A user can clear the selection by clicking a clear button. A user can navigate to other pages related to the type of executive benefits plan selected by clicking on other radio boxes. For example, the user can click on highlights radio box 11601 to navigate to a page showing highlights of the PLI bonus arrangements that appear substantially similar to FIGS. 101, 104, 118, 121, and 124.

Interface 12400 includes the PLI bonus arrangements flowchart. The flowchart shows business 11604 providing PLI premiums 11605 (shown as an arrow) to insurance company 11606. Business provides a 1099 form 11608 (shown as an arrow) to participant 11609 for the benefits to be received. Insurance company 11606 provides PLI benefits 11607 (shown as an arrow) to participant 11609. Participant received the PLI benefits 11610 which includes protection, rate of return, tax advantages, and flexibility.

The flowchart shown can be the summary displayed after the user has clicked on the “next” button of input 11631 through all the steps of the summary, or by clicking on “show all” of input 11631. The user can step forwards or backwards through the flowchart, causing some components to appear or disappear by clicking on the “next” and “previous” button of input 11631.

In operation, the user can click on radio button 11641 at a top menu to enable the interface shown, or can navigate to another page related to executive benefits by clicking on other radio boxes of the top menu.

The next step in the stage for business sponsored benefits management can be the display shown in FIG. 117. FIG. 117 shows an example of a user interface including business sponsored benefits and executive benefits and, more particularly, a detailed numerical example of a PLI bonus arrangements executive benefits plan.

The illustration shown in FIG. 117 is of a PLI Single Bonus plan which assumes that a business purchases a life insurance policy on the life of a 45-year-old employee. The business tax rate is assumed to be 35% and the employee rate is assumed to be 30%. The employee is assumed to retire at age 65.

The example is for an age 45 Male insured, for a $1,000,000 life insurance policy, such as a Whole Life 99 policy issued by Guardian Life Insurance Company (generic form number 06-WL) in the Preferred Plus NT risk class, and assumes dividends are applied under the Paid-Up-Additions dividend option. The example assumes that the currently illustrated non-guaranteed elements, including dividends, will continue unchanged for all years shown. The example reflects a premium offset situation. As such, even if the annual premium is shown above as zero for any year, a premium may still be required depending on the dividends credited, if any, to the policy. Dividends are not guaranteed and the premium for the life insurance is payable for the number of years shown in the policy.

As shown, example radio box 11703 is checked to show that the screen is an example of PLI bonus arrangements executive benefits plan. Interface 11700 includes summary 11704 which further includes information about the name, current age, and retirement age of the executive or key employee.

Interface 11700 includes a plurality of columns regarding the bonus arrangement's impact on the business and the client, including business protection column 11705, business cash flow column 11706, personal protection column 11707, and personal cash flow column 11708. Each of the columns may have sub components. Business protection column 11705 includes annual outlay 11720 (e.g., for showing the amount of monies provided by the business to the plan in that year), net cash value 11721, and net death benefit 11722. Business cash flow column 11706 includes annual net 11723. Personal protection column 11707 includes annual outlay 11724 (e.g., for showing the amount of monies provided by the client to the plan in that year), annual withdrawal 11725 (e.g., for showing the amount of monies the client can or is expected to withdraw from the plan in that year), net cash value 11729, and net death benefit 11728. Personal cash flow column 11708 includes annual net cash flow 11726.

Information for a plurality of year 11710 are provided for each of the columns. Subtotal 11730 is provided for a subset of years, (e.g., years 1-20), and another subtotal 11731 is provided for another subset of years (e.g., years 21-25).

In this example, the business protection annual outlay column 11720 shows the outlay that the employer makes to the insurance company on behalf of the employee. In this example, the employer pays a premium of $25,000 each year for 20 years until the employee retires at age 65.

The business protection net cash value column 11721 and net death benefit column 11722 display policy values net of any outstanding policy loans. Since the employee is the owner of the policy and is entitled to all policy values, the business has no interest in the cash value or death benefit.

The business cash flow annual net column 11723 depicts the business's after-tax cost of the employee's bonus. The business pays a $25,000 premium for 20 years on a life insurance policy for the benefit of the employee participant. The premium paid is bonus income to the employee participant and is a tax-deductible business expense. The deduction of the bonus expense by the business at its 35% tax rate will result in an after-tax cost of $16,250.

The personal protection annual outlay column 11724 illustrates the outlay that the employee makes to the insurance company. The business pays the premium on the policy for the first 20 years; therefore, the employee has no outlay for the policy during these years. Beginning in the 21st year, when the employee has retired, the premium on the policy is assumed to be paid from the surrender of accumulated dividends.

The personal protection annual withdrawal column 11725 illustrates the net after-tax cash flow of dividends and/or loans taken by the employee from the life insurance policy. Beginning in the 21st year through the 25th year, the employee takes a $100,000 tax-free distribution from the policy.

The personal protection net cash value column 11729 and net death benefit 11728 column display policy values net of any outstanding policy loans. The employee is the owner of the policy and is entitled to all policy values.

The personal cash flow annual net column 11726 for the first 20 years depicts the employee's after tax cost of the bonus. Income tax of $7,500 must be paid by the employee on the $25,000 premium that was paid by the business. Beginning at age 65, the employee retires and takes a tax-free distribution from the policy of $100,000 for five years. Beginning in the 26th year and thereafter, the premium on the life policy is assumed to be paid by dividends.

The next step in the stage for business sponsored benefits management can be the display shown in FIG. 118. FIG. 118 shows an example of a user interface including business sponsored benefits and executive benefits and, more particularly, highlights for SERP executive benefits plan.

As shown, interface 11800 includes left hand menu which includes highlights radio box 11801 (checked to show that the interface shows highlights for a SERP plan), flowchart radio box 11802, and example radio box 11803.

Interface 11800 includes information box 11804 which provides, for example, a suggested plan after entering information for a decision tree, such as from FIG. 115. Information box 11800 includes a plurality of plan features 11805-11809, which can appear in a sequence when a user clicks on the “next” button of input interface 11831. The user can go to the previous feature by clicking on “previous” or show all the features by clicking on “show all” of input interface 11831.

The next step in the stage for business sponsored benefits management can be the display shown in FIG. 119. FIG. 119 shows an example of a user interface including business sponsored benefits and executive benefits and more particularly a flowchart for strategies for managing a SERP executive benefits plan.

As shown, interface 11900 shows a flow chart for one type of executive benefits, including icons for showing the interrelationships between entities. Interface 11900 includes a left hand menu which includes flowchart radio box 11902 (checked to show that the current page displays the flowchart).

Interface 11900 includes the SERP flowchart. The flowchart shows business 11911 providing supplemental retirement income 11912 (shown as an arrow) to participant 11915. Business 11911 receives from participant 11915 optional income deferral 11913 (shown as an arrow). Participant 11915 provides income taxes 11916 (shown as an arrow) to IRS 11917. Business 11911 provides PLI Premium 11914 (shown as an arrow) to insurance company 11918 and receives from insurance company 11918 PLI benefits 11925 (shown as an arrow). Business 11912 receives PLI benefits 11904 which includes protection, rate of return, tax advantages, and flexibility.

The flowchart shown can be the summary displayed after the user has clicked on the “next” button of input 11931 through all the steps of the summary, or by clicking on “show all” of input 11931. The user can step forwards or backwards through the flowchart, causing some components to appear or disappear by clicking on the “next” and “previous” button of input 11931.

The next step in the stage for business sponsored benefits management can be the display shown in FIG. 120. FIG. 120 shows an example of a user interface including business sponsored benefits and executive benefits and, more particularly, a detailed numerical example of a SERP executive benefits plan.

The illustration shown in FIG. 120 is of a Supplemental Executive Retirement Plan (SERP) which assumes that a business purchases a life insurance policy on the life of a 45-year-old key employee. The business tax rate is assumed to be 35% and the employee rate is assumed to be 30%. The employee is assumed to retire at age 65. The assumptions about the executive/key employee and insurance plan can be managed by the mechanism described in more detail in FIG. 117.

As shown, example radio box 12003 is checked to show that the screen is an example of a SERP plan. Interface 12000 includes summary 12004 which further includes information about the name, current age, and retirement age of the executive or key employee. The information of the columns and sub columns are substantially similar to those described in FIG. 117.

Interface 12000 includes a plurality of columns regarding the bonus arrangement's impact on the business and the client, including business protection column 12005, business cash flow column 12006, personal protection column 12007, and personal cash flow column 12008. Business protection column 12005 includes annual outlay 12020 (e.g., for showing the amount of monies provided by the business to the plan in that year), annual withdrawal 12021, net cash value 12022, and net death benefit 12023. Business cash flow column 12006 includes annual net 12024. Personal protection column 12007 includes annual outlay 12025 (e.g., for showing the amount of monies provided by the client to the plan in that year), net cash value 12029 (e.g., for showing the amount of monies the client can or is expected to withdraw from the plan in that year), and net death benefit 12028. Personal cash flow column 12008 includes annual net cash flow 12026.

Information for a plurality of year 12010 can be provided for each of the columns. Subtotal 12030 is provided for a subset of years, (e.g., years 1-20), and another subtotal 12031 is provided for another subset of years (e.g., years 21-25).

The next step in the stage for business sponsored benefits management can be the display shown in FIG. 121. FIG. 121 shows an example of a user interface including business sponsored benefits and executive benefits and, more particularly, highlights and information for a split dollar executive benefits plan. As shown, interface 12100 includes a left hand menu which includes highlights radio box 12101 (checked to show that the highlights of the plan are displayed), flowchart radio box 12102, and example radio box 12103.

Interface 12100 includes information box 12104 which provides, for example, a suggested plan after entering information for a decision tree, such as from FIG. 115. Information box 12100 includes a plurality of plan features 12105-12108, which can appear in a sequence when a user clicks on the “next” button of input interface 12131. The user can go to the previous feature by clicking on “previous” or show all the features by clicking on “show all” of input interface 12131.

The next step in the stage for business sponsored benefits management can be the display shown in FIG. 122. FIG. 122 shows an example of a user interface including business sponsored benefits and executive benefits and, more particularly, a flowchart of a split dollar executive benefit plan. Interface 12200 includes a left hand menu which includes flowchart radio box 12203 (checked to show that the split dollar executive benefit plan flow chart is displayed). The flow chart of interface 12200 shows business 12210 providing PLI premiums 12211 (shown as an arrow) to insurance company 12213. Insurance company 12213 provides PLI benefits 12212 (shown as an arrow) to business 12210. Insurance company 12213 provides death benefits 12214 (shown as an arrow) to participant 12220. Participant 12220 provides economic benefit 12221 to IRS 12222. Participant 12220 receives PLI benefits 12216 which includes protection, rate of return, tax advantages, and flexibility. Business 12210 also receives and provides PLI benefits 12205 which includes protection, rate of return, tax advantages, and flexibility.

The flowchart shown can be the summary displayed after the user has clicked on the “next” button of input 12231 through all the steps of the summary, or by clicking on “show all” of input 12231. The user can step forwards or backwards through the flowchart, causing some components to appear or disappear by clicking on the “next” and “previous” button of input 12231.

The next step in the stage for business sponsored benefits management can be the display shown in FIG. 123. FIG. 123 shows an example of a user interface including business sponsored benefits and executive benefits and, more particularly, a detailed numerical example of a split dollar executive benefits plan.

The illustration shown in FIG. 123 is of an Economic Benefit Regime Split Dollar Plan. In this example, the Business purchases a life insurance policy on the life of a 45-year-old key employee. This is called a “Split Dollar” plan because the cash value and death benefits of the life insurance plan are “split” or allocated between the Business and the Employee. In this example, the Business applies for and owns a life insurance policy on the life of an Employee. The business tax rate is assumed to be 35% and the employee rate is assumed to be 30%. The employee is assumed to retire at age 65.

The business has an interest in the insurance policy's cash value equal to the total cash value of the policy. In the event of the death of the insured, the business's interest in the death benefit is also equal the total cash value of the insurance policy.

The employee has no interest in the policy's cash value, which belongs to the Business. The Employee is entitled to a death benefit from the policy equal to the total death benefit of the policy minus the Business's interest which is the total cash value.

In this example, the business pays the entire life policy premium. The employee receives an economic benefit from the Business equal to employee's portion of the policy death benefit. The value of the life insurance economic benefit that the employee receives is determined each year and is based upon a government term insurance table. The employee then recognizes the value of the economic benefit annually as income. At retirement, the Split Dollar arrangement is terminated and the policy is either surrendered by the employer, retained by the Business, or transferred as a bonus to the employee. This example illustrates the policy being transferred to the employee. Transferring of a policy to an employee is often referred to as a “Rollout.”

As shown, example radio box 12303 is checked to show that the screen is an example of Split Dollar Plan. Interface 12300 includes summary 12304 which further includes information about the name, current age, and retirement age of the executive or key employee. The information of the columns and sub columns are substantially similar to those described in FIG. 117.

Interface 12300 includes a plurality of columns regarding the bonus arrangement's impact on the business and the client, including business protection column 12305, business cash flow column 12306, personal protection column 12307, and personal cash flow column 12308. Each of the columns may have sub components.

Business protection column 12305 includes annual outlay 12320 (e.g., for showing the amount of monies provided by the business to the plan in that year), net cash value 12321, and net death benefit 12322. Business cash flow column 1206 includes annual net 12323. Personal protection column 12307 includes annual outlay 12324 (e.g., for showing the amount of monies provided by the client to the plan in that year), net cash value 12329, and net death benefit 12328. Personal cash flow column 12308 includes annual net cash flow 12326.

Information for a plurality of year 12310 can be provided for each of the columns. Subtotal 12330 is provided for a subset of years, (e.g., years 1-20), and another subtotal 12331 is provided for another subset of years (e.g., years 21-25).

The next step in the stage for business sponsored benefits management can be the display shown in FIG. 124. FIG. 124 shows an example of a user interface including business sponsored benefits and executive benefits and more particularly highlights and information for a split dollar loan executive benefits plan. As shown, interface 12400 includes a left hand menu which includes highlights radio box 12401 (checked to show that the highlights of the plan are displayed), flowchart radio box 12402, and example radio box 12403.

Interface 12400 includes information box 12404 which provides, for example, a suggested plan after entering information for a decision tree, such as from FIG. 115. Information box 12400 includes a plurality of plan features 12405-12408, which can appear in a sequence when a user clicks on the “next” button of input interface 12432. The user can go to the previous feature by clicking on “previous” or show all the features by clicking on “show all” of input interface 12432.

The next step in the stage for business sponsored benefits management can be the display shown in FIG. 125. FIG. 125 shows an example of a user interface including business sponsored benefits and executive benefits and, more particularly, a flowchart of a split dollar loan executive benefit plan. Interface 12500 includes a left hand menu which includes flowchart radio box 12502 (checked to show that the split dollar executive benefit plan flow chart is displayed). The flow chart of interface 12500 shows business 12504 providing loan 12505 (shown as an arrow) to participant 12507. Insurance company 12517 provides collateral for the loan 12516 (shown as an arrow) to business 12504. Participant 12507 provides to business 12504 interest and principal on loan 12506 (shown as an arrow), after a period of time. Participant 12507 provides PLI premiums 12515 (shown as an arrow) to insurance company 12517. Insurance company 12517 provides PLI benefits 12514 (shown as an arrow) to participant 12507. Participant 12507 receives PLI benefits 12509 which includes protection, rate of return, tax advantages, and flexibility.

The flowchart shown can be the summary displayed after the user has clicked on the “next” button of input 12531 through all the steps of the summary, or by clicking on “show all” of input 12531. The user can step forwards or backwards through the flowchart, causing some components to appear or disappear by clicking on the “next” and “previous” button of input 12531.

The next step in the stage for business sponsored benefits management can be the display shown in FIG. 126. FIG. 126 shows an example of a user interface including business sponsored benefits and executive benefits and more particularly a detailed numerical example of a split dollar loan executive benefits plan.

The illustration shown in FIG. 126 is a Loan Regime Split Dollar Plan. This is called a “Split Dollar” plan because the cash value and death benefits of the life insurance plan are “split” or allocated between the Business and the Employee. In this example, a 45-year-old Employee is the owner of the life insurance policy. The business tax rate is assumed to be 35% and the employee tax rate is assumed to be 30%. The employee is assumed to retire at age 65.

In a loan regime Split Dollar Plan, as the business pays the premium on an employee's life insurance policy, the employee accumulates a loan that is owed to the business for the premiums that have been paid by the Business. The loan is secured by the cash value and death benefit of the life insurance policy. The employee must report interest on the loan. The loan interest is either paid by the employee to the business or reported by the employee as imputed income.

The business has an interest in the cash value of the policy equal to the cumulative premium it has paid for the policy. When the insurance policy's cash value is less than the cumulative premiums paid by the business, the business's interest is limited to the cash value. In the event of the death of the insured, the business's interest in the policy is equal to the cumulative premiums it has paid.

The employee's interest in the policy's cash value and death benefit is equal to the total cash value and total death benefit minus the Business's interest in the policy which is equal to the cumulative premiums paid by the business.

When a Split Dollar Loan regime plan is terminated prior to death, the business is entitled to receive its interest in the cash value. The employee may access policy values to pay off the business's interest by way of a surrender of Paid-Up-Addition insurance (e.g., for a whole life policy), the withdrawal of cash value (e.g., for a universal life policy), and/or a loan against policy values.

In the event of death, the business is entitled to be paid for its interest in the policy from the policy death proceeds. The balance of the death benefit is then paid to the beneficiary of the life insurance policy.

As shown, example radio box 12603 is checked to show that the screen is an example of Split Dollar Loan Plan. Interface 12600 includes summary 12604 which further includes information about the name, current age, and retirement age of the executive or key employee. The information of the columns and sub columns are substantially similar to those described in FIG. 117.

Interface 12600 includes a plurality of columns regarding the bonus arrangement's impact on the business and the client, including business protection column 12605, business cash flow column 12606, personal protection column 12607, and personal cash flow column 12608. Each of the columns may have sub components.

Business protection column 12605 includes annual outlay 12620 (e.g., for showing the amount of monies provided by the business to the plan in that year), annual withdrawal 12621, net cash value 12622, and net death benefit 12623. Business cash flow column 12606 includes annual net 12624. Personal protection column 12607 includes annual outlay 12625 (e.g., for showing the amount of monies provided by the client to the plan in that year), net cash value 12629, and net death benefit 12628. Personal cash flow column 12608 includes annual net cash flow 12626.

Information for a plurality of year 12610 are provided for each of the columns. Subtotal 12630 is provided for a subset of years, (e.g., years 1-20), and another subtotal 12631 is provided for another subset of years (e.g., years 21-25).

The next step in the stage for business sponsored benefits management can be the displays shown in FIGS. 127-130. FIGS. 127-130 show interfaces for managing business owned/paid insurance. FIG. 127 shows an example of a user interface including business sponsored benefits with a business pay insurance with design center.

As shown, interface 12700 includes top navigation menu which includes design center radio box 12737 (shown as check to display the current design center screen), and details radio box 12738. A user can click on the radio boxes to navigate to the appropriate business owned/paid insurance pages.

Interface 12700 includes scenarios 12701 which informs the user to check the appropriate box(es) to view a combination of results. Scenarios 12701 includes select scenario(s) box 12702 and add scenario box 12713. A user can create a new scenario by clicking on add scenario box 12713 which will navigate the user to the page of FIG. 128, for example. By clicking on select scenario(s) box 12702, the user can manage an already created scenario, using a display substantially similar to the page of FIG. 128.

Scenarios 12701 includes a plurality of business paid life insurance information components, including PLI single bonus scenario 12703 which provides information 12704 (e.g., showing “There are currently no PLI Single Bonus scenarios defined for [business entity name]”), PLI double bonus scenario 12705 which provides information 12706 (e.g., showing “There are currently no PLI Double Bonus scenarios defined for [business entity name]”), key person scenario 12707 which includes information 12709 (e.g., showing “There are currently no Key Person scenarios defined for [business entity name]”), split dollar scenario 12709 which includes information 12710 (e.g., showing “There are currently no Split Dollar scenarios defined for [business entity name] and split dollar loan scenario 12711 which includes information 12712 (e.g., showing “There are currently no Split Dollar Loan scenarios defined for [business entity name]

In operation, the user can also navigate to the executive benefits management or to a management of the action steps by clicking on the appropriate buttons of navigation menu 12731.

The next step in the stage for business sponsored benefits management can be the display shown in FIG. 128. FIG. 128 shows an example of a user interface including business sponsored benefits with a business pay insurance with design center and more particularly an add scenario display. As shown, interface 12800 includes a pop-up display 12801 for entering business pay insurance-scenario details. The scenario entry includes insured name input 12803 (e.g., shown as entered as “Kyle”), plan type input 12804 (e.g., showing a plurality of options for different scenario types, including “PLI Single Bonus”, “PLI Double Bonus”, “Key Person”, “Split Dollar”, and “Split Dollar Plan”), study period input 12806 (e.g., for entering a period of time—e.g., years), retirement age input 12809, personal tax rate input 12814, business tax rate input 12815, FDP import file input 12816. Help box 12821 provides information about how to use the display to create a new business owned life insurance scenario.

In operation, the user can click on the “save” button of interface 12818 to save the entered data or click on the “cancel” button of interface 12818 to clear the data so that the data can be re-entered. Clicking on the “save” button may navigate the user to a page such as shown in FIG. 129, where the entered data is displayed in the current scenarios.

The next step in the stage for business sponsored benefits management can be the display shown in FIG. 129. FIG. 129 shows an example of a user interface including business sponsored benefits with a business pay insurance with design center with at least one scenario filled in.

Interface 12900 includes information substantially similar to the display of FIG. 127, except the scenario includes key person scenario 12909 which shows additional information. For the person entered in the display of FIG. 129, a row is provided (e.g., person 12917—Kyle). For each row, a user can click on the check box 12916 for the row to further manage the information in the row. Each row includes information for insured column 12910 (e.g., for showing the insured person's name), product name column 12911 (e.g., showing “Whole Life 99” for Kyle), file name column 12912 (e.g., for showing the FDP file name, such as “M45-10+10 50 k Withdrawal at 105.xml”), annual premium column 12913 (e.g., $20,000), death benefit column 12914 (e.g., $561,404), and delete input 12923 (e.g., for deleting the particular row by clicking on the input). Each row's annual premium 12913 and death benefit 12914 can be summed into total annual premium 12924 and death benefit 12925 respectively.

The next step in the stage for business sponsored benefits management can be the display shown in FIG. 130. FIG. 130 shows an example of a user interface including business sponsored benefits and more particularly detailed numerical information about a business pay insurance scenario over a number of years.

Interface 13000 also includes a plurality of columns with sub-columns for a plurality of years 13009 (e.g., 1-20). The columns include business protection column 13005, business cash flow column 13006, personal protection column 13007, and personal cash flow column 13008. Protection column 13005 includes annual outlay 13003, net cash value 13010, and net death benefit 13011. Business cash flow column 13006 includes annual net 13012. Personal protection column 13007 includes annual outlay 13013, net cash value 13014, and net death benefit 13015. Personal cash flow column 13008 includes annual net 13016. The sum for each column over the plurality of years 13009 can be provided in row 13017.

In operation, a user can navigate to a page with more information about a plan scenario shown by, for example, clicking plan design description link 13018.

Action Steps Review

The user can choose to review the actions taken to manage the life insurance options for the client and business. A section in the stage for reviewing action steps can be the display shown in FIG. 131. FIG. 131 shows an example of a user interface for confirming action steps. FIG. 131 displays a list of selectable action steps that are needed to be taken by the client to, for example, move the sales process or interaction with the client forward. A user can click in a checkbox associated with each action step to indicate that the selected action step should be completed with respect to the current client. A list of selected action steps from the various display pages for different insurance or protection categories or types can be displayed.

Interface 13100 includes action steps-business component 13101, which includes “Increase personal life insurance protection.” radio box 13102 (shown as checked), “Implement additional disability income protection.” radio box 13103, “Update all necessary business legal documents.” radio box 13104, “Fully fund all buy and sell agreements.” radio box 13105 (shown as checked), “Insure all key employees for their full replacement value.” radio box 13106 (shown as checked), “Obtain insurance to eliminate business debts and mortgages.” radio box 13107, “Establish a business sponsored retirement program.” radio box 13108 (shown as checked), “Establish a business sponsored executive benefit plan.” radio box 13109 (shown as checked), and “Evaluate possible business pay insurance options.” radio box 13110 (shown as checked).

A user can check the radio boxes for each of the steps performed and/or the step can automatically detect that data has been entered and completed for the steps and the boxes automatically checked by the system. The user can click “save changes” button 13111 to save the changes to any selected action steps. The user can go back to entering business pay insurance by clicking button 13112 or continue to the delivery stage by clicking button 13113.

Reports Delivery and Client View

FIGS. 132-142 are diagrams of illustrative reporting output and display pages for implementing interactive methods and systems for insurance related activities in accordance with embodiments of the invention. The pages of FIGS. 132-142 can be produced by data entered and/or generated from the interfaces and processes described herein. The pages of FIGS. 132-142 can be provided in a client view stage, a client dashboard for the client to manage independent of a user (e.g., insurance agent), a delivery stage and/or output in one document such as a Microsoft Word, an Excel spreadsheet, a PDF document, a web page, or in a plurality of pages or documents (e.g., with mechanisms to go from one page to the next, for example, in the sequence shown herein). The pages can be interactive or read-only. That is, the components of the pages shown can be clickable to drill down for more information about the clicked component.

FIGS. 132-142 can be included in display pages of a client website. After a client logs in and is authenticated, the client may be provided access to certain content. For example, assumption summary report for the client(s) of FIG. 132 can be displayed that provides summary information for the client and links to corresponding reports. Various reports that were generated as part of the workflow wizard in the above examples can also be made available to the client via the client website. The processes and interfaces described herein can be used in conjunction with the client website described in more detail in U.S. patent application Ser. Nos. 12/113,087, 11/891,616, 11/510,537, and/or 60/763,200.

FIG. 132 shows an assumption summary report for the client(s). The assumptions summary report shows tax and life event assumptions. The client's personalized information 13201 displays names of the client. The client's tax rates 13202 for state and local income taxes are displayed, if any are available. The other rates 13204 show capital gains tax rates and federal tax rates for the client. Retirement assumptions 13205-13206 display the targeted year and age of retirement of the client(s). Federal Tax Rate can be the percentage of income that is paid in federal taxes, including income tax, social security tax, and Medicare tax.

The user can choose to navigate to the next page or report. FIG. 133 shows a summary balance sheet report comprising the domains based on personal data about the client and/or their family. The summary balance sheet offers a unique financial perspective for the client by expanding on the traditional asset less liabilities equals net worth formula to include important protection and cash flow considerations. This holistic view allows optimum balance to be maintained in the four interdependent domains which are essential to the financial well-being of the client. The client's personalized information 13301 shows their name(s). The domains for the client comprises protection domain 13302, assets domain 13304, liabilities domain 13305, cash flow 13307, and the net worth 13317 of the client which is an aggregate of at least some of the domains (e.g., gross income+protection+assets−liabilities; assets−liabilities, etc.). Protection domain 13302 includes property and casualty insurance, disability and health insurance, legal documents, and life insurance layers, and can also include other forms of protection for the value of the life of the client and/or their family. Assets domain 13304 includes personal property, savings, investments, retirement, real estate, business layers, and the total of the layers, and can also include other forms of assets for the client and/or their family. Liabilities domain 13305 includes short term, taxes, mortgages, business debt layers, and the total of the layers, and can also include other forms of liabilities for the client and/or their family. Cash flow domain 13307 includes gross income, protection, assets, liabilities, and net income layers, and can also include other monetary flow into and out of the client's personal accounts and/or family accounts. Assets domain 13304 includes personal property 13317, savings 13318, investments 13319, retirement 13320, real estate 13321, business 13322, and total assets 13323. Liabilities domain 13305 includes short term liabilities 13324, taxes 13325 (e.g., based on the tax rate of the client(s)), mortgages 13326, business debt 13327, and total liabilities 13328.

The user can choose to navigate to the next page or report. FIG. 134 shows a report of a summary of the property and casualty insurance 13401 currently owned by or available to the client. For a plurality of businesses 13406-13407's insurance types, there are displayed insurance company 13402, renewal date 13403, annual premium 13404, and total premiums 13405. For example for business 13406, total premium 13409 is displayed. Also total annual premium for all businesses 13410 is also shown.

The user can choose to navigate to the next page or report. FIG. 135 shows a report of a summary of the disability and health insurance 13501 currently owned by or available to the client. For a plurality of businesses 13502-13403's the disability and health insurance types 13512-13514, there are displayed insurance company 13505, renewal date 13506, annual premium 13507, business pay % 13508, annual business premium 13505, annual employee premium 13510, and total premiums 13511. For example, for business 13502, types 13512-13513 are displayed, and the total business premiums for these types are displayed as total 13515. Also total annual business premium for all businesses 13516 is also shown.

The user can choose to navigate to the next page or report. FIG. 136 shows report of a summary of the life insurance currently 13601 owned by or available to the client, including corporate owned life insurance (COLI). For a plurality of businesses 13611, 13613, the policy type 13602, owner 13603 of the business, insured person 13604, beneficiary of the insurance 13605, purpose of the insurance 13606, cash value 13607, death benefit 13608, annual premium 13609, and total premiums 13610 are displayed. For each business, different types of life insurance are displayed. For example, business 13611 shows a plurality of COLI plans 13612. Also total annual business premiums for all businesses 13623-13625 are also shown.

The user can choose to navigate to the next page or report. FIG. 137 shows a summary balance sheet report comprising the domains based on business data about the business(s) of the client and/or their family. The summary balance sheet offers a unique financial perspective for the business by expanding on the traditional asset less liabilities equals net worth formula to include important protection and cash flow considerations. As shown, the business's identification information 13701 is displayed. The domains for the business comprises protection domain 13706, assets domain 13703, liabilities and owner's equity domain 13704, cash flow 13707, and the book value 13705 of the business which is an aggregate of at least some of the domains (e.g., equity/retained earnings; gross income+protection+assets−liabilities; assets−liabilities, etc.).

Protection domain 13706 includes property and casualty insurance 13709, disability and health insurance 13712, legal documents 13711, and life insurance 13710, and can also include other forms of protection for the value of the life of the owners and/or key persons of the business.

Assets domain 13304 includes current assets 13713, fixed assets 13714, intangible assets 13715, and total business assets 13716. As shown, the assets domain for a business comprises different components than the asset domain for a client.

Liabilities and owner's equity domain 13704 includes current liabilities 13717, long term liabilities 13718, equity/retained earnings 13719 (e.g., assets less liabilities such as the sum of the current and long term liabilities), and total liabilities and owner's equity 13720.

Cash flow domain 13707 includes gross income 13721, protection 13705, assets 13723, liabilities 13724, and net income 13725, and can also include other monetary flow into and out of the client's business (e.g., displaying actual dollar amounts for each component).

A summary of the business's information 13708 is displayed comprising the total business value 13726, tax basis 13727, the owners with their percentage of ownership 13728, and the valuation method 13724.

The user can choose to navigate to the next page or report. FIG. 138 shows a summary balance sheet report comprising the domains based on business data about another business 13801 of the client and/or their family. FIG. 138 shows similar types of information as FIG. 137 but for another business. In general, a plurality of a business's information can be shown, or an aggregate of all businesses' information can be shown.

The user can choose to navigate to the next page or report. FIG. 139 shows a summary of a cash flow for the business of the client. The cash flow report shows the sequential money flow in certain areas including gross income, protection or insurance costs, select business sponsored benefit programs, general operating expenses, and/or net income. This presentation of “unbundled” business cash flow can lead to improved protection portfolios, implementation of important fringe benefits, sound expense allocation decisions, and the opportunity to achieve optimal net income results. As shown in the report, cash flow label 13901 can be personalized for the client. Label 13902 shows the cash flow for a particular business of the client. For each row 13903-13907, an amount is shown for amount column 13908 and a total is shown for total column 13909. As shown, gross income 13903 of the business, protection 13904, asset building 13905, expenses 13906 and net income 13907 are shown along with the associated amounts and totals. Each of the components can have sub components detailing a portion of the amounts and totals. Total net income 13910 is shown for the business labeled by label 13902.

The user can choose to navigate to the next page or report. FIG. 140 shows another summary of a cash flow for another business of the client. The summary of FIG. 140 is substantially similar to the summary of FIG. 139 except the information shown is for the business labeled by label 14001.

The user can choose to navigate to the next page or report. FIG. 141 shows a summary of the current overview for a client and/or the client's business. The chart describes the client's current protection decisions in several categories, and makes an assessment of the relative levels of each. The protection classifications of the categories can be dependent upon periodic reviews with the client's appropriately licensed insurance agent, financial representatives, and tax and legal advisors. Ideally, relevant categories would be assessed as “Optimal Protection.” As shown, current overview details label 14101 can be personalized for the client. Explanation text 14102 describes the chart. The chart shows information for each business entity 14103, the level of protection for a human life value 14104, key person 14105, mortgage and loans 14106, keep/sell options 14107, and estate tax impact 14108. As shown, for business 14109, the protections levels are: human life value protection level 14111 (shown as “Under Protected”), key persons protection level 14112 (shown as “Under Protected”), mortgages & loans protection level 14113 (shown as “No Protection”), keep/sell protection level 14114 (shown as “No Protection”), and estate tax impact 14115 (shown as “No Protection”). As shown, for business 14110, the protections levels are: human life value protection level 14120 (shown as “N/A”), key persons protection level 14119 (shown as “N/A”), mortgages & loans protection level 14118 (shown as “No Protection”), keep/sell protection level 14117 (shown as “No Protection”), and estate tax impact 14116 (shown as “Under Protected”).

The user can choose to navigate to the next page or report. FIG. 142 shows a plurality of current overview charts displaying a comparison of insurance protections for different aspects of a client and/or the client's business. Current overview charts label 14201 can be personalized for the client. As shown, bar chart 14202 shows an aggregate of possible total insurability 14214 versus current insurance 14215 and the available insurance 14219 to the client and/or business for the aggregate. Bar chart 14203 shows a current insurance option for the human life value of the client and/or business. The chart also includes total insurability 14217 versus current insurance 14218 and the available insurance 14220 of the client and/or business for the human life value. Bar chart 14204 shows a current insurance option for key person(s) of the business including total insurability 14216 and the available insurance 14221 of the client and/or business for the key person(s). Bar chart 14205 shows a current insurance option for estate tax impact to the client and/or business. The chart also includes total insurability 14222 and the available insurance 14227 of the client and/or business for the key person(s). Bar chart 14206 shows a current insurance option for keep/sell options for the business. The chart also includes total insurability 14224 versus current insurance 14225 and the available insurance 14226 of the client and/or business for the keep/sell option. Bar chart 14207 shows a current insurance option for mortgages and loans to the client and/or business. The chart also includes total insurability 14223 and the available insurance 14228 of the client and/or business for the for mortgages and loans. A user can present the charts to a client for analyzing insurance for the client, and/or modify the insurance options on the charts using computer enabled user interfaces as described herein.

Accordingly, insurance professionals can use such display pages and features to manage and improve many aspects of their business operations and that clients can benefit from such improved operations and information. The display pages can be used as part of a client meeting, to form reports for a client, to practice for a meeting, to identify pertinent facts to discuss with a client, etc.

Although, the insurance-professional specific pages are particularly suited for insurance professionals, if desired, one or more of such pages can be configure for access and use by clients.

Note that the above display pages and processes were presented in particular sequences. However, variations in the order of the process steps, features, and the sequence of display pages, or the separate display or implementation of display pages are also contemplated.

One or more applications can be implemented (e.g., separately, in combination, or as a single application) to provide such insurance related display pages, features, or systems. Note that applications such as applets or modules can be used in or to implement display pages or features thereof.

For convenience and clarity, the word “page” is used herein to describe a graphical user interface through which a user or client interacts with the insurance services environment. Other terms may also be used for these features.

For the sake of brevity, it should be understood that certain structure and functionality, or aspects thereof of embodiments of the invention that are evident from the illustrations of the FIGS. have not been necessarily restated herein.

A computer or processor readable medium such as a floppy disk, CD-ROM, DVD, etc. may be use to store the processes, techniques, software, and information illustratively described herein. The media may store instructions, which when executed by a computer processor causes the processor to perform the processes described herein. The media can also be stored on devices, such as a server device, within a database, within main memory, within secondary storage, or the like.

It is to be understood that the invention is not to be limited to the exact configuration as illustrated and described herein. Accordingly, all expedient modifications readily attainable by one of ordinary skill in the art from the disclosure set forth herein, or by routine experimentation there from, are deemed to be within the spirit and scope of the invention as defined by the appended claims.

What is claimed is:

1. A method of providing an interactive retirement tool on a platform, comprising:
receiving personal data of a client for computing a personal financial condition for the client's family at a death of the client;
receiving business data of a business for computing a business financial condition of the business at the death of the client;
modifying an assumption of the business financial condition; and
providing a selection mechanism, which when selected displays a representation of a personal death benefit to the client and a representation of a business death benefit to the business, based on the modified assumption, wherein the personal financial condition and the business financial condition change in relation to a change in the personal death benefit and the business death benefit.

2. The method of claim 1, wherein modifying the assumption of the business financial condition comprises:
selecting a business owned life insurance policy for a key person of the business.

3. The method of claim 1, further comprising:
maintaining a business cash flow of the business at the death of the client within a threshold of a desired percentage of another business cash flow of the business prior to the death of the client, based on the modified assumption; and
maintaining a personal cash flow of the family at the death of the client within a threshold of another desired percentage of another personal cash flow of the family prior to the death of the client, based on the modified assumption, wherein the modified assumption comprises an addition of business owned life insurance.

4. The method of claim 1, further comprising:
displaying an impact on the liability of the business based on the business death benefit, wherein the liability includes funding a purchase of an ownership in the business, paying a mortgage or loan of the business, or replacing lost profits due to the death of a key person of the business.

5. The method of claim 1, further comprising:
displaying an impact on an asset of the family as a debt in an amount of a value of the business less at least a portion of the business death benefit.

6. The method of claim 1, further comprising:
computing a personal cash flow of the personal financial condition based on at least two of a savings rate of the family, a spending rate of the family, an income of the family, and an income replacement comprising disability insurance payments, retirement income, or savings; and
computing a net worth of the family based on an asset of the family, a liability of the family, and the change in the personal death benefit.

7. The method of claim 6, further comprising:
if an option is selected to sell an ownership of the business by the family at the death of the client:
computing an owner's equity of the business financial condition based on a mortgage or loan liability of the business, a contractual requirement to purchase the ownership by the business for a value of the business, and the change in the business death benefit;
computing a business cash flow of the business financial condition based on the mortgage or loan liability of the business and the change in the business death benefit;
computing a liability of the personal financial condition based on a debt owed by the business for at least a portion of a value of the business that is unfunded by the change in the business death benefit; and
computing a cash flow of the personal financial condition based on any assets paid by the business for the ownership.

8. The method of claim 6, further comprising:
if an option is selected to keep an ownership of the business by the family at the death of the client:
computing an owner's equity of the business financial condition based on a mortgage or loan liability of the business and the change in the business death benefit; and
computing a business cash flow of the business financial condition based on the mortgage or loan liability of the business and the change in the business death benefit.

9. The method of claim 1, further comprising:
varying a display of the personal financial condition for a client's family and a display of the business financial condition of the business based on a combination of at least two of a scenario for keeping an ownership of the business with the family, a scenario for selling the ownership, a scenario for changing a business owned life insurance policy, and a scenario for changing a personal life insurance policy.

10. An apparatus for providing an interactive retirement tool comprising:
a first computing component configured to generate a personal financial condition for a client's family at a death of the client, based on personal data of the client;
a second computing component configured to generate a business financial condition of the business at the death of the client, based on business data of a business of the client, wherein at least a portion of the personal financial condition or business financial condition is configured to be modified in a layer in a user interface;
a third computing component configured to receive an assumption about the business financial condition and the personal financial condition, wherein the assumption compromises a personal life insurance policy for the client, and a business owned life insurance policy for a key person of the business; and
a fourth computing component configured to change the personal financial condition and the business financial condition based on a change in a level of insurance protection provided by the received assumption.

11. The apparatus of claim 10, wherein the fourth computing component is further configured to display, based on the change in the level of insurance protection, a positive cash flow within the displayed layer, wherein the cash flow is a business cash flow of the business or a client cash flow of the client.

12. The apparatus of claim 10, wherein the fourth computing component is further configured to maintain a cash flow of the business at the death of the client within a threshold of a desired percentage of another cash flow of the business prior to the death of the client.

13. The apparatus of claim 10, further comprising:
a fifth component for displaying an impact on a liability of the business based on the business death benefit, wherein the liability includes funding a purchase of an interest in the business, paying a mortgage or loan of the business, or replacing lost profits due to the death of the key person.

14. The apparatus of claim 10, further comprising:
a fifth component for providing an interface mechanism for establishing a business sponsored retirement program or executive benefit plan based on a decision tree data structure, wherein the decision tree data structure comprises rules based on a type of the business, the business financial condition, and an employee characteristic.

15. A system for providing an interactive retirement tool over a network comprising:
a consumer interface for providing over the network, personal data about a client and business data about a business of the client;
a web host configured for calculating personal financial condition based on the personal data and to generate business financial condition based on the business data;
an agent configured to perform actions comprising:
providing a selection mechanism configured to receive a selection of a personal life insurance policy for the client and a business owned life insurance policy for a key person employed by the business; and
providing another selection mechanism, which when selected displays an aggregation of a representation of a personal death benefit to the client and a representation of a business death benefit to the business based on a combination of the life insurance policies, wherein the personal financial condition and the business financial condition change in relation to changes in the death benefit; and
an insurance carrier for marketing to the client over the network, the personal life insurance policy and the business owned life insurance policy.

16. The system of claim 15, wherein the agent's actions further comprise:
displaying an interactive comparison for displaying at death and the current business financial condition and personal financial condition.

17. The system of claim 16, wherein the agent's actions further comprise:
displaying an interactive tool for varying an application or parameter of the life insurances; and
sending a message over the network to the web host to recalculate the personal financial condition and the business financial condition based on the varied application or parameter.

18. The system of claim 17, wherein the business financial condition comprises an owner's equity comprising a business liability and a portion of the business death benefit that is due to a change in the business owned life insurance.

19. The system of claim 15, wherein the agent's actions further comprise:
providing an interactive cash flow planning tool for predicting a cash flow of the business based on a mortgage or loan information and an insurance protection for an asset of the business, wherein the asset comprises a key person of the business, and wherein the business financial condition comprises the business cash flow of the business.

20. A user interface for providing an interactive retirement tool comprising computer displayed components, comprising:
a personal interactive snapshot summary configured to provide personal information about a plurality of personal financial domains of the client, wherein a plurality of layers of the personal summary displays each of the different plurality of personal financial domains;
a business interactive snapshot summary configured to provide business information about a plurality of business financial domains of the business, wherein a plurality of layers of the business summary displays each of the different plurality of business financial domains;
a selection mechanism configured to modify an assumption about the personal financial domains and the business financial domains, wherein a modification of the assumption changes a display of the personal information and the business information, and wherein a change in the personal information is a function of a change in the business information and whether the assumption comprises sufficient levels of an additional insurance protection to fund a liability of the client and the business; and
a navigation mechanism configured to modify the information displayed in the personal and business information based on a sequence of displays of information within the personal financial domains and the business financial domains.

21. The user interface of claim 20, further comprising:
a personal data entry interface configured to receive information about at least a portion of the plurality of personal financial domains.

22. The user interface of claim 20, further comprising:
a personal cash flow interface configured to determine a cash flow of the family at the death or disability of the client.

23. The user interface of claim 20, further comprising:
a business cash flow design interface configured to compute a cash flow of the business based on a business valuation and at least a portion of the business financial domains.

24. The user interface of claim 20, further comprising:
a business protection interface configured to determine a degree of protection for at least a portion of the business financial domains.

25. The user interface of claim 20, further comprising:
a retirement plan interface configured to suggest a business paid retirement plan for a plurality of covered persons of the business based on received answers to decision trees.

26. The user interface of claim 20, further comprising:
a reporting interface configured to generate an observation reports about the personal financial domains and the business financial domains based on a received level of selected insurance for a key person, a received information about a mortgage and loan of the business.

27. A processor readable medium for providing an interactive retirement tool comprising instructions that when executed by a processor causes the processor to perform actions comprising:
receiving personal data of a client for computing a personal financial condition for a client's family at a death of the client;
receiving business data of a business for computing a business financial condition of the business at the death of the client;
selecting a personal life insurance policy for the client;
selecting a business owned life insurance policy for a key person employed by the business; and
providing a selection mechanism, which when selected displays an aggregation of a representation of a personal death benefit to the client and a representation of a business death benefit to the business based on a combination of the life insurance policies, wherein the personal financial condition and the business financial condition change in relation to a change in the personal death benefit and a change in the business death benefit.
